(19) United States
(12) Patent Application Publication
(10) Pub. No.: US 2026/0251287 A1
(43) Pub. Date: Aug. 27, 2026

(54) METHODS AND APPARATUS FOR SMALL APERTURE LIGHTING HAVING VARIABLE VERTICAL ADJUSTABILITY

(71) Applicant: DMF, Inc., Carson, CA (US)

(72) Inventors: Jonathan Schmidt, Manhattan Beach, CA (US); Elizabeth Soukup, Los Angeles, CA (US); Amir Lotfi, Redondo Beach, CA (US)

(73) Assignee: DMF, Inc., Carson, CA (US)

(21) Appl. No.: 19/551,512

(22) Filed: Feb. 26, 2026

Related U.S. Application Data
(60) Provisional application No. 63/763,876, filed on Feb. 26, 2025.
(60) Provisional application No. 63/964,885, filed on Jan. 21, 2026.

(51) Int. Cl. F21V 17/08; F21S 8/02; F21V 23/00; F21V 23/06; F21V 29/74; F21Y 115/10

(52) U.S. Cl. CPC F21V 17/08; F21S 8/026; F21V 23/002; F21V 23/06; F21V 29/74; F21Y 2115/10

(57) ABSTRACT

A small aperture recessed lighting apparatus includes a housing assembly, a lighting module, and a trim. The housing assembly includes a housing defining a cavity and an aperture, a heatsink subassembly disposed within the cavity and movably coupled to the housing, and a spring that applies a force to move the heatsink subassembly until the trim abuts an installation surface (e.g., a ceiling). In this manner, the lighting apparatus can accommodate drywall with different thicknesses without sacrificing light output or lighting efficiency. The cavity of the housing is divided into a wiring cavity and a heatsink cavity containing at least the heatsink subassembly and the aperture. The housing assembly further includes a wiring hub to make wiring connections with an external electrical system. The wiring hub is removable through the aperture using a wire door subassembly, which, when opened, provides access to the wiring cavity from the heatsink cavity.

### CROSS-REFERENCE TO RELATED APPLICATION(S)

This application claims the priority benefit, under 35 U.S.C. 119(e), of U.S. Application No. 63/964,885, filed Jan. 21, 2026 and entitled, “METHODS AND APPARATUS FOR SMALL APERTURE LIGHTING HAVING VARIABLE VERTICAL ADJUSTABILITY,” and U.S. Application No. 63/763,876, filed Feb. 26, 2025 and entitled, “METHODS AND APPARATUS FOR SMALL APERTURE LIGHTING HAVING VARIABLE VERTICAL ADJUSTABILITY.” Each of the aforementioned applications is incorporated herein by reference in its entirety.

### BACKGROUND

A lighting fixture is a ubiquitous device that provides artificial lighting in various indoor and outdoor settings. Conventional lighting fixtures reliant on incandescent or compact fluorescent lamp (CFL) lighting have typically used replaceable bulbs where the bulb contains components to receive an electrical input and to emit light. More recently, light emitting diode (LED)-based lighting fixtures have utilized lighting modules that contain LEDs and corresponding driver electronics to manage and control electrical inputs received by the lighting fixture.

### SUMMARY

In recent years, contemporary interior designs have trended towards a minimalist aesthetic that favors less cluttered interior spaces with clean lines. In terms of lighting, this trend has led to a desire for less visually intrusive lighting fixtures. Accordingly, recessed lighting fixtures have been developed with relatively smaller apertures, thus occupying less space on an installed surface, such as a ceiling. Herein, a non-limiting example of a small aperture recessed lighting fixture is a fixture that has an aperture with a width or diameter approximately equal or equal to 2 inches or less. Although conventional small aperture recessed lighting fixtures are less visually intrusive, the Inventors have recognized conventional small aperture recessed lighting fixtures suffer from several limitations that often make them inferior to recessed lighting fixtures with relatively larger apertures.

For instance, conventional small aperture recessed lighting fixtures typically provide less light output (e.g., a lower luminous flux) compared to larger aperture recessed lighting fixtures. This is due, in part, to a greater light output only being readily available using higher power LED light sources, which require more cooling, and the challenges in providing adequate thermal management in relatively smaller, more compact lighting modules used in conventional small aperture recessed lighting fixtures.

To the extent conventional small aperture recessed lighting fixtures can provide a relatively greater light output, this is typically only possible using a relatively large heatsink that is fixed in placed within the housing of the fixture. However, a fixed heatsink makes it more challenging for conventional small aperture recessed lighting fixtures to accommodate different built environments. For example, a ceiling space (also referred to as a “plenum”) is typically enclosed with a sheet of drywall to form a finished ceiling. Generally, the thickness of the drywall can vary between different built environments. The thickness of the drywall typically varies from 0.5 inches to 1.5 inches.

The variation in drywall thickness can have a detrimental effect on the placement of the LED light source of the fixture relative to a trim. For instance, the LED light source is typically fixed in place due to the fixed heatsink, as described above, and the trim is positioned to abut the bottom surface of the drywall. Thus, the distance between the LED light source and the aperture of the trim can vary depending on the thickness of the drywall. Because the placement of the LED light source is often optimized to be at a particular distance from the aperture of the trim, a change in this distance can result in a lower light output and a lower lighting efficiency (also referred to as a “light coupling efficiency”). Thus, the performance of a conventional small aperture recessed lighting fixture can vary depending on the thickness of the drywall enclosing a ceiling space.

Additionally, conventional recessed lighting fixtures are often challenging to service. For example, a recessed lighting fixture typically includes one or more electrical wire splices to electrically connect the lighting fixture to external wiring, which in turn is connected to an external electrical system, e.g., an external power supply (e.g., building mains), or an external controller (e.g., a dimmer, a controller to adjust the color of the emitted light). The splices are generally disposed in a junction box located within the ceiling space and, thus, inaccessible unless the drywall enclosing the ceiling space is removed. Moreover, creating wire splices is itself a laborious process that typically requires a contractor or electrician to strip the cladding from one or more wires, bend and/or twist the wire conductors from a pair of wires, and attach a wire nut to the twisted pair of wires.

Conventional small aperture recessed lighting fixtures also often include a relatively large housing (e.g., a housing with an appreciable height), thus limiting their installation in built environments with relatively small installation spaces (e.g., a ceiling with a small plenum). In some instances, the inclusion of a relatively large heatsink results in a larger housing. In some instances, a larger housing is used to accommodate an adjustable lighting module. An adjustable lighting module is a lighting module where the light source can be rotated about one or more rotation axes to adjust the direction of light emission. Conventional housings that accommodate an adjustable lighting module typically include either (a) a heatsink or an adjustment mechanism that is integrated into the housing, or (b) a “Lamp” that is installed from below the ceiling with both the heatsink and the adjustment mechanism integrated into the lamp. For both approaches, a relatively taller housing is needed to accommodate these mechanisms. In some instances, the lighting module may include an integrated driver, which typically increases the height of the lighting module, and, hence, the height of the housing.

In view of the foregoing limitations of conventional small aperture recessed lighting fixtures, the present disclosure is directed to various inventive implementations of a small aperture recessed lighting apparatus. The recessed lighting apparatus may include a housing assembly to facilitate installation into a built environment, such as a ceiling space. The housing assembly may include a housing defining a cavity and an aperture. The housing assembly may further include a heatsink subassembly disposed within the cavity of the housing. The recessed lighting apparatus may include a lighting module securely coupled to the heatsink subassembly and a trim securely coupled to the lighting module.

In one aspect, the recessed lighting apparatus may provide more light output through a relatively small aperture compared to conventional small aperture recessed lighting fixtures. For example, the recessed lighting apparatus may provide a light output up to about 1000 lumens, about 1250 lumens, or about 1500 lumens. The aperture may have a width or a diameter approximately equal or equal to 2 inches. More generally, the width or the diameter may range from about 1.8 inches to about 2.2 inches, including all values and sub-ranges in between.

In another aspect, the recessed lighting apparatus may readily accommodate drywall with different thicknesses without sacrificing light output or lighting efficiency. This may be accomplished, in part, by the heatsink subassembly being movably coupled to the housing. For example, the heatsink subassembly may travel up and down vertically within the housing. The housing assembly may further include one or more springs that apply a force to the heatsink causing the heatsink subassembly to move vertically upward. Thus, when a lighting module and a trim are coupled to the heatsink subassembly, the spring may cause the heatsink subassembly, the lighting module, and the trim to move vertically upward together. The vertical upward movement of these components may be limited by the trim making physical contact with, for example, the installation surface (e.g., the bottom surface of the drywall enclosing a ceiling space). By allowing the heatsink subassembly to move relative to the housing, the distance between the light source, which moves with the heatsink subassembly, and the aperture of the trim may be kept constant independent of the drywall thickness, thus maintaining lighting efficiency. Additionally, physical contact between the heatsink subassembly and the lighting module is maintained for all ceiling thicknesses, thus providing more consistent thermal performance. Moreover, the spring(s) may facilitate automatic adjustment in the placement of a lighting module and the trim with respect to the ceiling plane (e.g., the bottom surface of the drywall), thus reducing the need for tedious manual adjustments.

The manner in which the heatsink subassembly moves relative to the housing and the spring(s) used to facilitate this movement may be implemented in several ways. In one example, the heatsink subassembly may be movably coupled to one or more rails disposed within the cavity of the housing. The spring(s) may include one or more cantilever springs arranged to apply an upward vertical force to the heatsink subassembly. In another example, the heatsink subassembly may be coupled to a scissor linkage. Specifically, a first end of the scissor linkage may be directly coupled to the heatsink subassembly and a second end of the scissor linkage may be directly coupled to the housing. The spring(s) may include one or more helical springs attached to each scissor linkage to actuate the scissor linkage. The scissor linkages may be securely fixed to a pan frame (also referred to herein as a “base pan”) of the housing or the sides of the heatsink subassembly. Thus, the scissor linkage may be mechanically constrained to provide planar vertical motion (e.g., up and down).

In yet another aspect, the recessed lighting apparatus may provide access to wiring connections (e.g., wire splices) disposed within the housing via the aperture. Thus, the wiring connections may be accessible for servicing without requiring drywall to be removed. For example, the housing may include one or more dividers to divide the cavity into a heatsink cavity and a wiring cavity. The heatsink cavity may include the aperture and may contain the heatsink subassembly, the spring(s), the lighting module, and a portion of the trim. The wiring cavity may contain one or more wiring connections to connect the housing assembly to wiring, e.g., wiring from an external electrical system (e.g., an external power supply, an external controller, or another lighting apparatus). The housing may further include a wire door subassembly (also referred to herein as a “wire splice door subassembly”) located adjacent to the aperture. The wire door subassembly may have a closed position, e.g., when a lighting module is coupled to the housing assembly, thus blocking access to the wiring cavity from the heatsink cavity. However, when the lighting module is not present, the wire door subassembly may be moved to an open position. In the open position, the wiring connections within the wiring cavity may be accessed from the heatsink cavity via the aperture. For example, the wiring connections may be pulled out from the wiring cavity through the aperture, e.g., for servicing. Thereafter, the wiring connections may be placed back into the wiring cavity and the wire door subassembly may be moved back to the closed position before a lighting module is installed.

In some implementations, the housing assembly may include a wiring hub disposed in the wiring cavity to appreciably improve the ease of creating wiring connections, e.g., for connection with an external electrical system. The wiring hub may provide one or more electrical connectors to receive a wire connected to the external electrical system. The wire may be installed by removing the cladding from one end of the wire and inserting that end of the wire into an electrical connector. Various types of electrical connector(s) may be used including, but not limited to, a poke-in connector, and a lever connector. The wiring hub may also be connected to an electrical cable with an electrical connector to facilitate an electrical connection with the lighting module. In some implementations, the wiring hub may be removable from the wiring cavity through the aperture, e.g., when the wire door subassembly is in the open position.

In yet another aspect, the housing assembly may support both a downlight lighting module (also referred to herein as a “downlight module”) and an adjustable lighting module (also referred to herein as an “adjustable module”). Said another way, the downlight lighting modules and the adjustable lighting modules disclosed herein are interchangeable using the same housing assembly. Thus, the housing assembly may provide flexibility in terms of allowing a downlight lighting module to be readily replaced with an adjustable lighting module or vice-versa without requiring replacement of the housing assembly or removal of any drywall. In some implementations, the adjustable lighting modules disclosed herein may include an integrated tilt adjustment mechanism. Said another way, the tilt adjustment mechanism may be separate from the heatsink subassembly. Thus, the tilt adjustment mechanism may be removable from the heatsink subassembly together with the other components of the lighting module. Additionally, the tilt adjustment mechanism may remain accessible after installation of the recessed lighting apparatus, e.g., from below the ceiling.

In some implementations, the housing may be relatively compact in size (e.g., a low profile housing), thus allowing installation into relatively smaller spaces (e.g., ceilings with smaller plenums). For example, the housings disclosed herein may have a height ranging from about 2.2 inches to about 2.8 inches, including all sub-ranges and values in between.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. It should also be appreciated that terminology explicitly employed herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1A shows a bottom view of an example lighting apparatus according to various inventive implementations of the disclosure.

FIG. 1B shows a front view of the lighting apparatus of FIG. 1A.

FIG. 1C shows a cross-section view of the lighting apparatus of FIG. 1A according to the plane A-A of FIG. 1A.

FIG. 1D shows a top view of the lighting apparatus of FIG. 1A where a housing cover is removed for clarity.

FIG. 1E shows a cross-section view of the lighting apparatus of FIG. 1A according to the plane B-B of FIG. 1A.

FIG. 2A shows a top, front, left-side perspective view of a housing assembly for the lighting apparatus of FIG. 1A.

FIG. 2B shows a bottom, front, right-side perspective view of the housing assembly of FIG. 2A.

FIG. 2C shows a bottom view of the housing assembly of FIG. 2A.

FIG. 2D shows an exploded bottom, front, right-side perspective view of the housing assembly of FIG. 2A where a wire door plate is shown detached.

FIG. 2E shows an exploded bottom, front, left-side perspective view of the housing assembly of FIG. 2A where an adapter plate is shown detached.

FIG. 3A shows a top, rear, right-side perspective view of the housing assembly of FIG. 2A where a housing cover is removed for clarity.

FIG. 3B shows a top, front, left-side perspective view of the housing assembly of FIG. 3A.

FIG. 3C shows a top view of the housing assembly of FIG. 3A.

FIG. 3D shows a right-side view of the housing assembly of FIG. 3A.

FIG. 3E shows a rear view of the housing assembly of FIG. 3A.

FIG. 3F shows a left-side view of the housing assembly of FIG. 3A.

FIG. 3G shows a cross-section view of the housing assembly of FIG. 3A according to the plane A-A of FIG. 3C where a heatsink subassembly is shown at a bottom position.

FIG. 3H shows another cross-section view of the housing assembly of FIG. 3A according to the plane A-A of FIG. 3C where the heatsink subassembly is shown at an intermediate position.

FIG. 3I shows another cross-section view of the housing assembly of FIG. 3A according to the plane A-A of FIG. 3C where the heatsink subassembly is shown at a top position.

FIG. 3J shows an exploded top, front, left-side perspective view of the housing assembly of FIG. 3A where the heatsink subassembly is shown detached.

FIG. 4A shows a bottom perspective view of the heatsink subassembly of FIG. 3A.

FIG. 4B shows an exploded bottom perspective view of the heatsink subassembly of FIG. 4A.

FIG. 4C shows an exploded top perspective view of the heatsink subassembly of FIG. 4A.

FIG. 5A shows an exploded top, front, left-side perspective view of the housing of FIG. 3A where multiple divider plates, mounts, and cantilever springs are shown detached. The heatsink subassembly is removed for clarity.

FIG. 5B shows an exploded top, front, left-side perspective view of the housing assembly of FIG. 3A where a wire door subassembly and a wiring hub are shown detached.

FIG. 6A shows an exploded front perspective view of the wire door subassembly of FIG. 5B.

FIG. 6B shows an exploded rear perspective view of the wire door subassembly of FIG. 6A.

FIG. 7A shows an exploded top, front, left-side perspective view of the wiring hub and a cable of FIG. 5B.

FIG. 7B shows an exploded top, rear, right-side perspective view of the wiring hub of FIG. 7A.

FIG. 7C shows an exploded top, front, left-side perspective view of the wiring hub of FIG. 7B.

FIG. 8A shows a perspective view of a cantilever spring in the housing assembly of FIG. 3A.

FIG. 8B shows a cross-section view of the cantilever spring of FIG. 8A.

FIG. 9A shows a perspective view of a module spring in the housing assembly of FIG. 3A.

FIG. 9B shows a side view of the module spring of FIG. 9A.

FIG. 10A shows a bottom, front, left-side perspective view of an example lighting module for the lighting apparatus of FIG. 1A where the lighting module is configured as a downlight module.

FIG. 10B shows a top, rear, right-side perspective view of the lighting module of FIG. 10A.

FIG. 10C shows a front view of the lighting module of FIG. 10A.

FIG. 10D shows a right-side view of the lighting module of FIG. 10A.

FIG. 10E shows a bottom view of the lighting module of FIG. 10A.

FIG. 10F shows a top view of the lighting module of FIG. 10A.

FIG. 10G shows a cross-section view of the lighting module of FIG. 10A according to the plane A-A of FIG. 10C.

FIG. 10H shows a magnified cross-section view of a module subassembly in the lighting module of FIG. 10G.

FIG. 10I shows a cross-section view of the module subassembly of FIG. 10A according to the plane A-A of FIG. 10D.

FIG. 11A shows an exploded bottom, front, left-side perspective view of the lighting module of FIG. 10A where an optical subassembly is shown detached.

FIG. 11B shows a bottom view of the lighting module of FIG. 11A where the optical subassembly is removed for clarity.

FIG. 11C shows another exploded bottom, front, left-side perspective view of the lighting module of FIG. 11A where a wiring cover in the module subassembly is shown detached.

FIG. 12 shows an exploded top, front, left-side perspective view of a driver subassembly in the lighting module of FIG. 10A.

FIG. 13A shows an exploded bottom, front, left-side perspective view of the module subassembly in the lighting module of FIG. 10A.

FIG. 13B shows an exploded top, rear, right-side perspective view of the module subassembly of FIG. 13A.

FIG. 14A shows a bottom perspective view of the optical subassembly in the lighting module of FIG. 10A.

FIG. 14B shows a top perspective view of the optical subassembly of FIG. 14A.

FIG. 14C shows an exploded bottom perspective view of the optical subassembly of FIG. 14A.

FIG. 14D shows an exploded top perspective view of the optical subassembly of FIG. 14A.

FIG. 15A shows a bottom, front, left-side perspective view of an example lighting module for the lighting apparatus of FIG. 1A where the lighting module is configured as an adjustable module.

FIG. 15B shows a top, rear, right-side perspective view of the lighting module of FIG. 15A.

FIG. 15C shows a front view of the lighting module of FIG. 15A.

FIG. 15D shows a right-side view of the lighting module of FIG. 15A.

FIG. 15E shows a bottom view of the lighting module of FIG. 15A.

FIG. 15F shows a top view of the lighting module of FIG. 15A.

FIG. 15G shows a cross-section view of the lighting module of FIG. 15A according to the plane A-A of FIG. 15C.

FIG. 15H shows a magnified cross-section view of a module subassembly in the lighting module of FIG. 15G.

FIG. 15I shows a cross-section view of the module subassembly of FIG. 15A according to the plane A-A of FIG. 15D.

FIG. 16A shows an exploded bottom, front, left-side perspective view of the module subassembly in the lighting module of FIG. 15A.

FIG. 16B shows an exploded top, front, right-side perspective view of the module subassembly of FIG. 16A.

FIG. 17A shows a top, front, right-side perspective view of a mount subassembly in the module subassembly of FIG. 15A.

FIG. 17B shows a front view of the mount subassembly of FIG. 17A where a portion of a mount in the mount subassembly is removed for clarity.

FIG. 17C shows an exploded bottom, front, left-side perspective view of the mount subassembly of FIG. 17B.

FIG. 18A shows a top, rear, right-side perspective view of a core subassembly in the module subassembly of FIG. 15A.

FIG. 18B shows a bottom, rear, left-side perspective view of the core subassembly of FIG. 18A.

FIG. 18C shows a right-side view of the core subassembly of FIG. 18A.

FIG. 18D shows a front view of the core subassembly of FIG. 18A.

FIG. 18E shows a left-side view of the core subassembly of FIG. 18A.

FIG. 18F shows an exploded bottom, front, left-side perspective view of the core subassembly of FIG. 18A where an optical subassembly is shown detached.

FIG. 18G shows an exploded bottom, front, right-side perspective view of the core subassembly of FIG. 18A where an electrical connector and a wiring cover are shown detached. The optical subassembly is removed for clarity.

FIG. 18H shows an exploded top, front, left-side perspective view of the core subassembly of FIG. 18G.

FIG. 18I shows an exploded bottom, front, left-side perspective view of the core subassembly of FIG. 18H. The electrical connector and wiring cover of FIG. 18G are removed for clarity.

FIG. 18J shows an exploded top, front, right-side perspective view of the core subassembly of FIG. 18I.

FIG. 19A shows a bottom perspective view of the optical subassembly in the lighting module of FIG. 15A.

FIG. 19B shows a top perspective view of the optical subassembly of FIG. 19A.

FIG. 19C shows an exploded bottom perspective view of the optical subassembly of FIG. 19A.

FIG. 19D shows an exploded top perspective view of the optical subassembly of FIG. 19A.

FIG. 20A shows a bottom perspective view of a trim for the lighting apparatus of FIG. 1A.

FIG. 20B shows a top perspective view of the trim of FIG. 20A.

FIG. 20C shows a cross-section view of the trim of FIG. 20A.

FIG. 20D shows an exploded top perspective view of the trim of FIG. 20A.

FIG. 20E shows an exploded bottom perspective view of the trim of FIG. 20A.

FIG. 21A shows a cross-section view of the lighting apparatus of FIG. 1A where the lighting module and the trim are being inserted through an opening formed in a ceiling to facilitate installation of the lighting apparatus.

FIG. 21B shows a cross-section view of the lighting apparatus of FIG. 21A where the lighting module is engaging with the heatsink subassembly of the housing by deflecting a pair of module springs in the heatsink subassembly.

FIG. 21C shows a cross-section view of the lighting apparatus of FIG. 21B where the lighting module is engaged with the heatsink subassembly.

FIG. 21D shows a cross-section view of the lighting apparatus of FIG. 21C where the lighting module and the heatsink subassembly are actuated to disengage the heatsink subassembly from a stowed position.

FIG. 21E shows a cross-section view of the lighting apparatus of FIG. 21D where the lighting module and the heatsink subassembly are moved upward via forces applied by the sag springs to the heatsink assembly such that the trim physically contacts the bottom surface of the ceiling.

FIG. 22A shows a cross-section view of the lighting apparatus of FIG. 1A where the heatsink subassembly is raised to an elevated position (e.g., the top position) to allow the wire door subassembly to open from a closed position.

FIG. 22B shows a cross-section view of the lighting apparatus of FIG. 22B where the wire door subassembly is shown in an open position.

FIG. 23A shows a bottom, rear, right-side perspective view of another example lighting apparatus according to various inventive implementations of the disclosure. A wire door plate is shown open. Further, bar hangers and crossmembers are not shown.

FIG. 23B shows a top view of the lighting apparatus of FIG. 23A where a top portion of a housing cover is removed for clarity. A ceiling drywall is further shown.

FIG. 23C shows a cross-section view of the lighting apparatus of FIG. 23A according to the plane A-A of FIG. 23B.

FIG. 24A shows a top, rear, left-side perspective view of a housing assembly in the lighting apparatus of FIG. 23A.

FIG. 24B shows a bottom, rear, right-side perspective view of the housing assembly of FIG. 24A.

FIG. 24C shows a top, rear, left-side perspective view of the housing assembly of FIG. 24A where a portion of the housing cover is removed to provide view of a scissor linkage and a heatsink subassembly. The heatsink subassembly is shown in a lower position.

FIG. 24D shows a top, rear, left-side perspective view of the housing assembly of FIG. 24C where the heatsink subassembly is shown in an upper position.

FIG. 24E shows a rear view of the housing assembly of FIG. 24C.

FIG. 24F shows a rear view of the housing assembly of FIG. 24D.

FIG. 24G shows a perspective view of the scissor linkage in the housing assembly of FIG. 24C.

FIG. 24H shows an exploded perspective view of the scissor linkage of FIG. 24G.

FIG. 24I shows a cross-section view of the housing assembly of FIG. 24A according to the plane A-A of FIG. 24E.

FIG. 24J shows a rear view of the housing assembly of FIG. 24A where the housing cover, dividers, and heatsink subassembly, are removed to provide view of a gearbox mounted to the heatsinks subassembly.

FIG. 24K shows a top, rear, right-side perspective view of the housing assembly of FIG. 24J.

FIG. 25A shows a top, front, left-side perspective view of the gearbox and rails shown in the housing assembly of FIG. 24K. The gearbox is shown in an unlocked configuration.

FIG. 25B shows a left-side view of the gearbox and rails of FIG. 24L.

FIG. 25C shows a rear view of the gearbox and rails of FIG. 25A.

FIG. 25D shows a cross-section view of the gearbox of FIG. 25A according to the plane A-A of FIG. 25C.

FIG. 25E shows a cross-section view of the gearbox of FIG. 25D where the gearbox is shown in a locked configuration.

FIG. 26 shows a perspective view of the rail of FIG. 25A.

FIG. 27A shows a bottom, rear, right-side perspective view of an example lighting module and a trim for the lighting apparatus of FIG. 23A where the lighting module is configured as a downlight module.

FIG. 27B shows a top front, left-side perspective view of the lighting module and the trim of FIG. 27A.

FIG. 27C shows a front view of the lighting module and the trim of FIG. 27A.

FIG. 27D shows a rear view of the lighting module and the trim of FIG. 27A.

FIG. 27E shows a left-side view of the lighting module and the trim of FIG. 27A.

FIG. 27F shows a right-side view of the lighting module and the trim of FIG. 27A.

FIG. 27G shows a top view of the lighting module and the trim of FIG. 27A.

FIG. 27H shows a bottom view of the lighting module and the trim of FIG. 27A.

FIG. 27I shows a cross-section view of the lighting module and the trim of FIG. 27A according to the plane A-A of FIG. 27D.

FIG. 27J shows a cross-section view of the lighting module and the trim of FIG. 27A according to the plane A-A of FIG. 27E.

FIG. 27K shows an exploded bottom, front, left-side perspective view of the lighting module and the trim of FIG. 27A.

FIG. 27L shows an exploded top, rear, left-side perspective view of the lighting module and the trim of FIG. 27A.

FIG. 28 shows a bottom, rear, right-side perspective view of the lighting module of FIG. 27A.

FIG. 29A shows a front view of a module housing in the lighting module of FIG. 28.

FIG. 29B shows an auxiliary front-left-side view of the module housing of FIG. 29A.

FIG. 29C shows a cross-sectional top, rear, left-side perspective view of the module housing of FIG. 29A according to the plane A-A of FIG. 29A.

FIG. 29D shows a bottom, rear, left-side perspective view of the module housing of FIG. 29A.

FIG. 30A shows a bottom perspective view of a light source, a PCB connector, and a light source holder in the lighting module of FIG. 28.

FIG. 30B shows a top perspective view of the light source, the PCB connector, and the light source holder of FIG. 30A.

FIG. 30C shows an exploded bottom perspective view of the light source, the PCB connector, and the light source holder of FIG. 30A.

FIG. 30D shows an exploded top perspective view of the light source, the PCB connector, and the light source holder of FIG. 30A.

FIG. 31A shows a bottom perspective view of an optical subassembly in the lighting module of FIG. 28.

FIG. 31B shows a top perspective view of the optical subassembly of FIG. 31A.

FIG. 31C shows an exploded top perspective view of the optical subassembly of FIG. 31A.

FIG. 31D shows an exploded bottom perspective view of the optical subassembly of FIG. 31A.

FIG. 32A shows a top, rear, left-side perspective view of an example lighting module and a trim for the lighting apparatus of FIG. 23A where the lighting module is configured as an adjustable module.

FIG. 32B shows a bottom, rear, right-side perspective view of the lighting module and the trim of FIG. 32A.

FIG. 32C shows a front view of the lighting module and the trim of FIG. 32A.

FIG. 32D shows a rear view of the lighting module and the trim of FIG. 32A.

FIG. 32E shows a right-side view of the lighting module and the trim of FIG. 32A.

FIG. 32F shows a left-side view of the lighting module and the trim of FIG. 32A.

FIG. 32G shows a top view of the lighting module and the trim of FIG. 32A.

FIG. 32H shows a bottom view of the lighting module and the trim of FIG. 32A.

FIG. 32I shows a cross-section view of the lighting and the trim of FIG. 32A according to the plane A-A of FIG. 32E. A head mount supporting a light source is shown with the optical axis of the light source oriented vertically.

FIG. 32J shows a cross-section view of the lighting and the trim of FIG. 32A according to the plane A-A of FIG. 32E. The head mount supporting the light source is shown with the optical axis rotated at an angle.

FIG. 32K shows a cross-section view of the lighting and the trim of FIG. 32A according to the plane A-A of FIG. 32E.

FIG. 32L shows an exploded bottom, rear, left-side perspective view of the lighting and the trim of FIG. 32A.

FIG. 33A shows a bottom, rear, left-side perspective view of the lighting module of FIG. 32A.

FIG. 33B shows a left-side view of the lighting module of FIG. 33A. A pair of ring mounts in the lighting module are shown transparent.

FIG. 33C shows an exploded bottom, front, right-side perspective view of the lighting module of FIG. 33A.

FIG. 34A shows a top, rear, left-side perspective view of the lighting module of FIG. 33A with a collar shown removed and the pair of ring mounts in the lighting module are shown transparent.

FIG. 34B shows an exploded top, front, right-side view of a fastener assembly to facilitate rotational adjustment of a head mount in the lighting module of FIG. 33A.

FIG. 34C shows an exploded front view of the head mount in the lighting module of FIG. 34A.

FIG. 34D shows an exploded bottom perspective view of the lighting module of FIG. 34C.

FIG. 34E shows an exploded top, front, left-side perspective view of the mount subassembly and the core subassembly of the lighting module of FIG. 34A.

FIG. 34F shows an exploded top, rear, right-side perspective view of the mount subassembly and the core subassembly of the lighting module of FIG. 34A.

FIG. 35A shows a front view of the mount subassembly in the lighting module of FIG. 33A.

FIG. 35B shows an auxiliary front-left-side view of the mount subassembly of FIG. 35A.

FIG. 35C shows a bottom, rear perspective view of the mount subassembly of FIG. 35A where a portion of a mount in the mount subassembly is removed for clarity.

FIG. 36 shows a wiring interface for the core subassembly of FIG. 33A.

FIG. 37A shows a bottom perspective view of an optical subassembly in the lighting module of FIG. 33A.

FIG. 37B shows a top perspective view of the optical subassembly of FIG. 37A.

FIG. 37C shows an exploded top perspective view of the optical subassembly of FIG. 37A.

FIG. 37D shows an exploded bottom perspective view of the optical subassembly of FIG. 37A.

FIG. 38A shows a bottom perspective view of the trim of FIGS. 27A and 32A.

FIG. 38B shows a top perspective view of the trim of FIG. 38A.

FIG. 38C shows a top view of the trim of FIG. 38A.

FIG. 38D shows a bottom view of the trim of FIG. 38A.

FIG. 38E shows a front view of the trim of FIG. 38A.

FIG. 38F shows a right-side view of the trim of FIG. 38A.

FIG. 38G shows a cross-section view of the trim of FIG. 38A according to the plane A-A of FIG. 38E.

FIG. 38H shows an exploded view of the trim of FIG. 38A.

FIG. 39 shows an exploded view of another example trim.

FIG. 40A shows a table of additional example round-shaped trims compatible with the lighting apparatuses disclosed herein.

FIG. 40B shows a table of additional example round-shaped trims compatible with the lighting apparatuses disclosed herein.

FIG. 40C shows a table of example square-shaped trims compatible with the lighting apparatuses disclosed herein.

FIG. 40D shows a table of example accessory trims compatible with the lighting apparatuses disclosed herein.

### DETAILED DESCRIPTION

Following below are more detailed descriptions of various concepts related to, and implementations of, a small aperture recessed lighting apparatus. It should be appreciated that various concepts introduced above and discussed in greater detail below may be implemented in multiple ways. Examples of specific implementations and applications are provided primarily for illustrative purposes so as to enable those skilled in the art to practice the implementations and alternatives apparent to those skilled in the art.

The figures and example implementations described below are not meant to limit the scope of the present implementations to a single embodiment. Other implementations are possible by way of interchange of some or all of the described or illustrated elements. Moreover, where certain elements of the disclosed example implementations may be partially or fully implemented using known components, in some instances only those portions of such known components that are necessary for an understanding of the present implementations are described, and detailed descriptions of other portions of such known components are omitted so as not to obscure the present implementations.

In the discussion below, various examples of a small aperture recessed lighting apparatus are provided, wherein a given example or set of examples showcases a housing assembly with a movable heatsink subassembly and a spring (e.g., a cantilever spring, a sprung gearbox mechanism) to facilitate movement of the heatsink subassembly, one or more module springs, a wire door subassembly, and a wiring hub, a lighting module (e.g., a downlight module, an adjustable module), and a trim. It should be appreciated that one or more features discussed in connection with a given example of a lighting apparatus may be employed in other examples of lighting apparatuses, respectively, according to the present disclosure, such that the various features disclosed herein may be readily combined in a given lighting apparatus according to the present disclosure (provided that respective features are not mutually inconsistent).

Certain dimensions and features of the lighting apparatus are described herein using the terms “approximately,” “about,” “substantially,” and/or “similar.” As used herein, the terms “approximately,” “about,” “substantially,” and/or “similar” indicates that each of the described dimensions or features is not a strict boundary or parameter and does not exclude functionally similar variations therefrom. Unless context or the description indicates otherwise, the use of the terms “approximately,” “about,” “substantially,” and/or “similar” in connection with a numerical parameter indicates that the numerical parameter includes variations that, using mathematical and industrial principles accepted in the art (e.g., rounding, measurement or other systematic errors, manufacturing tolerances, etc.), would not vary the least significant digit.

### 1. A FIRST EXAMPLE OF A SMALL APERTURE RECESSED LIGHTING APPARATUS

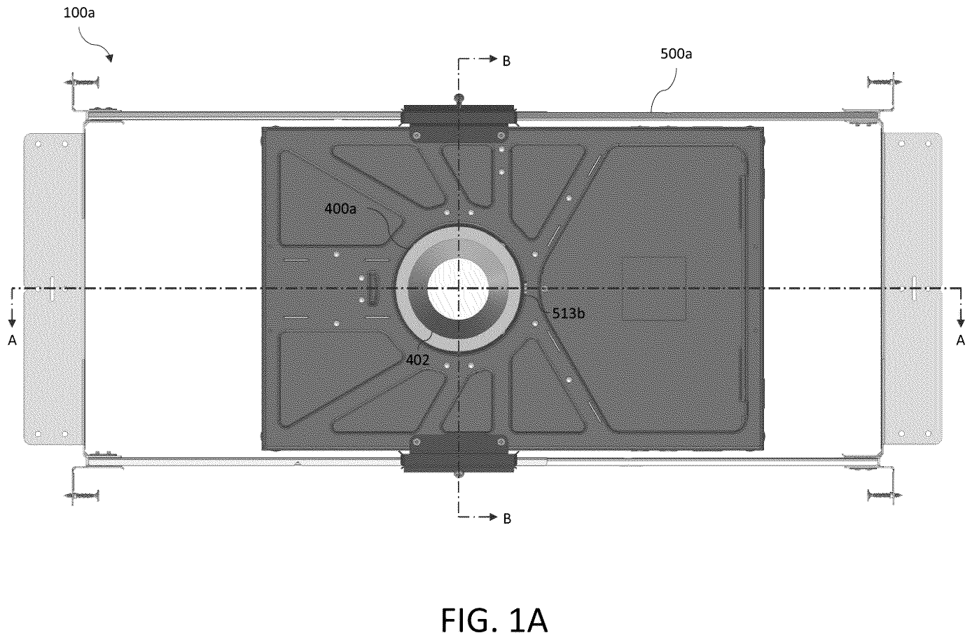

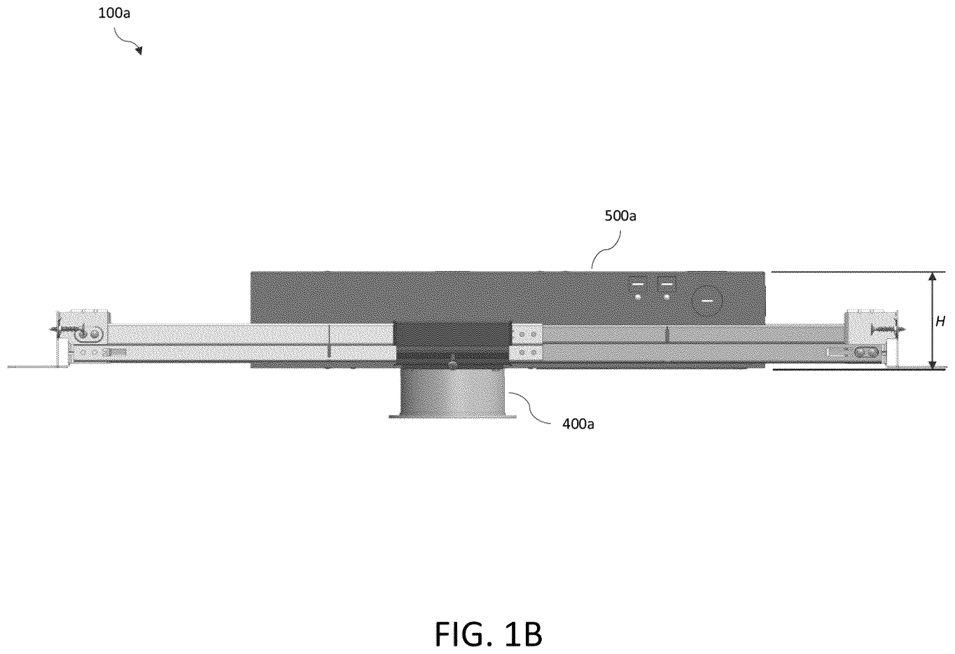

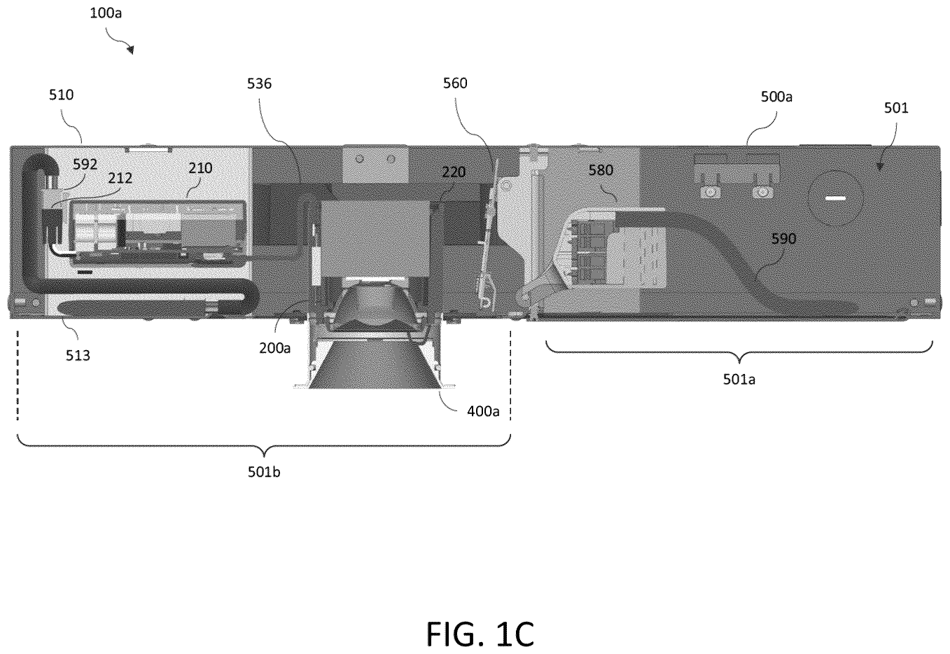

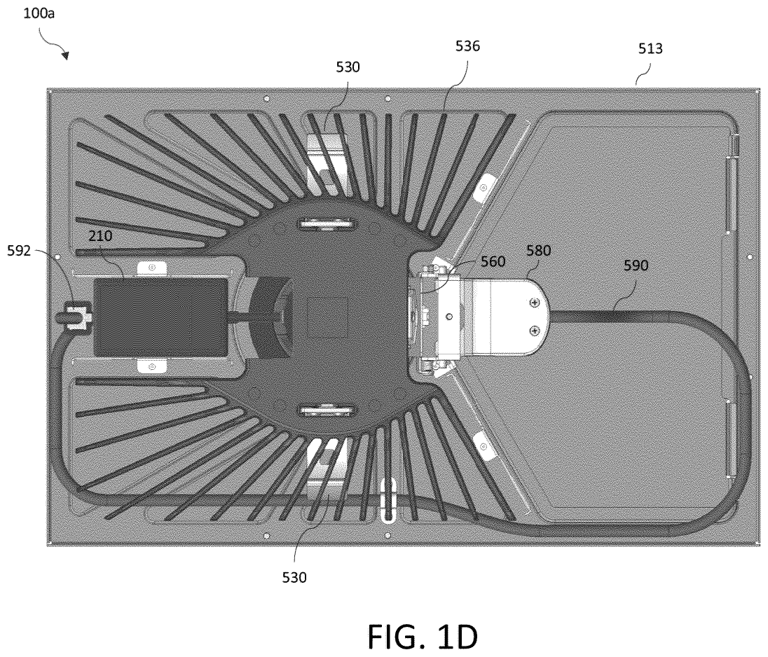

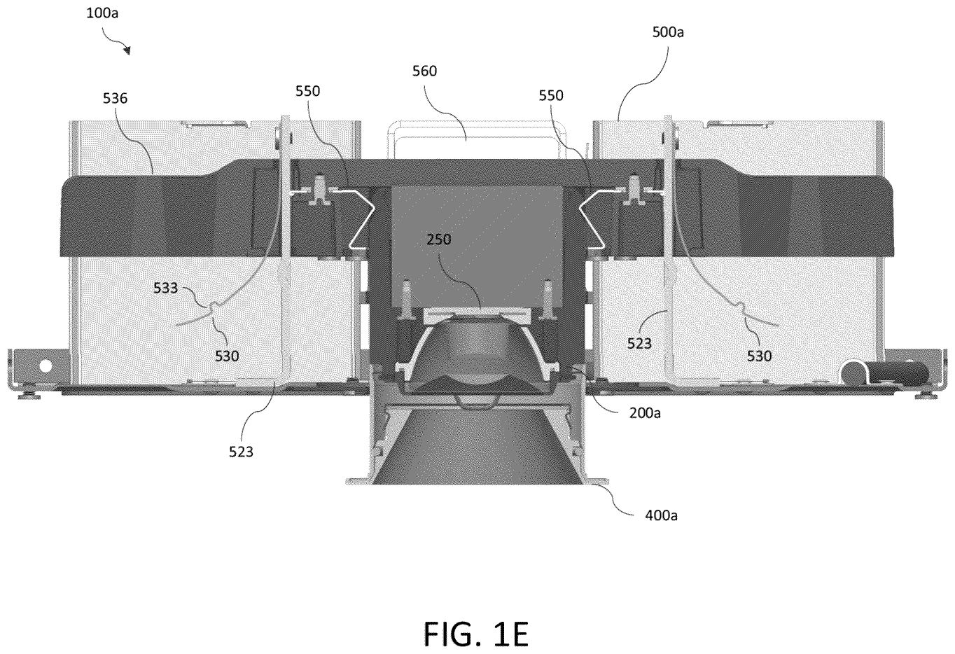

FIGS. 1A-1E show an example small aperture recessed lighting apparatus 100a (also referred to herein as a “lighting apparatus 100a”). As shown, the lighting apparatus 100a may include a housing assembly 500a to facilitate installation of the lighting apparatus 100a into a built environment. For example, the housing assembly 500a may be securely coupled to one or more support structures in a ceiling space, e.g. via bar hangers 506 and crossmembers 507. The housing assembly 500a may include a housing 510 that defines a cavity 501 to contain other components of the lighting apparatus 100a, such as a heatsink subassembly 536 (also referred to herein as a “heatsink 536” or a “housing-based heatsink 536”). The housing 510 may also define an aperture 519. In a typical ceiling installation, the housing assembly 500a may be disposed within the ceiling space and enclosed by drywall. An opening may be formed in the drywall in alignment with the aperture 519.

The lighting apparatus 100a may further include a lighting module 200a (or, alternatively, a lighting module 200b) at least partially inserted into the cavity 501 through the aperture 519. The lighting module 200a may be directly coupled to the heatsink subassembly 536. The lighting module 200a may include a module subassembly 230 containing a light source 250 (e.g., a LED light source), and a driver subassembly 210 electrically coupled to the module subassembly 230. The driver subassembly 210 may include an electrical connector 212 to receive electrical power and/or control signals from an external electrical system, e.g., an external power supply (e.g., building mains providing alternating current (AC) power), an external controller (e.g., a dimmer, a controller to adjust the color of the emitted light), or another lighting apparatus. The driver subassembly 210 may provide regulated electrical outputs (e.g., direct current (DC) power, control signals) to the module subassembly 230 to facilitate the emission of light.

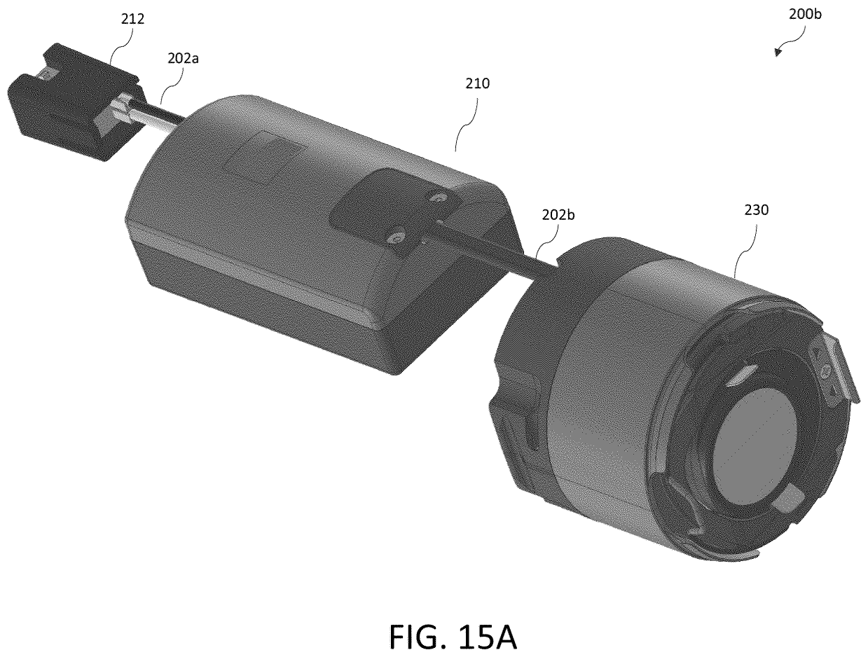

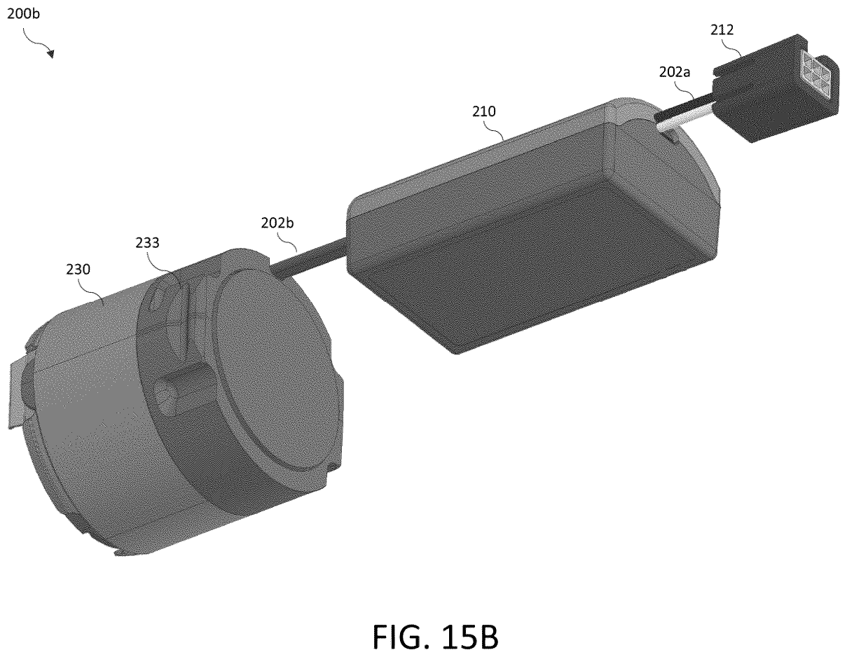

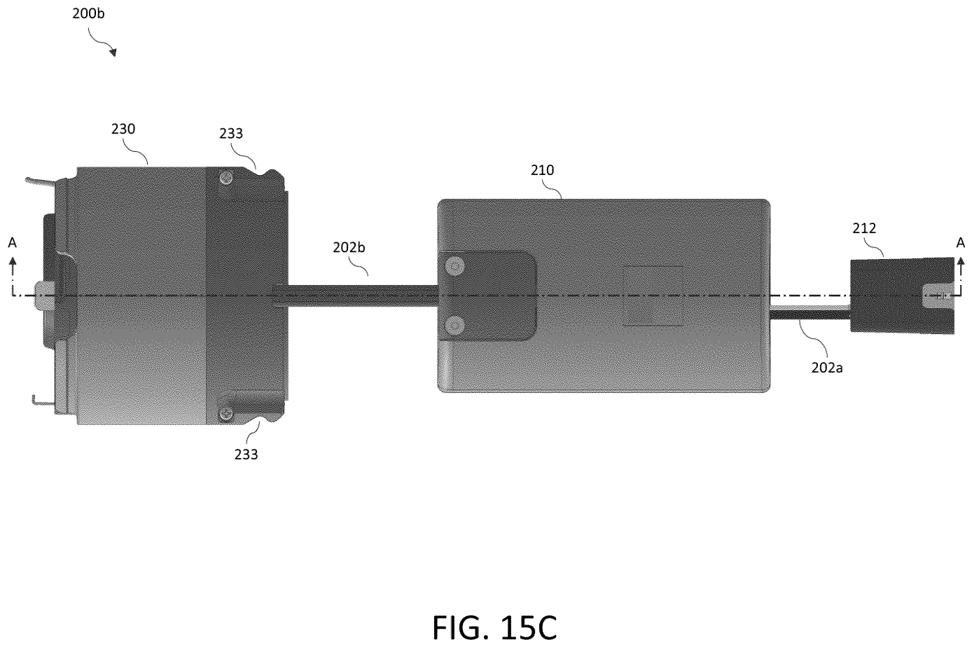

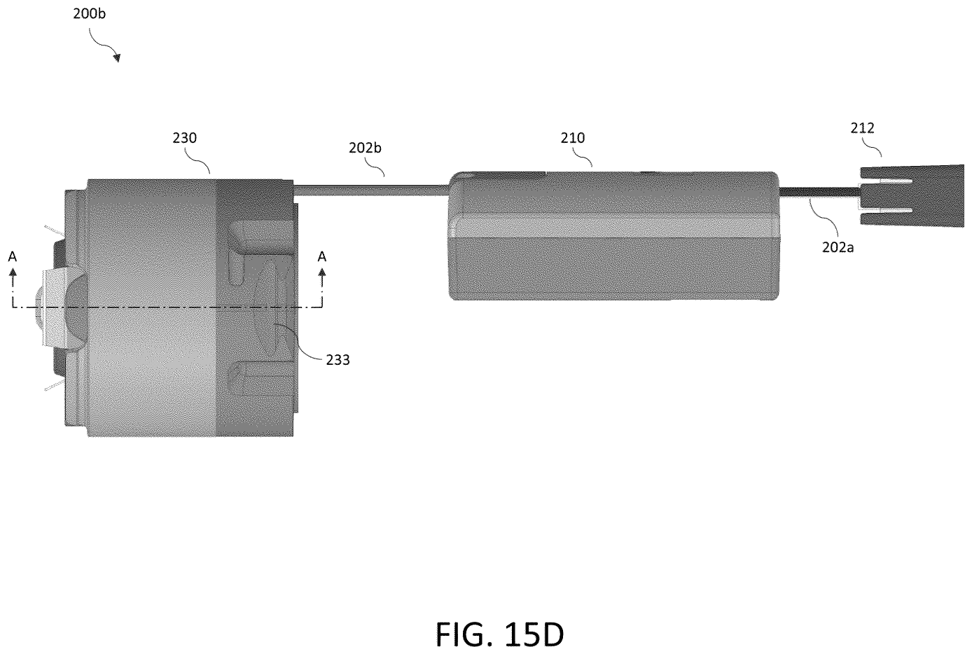

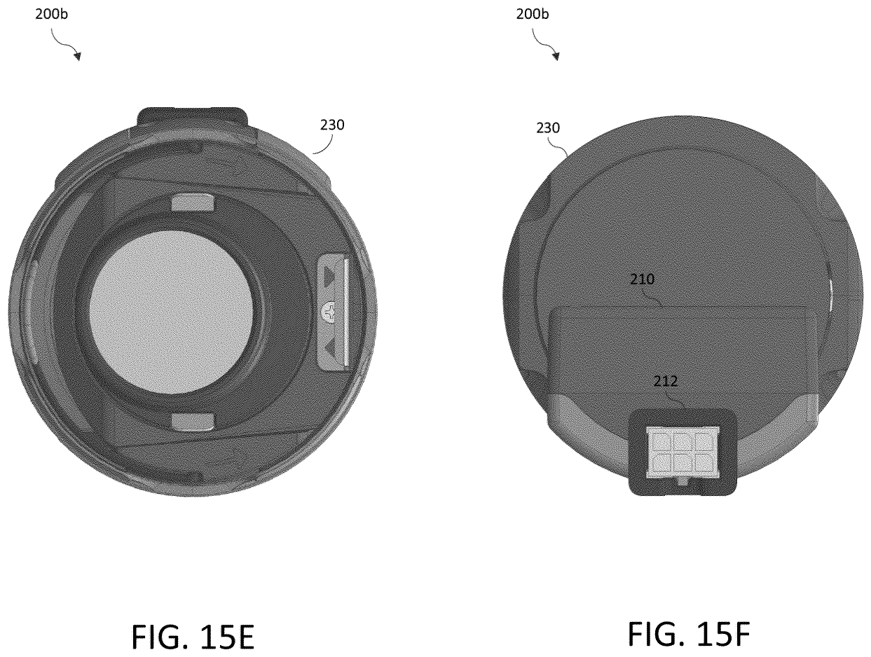

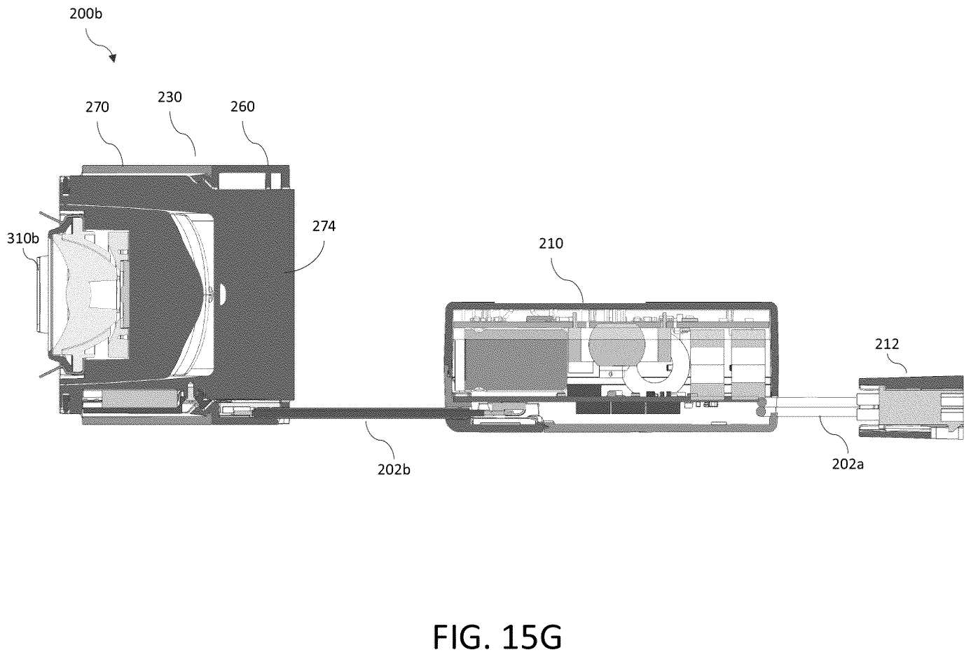

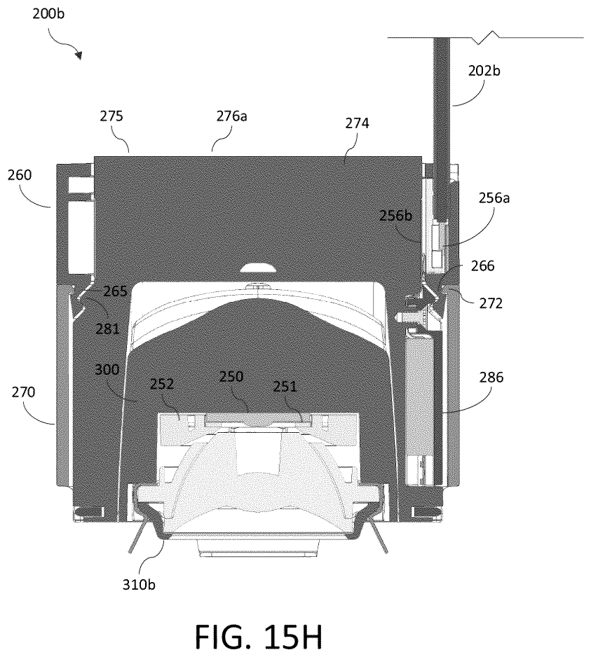

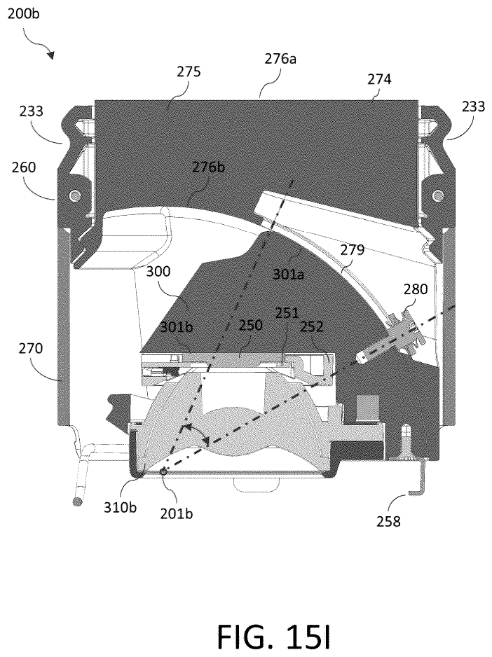

In FIGS. 1A-1E, the lighting module 200a is configured as a downlight module, i.e., a lighting module that emits light along an optical axis where the optical axis is fixed in a set direction. However, it should be appreciated that the lighting apparatus 100a may support other types of lighting modules, such as an adjustable module, i.e., a lighting module that emits light along an optical axis where the optical axis is rotatable about at least one axis (see, for example, the lighting module 200b shown in FIGS. 15A-15I).

The lighting apparatus 100a may further include a trim 400a securely coupled to the lighting module 200a. The trim 400a may include a flange component 410 to cover the edges of the opening formed in the installation surface (e.g., the ceiling drywall) and an aperture 402 through which light can pass from the lighting module 200a into an illuminated environment, thus providing an aesthetically pleasing finishing. In some implementations, the trim 400a may be the only component of the recessed lighting apparatus 100a that is observable from within the built environment (e.g., the room illuminated by the lighting apparatus 100a).

In one aspect, the recessed lighting apparatus 100a may be relatively compact in size while supporting either a downlight module (e.g., the lighting module 200a) or an adjustable module (e.g., the lighting module) 200b as described above. This, in turn, may allow the lighting apparatus 100a to be installed into smaller spaces (e.g., a smaller plenum) compared to conventional recessed lighting apparatuses. In some implementations, the housings 510 contemplated herein may have a height, H, that ranges from about 2.2 inches to about 2.8 inches, including all sub-ranges and values in between. For example, the height, H, of the housing 510 may be equal to about 2.2 inches, about 2.3 inches, about 2.4 inches, about 2.5 inches, about 2.6 inches, about 2.7 inches, or about 2.8 inches. The height, H, of the housing 510 may correspond to the largest vertical dimension of the recessed lighting apparatus 100a when installed, for example, in a ceiling space. It should be appreciated that the inventive aspects of the lighting apparatuses disclosed herein are not limited to housings having a height, H, with the foregoing dimensional ranges described above, but rather may be readily implemented into housings of any height.

Likewise, the aperture 519 of the housing assembly 500a may be relatively small, in part, so that the lighting apparatus 100a is less visually observable along the installation surface (e.g., the ceiling surface). In some implementations, the aperture 519 of the recessed lighting apparatus 100a may have a width (or diameter if circular in shape), D, ranging from about 1.8 inches to about 2.2 inches, including all sub-ranges and values in between. For example, the width, D, of the aperture 519 may be equal to about 1.8 inches, about 1.9 inches, about 2 inches, about 2.1 inches, or about 2.2 inches. In another example, the width, D, of the aperture 519 may be approximately equal or equal to 2 inches or less. It should be appreciated that the inventive aspects of the lighting apparatuses disclosed herein are not limited to a particular aperture width, D, with the foregoing dimensional ranges described above, but rather may be readily implemented into lighting apparatuses with an aperture of any width.

In another aspect, the lighting apparatus 100a may readily accommodate drywall (e.g., a panel formed from sheet rock) with different thicknesses without sacrificing light output or lighting efficiency. This may be accomplished by the housing assembly 500a providing a way to passively adjust the position (e.g., vertical position) of the lighting module 200a and the trim 400a such that the trim 400a abuts the installation surface (e.g., the bottom surface of the drywall enclosing a ceiling space). This adjustment may occur, for example, during installation of the lighting module 200a into the housing assembly 500a.

In some implementations, the lighting apparatus 100a may accommodate drywall with a thickness ranging from about 0.5 inches to about 1.5 inches, including all sub-ranges and values in between. For example, the lighting apparatus 100a may accommodate drywall with a thickness equal to about 0.5 inches, about 0.6 inches, about 0.625 inches, about 0.7 inches, about 0.75 inches, about 0.8 inches, about 0.875 inches, about 0.9 inches, about 1 inch, about 1.1 inches, about 1.125 inches, about 1.25 inches, about 1.375 inches, or about 1.5 inches. In some implementations, the heatsink subassembly 536 may have a range of travel ranging from about 1 inch to about 1.25 inches, including all sub-ranges and values in between. For example, the heatsink subassembly 536 may have a range of travel equal to about 1 inch, about 1.125 inches, or about 1.25 inches.

The passive positional adjustment of the lighting module 200a and the trim 400a may be accomplished by making the heatsink subassembly 536 of the housing assembly 500a movable with respect to the housing 510. For instance, the heatsink subassembly 536 may be slidably coupled to a pair of rails 523 as shown in FIG. 1E. The rails 523 may constrain the heatsink subassembly 536 to move along a vertical axis. More generally, the heatsink subassembly 536 may be constrained to move along an axis normal to the plane of the installation surface. The housing assembly 500a may further include a spring that applies a force directly or indirectly to the heatsink subassembly 536 to facilitate movement of the heatsink subassembly 536 and, by extension, the lighting module 200a and the trim 400a, along the vertical axis. The spring may be biased to cause movement in one direction along the vertical axis, e.g., a vertical upward direction for ceiling installations. The movement of the heatsink subassembly 536, the lighting module 200a, and the trim 400a may be limited by physical contact between the flange component 410 of the trim 400a and the installation surface (e.g., the bottom surface of the ceiling drywall). In this manner, the recessed lighting apparatus 100a may accommodate the thickness of the drywall by passively adjusting the position of the lighting module 200a and the trim 400a via the spring until the trim 400a abuts the installation surface.

By making the heatsink subassembly 536 movable with respect to the housing 510, the heatsink subassembly 536 may remain in thermal contact with the lighting module 200a to provide cooling as the position of the lighting module 200a changes. The cooling provided by the heatsink subassembly 536 may allow the lighting module 200a to support light sources that provide more light output compared to conventional small aperture lighting fixtures. For example, the light source 250 may provide a light output up to about 1000 lumens, about 1250 lumens, or about 1500 lumens. Additionally, the distance between the light source 250 and the aperture 402 of the trim 400a may remain fixed, thus providing a constant lighting efficiency as the position of the lighting module 200a and the trim 400a change in relation to the installation surface.

Generally, the spring alone may apply a sufficient force to move the heatsink subassembly 536, the lighting module 200a, and the trim 400a when the foregoing components are not mechanically constrained, i.e., when the heatsink subassembly 536 is free to move along the rails 523. Moreover, movement of the heatsink subassembly 536, the lighting module 200a, and the trim 400a may be achieved without any external force (e.g., a force applied by a user) applied directly or indirectly to the heatsink subassembly 536, the lighting module 200a, or the trim 400a. For example, the spring may apply a force greater than the sum of the combined weight of the heatsink subassembly 536, the lighting module 200a, and the trim 400a and any friction between the heatsink subassembly 536 and the rails 523.

In some implementations, the heatsink subassembly 536 may have a locked configuration where the heatsink subassembly 536 is mechanically restrained and, thus, unable to move when only the force from the spring is applied. The locked configuration may be used, for example, to keep the heatsink subassembly 536 stationary when the lighting module 200a is installed or uninstalled from the heatsink subassembly 536. The heatsink subassembly 536 may likewise have an unlocked configuration where the heatsink subassembly 536 is free to move along the rails 523 as described above. In some implementations, engagement of the locked configuration (i.e., transitioning the heatsink subassembly 536 from the unlocked configuration to the locked configuration) and disengagement of the locked configuration (i.e., transitioning the heatsink subassembly 536 from the locked configuration to the unlocked configuration) may require application of an external force (e.g., a force applied by the user). For example, an external force may be applied to disengage the locked configuration and thereafter the spring alone may cause movement of the heatsink subassembly 536. In another example, an external force may be applied to counteract the force from the spring to move the heatsink subassembly 536 into a position where the locked configuration is engaged.

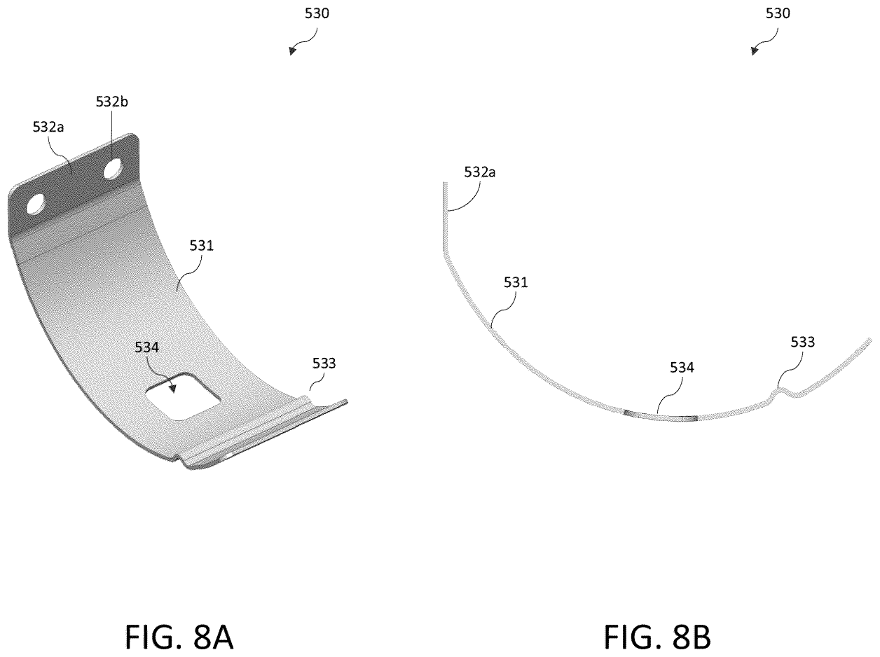

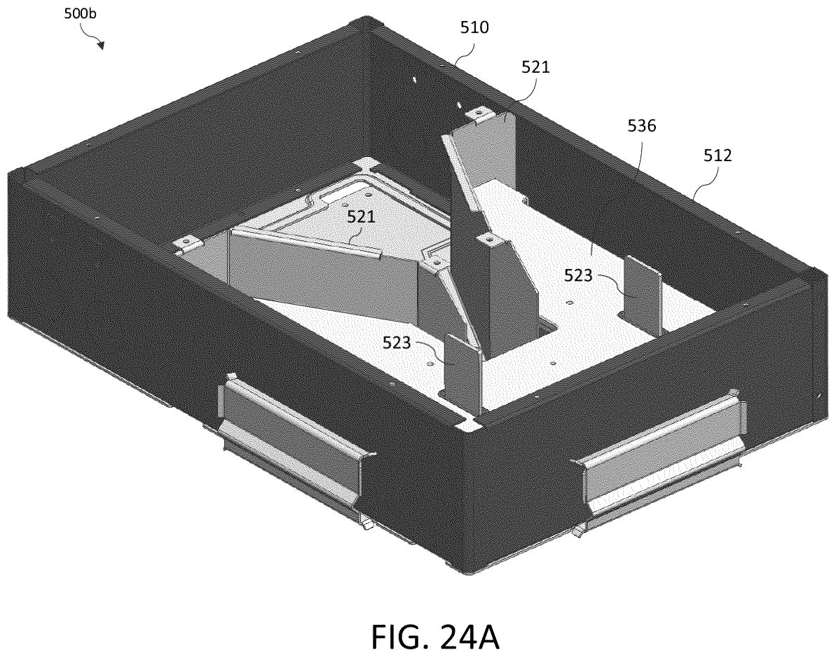

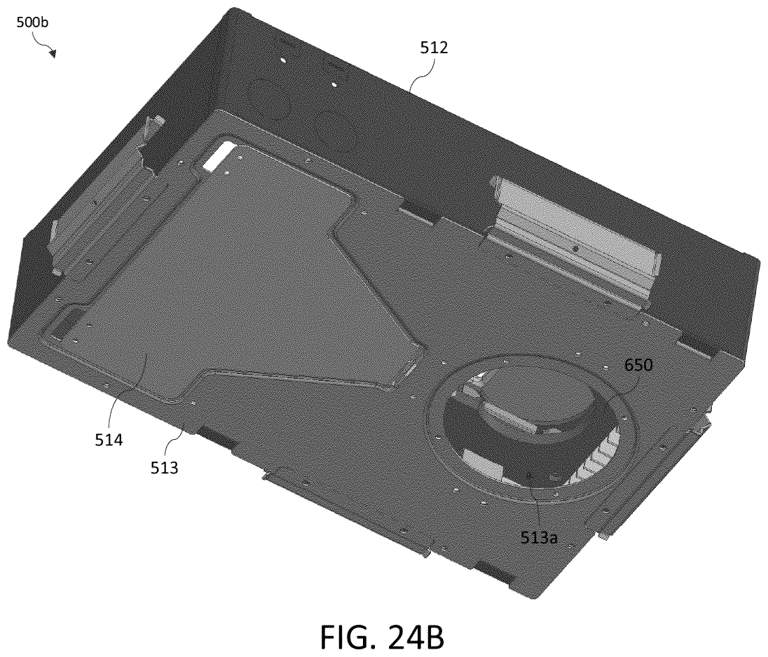

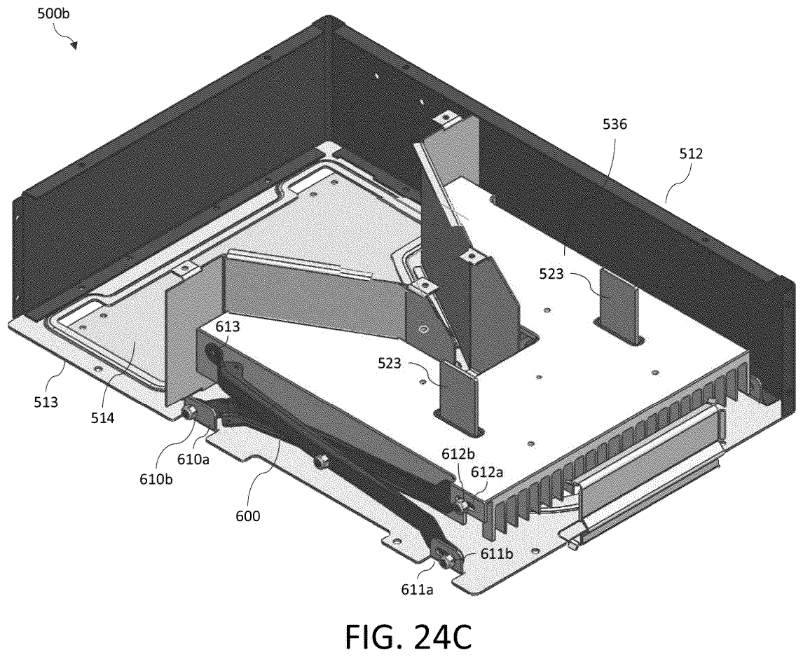

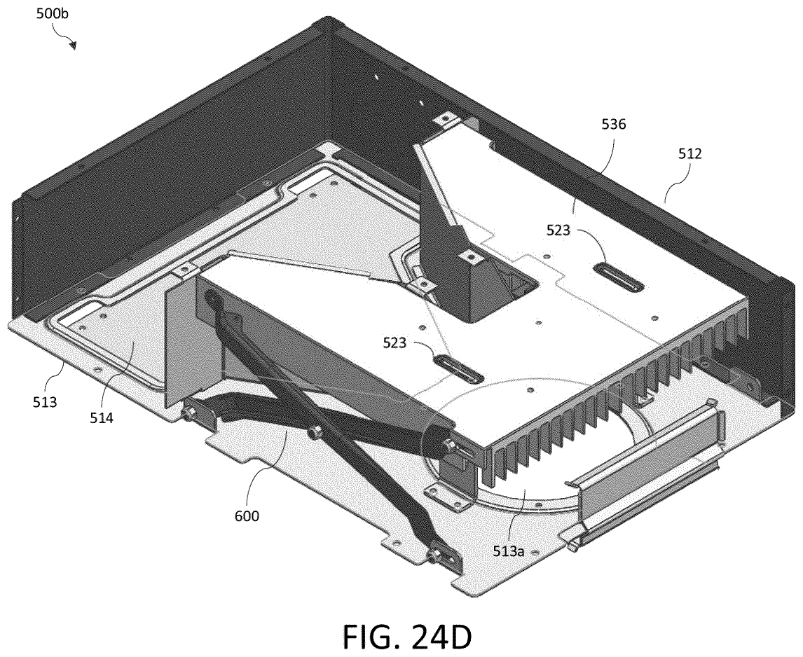

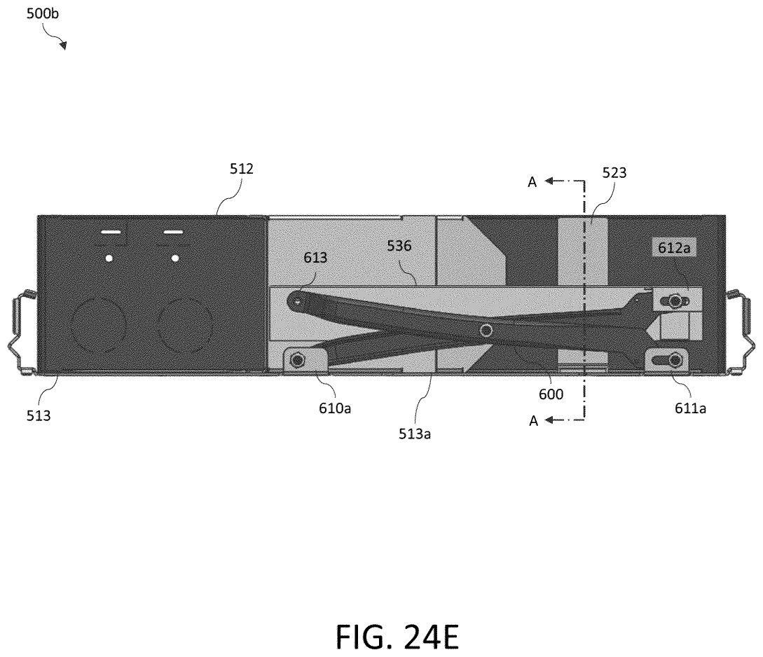

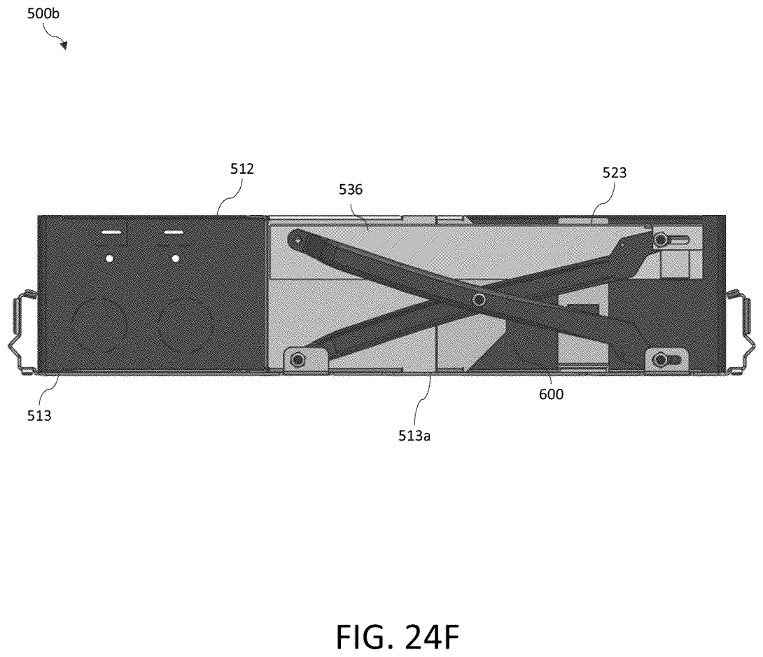

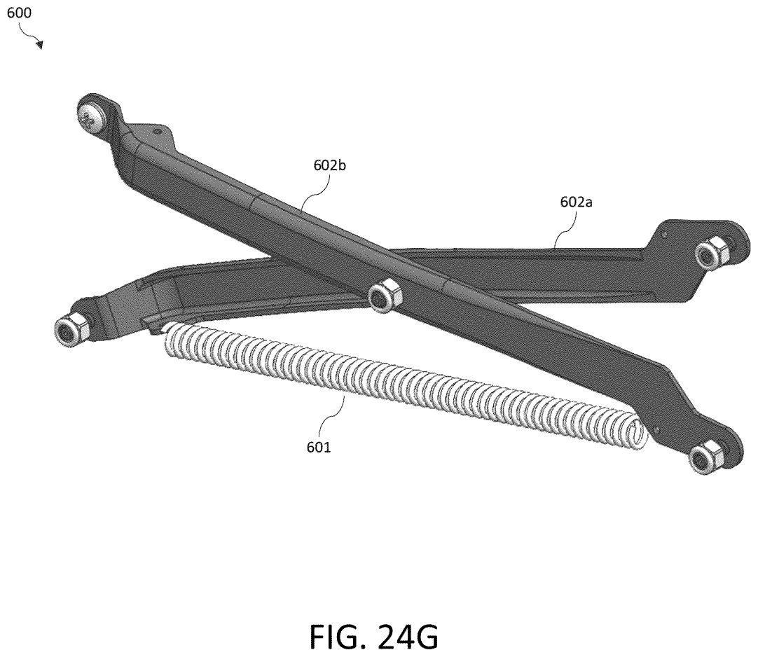

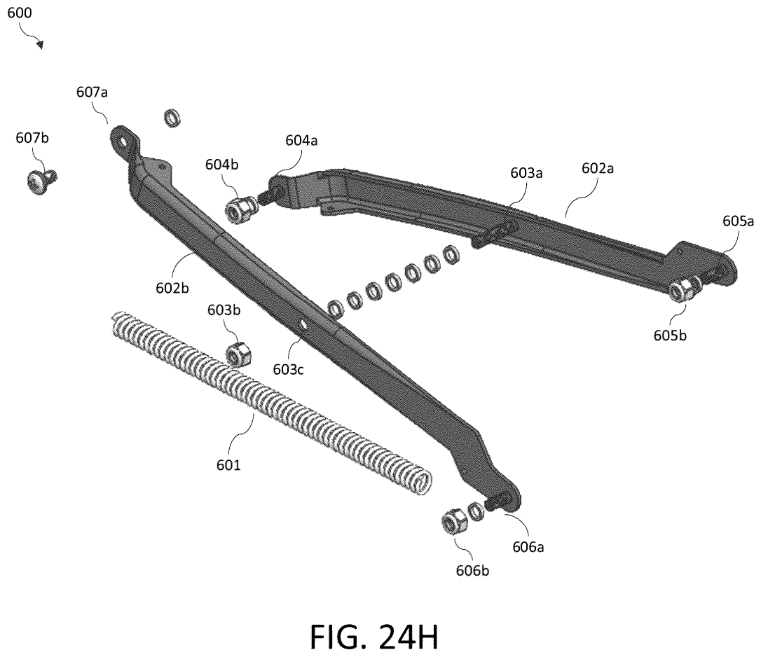

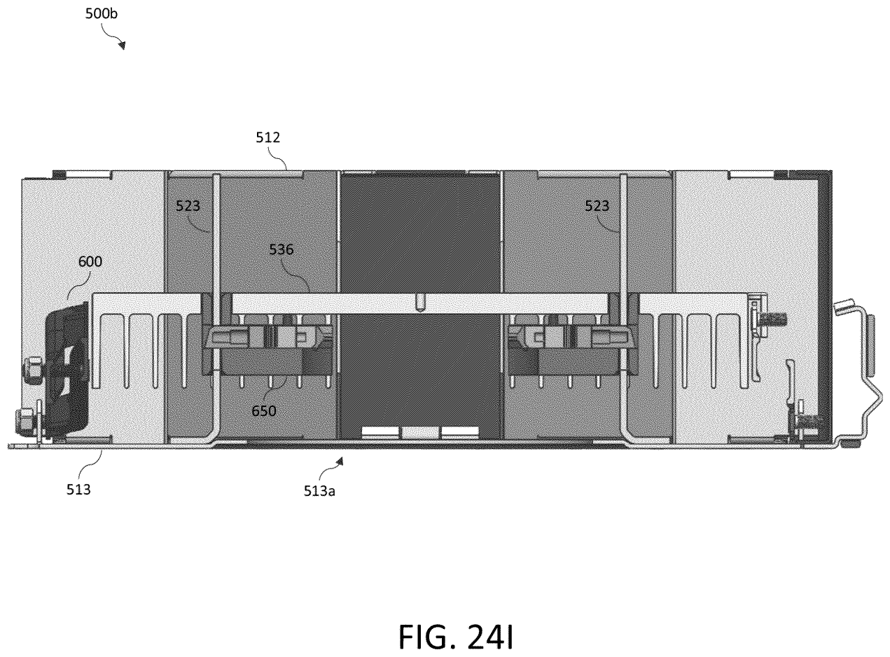

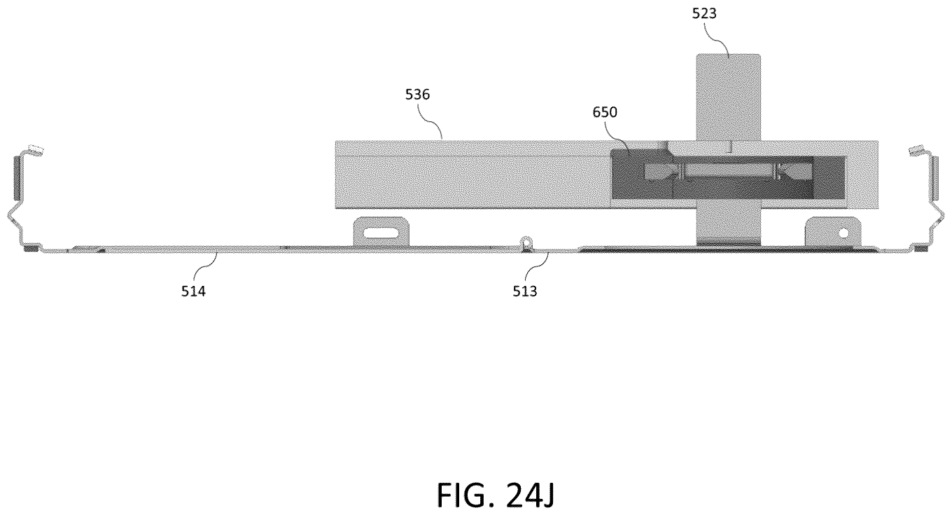

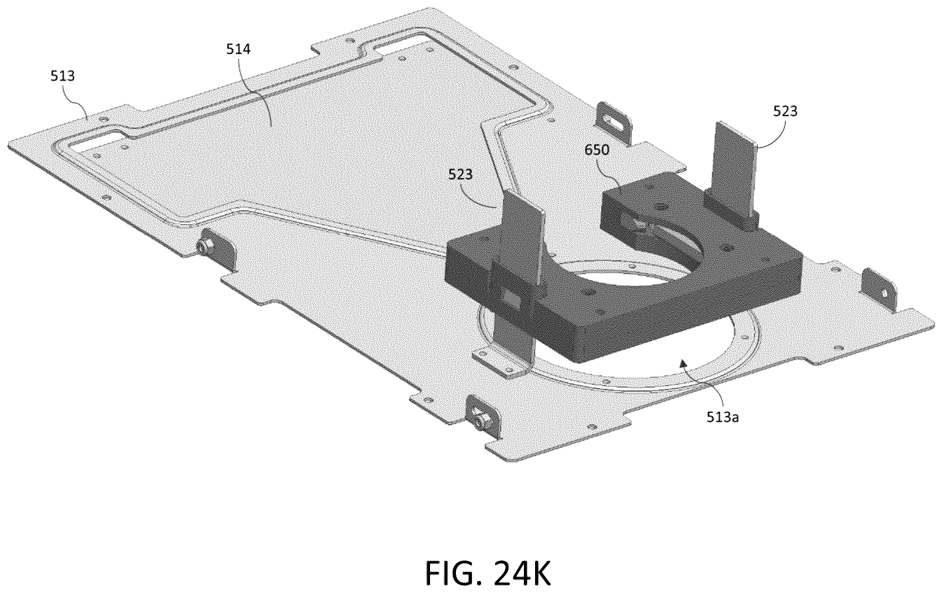

Various springs are contemplated herein to facilitate passive movement of the heatsink subassembly 536, the lighting module 200a, and the trim 400a. In one example, the spring may be a cantilever spring that directly applies a force to the heatsink subassembly 536 (see, for example, the spring 530 of FIGS. 8A and 8B). In another example, the spring may be a helical spring coupled to a scissor linkage where the scissor linkage includes a first end coupled to the housing 510 and a second end coupled to the heatsink subassembly 536 (see, for example, the spring 601 of FIGS. 24G and 24H). It should be appreciated that the housing assemblies disclosed herein may include one or more springs. Further details on the mechanisms to passively adjust the position of the heatsink subassembly 536 are provided below in Section 1.1.

In another aspect, the lighting apparatus 100a may provide access to wiring connections, such as wire splices, post-installation (i.e., after the ceiling drywall is installed to enclose the housing assembly 500a within a ceiling space) from the illuminated environment. In conventional small aperture recessed lighting apparatuses, the wiring connections are typically inaccessible post-installation unless a portion of the built environment (e.g., a portion of the ceiling drywall) is removed. In the lighting apparatus 100a, access to the wiring connections may be provided through the aperture 519 when the lighting module 200a and the trim 400a are removed from the housing assembly 500a.

As described above, the housing 510 may define a cavity 501 to contain various components of the lighting apparatus 100a. In some implementations, the cavity 501 may be divided (e.g., via one or more dividers 521a) into a wiring cavity 501a and a heatsink cavity 501b. The wiring cavity 501a may contain various wiring connections with the external electrical system. The heatsink cavity 501b may contain the heatsink subassembly 536, at least a portion of the lighting module 200a, and at least a portion of the trim 400a. Additionally, the aperture 519 of the housing assembly 500a may be adjacent to the heatsink cavity 501b. The dividers 521a may be arranged such that an opening 502 is formed between the wiring cavity 501a and the heatsink cavity 501b. The opening 502 may be sufficiently large to allow wiring connections to be moved from the wiring cavity 501a into the heatsink cavity 501b. Thereafter, the wiring connections may be moved from the heatsink cavity 501b to the exterior of the housing 510 (e.g., below the ceiling drywall) through the aperture 519. In this manner, the wiring connections may be readily serviced.

In some implementations, the housing assembly 500a may include a wire door subassembly 560 disposed at least partially within the opening 502 to facilitate access to the wiring connections disposed within the wiring cavity 501a through the opening 502. The wire door subassembly 560 may be movable between a closed position and an open position. In the closed position, the wire door subassembly 560 may block the opening 502, thus preventing access to the wiring cavity 501a from the heatsink cavity 501b, i.e., no components may be moved between the wiring cavity 501a and the heatsink cavity 501b. In the open position, the wire door subassembly 560 may be positioned to allow access to the wiring cavity 501a from the heatsink cavity 501b through the opening 502, i.e., components may be moved between the wiring cavity 501a and the heatsink cavity 501b. The heatsink cavity 501b, in turn, is accessible from within the illuminated environment (e.g., below the ceiling drywall) through the aperture 519.

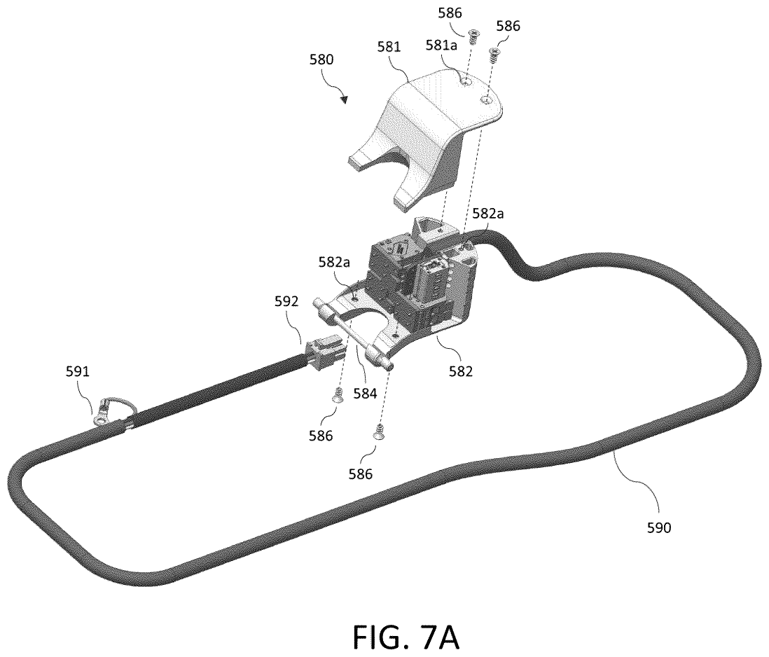

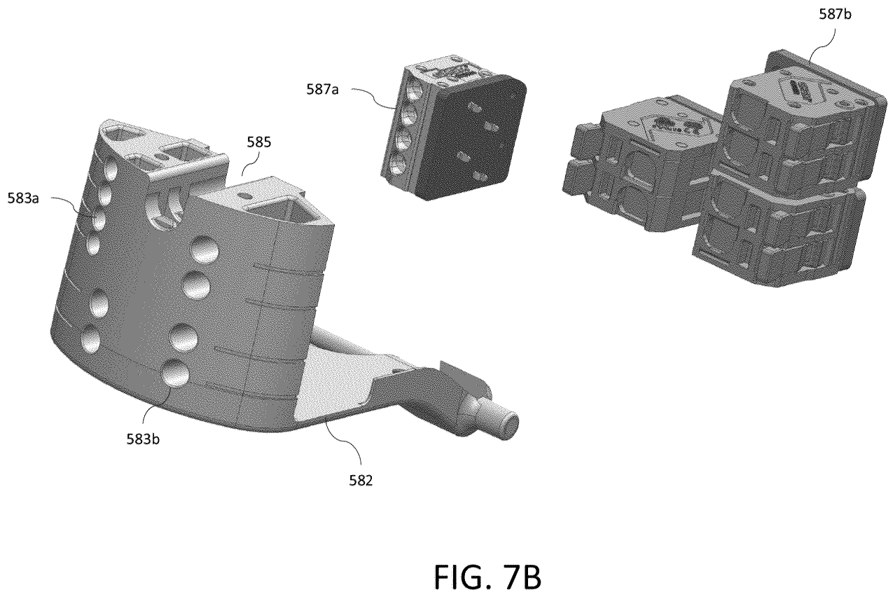

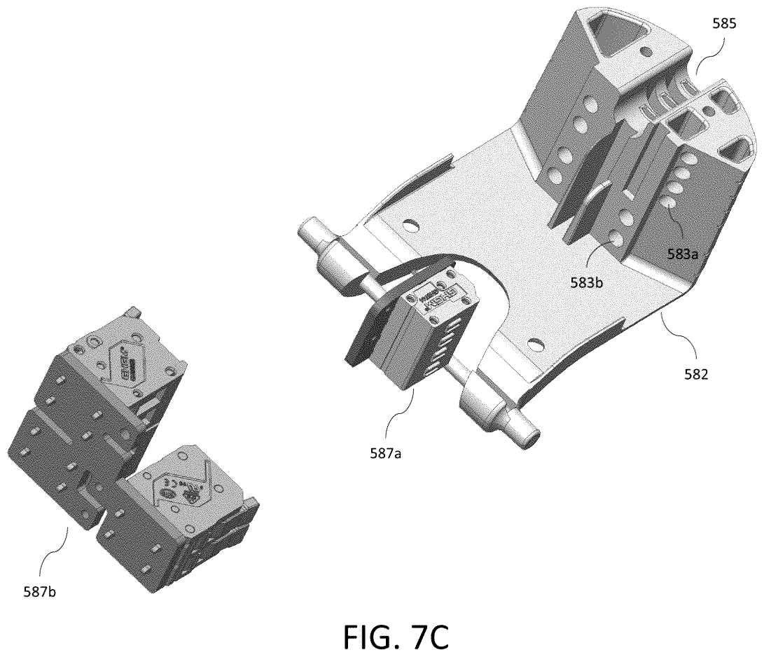

In yet another aspect, the lighting apparatus 100a may include a wiring hub 580 disposed within the wiring cavity 501a to improve the ease of making wiring connections with an external electrical system. The wiring hub 580 may provide one or more electrical connectors where each electrical connector is configured to receive a wire (see, for example, electrical connectors 587a and 587b in FIGS. 7B and 7C). The wire may be installed, for example, by removing the cladding from one end of the wire and inserting that end of the wire into a corresponding electrical connector. Various types of electrical connector(s) may be used including, but not limited to, a poke-in connector, and a lever connector. In this manner, the wiring hub 580 may reduce the number of wires that require cladding to be stripped, the need to bend and/or twist wire conductors from multiple wires, and/or the attachment of a wire nut.

The wiring hub 580 may further include an electrical interface (e.g., one or more printed circuit boards) that electrically couples the electrical connector(s) to a cable 590. The cable 590, in turn, may include an electrical connector 592 that connects to a corresponding electrical connector 212 on the lighting module 200a. The cable 590 may be arranged within the cavity 501 such that the connector 592 is positioned near the aperture 519 and, thus, readily accessible, e.g., when installing the lighting module 200a. In some implementations, the wiring hub 580 may be removable from the wiring cavity 501a through the opening 502, e.g., when the wire door subassembly 560 is in the open position, and the aperture 519.

### 1.1 An Example Housing Assembly

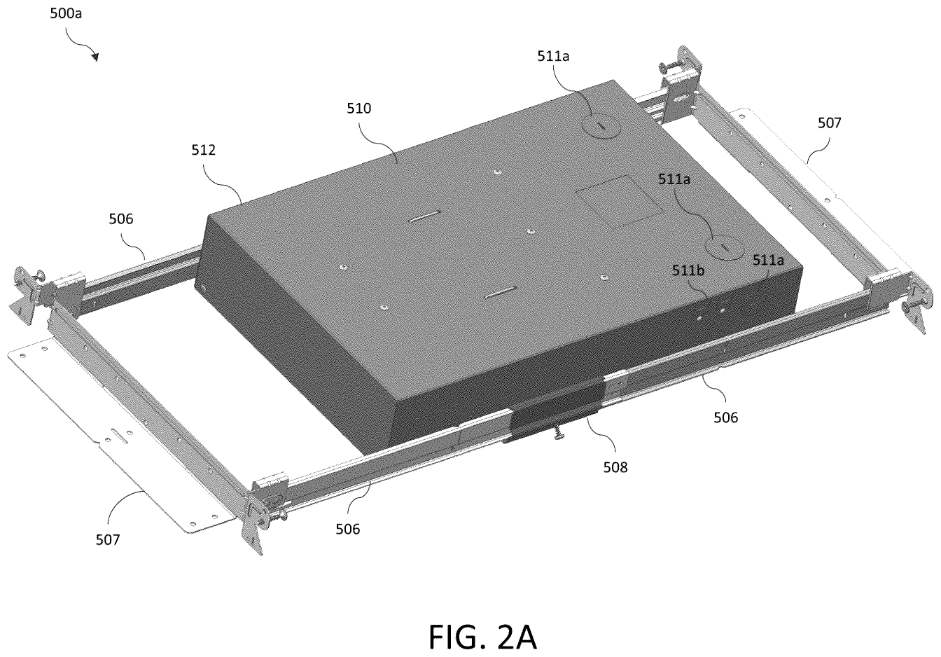

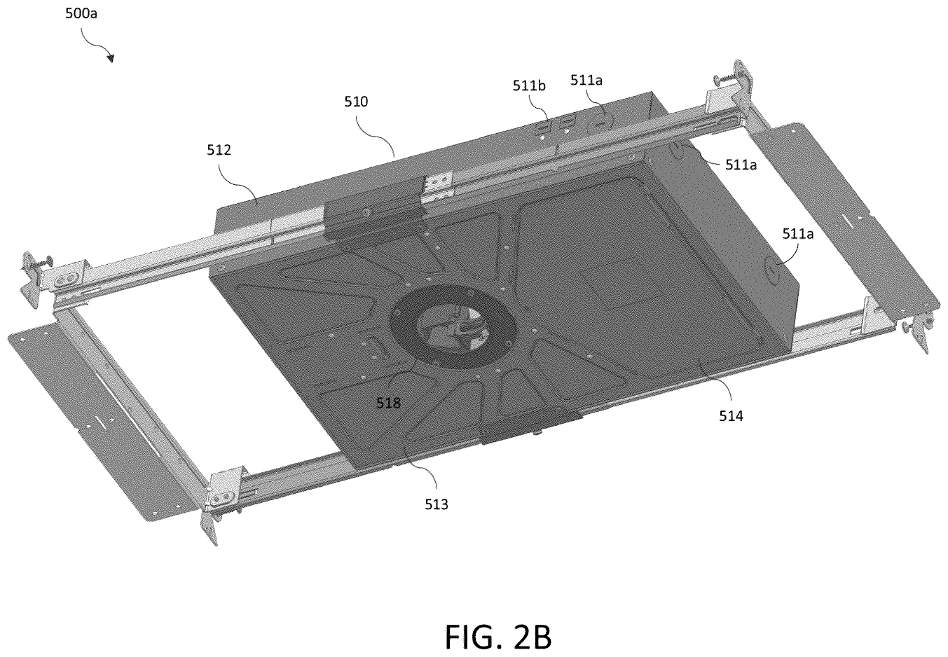

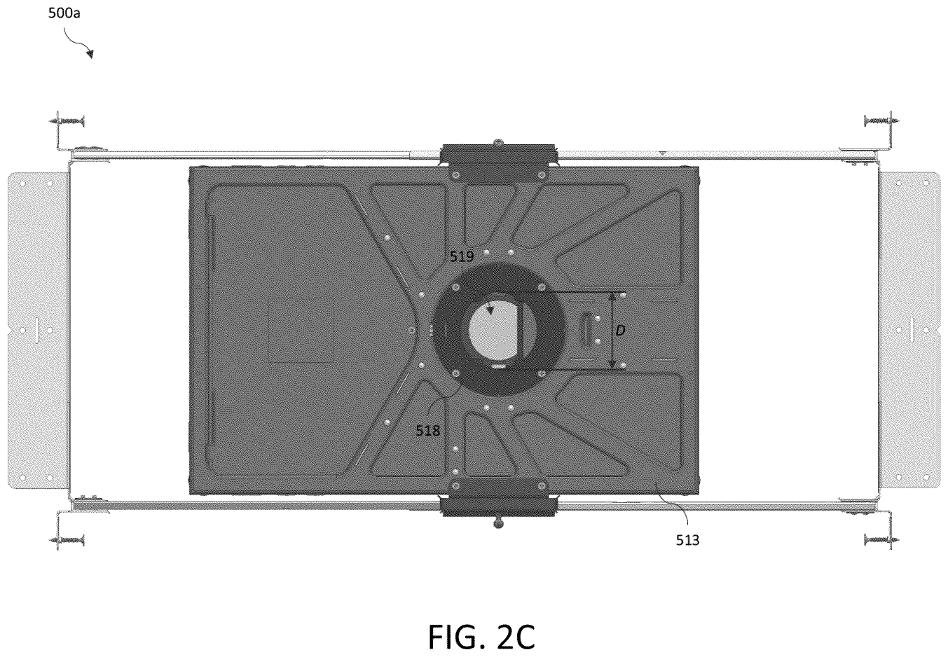

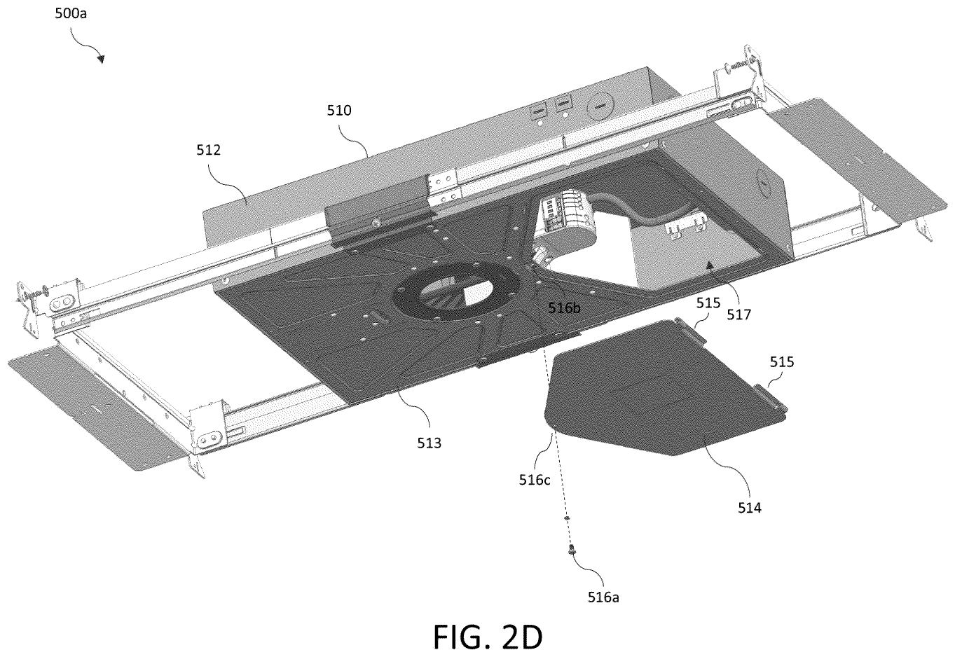

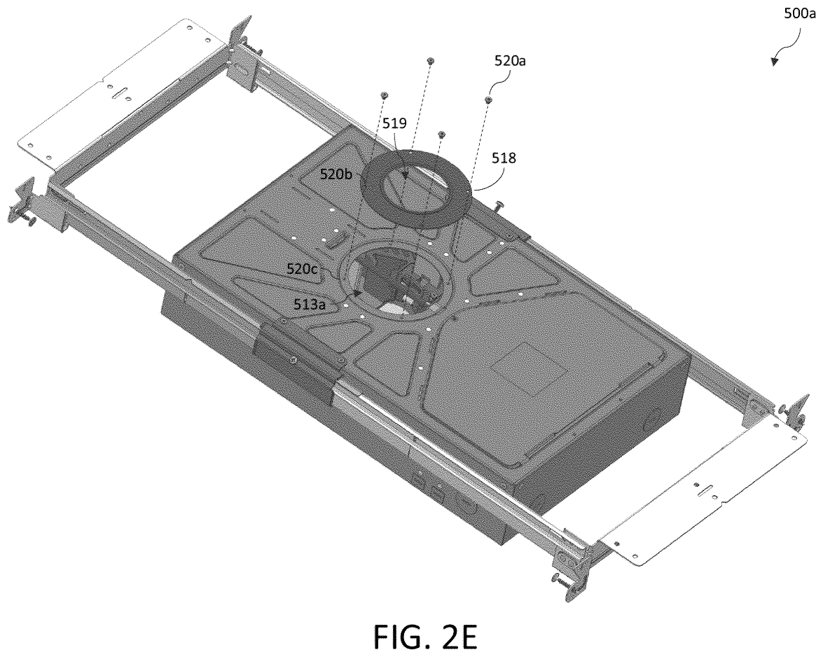

FIGS. 2A-2E show several views of the housing assembly 500a. As shown, the housing assembly 500a includes a housing 510. The housing assembly 500a may be securely coupled to one or more support structures in the built environment, e.g., support structures located in a ceiling space, to facilitate installation of the lighting apparatus 100a. In some implementations, the housing assembly 500a may include a bar hanger assembly coupled to the housing 510. For example, FIGS. 2A and 2B show the housing assembly 500a may include a first pair of bar hangers 506 coupled to a first side of the housing 510 via a first bar hanger holder 508 and a second pair of bar hangers 506 coupled to a second side of the housing 510 opposite the first side via a second bar hanger holder 508. The bar hangers 506 from the first pair of bar hangers may each be coupled to a corresponding bar hanger 506 from the second pair of bar hangers via a crossmember 507.

The crossmember 507 may couple the housing assembly 500a to various support structures including, but not limited to, a joist (e.g., a wood joist, a metal joist), a T-bar, and a hat channel. The respective bar hangers 506 in each pair of bar hangers may be slidably coupled to one another to adjust the distance between the two crossmembers 507, e.g., to span different gaps separating various support structures in a built environment. In some implementations, the bar hangers may span a gap (e.g., the center-to-center distance between two joists) ranging from about 9 inches to about 24 inches, including all values and sub-ranges in between. Additionally, the bar hanger holders 508 may each be slidably coupled to respective pairs of bar hangers 506, which allows the housing 510 to be repositioned along the bar hangers 506, e.g., to position the lighting module 200a and the trim 400a at a desired location along the installation surface. Each bar hanger holder 508 may include a locking screw to lock the position of the housing 510 along the bar hangers 506. Additional examples of bar hanger assemblies, the components and features of which may be incorporated into the bar hanger assemblies disclosed herein, are described in U.S. application Ser. No. 17/379,489, filed Jul. 19, 2021 and entitled, “BAR HANGER ASSEMBLY WITH CROSSMEMBERS AND HOUSING ASSEMBLIES USING SAME,” which is incorporated herein by reference in its entirety.

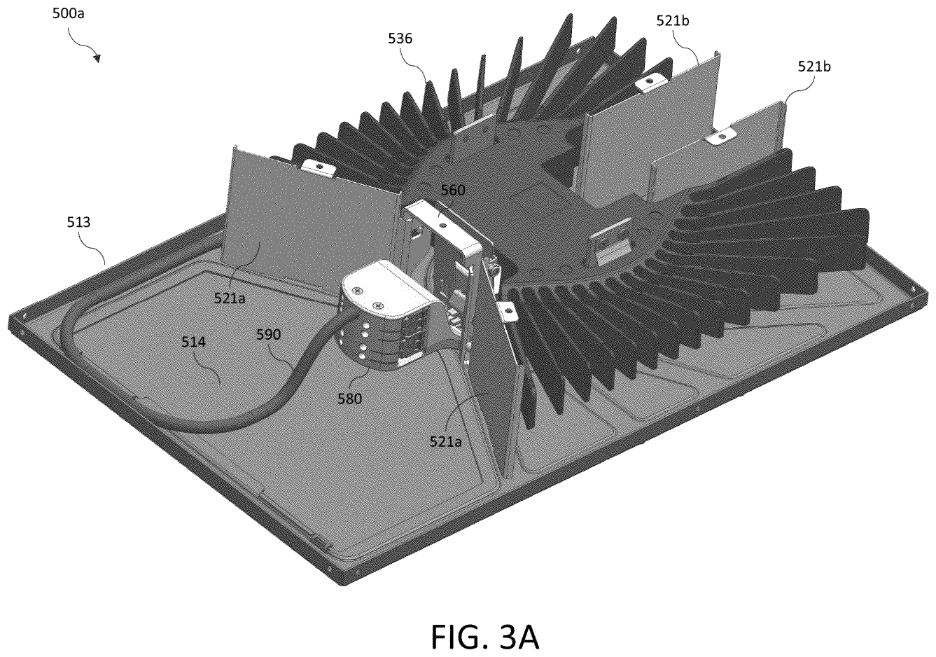

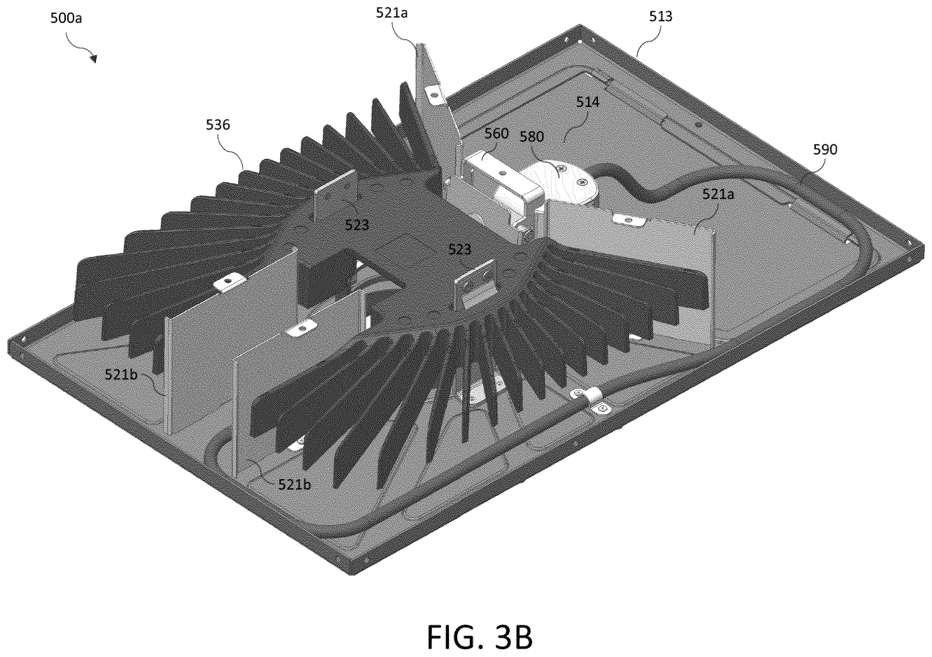

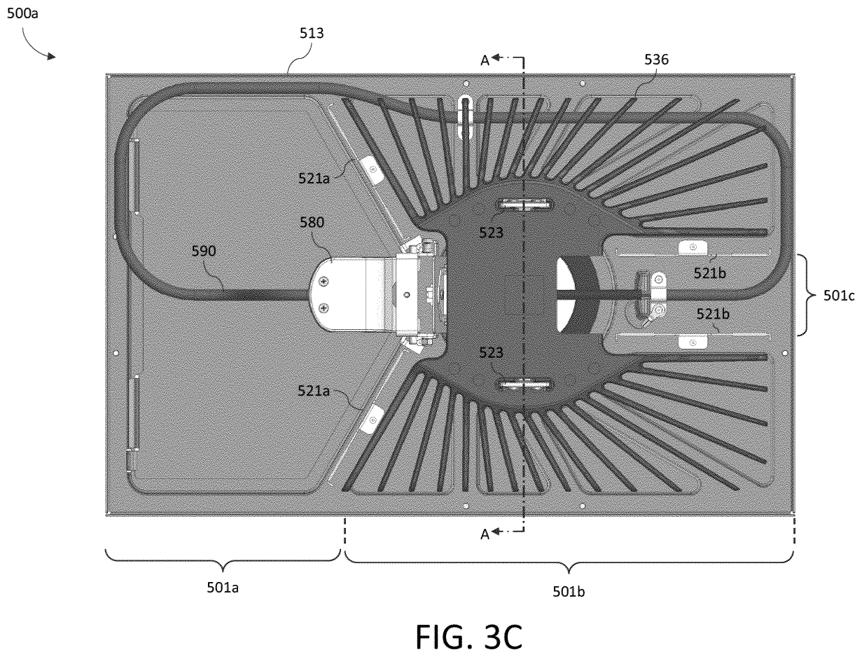

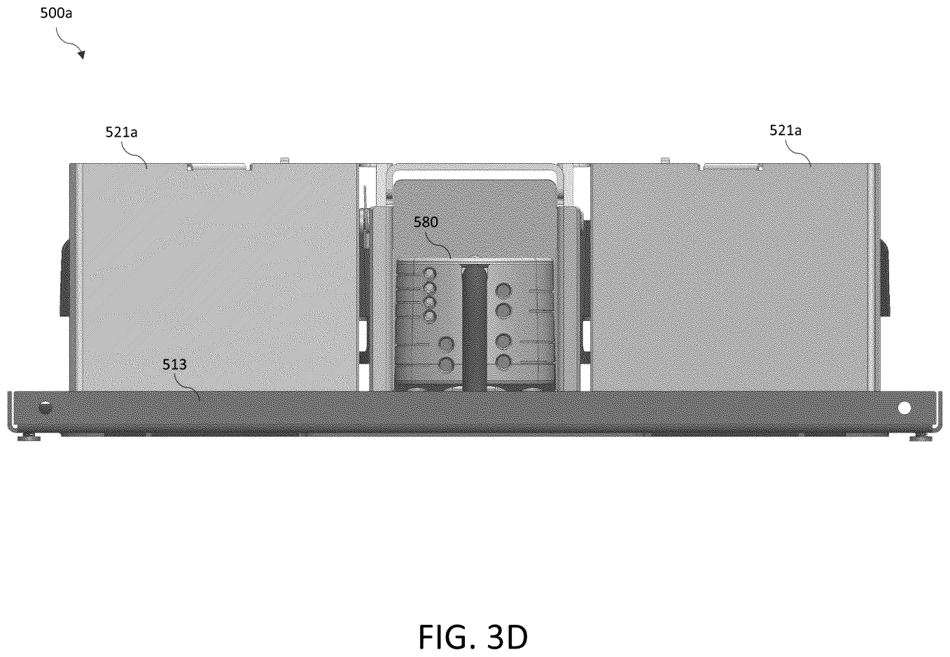

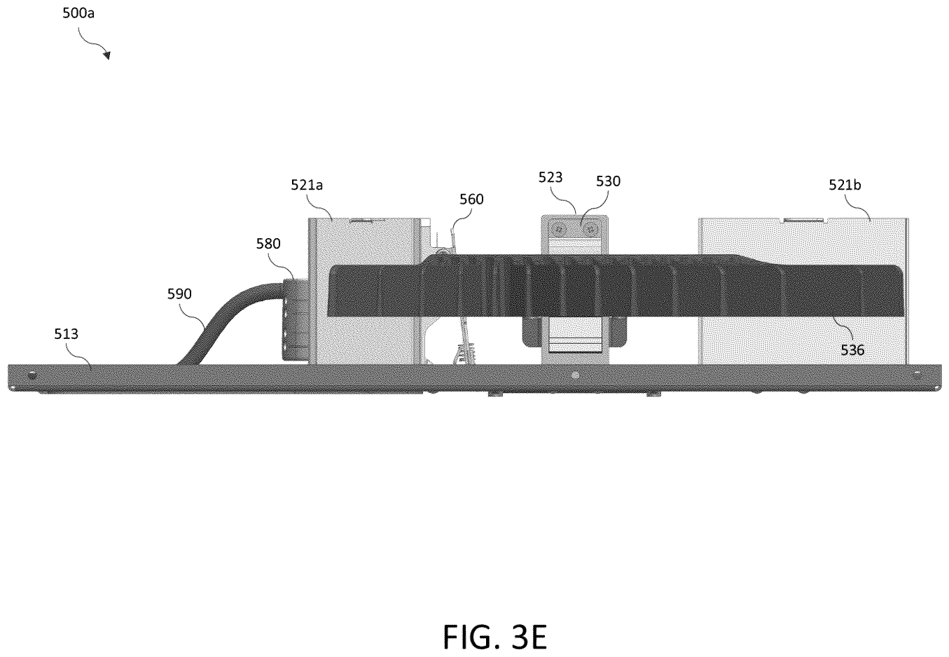

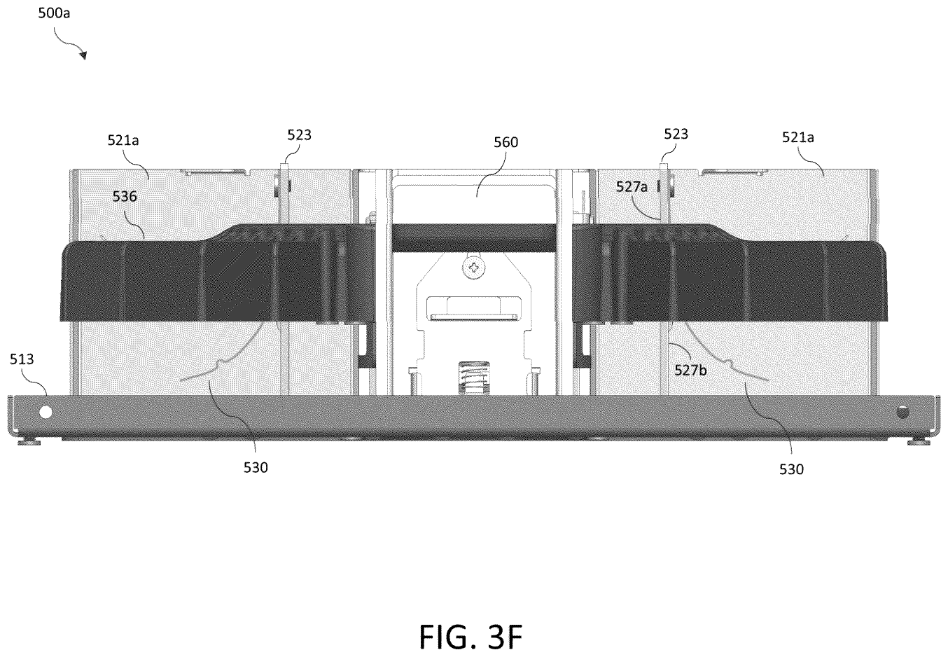

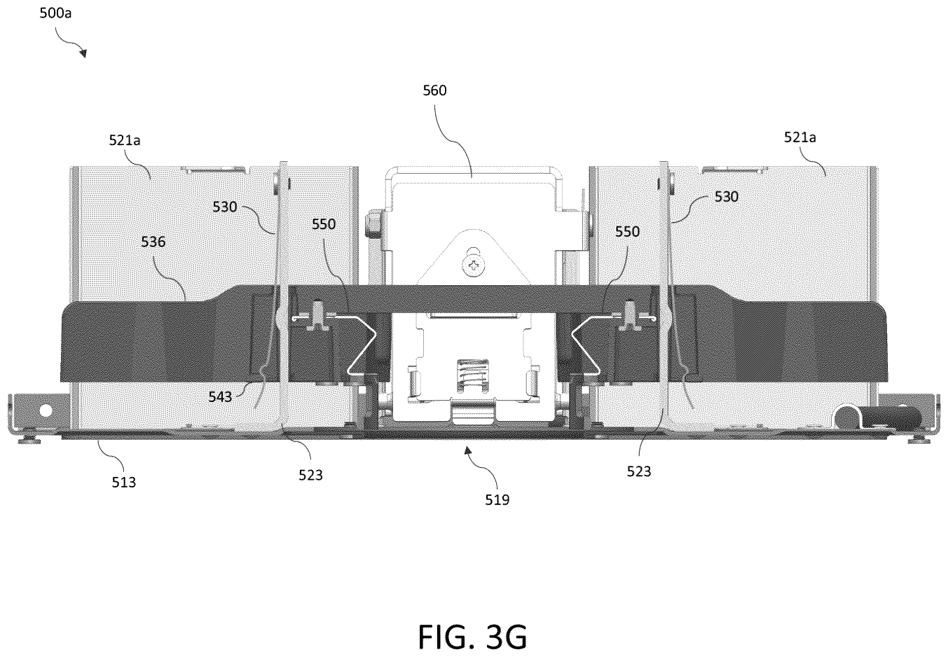

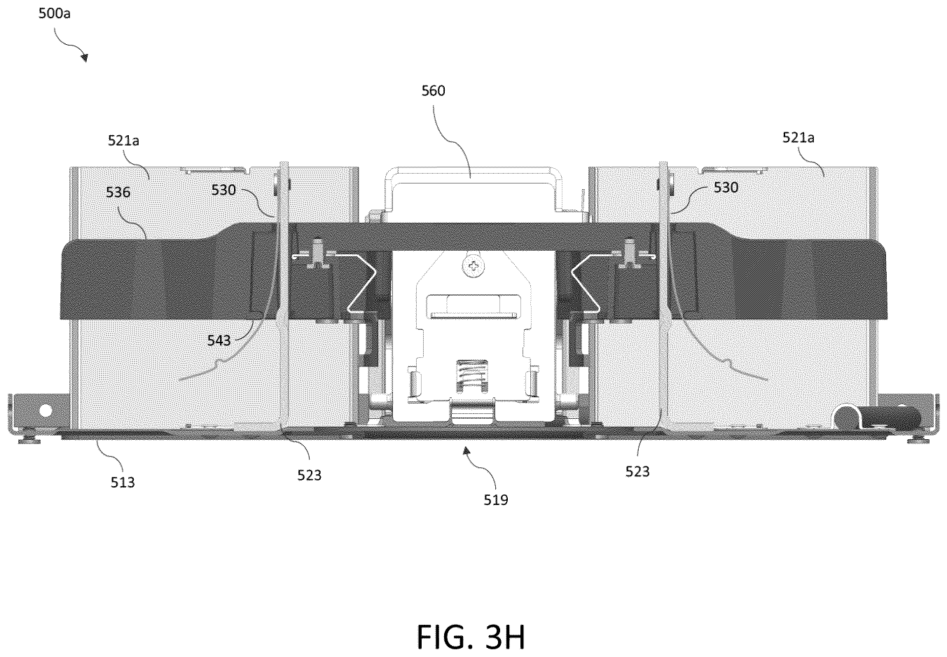

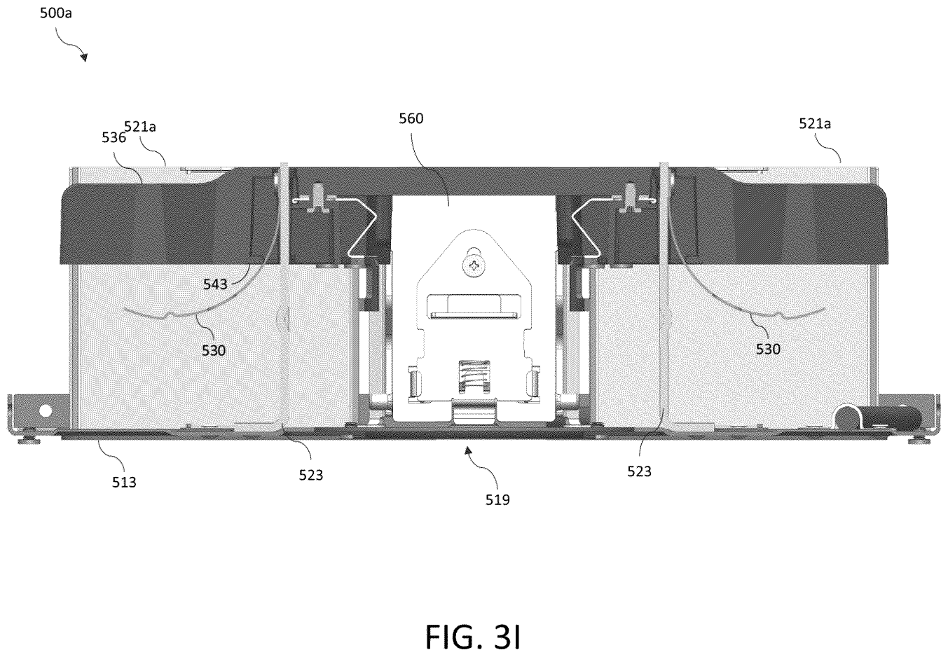

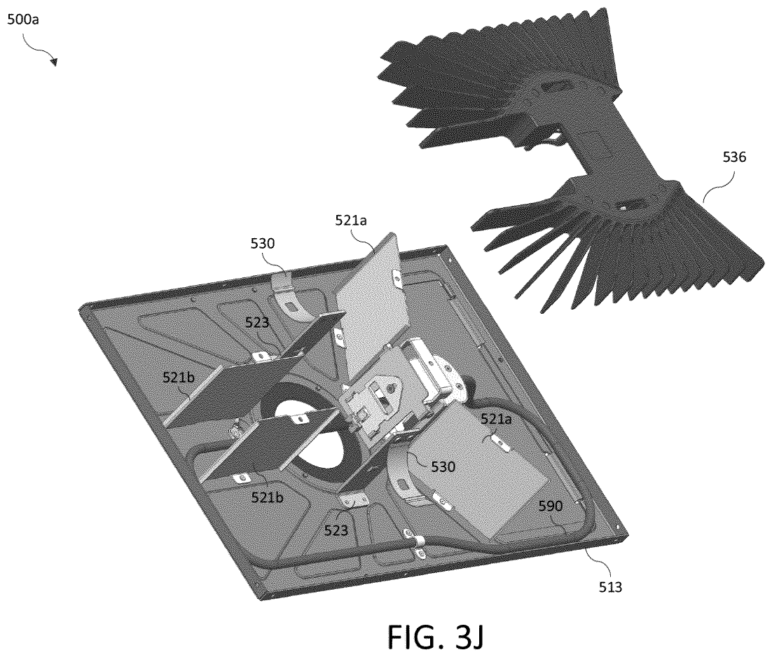

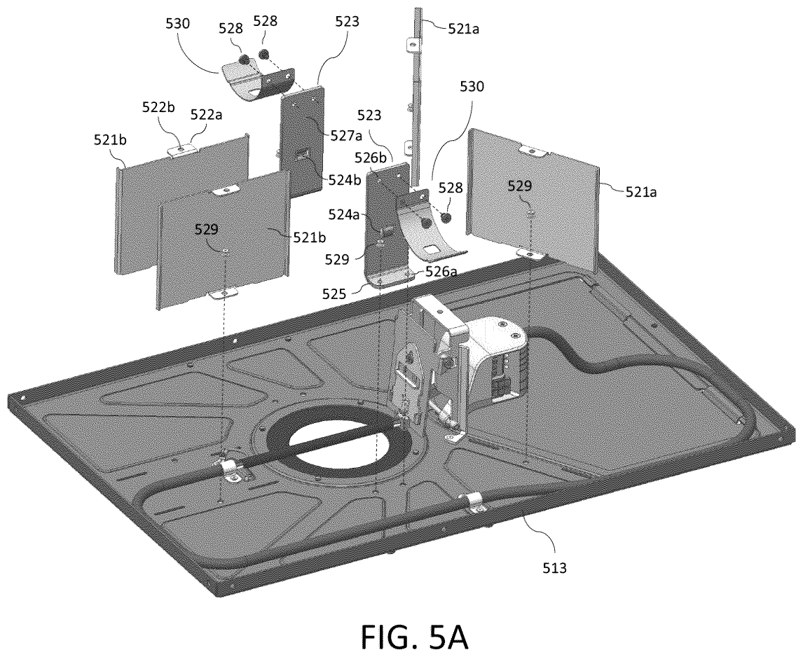

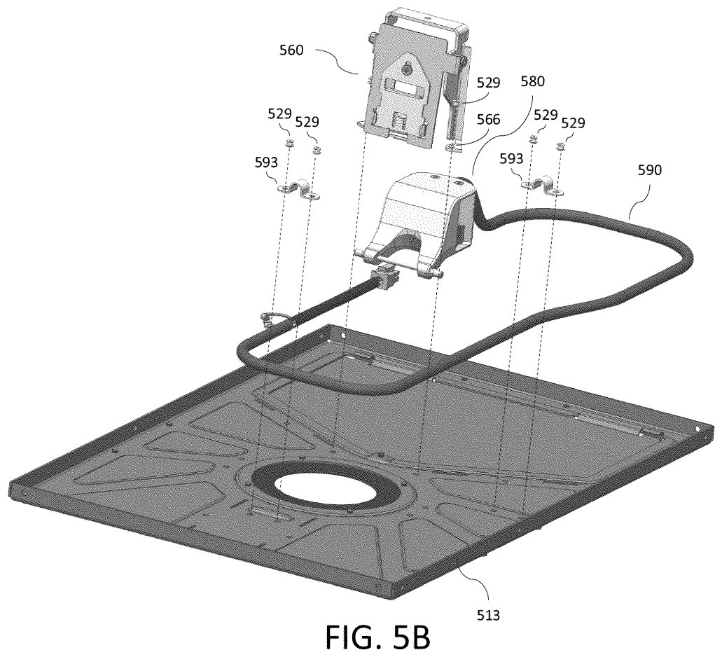

The housing 510 may include a housing cover 512 coupled to a pan frame 513, e.g., via a plurality of fasteners. Together, the housing cover 512 and the pan frame 513 defines the cavity 501. For reference, FIGS. 3A-3J show several views of the housing assembly 500a where the housing cover 512 is removed. As shown, the cavity 501 may be divided into a wiring cavity 501a to contain various wiring connections with an external electrical system and a heatsink cavity 501b to contain the heatsink subassembly 536 (see, for example, FIG. 1C or FIG. 3C). This may be accomplished, in part, by the housing 510 including one or more dividers 521a to physically divide the cavity 501. As shown in FIG. 5A, each divider 521a may include one or more tabs 522a that abut the pan frame 513 or the housing cover 512. The divider 521a may be securely coupled to the pan frame 513 and/or the housing cover 512 via rivets 529 inserted through corresponding openings 522b on the tabs 522a and the corresponding openings on the pan frame 513 or the housing cover 512.

One or more knockouts 511a and/or one or more Romex feedthroughs 511b may be disposed on the housing cover 512 for external wiring to pass into the wiring cavity 501a. The knockout(s) 511a and/or the feedthroughs 511b may be disposed on the top and/or the sides of the housing cover 512. As shown in FIGS. 2A and 2B, the knockouts 511a and the Romex feedthroughs 511b may be disposed on portions of the housing cover 512 that adjoin the wiring cavity 501a.

The housing assembly 500a may include a wire door plate 514 coupled to the pan frame 513, as shown in FIG. 2D. The wire door plate 514, when opened, may provide access to the wiring cavity 501a from below the housing assembly 500a through an opening 517. The wire door plate 514 may be opened, for example, after the housing assembly 500a is securely coupled to a support structure, but before the ceiling drywall is installed. Access to the wiring cavity 501a in this manner may allow a user to route external wiring into the wiring cavity 501a and/or to make wiring connections, e.g., by inserting wires into corresponding electrical connectors of the wiring hub 580.

In some implementations, the wire door plate 514 may be dimensioned and shaped to span the portion of the pan frame 513 that defines the wiring cavity 501a, e.g., the wire door plate 514 may extend to the sides of the pan frame 513 and the dividers 521a. As shown in FIG. 2D, the wire door plate 514 may be securely coupled to the pan frame 513 via a fastener 516a inserted through a fastener opening 516c on the wire door plate 514 and a fastener opening 516b on the pan frame 513. In some implementations, the wire door plate 514 may include a pair of hinge connectors 515. When the fastener 516a is removed, the wire door plate 514 may rotate open via the hinge connectors 515 rather than separating from the pan frame 513.

The pan frame 513 may define an aperture 513a that provides access to the heatsink cavity 501b. The housing assembly 500a may include an adapter plate 518 coupled to the pan frame 513 to cover the aperture 513a. The adapter plate 518, in turn, may define the aperture 519. As shown in FIG. 2E, the adapter plate 518 may be coupled to the pan frame 513 via multiple fasteners 520a inserted through corresponding fastener openings 520b on the adapter plate 518 and corresponding fastener openings 520c on the pan frame 513.

In some implementations, the adapter plate 518 may be readily removed and replaced with other adapter plates 518 having a different sized or shaped aperture 519. In this manner, the housing assembly 500a may be configured to support different apertures using the same housing 510. The aperture 519 may have various geometries including, but not limited to, a circle, an oval, a polygon (e.g., a square, a hexagon, an octagon), or any combinations of the foregoing. The dimensions of the aperture 519 are described above in Section 1. It should be appreciated that, in some implementations, the housing assembly 500a may not include the adapter plate 518; instead, the aperture 513a may provide the same function as the aperture 519.

The cavity 501 may be further divided to provide space for specific components of the lighting apparatus 100a. For example, FIGS. 3A and 3B show the housing assembly 500a may include a pair of dividers 521b disposed within the heatsink cavity 501b. The dividers 521b may define a driver region 501c that serves as a dedicated space to accommodate the driver subassembly 210 of the lighting module 200a. As shown in FIG. 3C, the driver region 501c may correspond to the portion of the heatsink cavity 501b located between the dividers 521b. In some implementations, the driver region 501c may be disposed adjacent to the aperture 519 to provide greater ease of access when installing the driver module 200a. In some implementations, the divider 521b may be identical to the divider 521a.

As described above, the housing assembly 500a may passively adjust the position (e.g., vertical position) of the heatsink subassembly 536, the lighting module 200a, and the trim 400a to accommodate drywall with different thicknesses. In the housing assembly 500a, this is accomplished by making the heatsink subassembly 536 movably coupled to the housing 510 and including one or more cantilever springs 530 (also referred to herein as a the “spring 530”) to apply a force to facilitate movement of the heatsink subassembly 536. For example, FIGS. 3A, 3B, and 3F show the heatsink subassembly 536 may be slidably coupled to the pan frame 513. Specifically, the housing assembly 500a may include a pair of rails 523 mounted to the pan frame 513 and the heatsink subassembly 536 may include a pair of slots 544 that allow the heatsink subassembly 536 to slide along the rails 523.

Each rail 523 may be oriented vertically, thus constraining the heatsink subassembly 536 to move along a vertical axis. In some implementations, the rails 523 may span the height of the housing 510, i.e., from the pan frame 513 to the top of the housing cover 512. It should be appreciated that, in some implementations, the rails 523 may only span a portion of the height of the housing 510, e.g., the height of the rails 523 may be less than the height of the housing 510. The heatsink subassembly 536 may be moved to any position along the rails 523. This includes, for example, a first position proximate to the aperture 519 (e.g., the lowest vertical position along the rails 523), a second position proximate to the top of the housing cover 512 (e.g., the highest vertical position along the rails 523), i.e., distal to the aperture 519, and any position therebetween.

As shown in FIG. 5A, the rail 523 may include a tab 525 with one or more openings 526a. The rail 523 may be securely coupled to the pan frame 513 via rivets 529 inserted through corresponding openings 526a on the tab 525 and corresponding openings on the pan frame 513. In some implementations, each rail 523 may include a bump 524a on an exterior side 527b of the rail 523 (also referred to herein as an “exterior surface 527b”) that forms a corresponding recess 524b on an interior side 527a of the rail 523 (also referred to herein as an “interior surface 527a”). The recess 524b may facilitate engagement of the lighting module 200a to the heatsink subassembly 536 by providing space to allow a module spring 550 in the heatsink subassembly 536 to deflect as the lighting module 200a engages with the module spring 550. Further details of the module spring 550 and its interaction with the rail 523 are discussed in detail below.

FIG. 5A further shows each rail 523 may support one cantilever spring 530. Thus, the housing assembly 500a may include a pair of springs 530. As shown in FIG. 3F, the springs 530 may be disposed on the exterior sides 527b of respective rails 523 (i.e., facing away from the aperture 519). With this arrangement, the springs 530 may apply an upward vertical force to the heatsink subassembly 536 while reducing or, in some instances, mitigating any undesirable tilting of the heatsink subassembly 536. The cantilever spring 530 may be directly coupled to the exterior side 527b of the rail 523 via one or more fasteners 528 inserted through corresponding fastener openings 532b on the spring 530 and corresponding fastener openings 526b on the rail 523.

As shown in FIGS. 3E and 3F, the spring 530 may be coupled to a top portion of the rail 523, e.g., the fastener openings 526b may be disposed on the top portion of the rail 523. The spring 530, in turn, may extend downward through the slot 544 of the heatsink subassembly 536. The spring 530 may be curved in shape to facilitate contact with a bottom portion of the heatsink subassembly 536 (e.g., the bushing 543). It should be appreciated that the arrangement of the spring 530 is a non-limiting example. For example, the spring 530 may be coupled to a bottom portion of the rail 523. Further, the spring 530 may not extend through the slot 544 of the heatsink subassembly 536. The spring 530 may be curved in shape and contact a bottom portion of the heatsink subassembly 536. More generally, the spring 530 may be coupled to any portion of the rail 523.

FIGS. 8A-8B show several views of the spring 530. The spring 530, as described above, may be a cantilever spring (also referred to herein as a “sag spring”). In other words, the spring 530 may be a beam that generates a force via elastic bending. As shown, the spring 530 may include a body portion 531 and a tab 532 joined to the body portion 531. The tab 532 may include one or more fastener openings 532b to facilitate attachment of the spring 530 to the rail 523. The spring 530 may further include an opening 534 formed on the body portion 531. When the spring 530 is subjected to substantial bending such that the body portion 531 is substantially aligned and parallel to the exterior side 527b of the rail 523, the opening 534 may allow the bump 524a to pass through. That way, the bump 524a may not limit how far the spring 530 is bent.

The body portion 531 may be sufficiently curved in shape such that, when the body portion 531 is inserted through the slot 544 of the heatsink subassembly 536, the spring 530 is always bent due to contact with the heatsink subassembly 536. Said another way, the spring 530 may never be in a neutral, unbent state where no force is generated. This, in turn, means the spring 530 may always generate a force that is applied to the heatsink subassembly 536 regardless of the position of the heatsink subassembly 536 along the rail 523. In some implementations, the spring 530 may always apply an upward vertical force to the heatsink subassembly 536.

For example, FIGS. 3G-3I show the heatsink subassembly 536 at different positions along the rail 523 and how the spring 530 is bent at each position. In particular, FIG. 3G shows the heatsink subassembly 536 at its lowest position along the rail 523, which corresponds to the spring 530 experiencing the greatest bending relative to its neutral state as shown in FIG. 8B. FIG. 3H shows the heatsink subassembly 536 raise to an intermediate position along the rail 523 where the spring 530 is less bent relative to its neutral state compared to FIG. 3G. FIG. 3I shows the heatsink subassembly 536 at its highest position along the rail 523, which is limited by the heatsink subassembly 536 contacting the housing cover 512), and the spring 530 bent relative to its neutral state albeit less so when compared to FIG. 3H. FIGS. 3G-3I further show the spring 530 may maintain physical contact with the bushing 543 (specifically, the bumper 545 of the bushing 543) for all positions of the heatsink subassembly 536 along the rail 523.

As described above, the heatsink subassembly 536 may have a locked configuration (also referred to herein as a “stowed position”), e.g., where the heatsink subassembly 536 is mechanically restrained and unable to move along the rail 523 when the forces from the springs 530 are applied, and an unlocked configuration where the heatsink subassembly 536 is able to move freely along the rail 523. This may be accomplished, for example, by the spring 530 having a bump 533 disposed on the body portion 531. For example, FIG. 3G shows the heatsink subassembly 536 in the locked configuration. As shown, the heatsink subassembly 536 may be positioned such that the bumper 545 of the bushing 543 is disposed directly below and in contact with the bump 533 of the spring 530. In this manner, the bump 533 may act as a mechanical stop, preventing movement of the heatsink subassembly 536. Although the spring 530 applies a force urging the heatsink subassembly 536 to move vertically upward, this force alone is insufficient because the force from the spring 530 is a result of the spring 530 trying to return to its neutral state, which incidentally keeps the bump 533 engaged with the bumper 545.

To disengage the heatsink subassembly 536 from the locked configuration, a separate force (e.g., a vertical upward force) should be applied directly or indirectly to the heatsink subassembly 536 such that the contact between the bumper 545 and the spring 530 causes the spring 530 to deflect towards the rail 523 thereby allowing the bumper 545 of the bushing 543 to move vertically upward past the bump 533 of the spring 530. Once the bumper 545 is above the bump 533, the force from the spring 530 may be sufficient to move the heatsink subassembly 536 vertically upward. For example, a separate force may be applied directly to the heatsink subassembly 536 (e.g., by a user pushing the handles 558) or indirectly to the heatsink subassembly 536 (e.g., by the user pushing the lighting module 200a or the trim 400a).

The magnitude of the force required to disengage the heatsink subassembly 536 from the locked configuration depends, in part, on the profile of the bumper 545 and the profile of the bump 533. As shown in FIG. 3G, the bumper 545 and the bump 533 may each have a round contoured profile. This may allow some displacement in the heatsink subassembly 536 as a force is applied to disengage the locked configuration, thus providing the user feedback whether more or less force is needed to fully disengage the heatsink subassembly 536 from the locked configuration. In some implementations, the magnitude of the force may be greater than the force required to engage the lighting module 200a to the heatsink subassembly 536 (e.g., via actuation of the module springs 550).

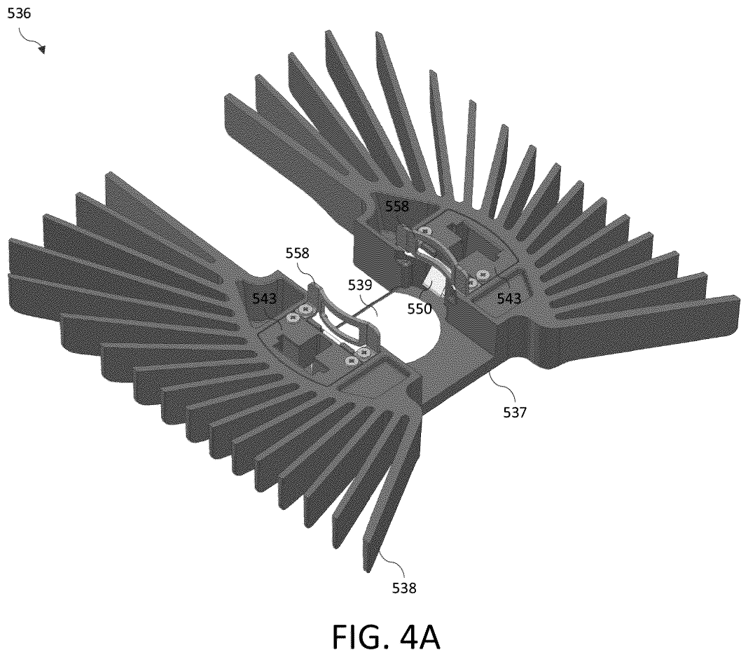

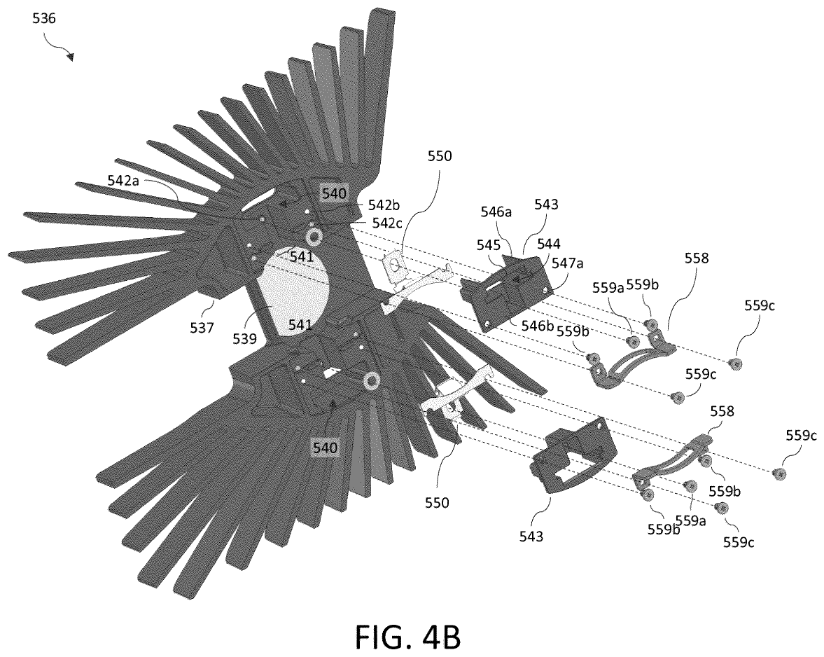

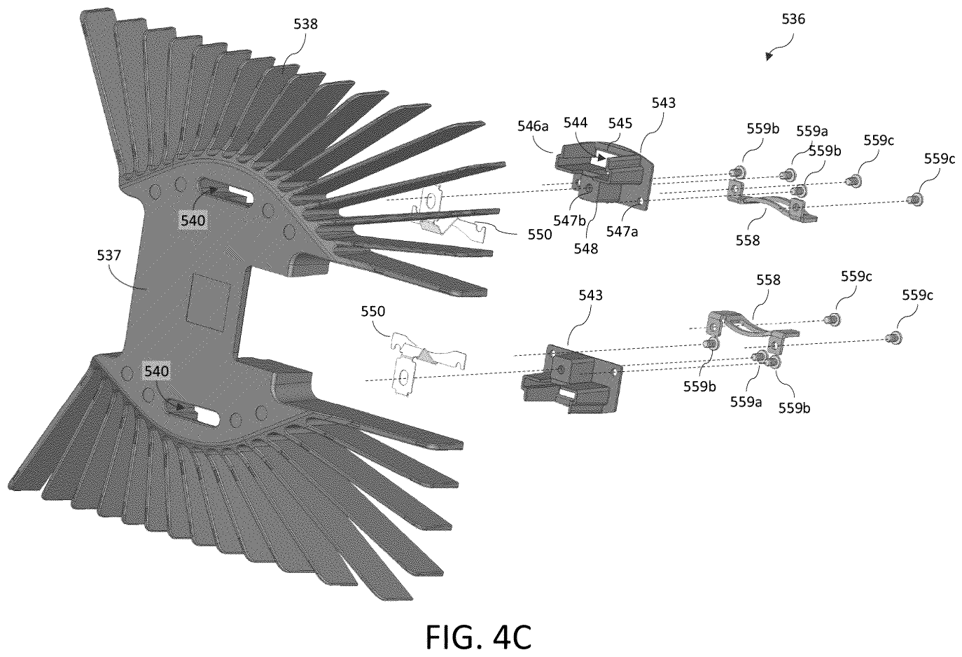

FIGS. 4A-4C show several views of the heatsink subassembly 536. The heatsink subassembly 536 may dissipate heat generated by the light source 250 in the lighting module 200a during operation. As shown, the heatsink subassembly 536 may include a base 537, which provides a surface to thermally contact the lighting module 200a. In some implementations, the heatsink subassembly 536 may include a thermal pad 539 to reduce the thermal interface resistance between the base 537 and the lighting module 200a and, thus, increase heat transfer from the lighting module 200a to the heatsink subassembly 536. The heatsink subassembly 536 may further include a plurality of fins 538 extending from the base 537 to provide convective cooling with the surrounding air within the heatsink cavity 501b. In some implementations, the fins 538 may laterally span a substantial portion of the heatsink cavity 501b. For example, FIG. 3C shows the fins 538 may extend laterally to the sides of the pan frame 513 and the dividers 521a. FIG. 3C further shows the fins 538 may not extend into the driver region 501c to reserve space for the driver subassembly 210 of the lighting module 200a.

As shown, the base 537 may define a pair of slots 540. As shown in FIG. 4B, the base 537 may further define a pair of channels 541 with each channel 541 adjoining one slot 540 from the pair of slots 540. Each channel-slot pair may support other components of the heatsink subassembly 536. For example, FIG. 4B shows a bushing 543 may be inserted into each channel-slot pair. The bushing 543, in turn, may define a slot 544 described above to facilitate movement of the heatsink subassembly 536 along one rail 523. FIG. 4B further shows a handle 558 may be coupled to the base 537. The handles 558 may provide a way for a user to manually actuate the heatsink subassembly 536, e.g., by directly applying a force to the heatsink subassembly 536 to push or pull the heatsink subassembly 536 along the rail 523. Each channel-slot pair may also support a module spring 550 (also referred to herein as a “spring 550”) to couple the lighting module 200a to the heatsink subassembly 536. In particular, an end portion 553 of the module spring 550 may be disposed within the channel 541. Each of the foregoing components are described below.

The bushing 543 may include a sidewall portion 546a that defines, in part, the slot 544 through which the rail 523 and a portion of the spring 530 pass through the heatsink subassembly 536, e.g., as the heatsink subassembly 536 slidably moves along the rail 523. The bushing 543 may further include a base portion 546b joined to one end of the sidewall portion 546a. The base portion 546b may include the bumper 545, which physically contacts the spring 530. Thus, the bumper 545 represents the portion of the heatsink subassembly 536 where the force from the spring 530 is applied. The bushing 543 may be securely coupled to the base 537 via fasteners 559b inserted through corresponding fastener openings 547a disposed on the base portion 546b of the bushing 543 and corresponding fastener openings on the base 537 as shown in FIG. 4B.

FIG. 4C shows the bushing 543 may further include a recessed portion 548 adjoining the sidewall portion 546a and the base portion 546b. The recessed portion 548 may include a fastener opening 547b that aligns with a fastener opening 542a disposed within the channel 541 of the base 537. A fastener 559a may be inserted through the fastener openings 547b and 542a and an opening 554 of the spring 550. The fastener 559a may constrain the motion of an end portion 553 of the spring 550, e.g., when the end portion 553 of the spring 550 is displaced as the engagement portion 552 of the spring 550 is actuated. The bushing 543 may be formed from various materials including, but not limited to, polyoxymethylene (e.g., Delrin @), and polycarbonate.

The handle 558 may be coupled to the base 537 via fasteners 559c inserted through corresponding fastener openings on the handle 558 and the base 537. The fasteners 559c may also securely couple the spring 550 to the base 537. For example, the spring 550 may include notches 556b align with the fastener openings 542c on the base 537 and, thus, partially receive the fasteners 559c. Thus, a portion of the spring 550 (e.g., the base portion 551) may be clamped between the base 537 and the handle 558.

The handle 558 may be laterally disposed adjacent to the aperture 519 of the housing 510. Thus, in some implementations, the handle 558 may be shaped to conform to the geometry of the aperture 519. For example, FIG. 4A shows the handle 558 may be curved in shape where the curvature is based on the circular geometry of the aperture 519. The handle 558 may further be disposed below the other components of the heatsink subassembly 536 (e.g., the base 537, the bushing 543) to provide greater ease of access through the aperture 519, i.e., when the lighting module 200a is not present. Thus, the handle 558 may be the lowest component of the heatsink subassembly 536 and, hence, located closest to the aperture 519. As a result, the handle 558 may limit how low the heatsink subassembly 536 can be positioned along the rail 523 (see, for example, the heatsink subassembly 536 at its lowest position in FIG. 3G).

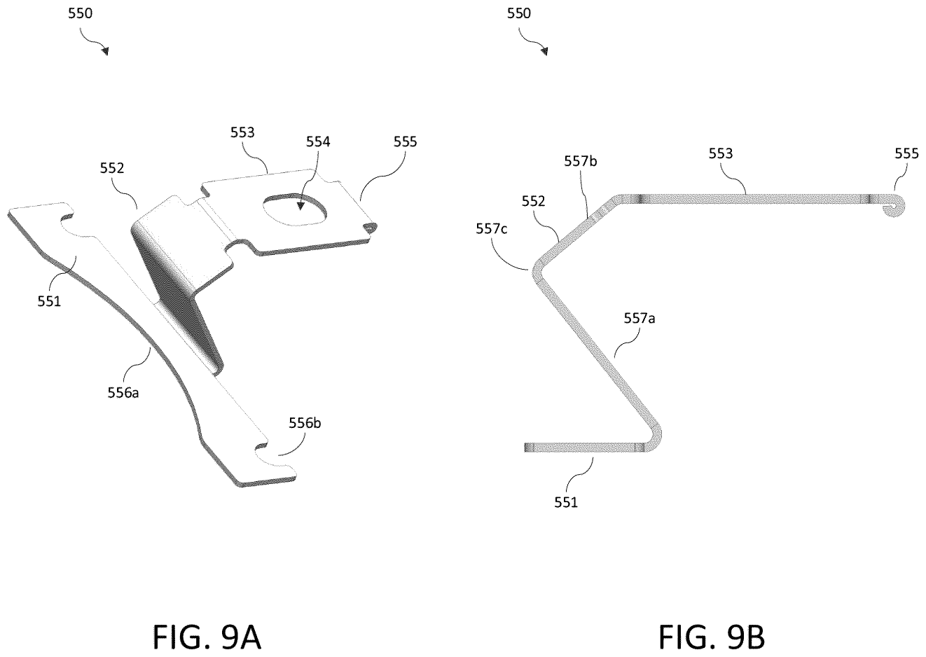

The spring 550 may securely couple the lighting module 200a to the heatsink subassembly 536. In some implementations, this may be accomplished by the spring 550 providing a snap-fit connection. For example, the heatsinks subassembly 536 may include a pair of springs 550 disposed diametrically opposite to each other about the aperture 519 (e.g., the centerline of the aperture 519). In this manner, the two opposing springs 550 may form a snap-fit connection that mechanically clamps the lighting module 200a to the heatsink subassembly 536. For reference, FIGS. 9A-9B show several views of the spring 550. As shown, the spring 550 may include a base portion 551 to securely couple the spring 550 to the base 537 of the heatsink subassembly 536, an engagement portion 552 joined to the base portion 551 to facilitate a snap-fit connection with the lighting module 200a, and an end portion 553 joined to the engagement portion 552 to provide a mechanical constraint that controls whether the spring 550 can be actuated or not.

The base portion 551 may be clamped between the base 537 and the handle 558. Due to the close proximity of the base portion 551 to the aperture 519, the base portion 551 may include a curved edge 556a to accommodate the round geometry of the lighting module 200a. Additionally, the base portion 551 may include notches 556b, which as described above, may align with fastener openings 542c on the base 537 and receive, in part, the fasteners 559c. In some implementations, the notches 556b may be semicircular in shape to conform with the round geometry of the fastener 559c. However, it should be appreciated that this is a non-limiting example and the notches 556b may have other geometries, such as a V-shaped notch, or a rectangular-shaped notch, or the like.

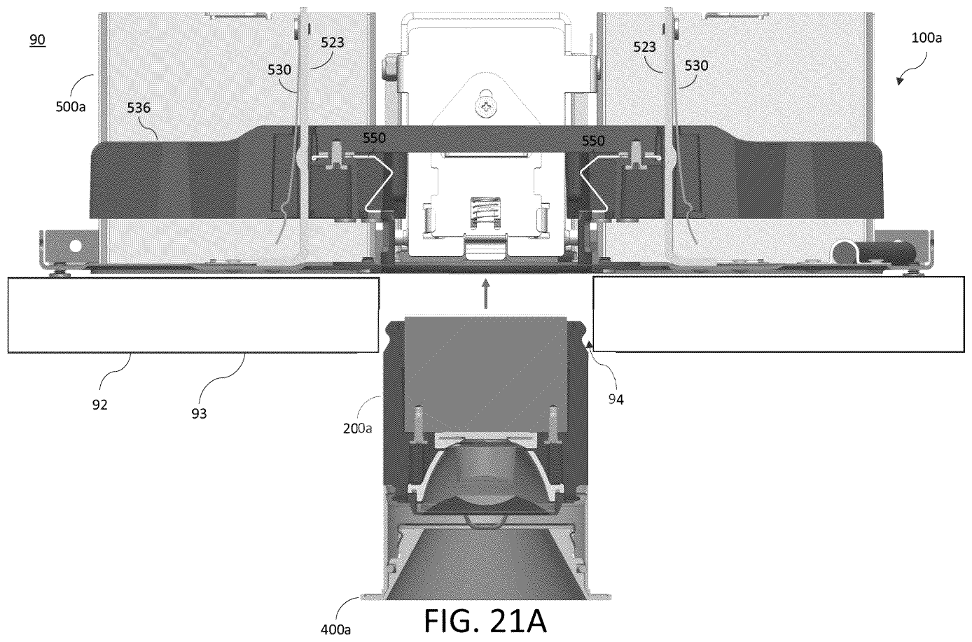

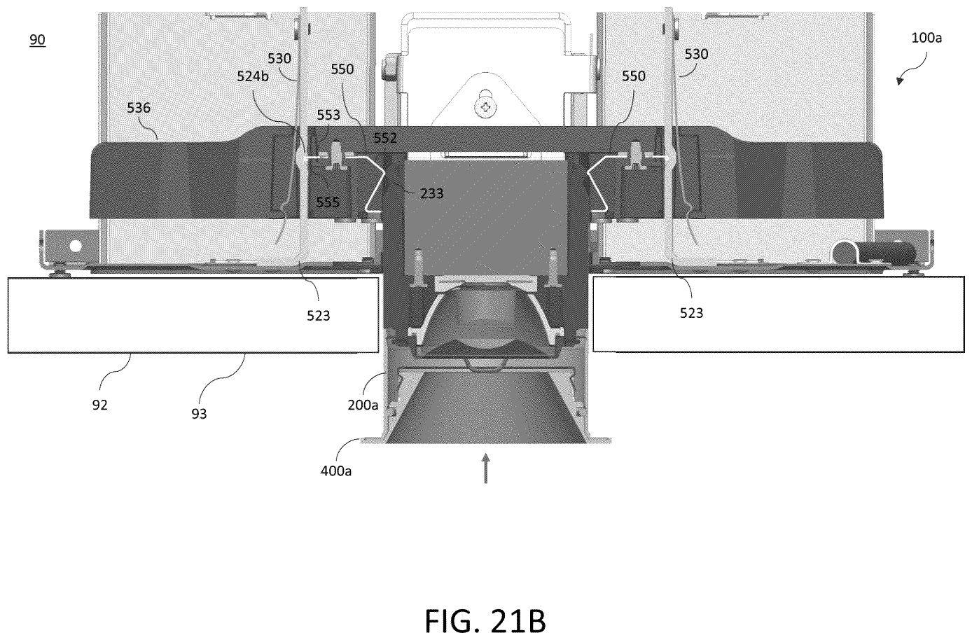

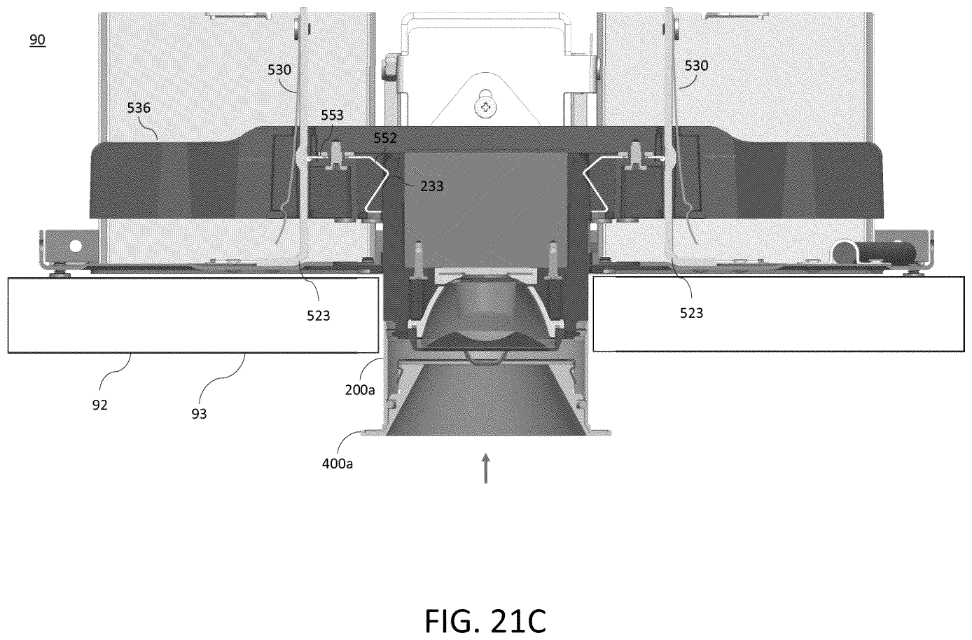

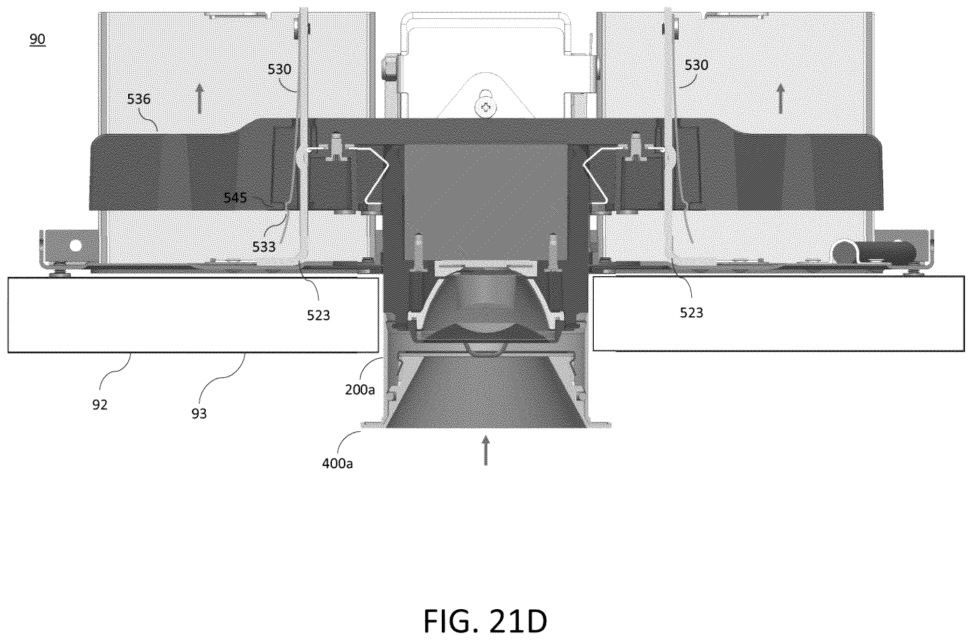

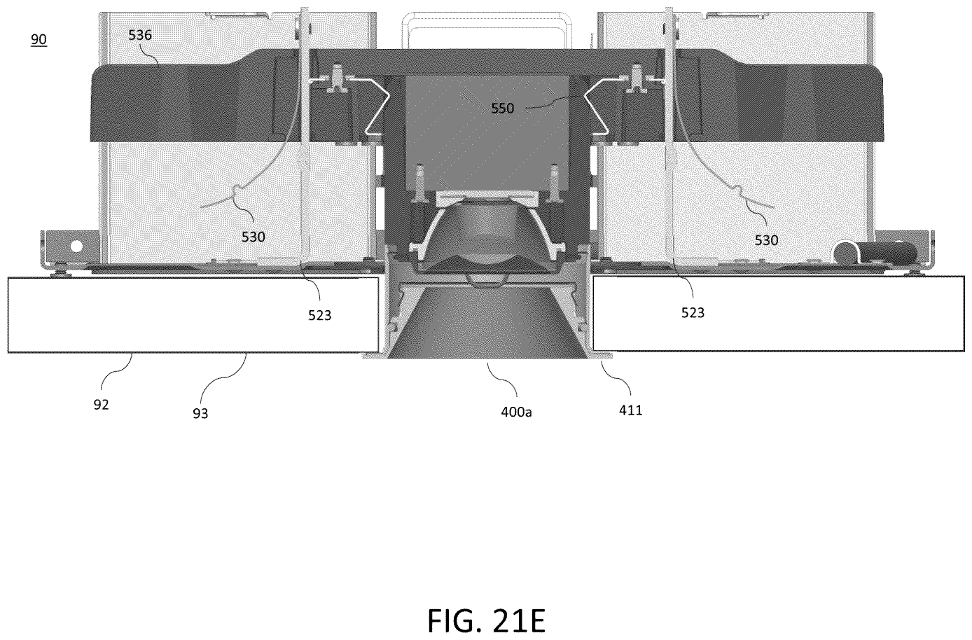

The engagement portion 552 may include a V-shaped beam. For example, FIG. 9B shows the engagement portion 552 may include a first beam portion 557a and a second beam portion 557b joined to the first beam portion 557a. As shown, the second beam portion 557b may be joined at an angle with respect to the first beam portion 557a, thus forming a corner 557c. The corner 557c may engage with a retaining element 233 (also referred to herein as an “element 233”) on the lighting module 200a (see, for example, FIG. 1E, or FIG. 21C), thereby securely coupling the lighting module 200a to the heatsink subassembly 536. In some implementations, the engagement portion 552 may be shaped such that a vertical upward force is applied to the lighting module 200a to increase thermal contact between the lighting module 200a (e.g., the mounting surface 241b) and the base 537.

The end portion 553 may extend from the engagement portion 552. As a result, deflections in the engagement portion 552 may cause translational movement in the end portion 553 (see, for example, FIGS. 21A-21C). The end portion 553 may be constrained to move along a horizontal axis between the base 537 and the bushing 543. Furthermore, the range of translational movement may be sufficient for the end portion 553 to extend across the slot 544 of the bushing 543 and physically contact the rail 523 passing through the slot 544.

The end portion 553 may include an opening 554 through which a fastener 559a may pass through when connected to the fastener opening 542a. In some implementations, the fastener opening 542a may be formed, in part, on a stub that protrudes from the surface of the base 537. The stub may provide clearance to ensure the end portion 553 can freely move between the base 537 and the bushing 543. In other words, the stub may prevent the end portion 553 from being clamped between the base 537 and the bushing 543. FIGS. 9A and 9B further show the end portion 553 may include a hem 555 disposed at the tip of the end portion 553. More generally, the tip of the end portion 553 may have a rounded shape, in part, to reduce friction between the spring 550 and the rail 523 when the end portion 553 contacts the rail 523.

As described above, the heatsink subassembly 536 may be in the locked configuration when the lighting module 200a is coupled to the heatsink subassembly 536. In the locked configuration, the heatsink subassembly may be positioned along the rails 523 such that the hem 555 of each spring 550 is vertically aligned with the recesses 524b formed on the rails 523. When the lighting module 200a is pushed to engage the heatsink subassembly 536, physical contact between the lighting module 200a and the engagement portion 552 of the spring 550 may initially cause actuation (e.g., deflection) of the engagement portion 552. The actuation of the engagement portion 552 may be sufficient to translationally move the end portion 553 of the spring 550 such that a portion of the end portion 553 (e.g., the hem 555) is partially inserted into the recess 524b of the rail 523.

When the engagement portion 552 of the spring 550 engages the retaining element 233 of the lighting module 200a, the engagement portion 552 may partially return to its neutral state resulting in the end portion 553 moving away from the rail 523. Thereafter, when the heatsink subassembly 536 is released from the locked configuration (i.e., the heatsink subassembly 536 is transitioned to the unlocked configuration) the heatsink subassembly 536 may move vertically upward along the rail 523 due to the force applied by the springs 530. As this occurs, the end portion 553 may move out of vertical alignment with the recess 524b. As the heatsink subassembly 536 moves along the rail 523, the end portion 553 and, in particular, the hem 555 of each spring 550 may slide along respective interior sides 527a of the rails 523. The physical contact between the hem 555 and the rail 523 may prevent translational movement of the end portion 553, thus limiting or, in some instances, preventing actuation of the engagement portion 552. This, in turn, appreciably reduces the likelihood of the lighting module 200a being accidentally removed from the heatsink subassembly 536 when the heatsink subassembly 536 is in the unlocked configuration. For example, when replacing the lighting module 200a, a user may apply an external force to pull the lighting module 200a and, by extension the heatsink subassembly 536 vertically downward until the heatsink subassembly 536 engages the locked configuration. The mechanical constraints imposed by the rails 523 onto the springs 550 may significantly reduce the likelihood of the lighting module 200a being accidentally removed from the heatsink subassembly 536 before the locked configuration is engaged.

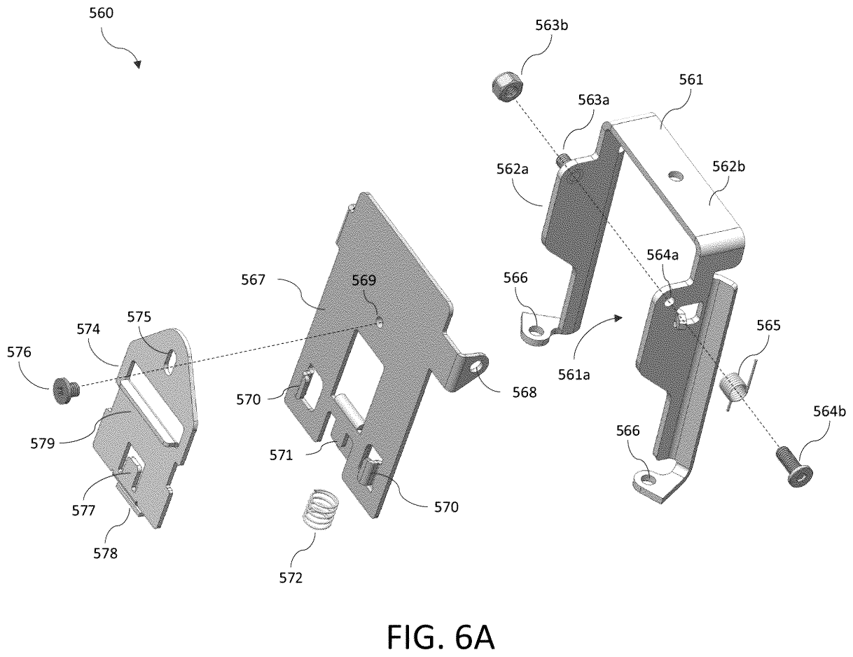

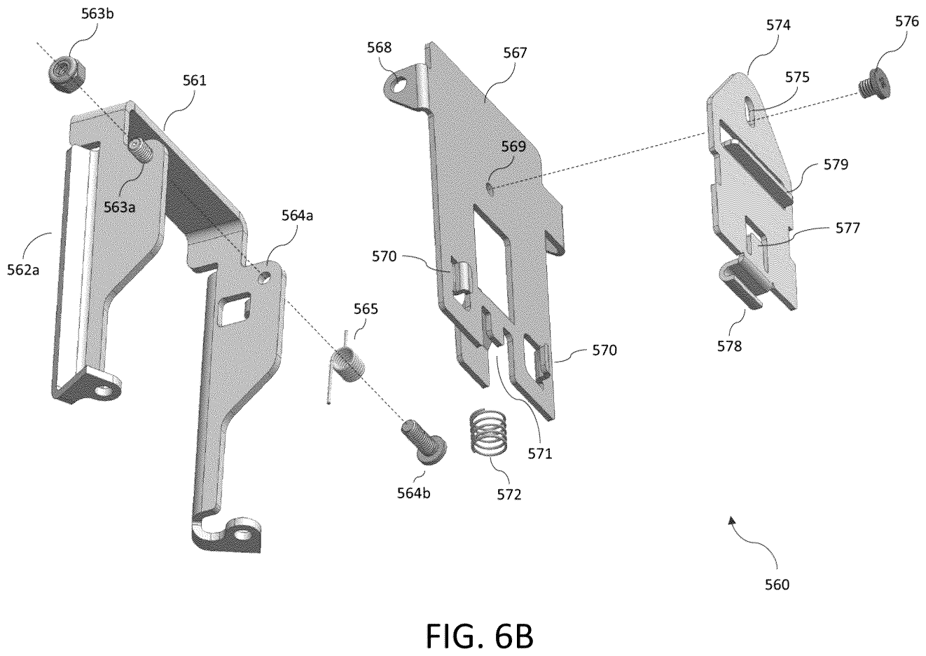

The housing assembly 500a may include the wire door subassembly 560 disposed within the opening 502 of the housing 510 to provide access to the wiring cavity 501a post-installation via the aperture 519. FIGS. 6A and 6B show several views of the wire door subassembly 560. As shown, the wire door subassembly 560 may include a frame 561 mounted to the pan frame 513. Specifically, the frame 561 may include a pair of sidewalls 562a and a topside 562b that together define an opening 561a. Each sidewall 562a may include a tab with a fastener opening 566 to facilitate attachment to the pan frame 513, e.g., via a rivet connection formed using rivets 529 (see, for example, FIGS. 5A and 5B).

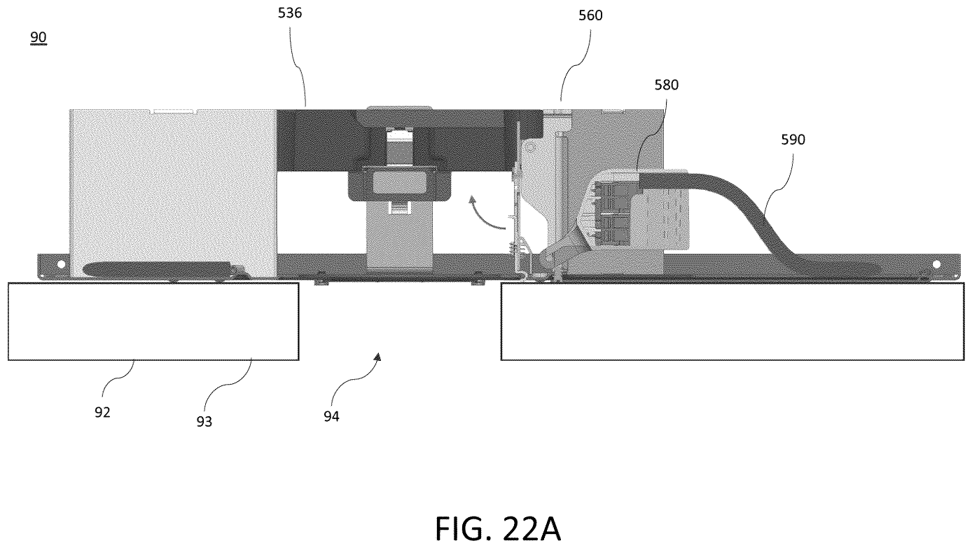

The wire door subassembly 560 may further include a door 567 rotatably coupled to the frame 561. As described above, wire door subassembly 560 may have an open position and a closed position. In the closed position, the wire door subassembly 560 and, specifically, the door 567 may block the opening 561a and, by extension, the opening 502. In the open position, the wire door subassembly 560 and, specifically, the door 567 may be rotated to allow access to the wiring cavity 501a from the heatsink cavity 501b through the opening 561a and, by extension, the opening 502. In some implementations, the door 567 may only be rotated to the open position when the heatsink subassembly 536 is raised to its highest position and the lighting module 200a and the trim 400a are removed from the housing assembly 500a (see, for example, FIGS. 22A and 22B).

As shown in FIG. 6A, the door 567 may include tabs with openings 568. One tab may be placed onto a post 563a disposed on one sidewall 562a, e.g., with the post 563 being inserted through the opening 568. In some implementations, the post 563a may be threaded. Accordingly, a nut 563b may be fastened onto the post 563a to securely couple one side of the door 567 to the frame 561. The other tab of the door 567 may be positioned such that the opening 568 is aligned with an opening 564a on the other sidewall 562a. A fastener 564b may be inserted through the openings 564a and 568. Together, the post 563 and the fastener 564b allows the door 567 to rotate with respect to the frame 561.

In some implementations, the door 567 may be sprung such that the door 567 moves either from the closed position to the open position, or the open position to the closed position. For example, FIGS. 6A and 6B show the wire door subassembly 560 may include a spring 565 (e.g., a helical spring) coupled at one end to the door 567 and at the other end to the sidewall 562a. In this example, the spring 565 may be biased to rotate the door 567 to the open position. This may allow, for example, a user to access the wiring cavity 501a without having to apply a separate force to keep the door 567 open. However, it should be appreciated that, in some implementations, the spring 565 may be biased to rotate the door 567 to the closed position. This may have the benefit of preventing the wire door subassembly 560 from the being accidentally left in the open position during installation of the lighting apparatus 100a.

In implementations where the spring 565 is biased to rotate the door 567 to the open position, the wire door subassembly 560 may include a latch mechanism that allows the door 567 to be locked in the closed position. When the latch mechanism is actuated, the door 567 may be released and allowed to rotate to the open position via the spring 565. As shown in FIGS. 6A and 6B, the wire door subassembly 560 may include a door latch 574 slidably coupled to the door 567. Specifically, the door 567 may include a pair of rail guides 570 that constrain the door latch 574 to slidably move along a single axis. The door latch 574 may include a slot 575 that aligns with an opening 569 on the door 567. A fastener 576 may be inserted through the opening 569 and the slot 575. In this manner, the range of travel of the door latch 574 relative to the door 567 may be limited by the length of the slot 575. The door latch 574 may further include a hook 578 that can be inserted into a slot 513b formed on the pan frame 513. When inserted into the slot 513b, the hook 578 may lock the door 567 in the closed position. When the door latch 574 is moved such that the hook 578 is removed from the slot 513b, the door 567 may be allowed to rotate from the closed position to the open position.

In some implementations, the door latch 574 may be sprung to maintain the hook 578 in the slot 513b when the door subassembly 560 is in the closed position. For example, FIG. 6A shows the wire door subassembly 560 may include a spring 572 (e.g., a helical spring) where one end of the spring 572 is placed onto a tab 571 of the door 567 and the other end of the spring 572 is placed onto a tab 577 of the door latch 574. The spring 572 may apply a force to the door latch 574 that either moves the door latch 574 so that the hook 578 engages the slot 513b or maintains the hook 578 within the slot 513b. To release the door 567, a user may apply an external force onto the door latch 574 to move the door latch 574 and, in particular, the hook 578 away from the slot 513b. The door latch 574 may further include a handle 579 to provide the user with a structural feature that they can readily grab to release the door 567. The handle 579 may aid the user in applying an external force along a direction that counteracts the force from the spring 572.

The housing assembly 500a may include a wiring hub 580 to facilitate connection with an external electrical system, e.g., to receive electrical power and/or control signals (e.g., for dimming, color adjustment). As described above, the wiring hub 580 may be disposed within the wiring cavity 501a as shown in FIG. 1C. In some implementations, the wiring hub 580 may not be securely coupled to the housing 510 (e.g., the pan frame 513). In other words, the wiring hub 580 may be allowed, in principle, to move around within the wiring cavity 501a. This, in turn, may make it easier to install and remove the wiring hub 580 to and from the wiring cavity 501a through the openings 502/561a and the aperture 519 post-installation. In some implementations, the wiring hub 580 may include alignment features (e.g., the handle 584) to reliably position the wiring hub 580 near the wire door subassembly 560.

Additionally, a cable 590 may be connected to the wiring hub 580 to facilitate connection with the lighting module 200a. For example, the cable 590 may include an electrical connector 592 that connects with the electrical connector 212 of the lighting module 200a. As shown in FIG. 3C, the cable 590 may be routed from the wiring cavity 501a to the heatsink cavity 501b. This may be accomplished, for example, by routing the cable 590 around the dividers 521a as shown in FIG. 3C. The housing assembly 500a may include one or more strain relief brackets 593 to reduce or, in some instances, prevent the cable 590 from being subjected to undesirable stresses, e.g., when connecting or disconnecting the lighting module 200a. As shown in FIG. 5B, the housing assembly 500a may include multiple strain relief brackets 593 coupled to the pan frame 513 via rivets 529. In some implementations, the cable 590 may also include a ground connector 591 that is coupled, for example, to a portion of the housing 510 (e.g., the housing cover 512 or the pan frame 513).

FIGS. 7A-7C show several views of the wiring hub 580 and the cable 590. As shown, the wiring hub 580 may include a base 582 and a cover 581 coupled to the base 582 via fasteners 586 inserted through fastener openings 581a on the cover 581 and fastener openings 582a on the base 582. Together, the base 582 and the cover 581 may define a cavity to contain a plurality of electrical connectors (e.g., the electrical connectors 587a and 587b). Each connector may be aligned with a wire opening on the base 582 (e.g., the wire openings 583a and 583b). In this manner, a wire may be connected to the wiring hub 580 by inserting a stripped end of the wire through the wire opening and into the connector. Once the wire is inserted into the connector, the wire may not be readily removed from the connector.

In some implementations, each electrical connector of the plurality of electrical connectors may be identical to one another. In some implementations, the plurality of electrical connectors may contain different types of connectors. Generally, the plurality of electrical connectors may include various types of electrical connectors including, but not limited to, a poke-in connector, and a lever connector. FIGS. 7A-7C show one non-limiting example where the wiring hub 580 includes both poke-in electrical connectors 587a and lever electrical connectors 587b. In some implementations, the plurality of electrical connectors may include different electrical connectors to receive different sized wires (i.e., wires with different wire gauges).

As shown, the electrical connectors 587a and 587b may each be mounted to a printed circuit board (PCB). The PCB's, in turn, may be electrically coupled to the wire conductors in the cable 590. In this manner, the wiring hub 580 may eliminate the need to tediously strip multiple wires for connection via a wire cap as is typical in conventional recessed lighting fixtures. The base 582 and the cover 581 may further include a strain relief feature 585 for the cable 590, e.g., to reduce or, in some instances, prevent undesirable stresses from being applied to the wire conductors connected to the PCB's of the electrical connectors.

The wiring hub 580 may further include a handle 584 to facilitate retrieval and placement from below the aperture 519 after the housing assembly 500a is installed in the built environment. As shown, the handle 584 may include a bar, which a user can grab to manipulate the wiring hub 580. In some implementations, the handle 584 may be sufficiently long such that the ends of the handle 584 may physically contact the sidewalls 562a of the wire door subassembly 560 when the wiring hub 580 is placed into the wiring cavity 501a. Because the wiring hub 580 may not be securely coupled to the housing 510, the handle 584 may thus provide an alignment feature that places the wiring hub 580 near the openings 502 and 561a for later retrieval.

It should be appreciated that the housing assembly 500a is not limited to use only in a recessed lighting apparatus. Rather, the housing assembly 500a and, more generally, the housing assemblies disclosed herein may be used in non-recessed lighting apparatuses as well. For example, the housing assemblies disclosed herein may support lighting modules that extend, for example, below the installation surface of a ceiling. In addition to recessed lighting modules (e.g., downlight modules, adjustable modules), the housing assemblies disclosed herein may support, for example, a wall wash module, a pendant module, and/or a monopoint module.

### 1.2 An Example Downlight Lighting Module

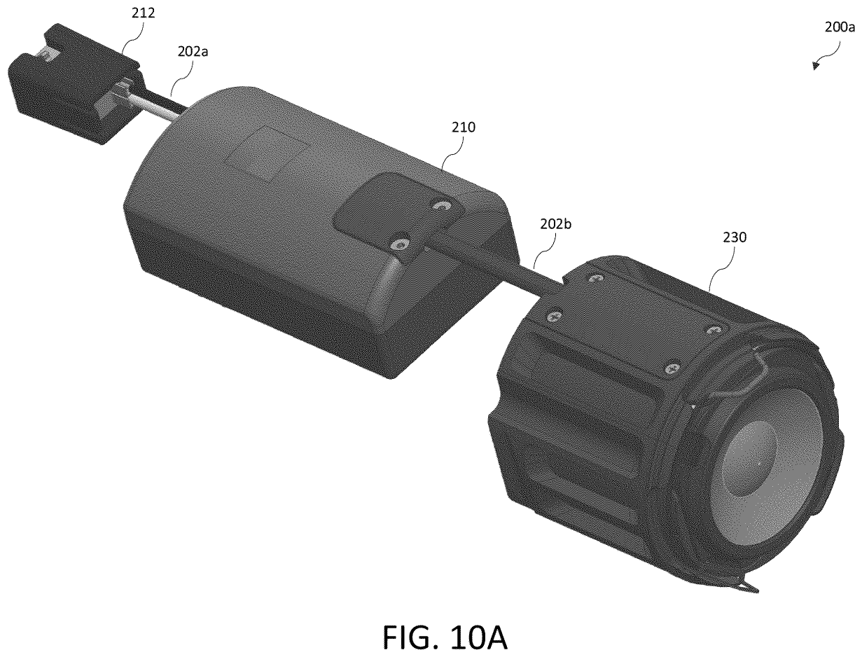

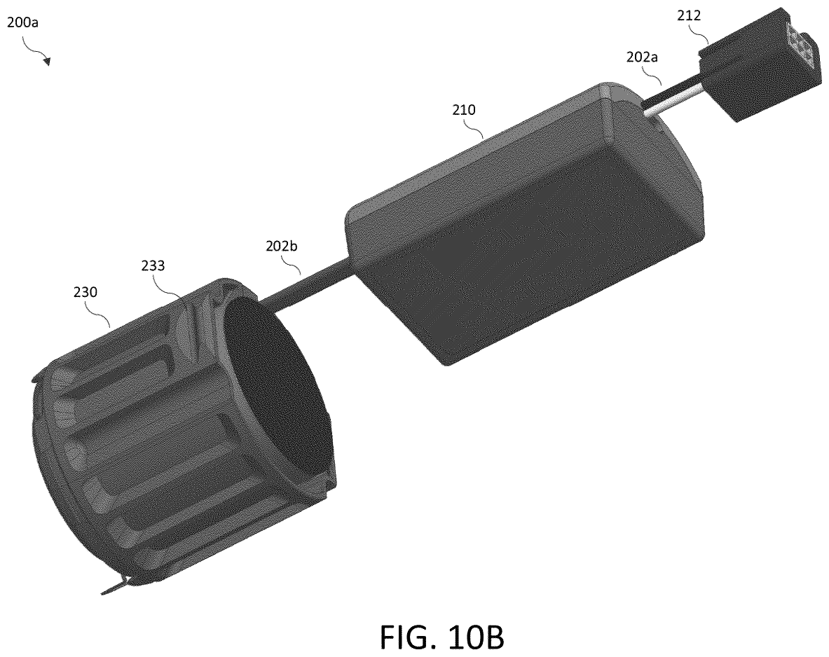

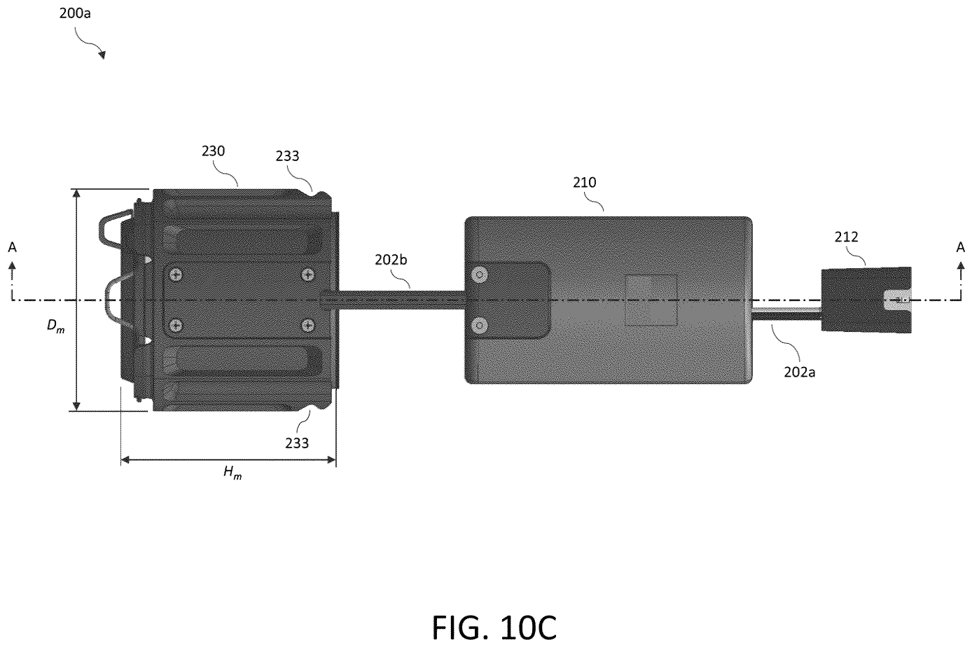

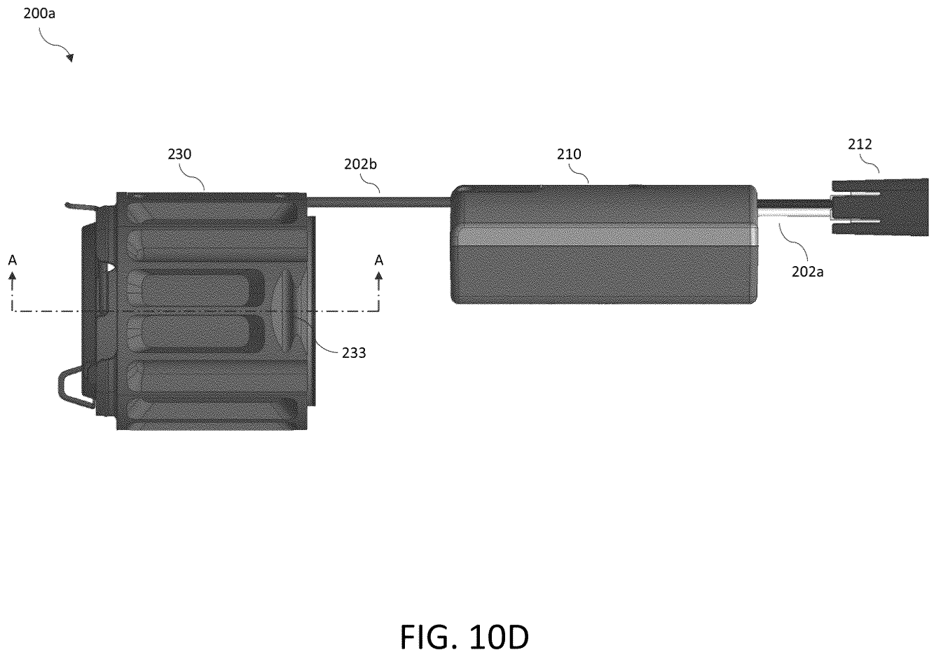

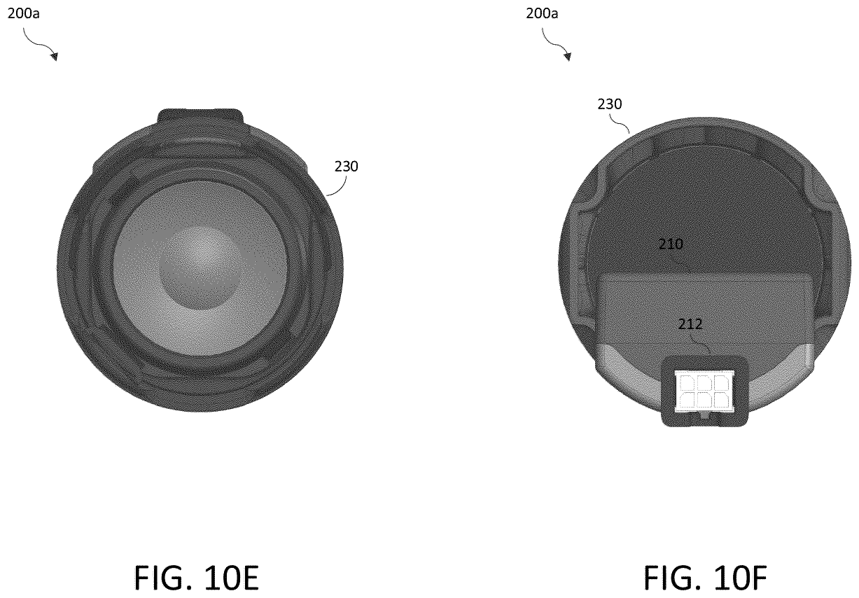

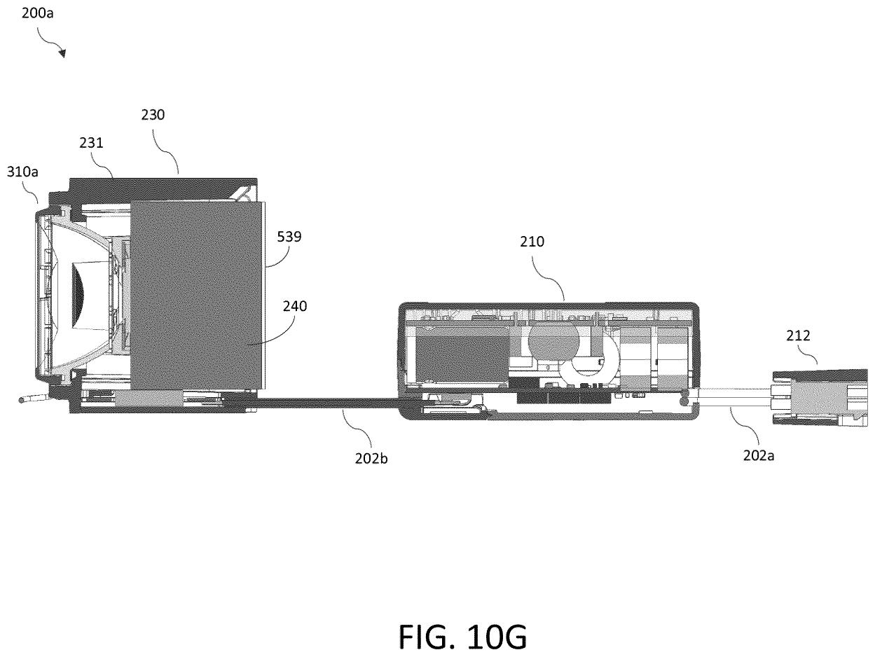

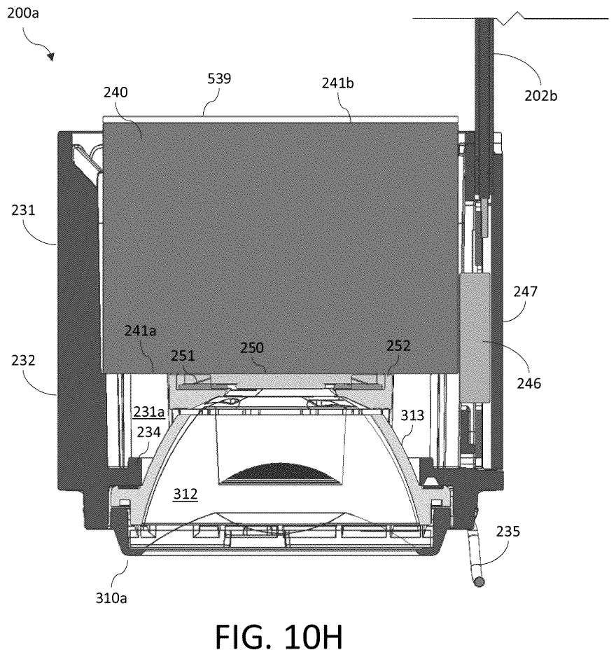

FIGS. 10A-10I show several views of the lighting module 200a. The lighting module 200a may be configured as a downlight module meaning the direction of light emission may be fixed (i.e., the direction of light emission is not adjustable). As shown, the lighting module 200a may include a module subassembly 230, a driver subassembly 210 connected to the module subassembly 230 via a cable 202b, and an electrical connector 212 connected to the driver subassembly 210 via a cable 202a. The electrical connector 212 may receive electrical inputs (e.g., AC power, control signals) from the external electrical system via the wiring hub 580 and the cable 590. The driver subassembly 210 may receive the electrical inputs from the electrical connector 212 via the cable 202a and, in turn, provide regulated electrical outputs (e.g., DC power, control signals) to the module subassembly 230.

To install the lighting module 200a, the electrical connector 212 is connected to the electrical connector 592 of the cable 590. Then, the electrical connector 21 and the driver subassembly 210 are placed into the heatsink cavity 501b and, in particular, the driver region 501c. The cable 202a and 202b may be mechanically compliant, thus providing flexibility in the placement and arrangement of the driver subassembly 210 and the electrical connector 212 in the heatsink cavity 501b. The module subassembly 230 may then be securely coupled to the heatsink subassembly 536. In some implementations, the trim 400a may be coupled to the module subassembly 230 before the module subassembly 230 is mounted to the heatsink subassembly 536.

The driver subassembly 210 may include various driver electronics to convert the electrical inputs received by the electrical connector 212 to regulated electrical outputs for the light source 250 in the module subassembly 230. For example, the driver electronics may receive AC power at a voltage equal to 120 V or 277 V. The driver electronics may convert the electrical inputs from AC to direct current DC. Thus, the driver electronics may include, in part, an AC-to-DC converter. The driver subassembly 210 may transmit DC power to the module subassembly 230 at a voltage ranging from 0 V to 48 V, including all sub-ranges and values in between. It should be appreciated that the foregoing electrical inputs and outputs provided by the driver subassembly 230 are non-limiting examples.

The driver electronics may also receive and transmit control signals to modify the properties of the light output from the module subassembly 230. In one example, the driver subassembly 210 may facilitate dimming of the light output, e.g., by adjusting the brightness of the light output. Various dimming protocols may be implemented including, but not limited to, Triac, 0-10 v, Digital Addressable Lighting Interface (DALI), PhaseX, and the like. In another example, the driver subassembly may facilitate adjustments to the color of the light output. For example, the correlated color temperature (CCT) of the light output may be adjusted.

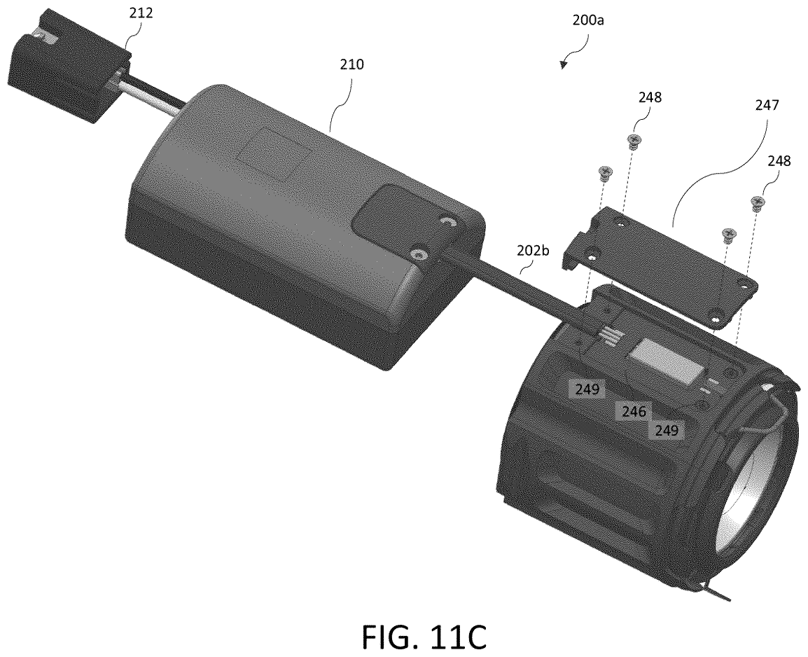

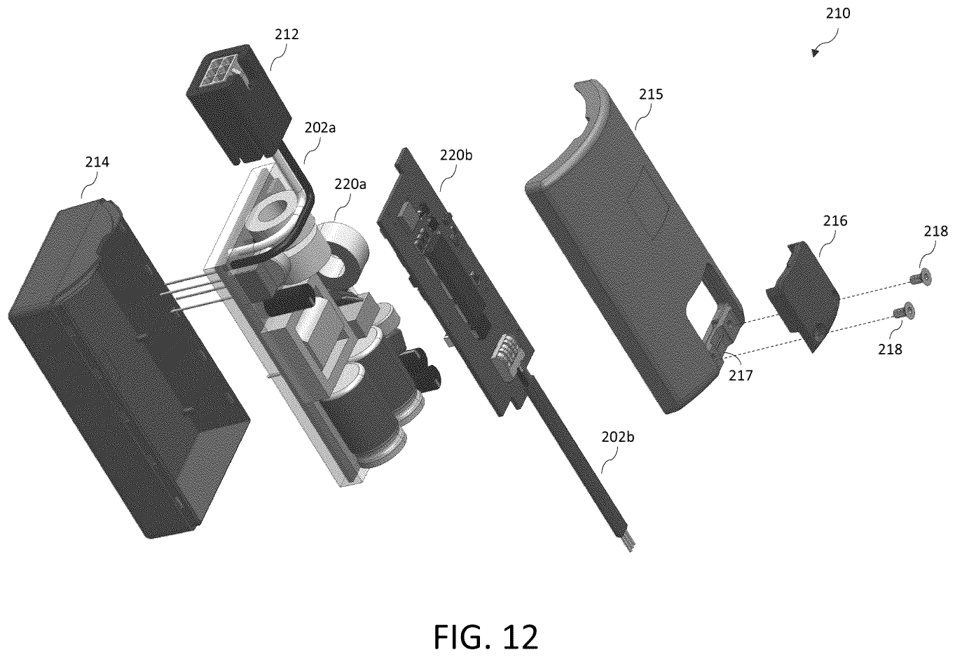

FIG. 12 shows an exploded view of the driver subassembly 210. As shown, the driver subassembly 210 may include a housing 214 and a cover 215 coupled to the housing 214, e.g., via a snap-fit connection. Together, the housing 214 and the cover 215 may define a cavity containing the driver electronics. In this non-limiting example, the driver subassembly 210 may include driver electronics 220a electrically connected to the cable 202a and driver electronics 220b connected to the cable 202b. The driver electronics 220a may be electrically coupled to the driver electronics 220b, e.g., via one or more wired connections and the like. In some implementations, the driver electronics 220a and 220b may be embedded within a potting compound that provides electrical insulation.

In some implementations, the cover 215 may include an opening to provide access to the portion of the driver electronics 220b that connects with the cable 202b. The driver subassembly 210 may include a wiring cover 216 to cover the opening. For instance, the wiring cover 216 may be directly coupled to the cover 215 via fasteners 218 inserted through corresponding fastener openings on the wiring cover 216 and the cover 215. During assembly, the wiring cover 216 may be removed, for example, to connect the cable 202b to the driver electronics 220b. As shown in FIG. 12, the cover 215 may further provide a strain relief feature 217 for the cable 202b.

In some implementations, the driver subassembly 210 may include one or more electrical connectors to facilitate connection of the cables 202a and 202b to the driver subassembly 210. For example, the driver electronics 220a may include an electrical connector (e.g., a USB connector, a Molex connector) to connect the cable 202a, which may include a corresponding electrical connector (e.g., a USB connector, a Molex connector). In another example, the driver electronics 220b may include an electrical connector (e.g., a USB connector, a Molex connector) to connect the cable 202b, which may include a corresponding electrical connector (e.g., a USB connector, a Molex connector).

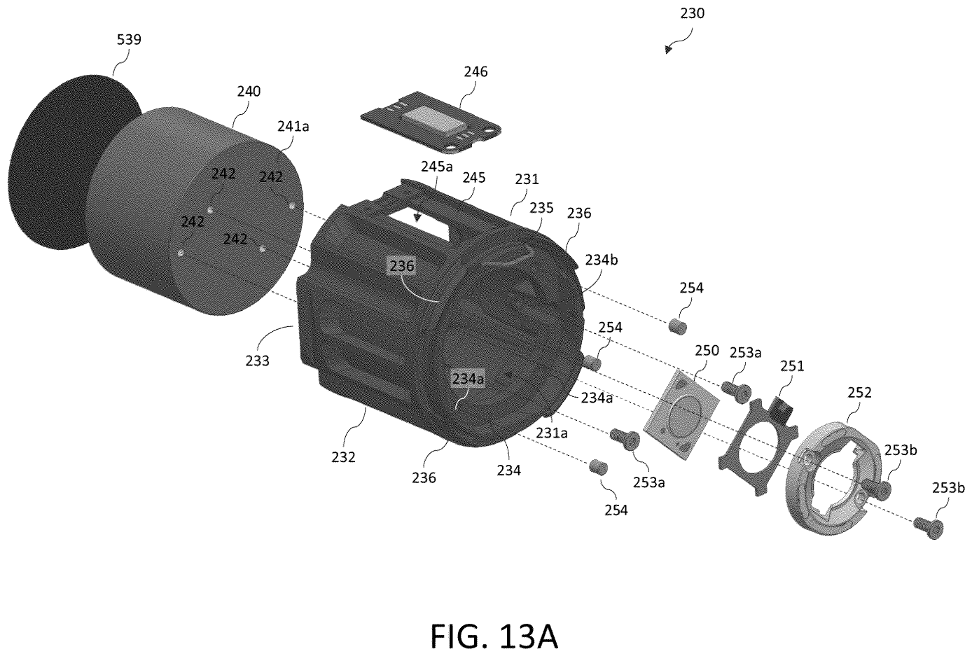

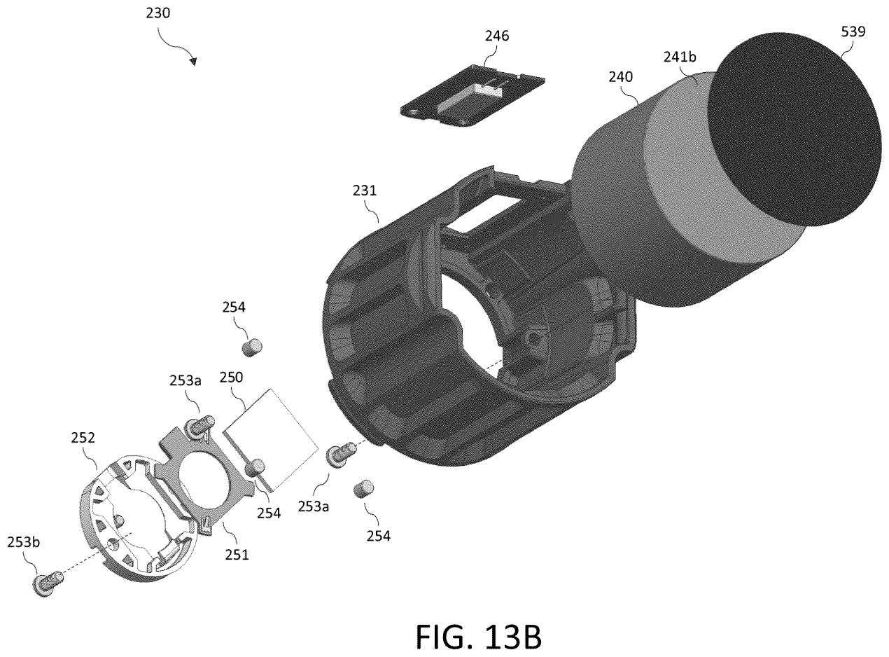

The module subassembly 230, as described above, may include the light source 250 to emit light. FIGS. 10H, 10I, 13A, and 13B show several additional views of the module subassembly 230. As shown, the module subassembly 230 may include a module housing 231 with a sidewall 232 defining a module cavity 231a having a top end defining a top opening and a bottom end defining a bottom opening. The module housing 231 may include a pair of retaining elements 233. Each retaining element 233 may mechanically couple the module subassembly 230 to the heatsink subassembly 536 via the module springs 550. As shown, the retaining element 233 may include a concave groove formed on an exterior side of the sidewall 232 near the top end of the sidewall 232. The groove may be shaped to have the same or similar geometry as the corner 557c of the spring 550 to facilitate engagement of the spring 550 to the module subassembly 230.

The module housing 231 may further include one or more snap-fit connectors 236 at the bottom end of the sidewall 232. The snap-fit connectors 236 may connect the module subassembly 230 to the trim 400a (e.g., via the snap-fit connector 425 on the collar 420). In some implementations, multiple snap-fit connectors 236 may be disposed around the bottom opening with each snap-fit connector 236 spanning only a portion of the perimeter of the bottom opening. For example, the module housing 231 may include four snap-fit connectors 236. Each snap-fit connector 236 may be sufficiently compliant to allow some deflection to facilitate connection with the snap-fit connector 425 of the trim 400a. The module housing 231 may support a wire handle 235. The wire handle 235 may provide a way to pull the module subassembly 230 out from the heatsink cavity 501b of the housing 510, for example, to replace the lighting module 200a and/or the trim 400a. In some implementations, the wire handle 235 may be accessible even when the trim 400a is coupled to the lighting module 200a. For instance, a user may reach their hands through the apertures 402a and 402b to grab the wire handle 235.

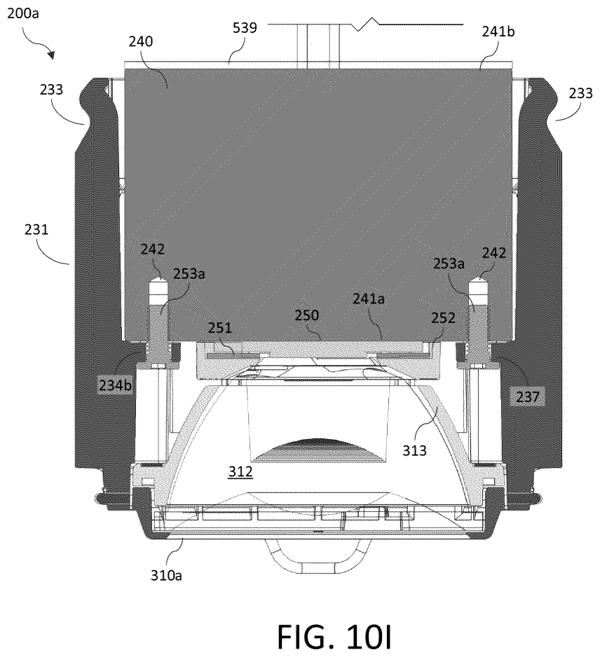

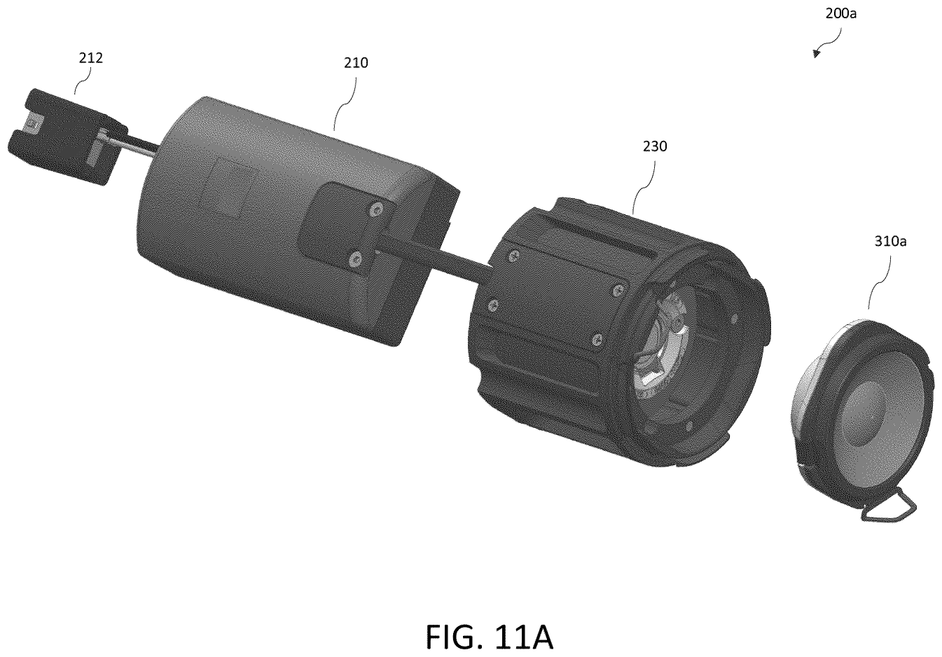

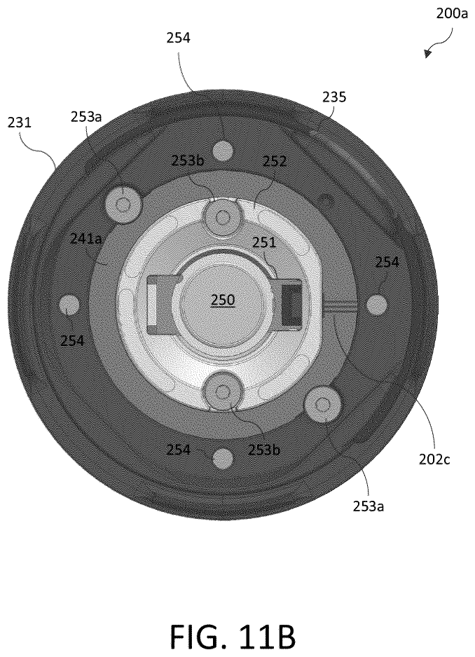

The module housing 231 may contain and/or support various components of the module subassembly 230. For instance, the module housing 231 may support a wiring interface 246. As shown in FIG. 11C, the wiring interface 246 may connect to the cable 202b, thus receiving regulated electrical outputs from the driver subassembly 210. Additionally, the wiring interface 246 may be electrically connected to a cable 202c, which, in turn, is connected to a PCB connector 251. The PCB connector 251 may be electrically connected to the light source 250. For example, the PCB connector 251 may include one or more spring contacts that touch corresponding contact pads on the light source 250. In this manner, the wiring interface 246 may transmit the regulated electrical outputs to the light source 250 via the cable 202c and the PCB connector 251. In some implementations, the wiring interface 246 may include a thermal cutoff switch that disables transmission of the regulated electrical outputs to the light source 250, for example, when the temperature at or near the light source 250 exceeds a predetermined temperature threshold. The thermal cutoff switch may include a built-in temperature sensor (e.g., a thermocouple) to measure the temperature at the wiring interface 246.

As shown in FIG. 11C, the module housing 231 may provide a recess 245 on the sidewall 232 to contain the wiring interface 246. FIG. 13A shows the module housing 231 may include an opening 245a adjoining the recess 245 to allow the cable 202c to pass into the module cavity 231a and connect with the PCB connector 251. The wiring interface 246 may be secured to the module housing 231 by a wiring cover 247 that encloses the recess 245. For example, the wiring cover 247 may be securely coupled to the module housing 231 via fasteners 248 inserted through corresponding fastener openings on the wire cover 247 and fastener openings 249 on the sidewall 232.

The module subassembly 230 may further include a core 240 to dissipate heat generated by the light source 250. Accordingly, the core 240 may be formed from various thermally conductive materials including, but not limited to, aluminum, copper, steel, and any combinations of the foregoing. The core 240 may include a mounting surface 241a to support the light source 250. The core 240 may further include a mounting surface 241b to thermally couple the module subassembly 230 to the base 537 of the heatsink subassembly 536. In some implementations, the thermal pad 539 may be coupled to the mounting surface 241b.

The core 240 may be partially disposed in the module cavity 231a such that the mounting surface 241a abuts a pair of ledges 237 disposed on the interior surface of the sidewall 232. The core 240 may be securely coupled to the module housing 231 via a fastener 253a inserted through a corresponding fastener opening 234b on each ledge 237 and a corresponding fastener opening 242 on the mounting surface 241a of the core 240 as shown in FIG. 10I. As shown in FIGS. 10H and 10I, the core 240 may appreciably span the interior width of the module cavity 231a.

The light source 250 and the PCB connector 251 may be coupled to the core 240 via a light source holder 252. As shown in FIG. 13A, the light source holder 252 may be mounted to the core 240 via fasteners 253b inserted through corresponding fastener openings on the light source holder 252 and corresponding fastener openings 242 on the mounting surface 241a. In this manner, the light source holder 252 may effectively clamp the light source 250 and the PCB connector 251 to the mounting surface 241a of the core 240.

The light source 250 may include one or more light emitting diodes (LEDs) to emit light. In some implementations, the light source 250 may emit light having a light flux up to about 500 lumens, about 600 lumens, about 700 lumens, about 800 lumens, about 900 lumens, about 1000 lumens, about 1100 lumens, about 1200 lumens, about 1250 lumens, about 1300 lumens, about 1400 lumens, about 1500 lumens, or more than 1500 lumens. It should be appreciated that the foregoing values are an upper limit and that the light flux emitted by the light source may generally vary from 0% to 100% of the upper limit, e.g., by using the driver subassembly 210 to facilitate dimming of the light source 250 as described above.

The light source 250 may emit light having a correlated color temperature (CCT). The CCT of the light output may range from about 1000K to about 10,000K, including all sub-ranges and values in between. For example, the CCT of the light output may be equal to about 1000K, about 1500K, about 2000K, about 2500K, about 3000K, about 3500K, about 4000K, about 4500K, about 5000K, about 5500K, about 6000K, about 6500K, about 7000K, about 7500K, about 8000K, about 8500K, about 9000K, about 9500K, or about 10,000K. In some implementations, the CCT of the light output from the light source 250 may be tunable. For example, the CCT may be adjusted from about 1000K to about 10,000K, including all sub-ranges and values in between. In another example, the CCT may be adjusted from about 1800K to about 3000K, including all sub-ranges and values in between. In yet another example, the CCT may be adjusted from about 4000K to about 6500K, including all sub-ranges and values in between.

The light source 250 may have a light emitting surface (LES) with a size ranging from about 1 mm to about 15 mm, including all sub-ranges and values in between. The size of the LES may be defined as the characteristic width of the LES, e.g., the diameter in instances where the LES is circular in shape. For example, the size of the LES may be equal to about 1 mm, about 3 mm, about 5 mm, about 6 mm, about 6.8 mm, about 7 mm, about 7.2 mm, about 8.9 mm, about 9.1 mm, about 10.3 mm, or about 14.3 mm. Examples of the light source 250 include, but are not limited to, a Cree CXB1410 Pro9, a Cree CXB1512 Pro9, a Cree CXB1520, a Bridgelux BXRV-DR-1830G-0600-B-2x, a Bridgelux BXRV-TR-1840G-10A0-B-2x, a Bridgelux BXRV-DR-1830G-1000-B-13, a Bridgelux BXRV-TR-1840G-20A0-A-2x.

In some implementations, the module subassembly 230 may further include an optical subassembly 310a to modify the spatial distribution and/or the angular distribution of the light emitted by the light source 250. The optical subassembly 310a may be removably coupled to the module housing 231. This may be accomplished, in part, by the optical subassembly 310a being securely coupled to module housing 231 via a plurality of magnets 254. Specifically, the optical subassembly 310a may include a reflector 313 with a mounting surface 316 that is magnetically coupled to the plurality of magnets 254 when installed in the module housing 231. FIG. 13A shows the magnets 254 may be mounted to the module housing 231 via insertion into corresponding holes 234a disposed on a flange 234 within the module cavity 231a. Thus, the mounting surface 316 of the optical subassembly 310a may abut the flange 234. FIGS. 10H and 10I show the flange 234 may be offset from the bottom end of the module housing 231 such that at least a portion of the optical subassembly 310a is disposed within the module cavity 231a.

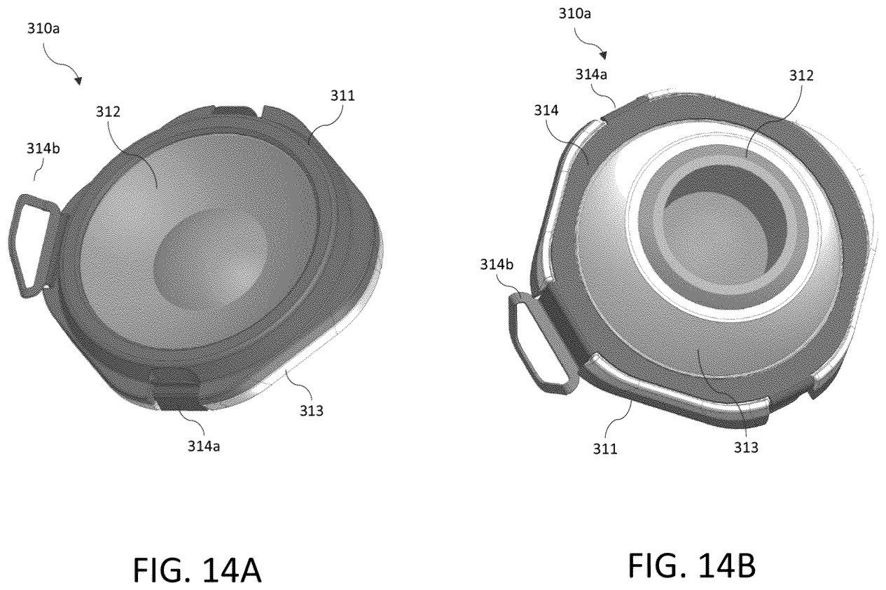

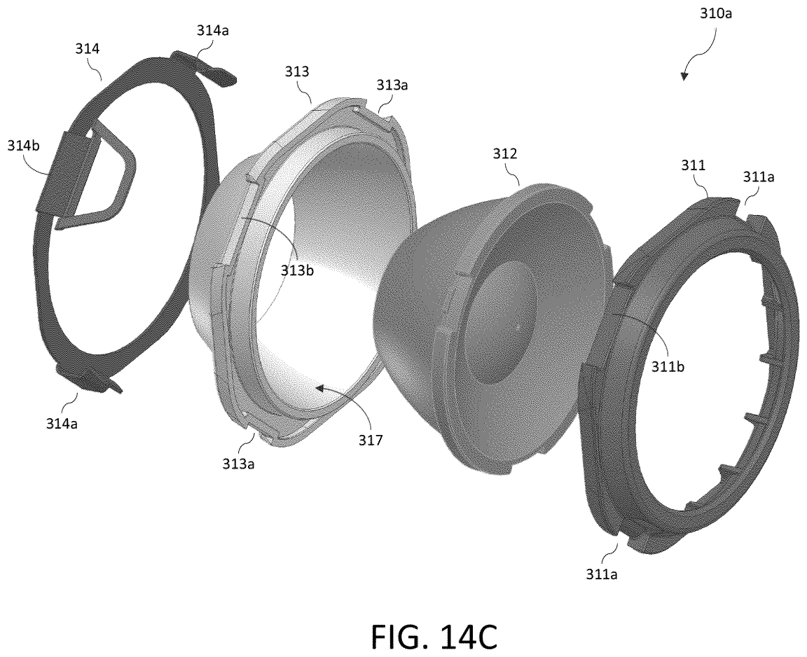

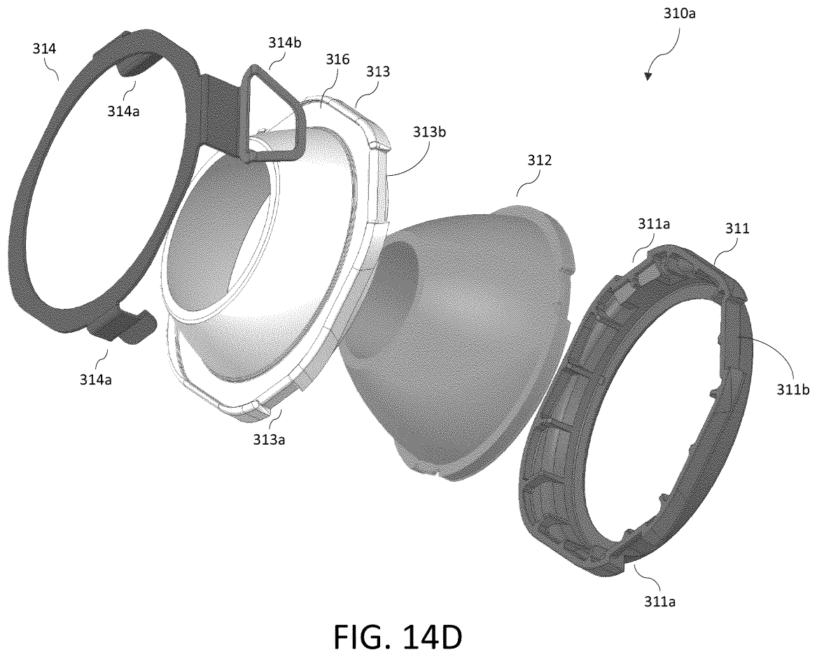

FIGS. 14A-14D show several views of the optical subassembly 310a. As shown, the optical subassembly 310a may include the reflector 313, which provides a cavity 317 to receive a lens 312. In some implementations, the lens 312 may be a total internal reflection (TIR) lens that receives light emitted by the light source 250 and redirects the light along a desired spatial distribution and angular distribution. The surface of the cavity 317 may reflect any stray light that escapes the lens 312, thus increasing the lighting efficiency of the lighting module 200a.

A cover 311 may be coupled to the bottom end of the reflector 313 to securely retain the lens 312 within the cavity 317. The cover 311 may be securely coupled to the reflector 313 via a spring clip 314. For example, the spring clip 314 may include a pair of snap-fit connectors 314a. When the spring clip 314 is coupled to the reflector 313 and the cover 311, each snap-fit connector 314a may be disposed within a corresponding slot 313a on the reflector and couple to a corresponding snap-fit receiver 311a on the cover 311. In some implementations, the spring clip 314 may include a handle 314b to facilitate removal of the optical subassembly 310a from the module housing 231 and/or placement of the optical subassembly 310a when installing the optical subassembly 310a into the module housing 231. The handle 314b may pass through a slot 313b of the reflector 313 and a slot 311b of the cover 311.

As described above, the reflector 313 may include a mounting surface 316 that is magnetically coupled to the magnets 254 of the module housing 231. Accordingly, in some implementations, the reflector 313 may be formed from a magnetizable material, such as a ferromagnetic material (e.g., iron, steel). In some implementations, the reflector 313 may include one or more magnets disposed on the mounting surface 316 to magnetically couple to corresponding magnets 254. It should be appreciated that the magnetic coupling mechanism is a non-limiting example and that other coupling mechanisms may be used to couple the optical subassembly 310a to the module housing 231, such as a snap-fit connection, a fastener connection, and the like.

In some implementations, the module subassembly 230 may be relatively compact in size. For example, the module subassembly 230 may have an overall height, Hm, defined as the distance between the bottom end of the optical subassembly 310a and the mounting surface 241b of the core 240, ranging from about 1.9 inches to about 2.2 inches, including all values and sub-ranges in between. For example, the height, Hm, may be equal to about 1.9 inches, about 2 inches, about 2.1 inches, or about 2.2 inches. The module subassembly 230 may have an overall width, Dₘ, defined as the largest width of the module housing 231, ranging from about 1.9 inches to about 2.2 inches, including all values and sub-ranges in between. For example, the width, Din, may be equal to about 1.9 inches, about 2 inches, about 2.1 inches, or about 2.2 inches.

### 1.3 An Example Adjustable Lighting Module

It should be appreciated that the lighting apparatuses disclosed herein may support different types of lighting modules. For instance, in addition to downlight modules (e.g., the lighting module 200a), the lighting apparatus 100a may support an adjustable module, i.e., a lighting module that emits light along an optical axis where the optical axis is rotatable about at least one axis. In some implementations, the adjustable modules disclosed herein may have the same or substantially similar dimensions as the downlight modules disclosed herein. The relatively compact size of the adjustable module allows the housing assembly 500a to remain relatively compact in size, which, in turn, allows installation of the lighting apparatus 100a into relatively more confined spaces compared to conventional small aperture recessed lighting apparatuses.

FIGS. 15A-15I show several views of an example lighting module 200b configured as an adjustable module. As shown, the lighting module 200b may include an electrical connector 212, a driver subassembly 210 connected to the electrical connector 212 via a cable 202a, and a module subassembly 230 connected to the driver subassembly 210 via a cable 202b. The lighting module 200b may incorporate one or more of the same components and/or features as the lighting module 200a described in Section 1.1. For brevity, repeated discussion of these components and/or features are not provided below unless indicated otherwise. For example, the electrical connector 212, the driver subassembly 210, and the cables 202a and 202b may be the same as in the lighting module 200a. In another example, the dimensions of the module subassembly 230 in the lighting module 200b may be substantially similar or the same as the module subassembly 230 in the lighting module 200a.

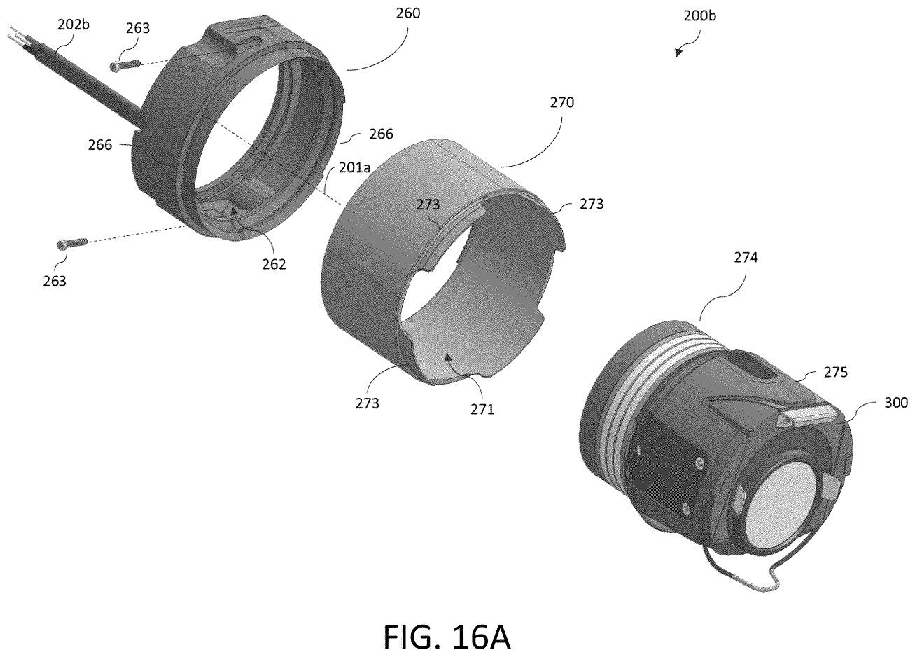

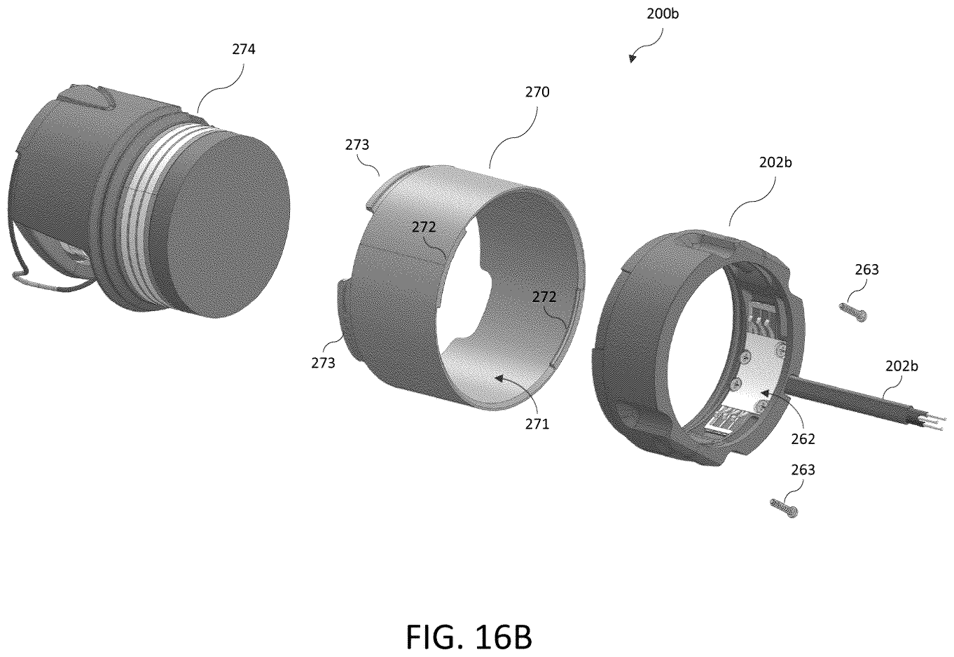

The module subassembly 230 may allow rotation of the optical axis about two axes, e.g., an azimuthal axis 201a and a polar axis 201b (see, for example, FIGS. 15I and 16A). In some implementations, the module subassembly 230 may further allow adjustments to the direction of the optical axis about either the polar axis or the azimuthal axis after the lighting module 200b is installed into the housing assembly 500a. In some implementations, the range of rotation of the optical axis about the azimuthal axis 201a may range from about 0 degrees (corresponding to the optical axis being vertically oriented) to about 360 degrees, including all sub-ranges and values in between. In some implementations, the optical axis may be rotated about the azimuthal axis 201a without limit. For example, the optical axis may be allowed to rotate about the azimuthal axis 201a more than one full rotation. In some implementations, the range of rotation of the optical axis about the polar axis 201b may range from about 0 degrees (corresponding to the optical axis being vertically oriented) to about 45 degrees, including all sub-ranges and values in between. In some implementations, the range of rotation of the optical axis about the polar axis 201b may range from about 0 degrees (corresponding to the optical axis being vertically oriented) to about 35 degrees, including all sub-ranges and values in between. For example, the optical axis may have an angle with respect to the polar axis 201b equal to about 0 degrees, about 5 degrees, about 10 degrees, about 15 degrees, about 20 degrees, about 25 degrees, about 30 degrees, about 35 degrees, about 40 degrees, or about 45 degrees.

FIGS. 16A and 16B show several views of the module subassembly 230. As shown, the module subassembly 230 may include a mount subassembly 260, a collar 270, and a core subassembly 274 supporting the light source 250. The mount subassembly 260 may facilitate connection with the cable 202b and transmit regulated electrical outputs from the driver subassembly 210 to the light source 250 in the core subassembly 274. The collar 270 may define an opening 271 for the core subassembly 274 to pass through. The collar 270 may include one or more snap-fit connectors 273 to couple a trim (not shown) to the lighting module 200b. The collar 270 may be securely coupled to the mount subassembly 260, e.g., via a snap-fit connection, such that the collar 270 does not move relative to the mount subassembly 260. The core subassembly 274 may include a core mount 275 and a head mount 300 supporting the light source 250. The core mount 275 and, by extension, the head mount 300, may be rotatable about the azimuthal axis 201a with respect to the mount subassembly 260. The head mount 300 may be rotatable about the polar axis 201b with respect the core mount 275. In this manner, the light source 250 supported by the head mount 300 may be rotated about both the azimuthal axis 201a and the polar axis 201b.

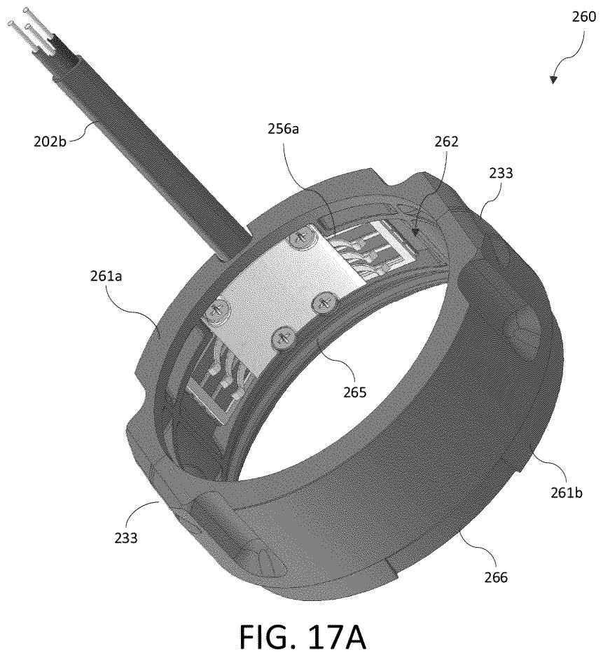

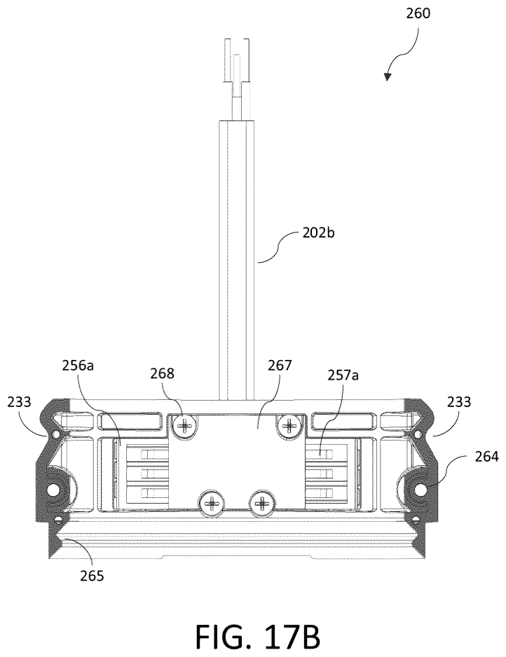

FIGS. 17A-17C show several views of the mount subassembly 260. As shown, the mount subassembly 260 may include a ring mount 261a and a ring mount 261b coupled to the ring mount 261a via fasteners 263 inserted through corresponding fastener openings 264 on the ring mounts 261a and 261b. Together, the ring mounts 261a and 261b may define an opening 262. The ring mounts 261a and 261b may together form the retaining elements 233 to couple the module subassembly 230 to the springs 550 of the heatsink subassembly 536. As shown in FIGS. 15I and 17B, the retaining elements 233 may be disposed toward the top end of the ring mounts 261a and 261b. The bottom end of the ring mounts 261a and 261b may include one or more snap-fit receivers 266 that couple to corresponding snap-fit connectors 272 on the collar 270 to securely couple the collar 270 to the mount subassembly 260.

Additionally, the interior sides of the ring mounts 261a and 261b may define a track 265 to facilitate rotation of the core subassembly 274 and, in particular, the core mount 275, with respect to the mount subassembly 260. In some implementations, the track 265 and the rail 281 may have interlocking geometries that only allows rotation of the core subassembly 274 with respect to the mount subassembly 260 about the azimuthal axis 201a. In other words, the geometries of the track 265 and the rail 281 may constrain translational and rotational motion between the core subassembly 274 and the mount subassembly 260 about all other axes. For example, FIGS. 15H and 15I show the track 265 may form a groove that engages with a corresponding rail 281 on the core mount 275. When the core subassembly 274 is rotated relative to the mount subassembly 260, the rail 281 may slidably move along the track 265. In some implementations, the track 265 and/or the rail 281 may be coated with a lubricant to reduce friction and, in turn, provide smoother rotational adjustment of the core subassembly 274 relative to the mount subassembly 260. For example, the lubricant may include, but is not limited to, a Teflon coating, a graphite coating, and the like.

The mount subassembly 260 may include a wiring interface 256a that directly connects to the cable 202b as shown in FIG. 17C. In some implementations, the wiring interface 256a may maintain an electrical connection between the mount subassembly 260 and a corresponding wiring interface 256b of the core subassembly 274 while allowing rotation of the core subassembly 274 about the azimuthal axis 201a without limit. This may be accomplished, for example, by the wiring interface 256a including a plurality of electrical spring contacts 257a and the wiring interface 256b including a plurality of contact pads 257b. The electrical spring contacts 257a may physically contact the contact pads 257b to transmit the regulated electrical outputs from the driver subassembly 210 to the light source 250. As the core subassembly 274 rotates with respect to the mount subassembly 260, each electrical spring contact 257a may slidably move along a corresponding contact pad 257b, thus maintaining an electrical connection.

FIG. 17C shows the wiring interface 256a may be disposed within a recess formed on the interior side of the ring mount 261a. The wiring interface 256a may be secured to the ring mount 261a by a cover 267, which is securely coupled to the ring mount 261a via a plurality of fasteners 268 inserted through corresponding slots on the cover 267 and fastener openings 269 on the ring mount 261a.

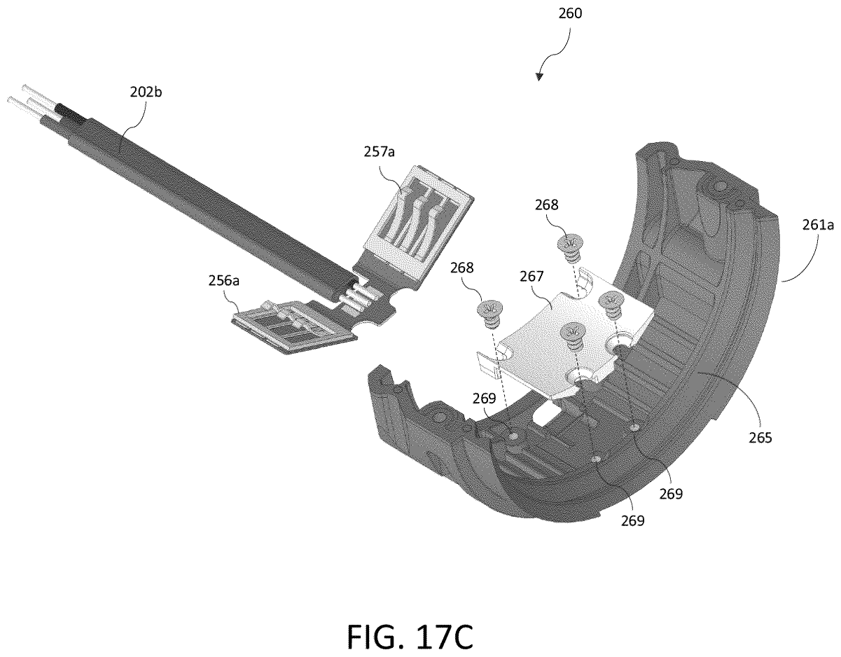

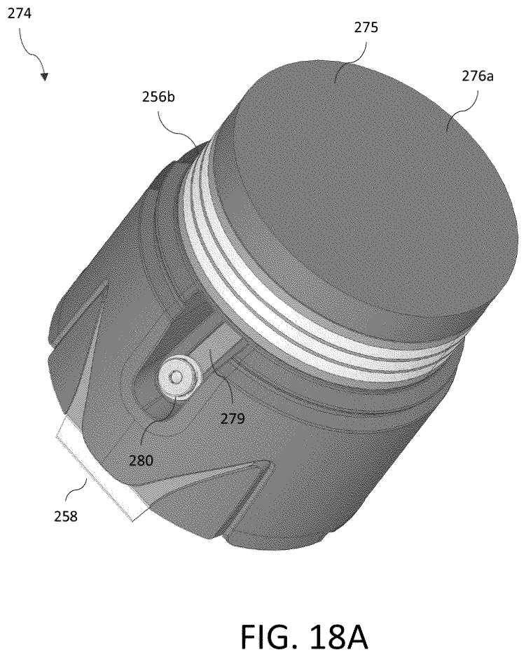

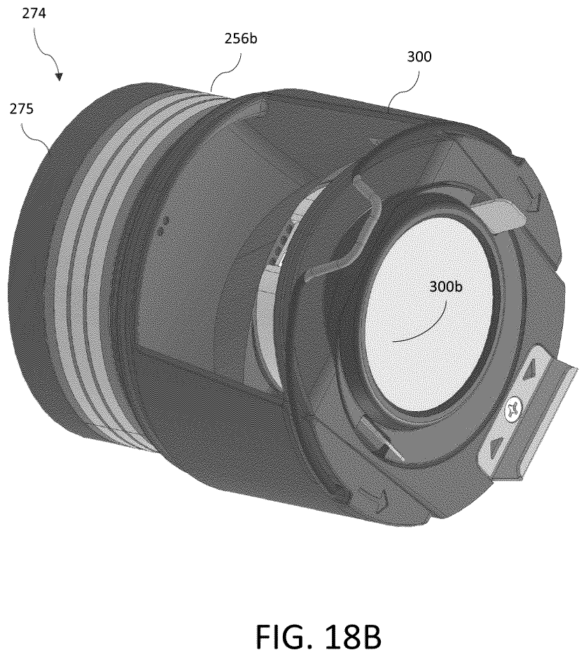

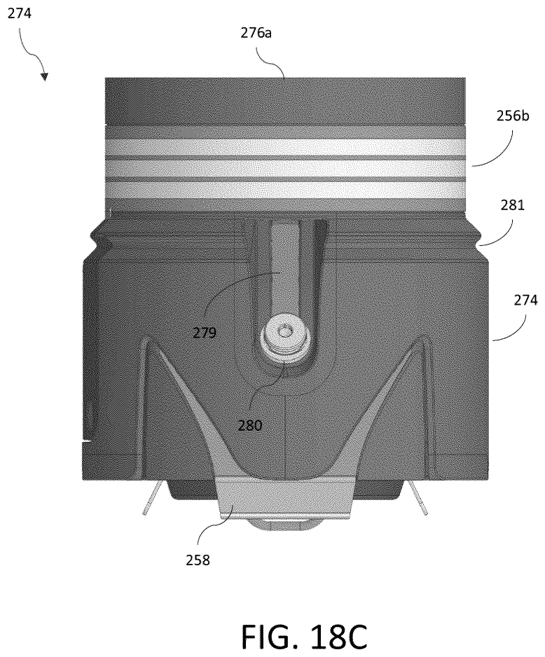

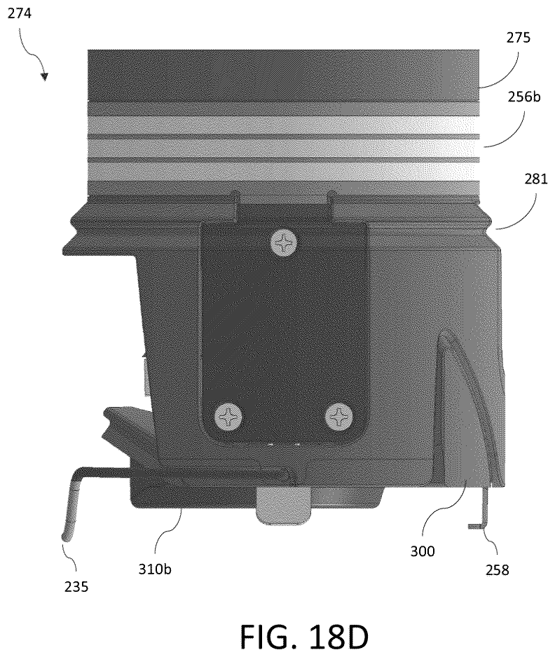

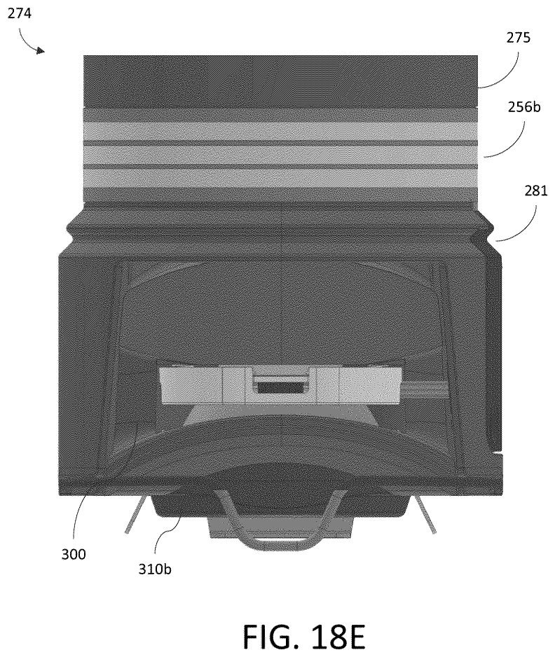

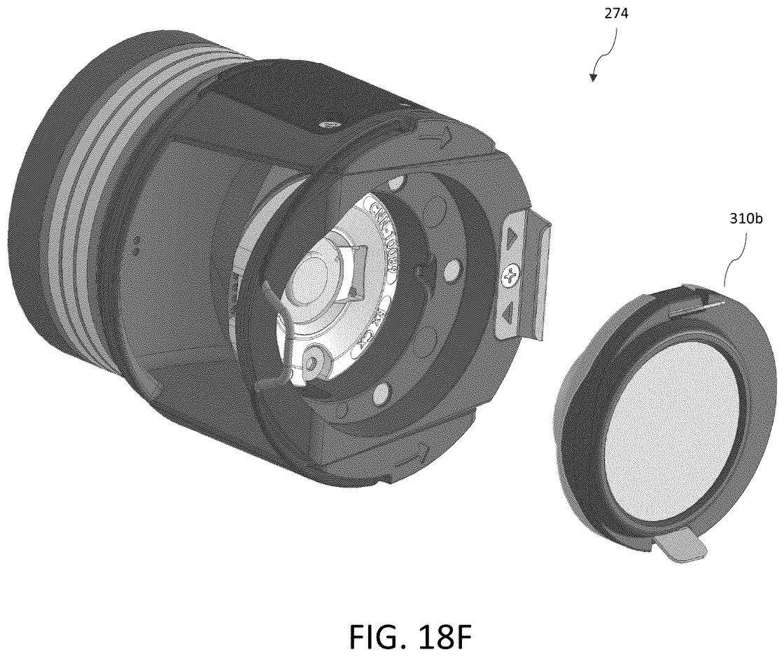

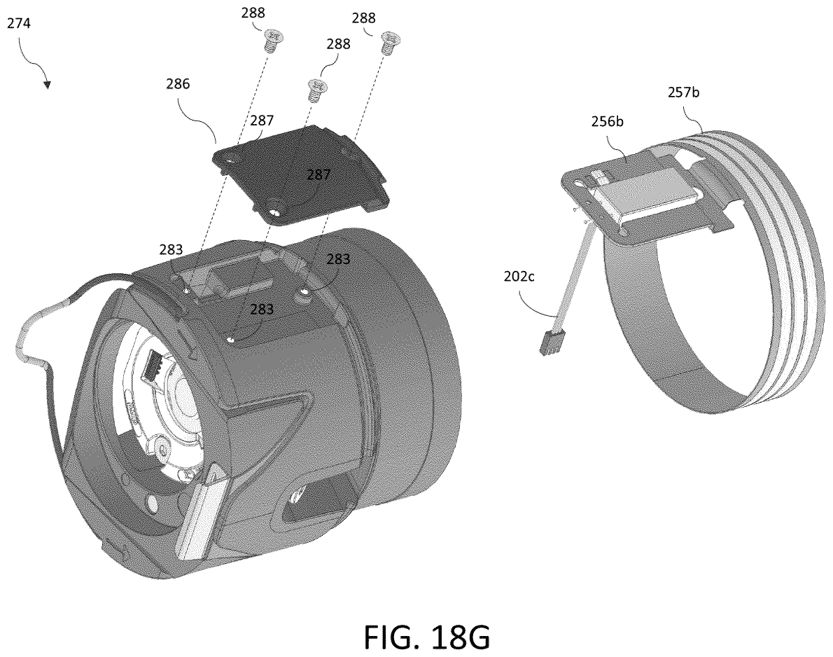

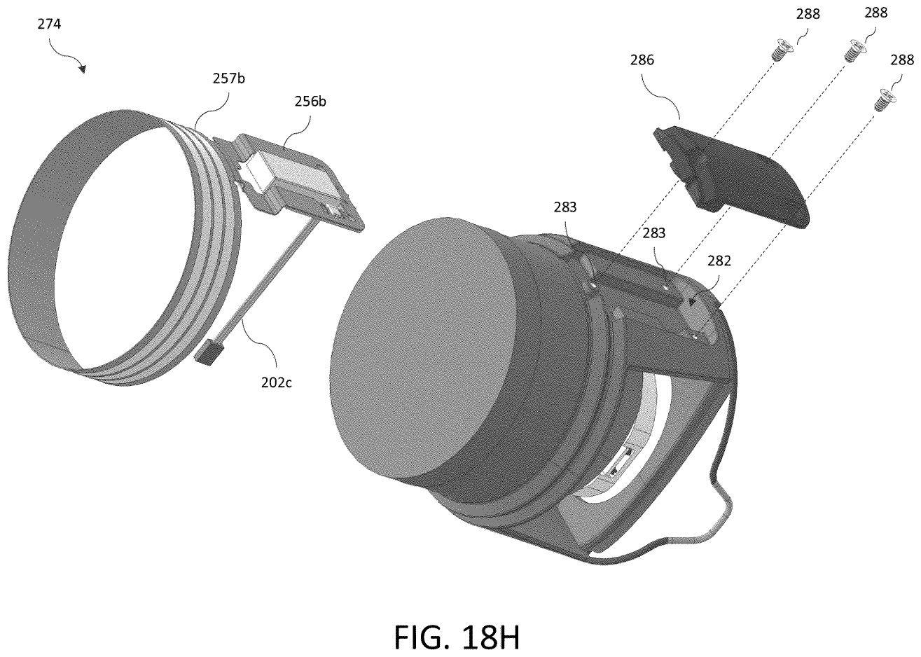

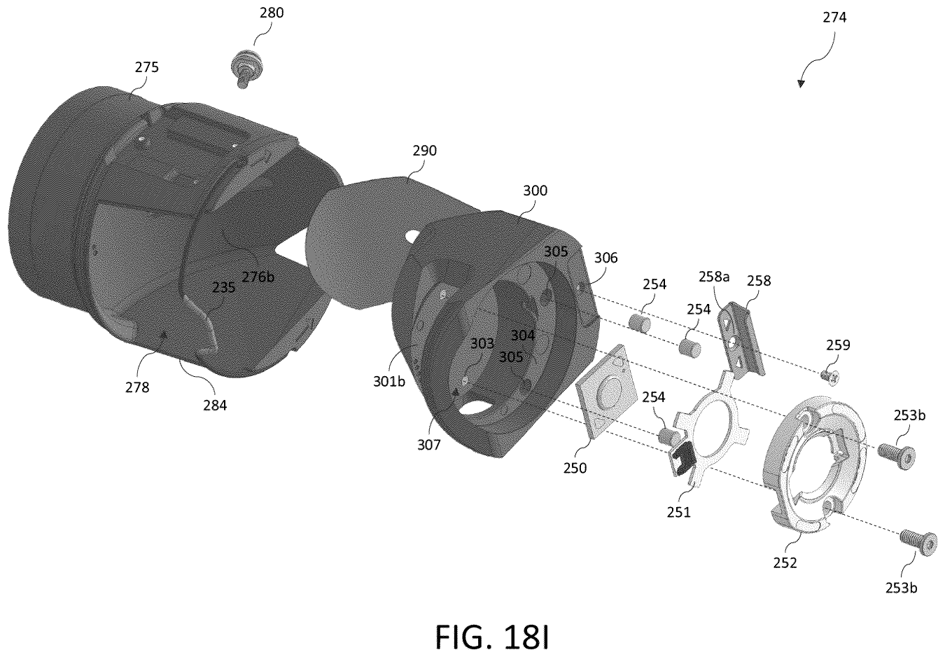

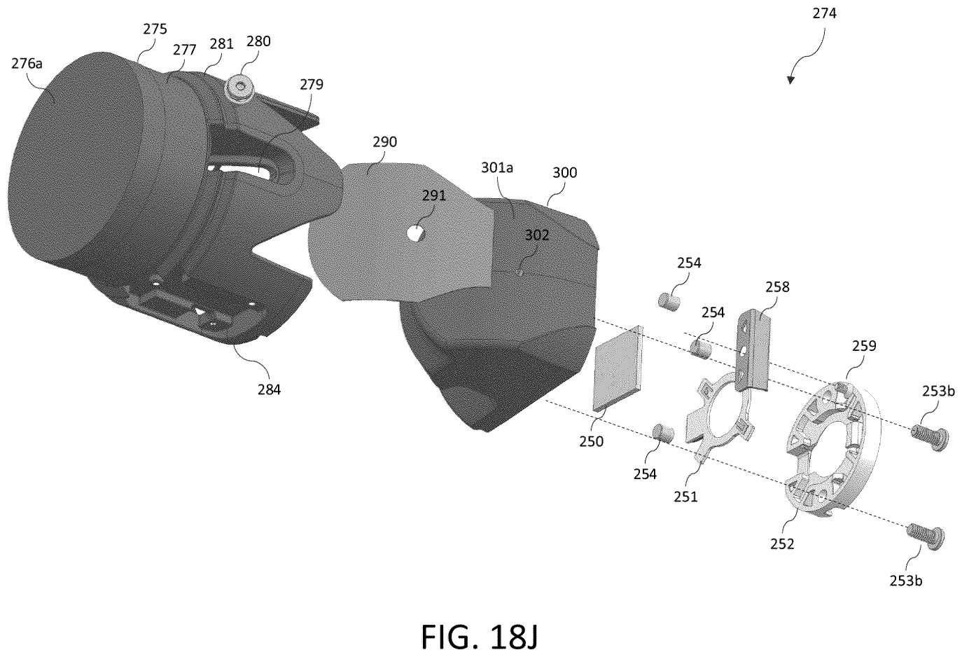

FIGS. 18A-18J show several views of the core subassembly 274. As described above, the core subassembly 274 may include a core mount 275 and a head mount 300 rotatably coupled to the core mount 275. As shown, the core mount 275 may include a cylindrical portion 277 that is disposed within the opening 262 of the mount subassembly 260 and coaxially aligned with the ring mounts 261a and 261b to facilitate rotation of the core subassembly 274 about the azimuthal axis 201a relative to the mount subassembly 260 (see FIGS. 15H and 15I). As shown in FIGS. 18A-18F, the cylindrical portion 277 may support the portion of the wiring interface 256b that includes the electrical contact pads 257b, which are electrically coupled to the electrical spring contacts 257a of the wiring interface 256a, as discussed in further detail below.

The cylindrical portion 277 may further include a mounting surface 276a to couple the module subassembly 230 of the lighting module 200b to the base 537 of the heatsink subassembly 536. In some implementations, the mounting surface 276a may serve the same function as the mounting surface 241b in the lighting module 200a in that the mounting surface 276a may thermally dissipate heat generated by the module subassembly 230 to the heatsink subassembly 536. In some implementations, the mounting surface 276a may be thermally coupled to the base 537 of the heatsink subassembly 536 via a thermal pad (not shown). To accommodate the rotational motion of the core subassembly 274 about the azimuthal axis 201a, the thermal pad may be formed from relatively low-friction materials that can be readily slid across a surface and/or reworked, such as thermal pads formed from silicone, graphite, or carbon.

The core mount 275 may include the rail 281 to engage the track 265 of the ring mounts 261a and 261b. As shown in FIGS. 18C-18E, the rail 281 may be disposed below the cylindrical portion 277. The rail 281, as described above, may have an interlocking geometry with the track 265. In some implementations, the rail 281 may span a substantial portion of the perimeter of the core mount 275 (see, for example, FIGS. 18C and 18D).

The core mount 275 may further include a side portion 284 joined to the rail 281. The side portion 284, the rail 281, and the cylindrical portion 277 may together define and surround a cavity 278 to contain a portion of the head mount 300. The core mount 275 may include a mounting surface 276b disposed within the cavity 278 that is shaped to accommodate rotation of the head mount 300 with respect to the core mount 275. In some implementations, the mounting surface 276b may be curved in shape to match the curvature of a mounting surface 301a of the head mount 300. For example, FIGS. 15I and 18I show that the mounting surfaces 276b and 301a may each have a curvature corresponding to a circular arc. The arc may have a center of curvature that coincides with the polar axis 201b.

In some implementations, the side portion 284, the rail 281, and the cylindrical portion 277 may be formed together as a unitary component. Accordingly, the side portion 284, the rail 281, and the cylindrical portion 277 may be formed from various thermally conductive materials including, but not limited to, aluminum, copper, steel, and any combinations of the foregoing.

The core mount 275 may include a slot 279 that formed along a portion of the mounting surface 276b and accessible from the exterior of the core mount 275. A fastener 280 may be inserted through the slot 279 and into a corresponding fastener opening 302 on the mounting surface 301a of the head mount 300. The fastener 280 may be slidable along the slot 279 to facilitate rotation of the head mount 300 about the polar axis 201b. Thus, the slot 279 may define the range of rotation of the head mount 300 about the polar axis 201b. In some implementations, one or more washers may be disposed between the head of the fastener 280 and the portion of the core mount 275 forming the slot 279.

To maintain the head mount 300 at a desired orientation about the polar axis 201b, the washer(s) may include at least one spring washer to increase the clamping force of the fastener 280. Said another way, the clamping force may be sufficient to hold the weight of the head mount 300 when the fastener 280 is at any position along the slot 279. In this manner, accidental rotation of the head mount 300 about the polar axis 201b may be appreciably reduced. Moreover, the foregoing approach may allow the module subassembly 230 to forego a separate locking mechanism for the head mount 300, thus appreciably simplifying the core subassembly 274.

Matching the curvature of the mounting surface 276b to the curvature of the mounting surface 301a may allow a greater portion of the mounting surface 276b to physically contact the mounting surface 301a, thus increasing heat transfer from the head mount 300 to the core mount 275. In some implementations, the core subassembly 274 may include a thermal pad 290 disposed between the mounting surfaces 276b and 301a to increase heat dissipation. As shown in FIGS. 181 and 18J, the thermal pad 290 may include an opening 291 that aligns with the fastener opening 302 and, hence, receives the fastener 280. Thus, the thermal pad 290 may be securely coupled to the head mount 300 and configured to rotate together with the head mount 300 about the polar axis 201b with respect to the core mount 275. The thermal pad 290 may be formed from relatively low-friction materials that can be readily slid across a surface and/or reworked, such as thermal pads formed from silicone, graphite, or carbon.

As described above, the core subassembly 274 and, in particular, the core mount 275 may support the wiring interface 256b, which provides electrical connections with the wiring interface 256a of the mount subassembly 260 and the light source 250 supported by the head mount 300. As shown in FIGS. 18G and 18H, the wiring interface 256b may include a ring portion supporting the plurality of contact pads 257b, which is disposed around the cylindrical portion 277, and a board portion supporting other electronic components, such as a thermal cutoff switch. The board portion may be connected to a cable 202c, which, in turn, is inserted through an opening on the side portion 284 and into the cavity 278 for connection with a PCB connector 251. The PCB connector 251, in turn, is electrically coupled to the light source 250. The cable 202c may have sufficient slack to maintain an electrical connection with the PCB connector 251 for any rotational position of the head mount 300.

FIGS. 18G and 18H further show the board portion of the wiring interface 256b may be disposed within a recess 282 formed on the side portion 284 of the core mount 275. The board portion and, by extension, the entirety of the wiring interface 256b may be secured to the core mount 275 via a cover 286, which is securely coupled to the core mount 275 via fasteners 288 inserted through corresponding fastener openings 287 on the cover 286 and corresponding fastener openings 283 on the core mount 275.

In some implementations, the core mount 275 may support a handle 235, e.g., to facilitate removal of the module subassembly 230 from the heatsink subassembly 536. As shown, the handle 235 may be a wire handle coupled to a bottom portion of the side portion 284. In some implementations, the handle 235 may not be used to adjust the orientation of the optical axis. Rather, the module subassembly 230 may include a separate handle 258 to adjust the orientation of the optical axis.

The head mount 300, as described above, may support the light source 250. As shown in FIGS. 181 and 18J, the head mount 300 may include the mounting surface 301a, which mechanically abuts the mounting surface 276b as described above. The head mount 300 may further include a mounting surface 301b disposed within a recess 307. In some implementations, the mounting surface 301b may serve the same function as the mounting surface 241a in the lighting module 200a in that the mounting surface 301b may support and thermally dissipate heat generated by the light source 250. In some implementations, the light source 250 may be mounted such that the optical axis of the light source 250 is offset from the centerline axis of the module subassembly 230 (see FIG. 15E). This offset may appreciably reduce or, in some instances, prevent light emitted by the light source 250 from being blocked by a portion of the head mount 300 when, for example, the head mount 300 is rotated about the polar axis 201b.

As shown in FIGS. 15H, 15I, and 18I, the core subassembly 274 may include a PCB connector 251 disposed onto the light source 250 to electrically connect the light source 250 to the cable 202c. The core subassembly 274 may further include a light source holder 252 to securely couple the light source 250 and the PCB connector 251 to the mounting surface 301b, e.g. via fasteners 253b inserted through corresponding fastener openings on the light source holder 252 and corresponding fastener openings 303 on the mounting surface 301b. The head mount 300 may further include a flange 304 offset from the mounting surface 301b to support an optical subassembly 310b. As shown in FIG. 18I, the flange 304 may include multiple holes 305 for corresponding magnets 254. The optical subassembly 310b may be magnetically coupled to the head mount 300 via the magnets 254 (see FIG. 18F).

In some implementations, the head mount 300 may include a handle 258 to facilitate adjustment of the head mount 300 about the polar axis 201b and the core subassembly 274 about the azimuthal axis 201a. As shown, the handle 258 may be directly coupled to a bottom end of the head mount 300 via fastener 259 inserted through a corresponding fastener opening 258a of the handle 258 and a corresponding fastener opening 306 of the head mount 300. In this manner, the handle 258 may be readily accessible, e.g., through the opening 94 in the ceiling drywall 92 and the aperture 519.

In some implementations, the head mount 300 may be a unitary component. Accordingly, the head mount 300 may be formed from various thermally conductive materials including, but not limited to, aluminum, copper, steel, and any combinations of the foregoing.

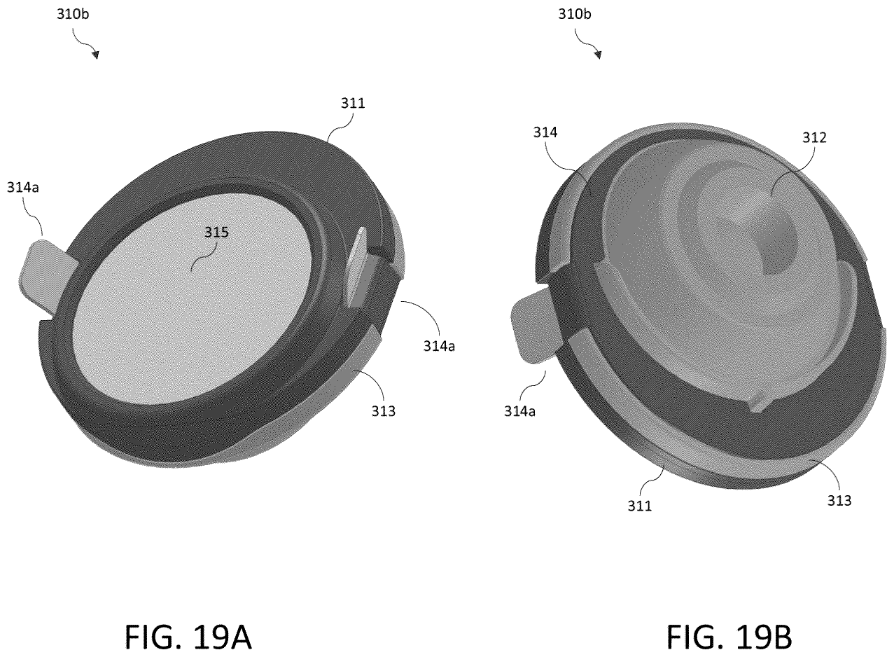

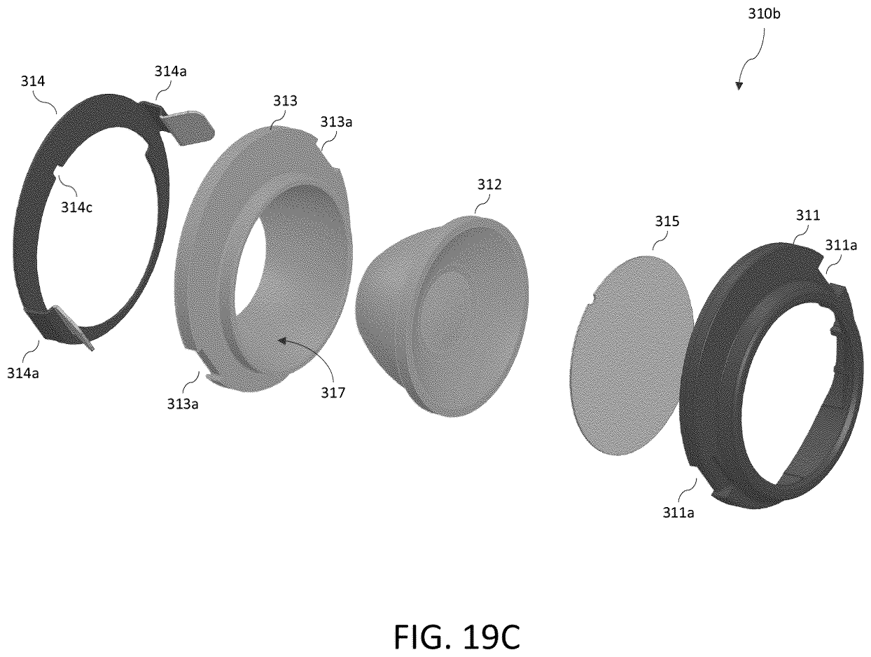

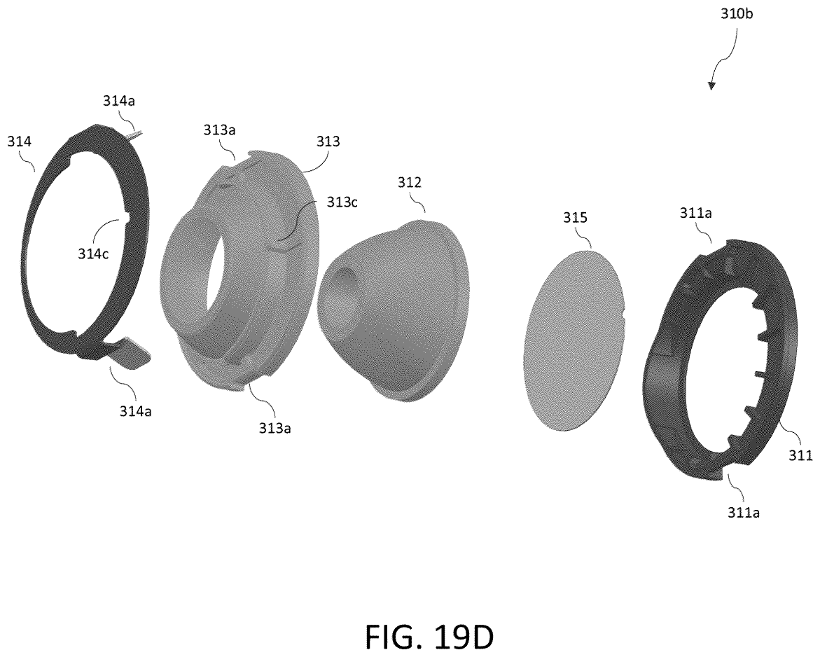

FIGS. 19A-19D show several views of the optical subassembly 310b. The optical subassembly 310b may be a variant of the optical subassembly 310a adapted for the lighting module 200b. For example, the optical subassembly 310b may be designed to account for the light source 250 being offset from the centerline axis of the module subassembly 230 (see FIG. 15E) and, by extension, the centerline axis of the aperture 519. As shown, the optical subassembly 310b may include a reflector 313, a lens 312 disposed in a cavity 317 of the reflector 313, a cover 311 to securely retain the lens 312 in the cavity 317 of the reflector 313, and a spring clip 314 to couple the reflector 313 to the cover 311. In this example, the spring clip 314 may not include a handle since the snap-fit connectors 314a and the side portions of the optical subassembly 310b may be readily accessible to a user to grab.

In some implementations, the optical subassembly 310b may include a lens 315 disposed between the lens 312 and the cover 311. The lens 315 may serve the same function as the lens 430 in the trim 400a in that the lens 315 may modify the spatial and/or angular distribution of light provided by the light source 250. In one non-limiting example, the lens 315 may diffuse the light to provide a smoother, softer light beam. In another non-limiting example, the lens 315 may narrow or widen the light. In some implementations, the lens 315 may be a solite lens, a frosted lens, a prismatic lens, a clear lens, or the like. The inclusion of the lens 315 in the optical subassembly 310b may simplify the trim used with the lighting module 200b, e.g., by eliminating the need for the trim to support a diffusing lens.

### 1.4 An Example Trim

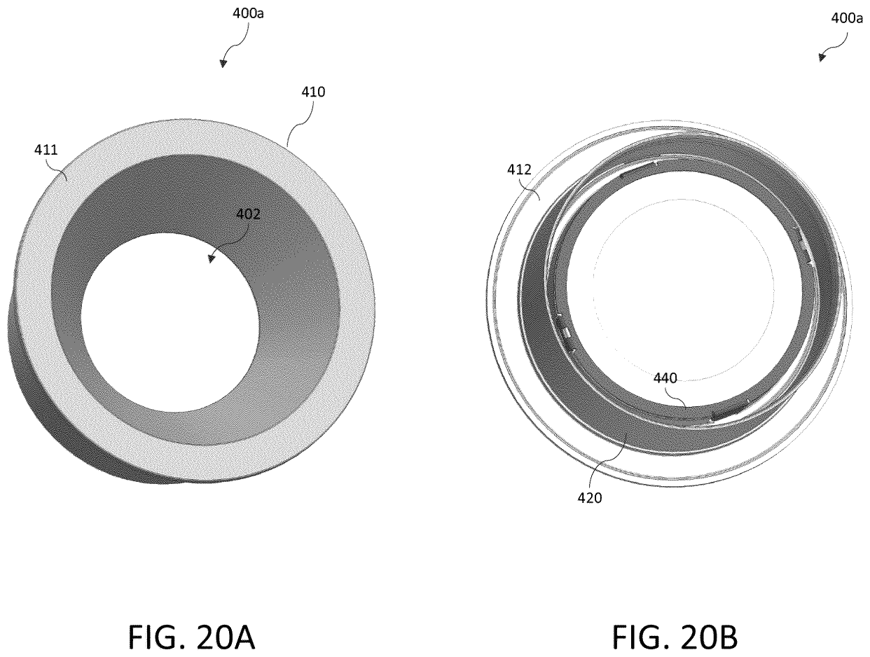

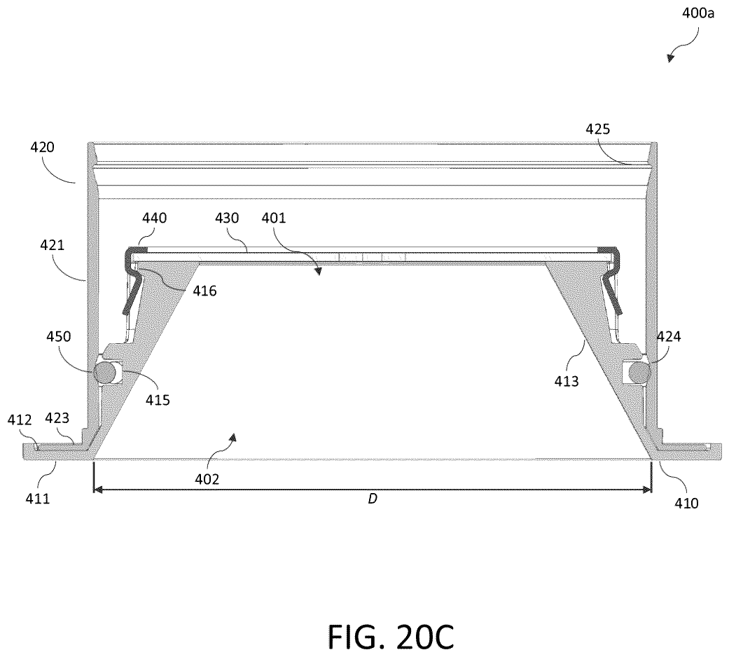

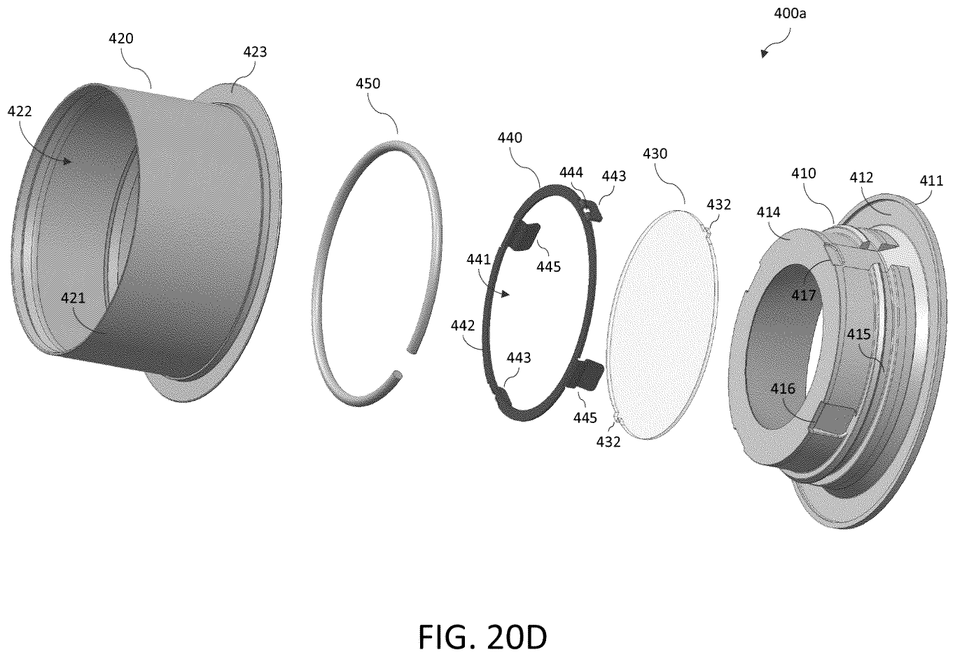

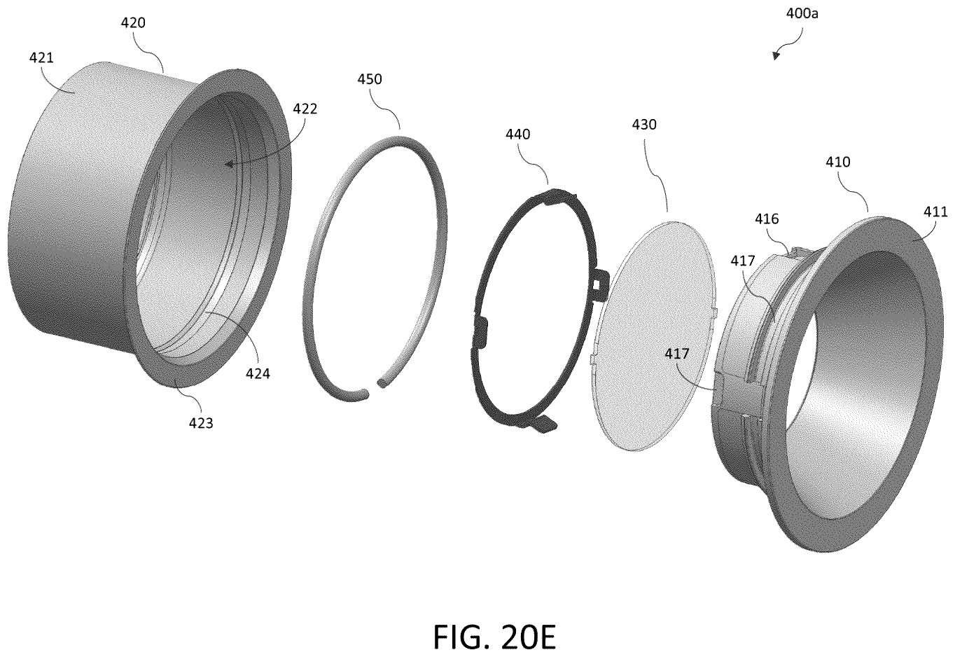

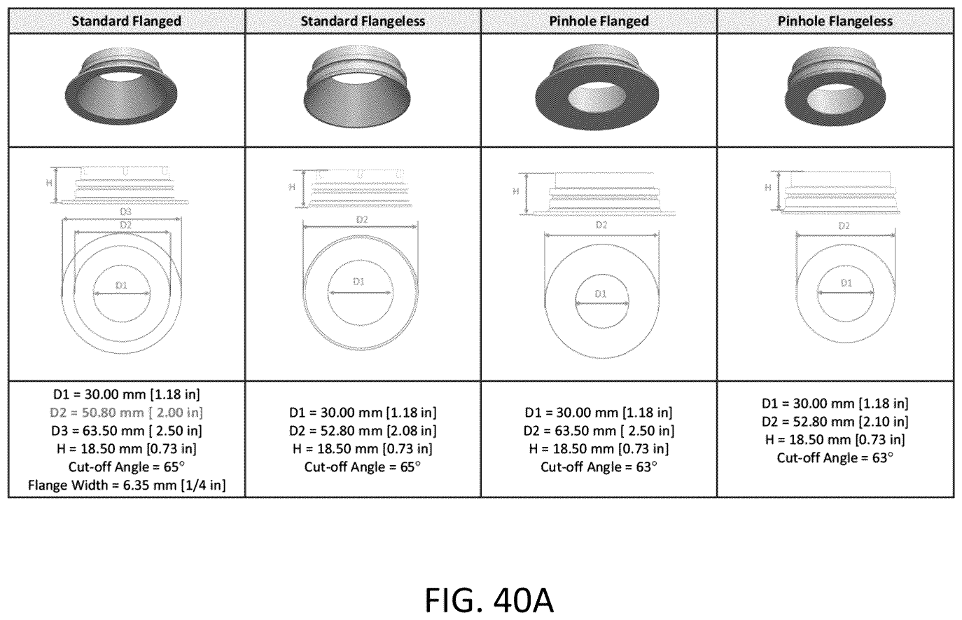

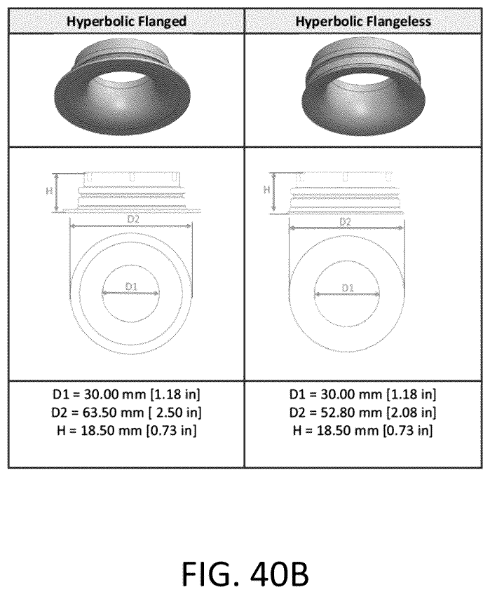

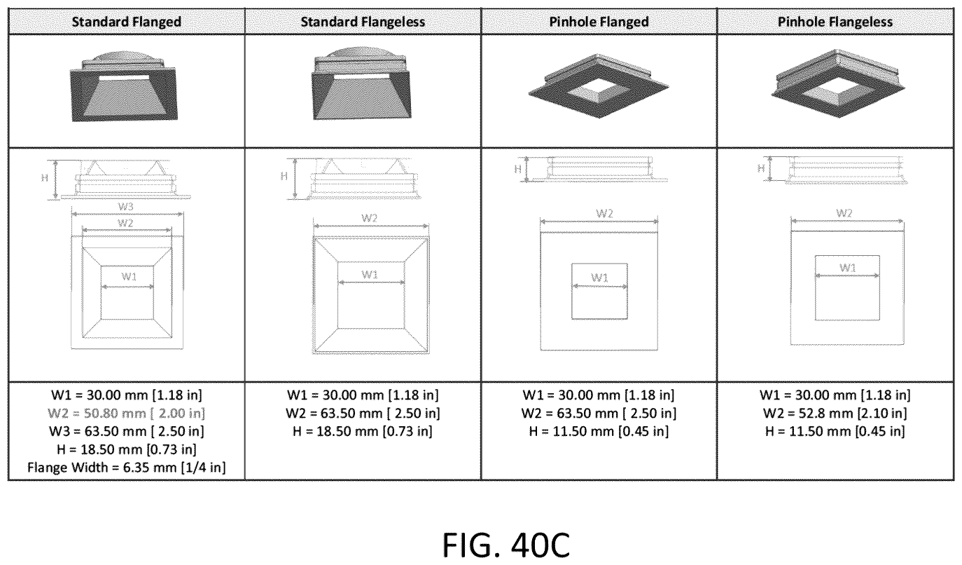

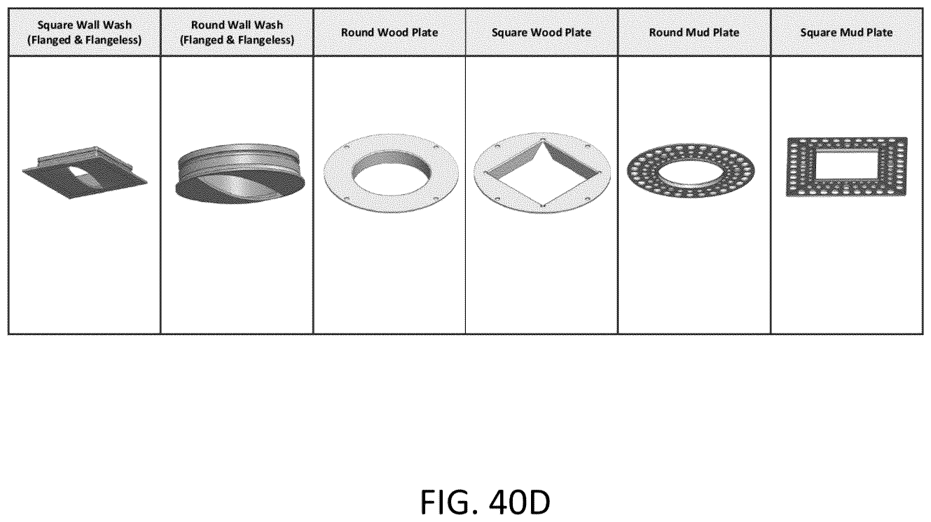

FIGS. 20A-20E show several views of the trim 400a. The trim 400a may be coupled, for example, to the lighting module 200a or the lighting module 200b. More generally, various trims may be provided for any of the lighting modules disclosed herein including downlight and adjustable lighting modules. For instance, the trim 400a may be a standard flanged trim. More generally, the trims contemplated herein may include, but are not limited to, a standard flanged trim, a bevel trim, flangeless trim, a pinhole trim, a hyperbolic trim, a wall wash trim, a wood plate, a mud plate, and any combinations of the foregoing. Additionally, trims with various shapes are contemplated herein including, but not limited to, a circular trim, and a square trim. It should be appreciated that the features of the trim 400a may be readily incorporated into any other trims contemplated herein. FIGS. 40A-40D show additional examples of trims that may be readily used with the lighting apparatus 100a.

As shown, the trim 400a may include a flange component 410 that defines an aperture 401 to receive the light from the lighting module and the aperture 402 for light to exit into the illuminated environment. The trim 400a may further include a collar 420 coupled to the flange component 410 via a wire spring 450. The collar 420 may couple the trim 400a to the lighting module. The trim 400a may further include a lens 430 disposed on a mounting surface 414 of the flange component 410 and a lens holder 440 to securely couple the lens 430 to the flange component 410. Each of these components are discussed below.

The flange component 410 may include a crown 413 that defines the apertures 401 and 402. As shown in FIG. 20C, the crown 413 may be frustoconical in shape with the aperture 401 having a smaller width compared to the width, D, of the aperture 402. The flange component 410 may further include a flange portion 411 joined to the crown 413 and surrounding the aperture 402. When the lighting apparatus 100a is installed into a built environment, the flange portion 411 may physically contact the installation surface.

As shown in FIGS. 20C and 20D, the top side of the flange portion 411 may include a recess 412 to seat a flange portion 423 of the collar 420 as discussed further below. The crown 413 may include a mounting surface 414 along the top side of the crown 413 surrounding the aperture 401. The mounting surface 414 may support the lens 430 and the lens holder 440. The flange component 410 may include a notch 415 that extends around the exterior side of the crown 413. The notch 415 may receive a portion of a wire spring 450 used to couple the collar 420 to the flange component 410. The flange component 410 may include a pair of snap-fit receivers 416 that engage with corresponding snap-fit connectors 445 of the lens holder 440 to securely couple the lens holder 440 to the flange component 410. The snap-fit receivers 416 may adjoin the mounting surface 414. The flange component 410 may include a pair of recesses 417 formed on the exterior side of the crown 413 and adjoining the mounting surface 414. Each recess 417 may accommodate a tab 443 on the lens holder 440 so that the lens 430 may be placed against the mounting surface 414.

The collar 420 may include a sidewall 421 that surrounds and defines an opening 422. The collar 420 may further include a flange portion 423 joined to a bottom end of the sidewall 421. The flange portion 423 may be shaped and/or dimensioned to be disposed within the recess 412 formed on the flange portion 411 of the flange component 410. When the trim 400a is assembled, the flange component 410 may be coupled to the collar 420 such that the crown 413 is inserted through the opening 422 of the collar 420 and the flange portion 423 abuts the flange portion 411 of the flange component 410. The physical contact between the flange portions 411 and 423 may provide a way to align the flange component 410 to the collar 420. For example, the collar 420 may be aligned to the flange component 410 such that the centerline axis of the opening 422 is colinear with the centerline axis of the aperture 402. The collar 420 may include a notch 424 formed along the interior side of the sidewall 421 to receive a portion of the wire spring 450.

The collar 420 may further include a snap-fit connector 425 formed along the interior side of the sidewall 421 near the top end of the sidewall 421. The snap-fit connector 425 may couple to the snap-fit connectors 236 of the lighting module 200a or the snap-fit connectors 273 of the lighting module 200b, thus coupling the trim 400a to the lighting module. When attaching the trim 400a to the lighting module, a force may be applied to press the trim 400a and, in particular, the snap-fit connector 425 into engagement with the snap-fit connectors 236. The design and arrangement of the snap-fit connectors 236 may allow each snap-fit connector 236 to deflect in order to facilitate engagement with the snap-fit connector 425.

The lens 430 may modify the spatial and/or angular distribution of light provided by the lighting module. It should be appreciated that the lens 430 is an optional component and may not be present for some trims. In one non-limiting example, the lens 430 may diffuse the light to provide a smoother, softer light beam. In another non-limiting example, the lens 430 may narrow or widen the light. In some implementations, the lens 430 may be a solite lens, a frosted lens, a prismatic lens, a clear lens, or the like.

One or more tabs 432 may be disposed along the edge of the lens 430 to securely couple the lens 430 to the lens holder 440. Specifically, the tabs 432 may be snap-fit connected to the tabs 443 of the lens holder 440 such that each tab 432 is inserted into an opening 444 on the tab 443 of the lens holder 440. The lens 430, via the lens holder 440, may be coupled to the flange component 410 with the lens 430 abutting the mounting surface 414 of the flange component 410.

The lens holder 440, as described above, may securely couple the lens 430 to the flange component 410. It should be appreciated that the lens holder 440 is an optional component and may not be present for some trims when no lens 430 is present. As shown, the lens holder 440 may have a ring-shaped body 442 that defines an opening 441 for light to pass through the lens 430. The lens holder 440 may include a pair of snap-fit connectors 445 to couple the lens holder 440 to the flange component 410. Specifically, each snap-fit connector 445 may engage a snap-fit receiver 416 on the flange component 410. The lens holder 440 may further include a pair of tabs 443 with corresponding openings 444 to securely couple the lens 430 to the lens holder 440. When the lens holder 440 is coupled to the flange component 410, the tabs 443 may be placed into the recesses 417 formed along the exterior side of the crown 413 of the flange component 410.

### 1.5 An Example Method for Installing and Servicing the Lighting Apparatus

The various inventive features of the lighting apparatus 100a described in the foregoing sections may make it appreciably easier to install the lighting apparatus 100a in various built environments. Following below are example methods for installing and servicing the lighting apparatus 100a in a ceiling space. It should be appreciated that the method steps are not limited only to installation in a ceiling, but may be readily applied to any installation surface and space. It should also be appreciated that, in some instances, the steps in the methods below may be executed in a different order.

FIGS. 21A-21E show a method for installing the lighting module 200a and the trim 400a into the housing assembly 500a after the housing assembly 500a is installed into a ceiling space 90. It should be appreciated that the same or similar steps may be executed to install the lighting module 200b. Before the method shown in FIGS. 21A-21E occurs, the method may be preceded by the following steps: (1) securely mounting the housing assembly 500a to one or more support structures in a ceiling space 90 via the crossmembers 507 and the bar hangers 506; (2) positioning the housing assembly 500a to a desired location along the bar hangers 506; (3) tightening the lock screws on the bar hanger holders 508 to lock the position of the housing 510; (4) removing one or more knockouts 511a and/or one or more Romex feedthroughs 511b; (5) inserting one or more wires from an external electrical system into the wiring cavity 501a of the housing 510; (6) opening the wire door plate 514 (e.g., by loosening the fastener 516a) to access the wiring cavity 501a; (7) inserting each wire into an appropriate wire opening (e.g., wire openings 583a or 583b) for connection with a corresponding electrical connector (e.g., electrical connectors 587a or 587b); (8) closing the wire door plate 514 (e.g., by tightening the fastener 516a); (9) inserting a plug (e.g., a dummy module) through the aperture 519 of the housing 510 to cover the aperture 519 during installation and cutting of drywall, thus preventing deposition of dust onto the base 537 of the heatsink subassembly 536; (10) installing ceiling drywall 92 to enclose the ceiling space 90; (11) cutting an opening 94 into the drywall 92 to provide access to the aperture 519 of the housing 510 from below the ceiling drywall 92; (12) removing the plug from the aperture 519; (13) applying a force (e.g., by a user) to lower the vertical position of the heatsink subassembly 536 such that the heatsink subassembly 536 is engaged in the locked configuration (see FIG. 21A); and (14) securely coupling the trim 400a to the lighting module 200a. In some implementations, step (14) may be performed after the lighting module 200a is installed in the housing assembly 500a, but before the heatsink subassembly 536 is disengaged from the locked configuration (e.g., between steps (17) and (18) below).

Following the preceding steps, the method of installing the lighting module 200a and the trim 400a may include the following steps: (15) connecting the connector 212 of the lighting module 200a to the connector 592 of the cable 590 (e.g., by reaching through the aperture 519 and pulling the connector 592 down below the ceiling drywall 92); (16) inserting the lighting module 200a and the trim 400a at least partially through the opening 94 of the ceiling drywall 92 and the aperture 519 of the housing assembly 500a with the electrical connector 212 and the driver subassembly 210 placed, for example, in the driver region 501c (see FIG. 21A); (17) securely coupling the module subassembly 230 to the heatsink subassembly 536 by applying a first force along a vertical upward direction to actuate and engage the springs 550 with the retaining elements 233 of the module subassembly 230 (FIGS. 21B and 21C); and (18) applying a second force to the lighting module 200a and/or the trim 400a along a vertical upward direction to disengage the heatsink subassembly 536 from the locked configuration, thus allowing the heatsink subassembly 536, the lighting module 200a, and the trim 400a to move vertically upward in response to the forces applied by the springs 530 until the flange portion 411 of the trim 400a abuts the surface 93 of the ceiling drywall 92 (FIGS. 21D and 21E).

FIG. 21B shows that during step (18), as lighting module 200a and, in particular, the module subassembly 230 is inserted into the cavity 501b, the sidewall 232 of the module housing 231 may initially deflect and displace the end portion 553 of each spring 550 such that the hem 555 of each spring 550 is disposed within a corresponding recess 524b on each rail 523. FIG. 21C shows that further insertion of the module subassembly 230 results in the corner 557c of each spring 550 engaging a corresponding retaining element 233 of the module subassembly 230, resulting in the end portion 553 of each spring 550 moving back toward the module subassembly 230. In some implementations, the hem 555 of each spring 550 may no longer be disposed within the corresponding recess 524b of each rail 523 after the module subassembly 230 is mechanically engaged to the heatsink subassembly 536. During this step, the heatsink subassembly 536 may remain in the locked configuration.

FIG. 21D shows that the second force causes each bumper 545 to press against the bump 533 on the corresponding spring 530 resulting in the spring 530 being deflected toward the module subassembly 230 while the heatsink subassembly 536 moves vertically upward. Once the bumper 545 moves past the bump 533 of the spring 530, the user may stop applying the second force and allow the force from the springs 530 to raise the heatsink subassembly 536, the lighting module 200a, and the trim 400a vertically upward. In some implementations, the first force and the second force may be oriented along a vertical upward direction. Additionally, the magnitude of the second force may be greater than the magnitude of the first force. Said another way, the force required to engage the module subassembly 230 to the heatsink subassembly 536 via the springs 550 may be less than the force required to disengage the heatsink subassembly 536 from the locked configuration. This may ensure the heatsink subassembly 536 remains in the locked configuration when the module subassembly 230 is coupled to the heatsink subassembly 536. FIG. 21E shows that once the heatsink subassembly 536 transitions to the unlocked configuration, the hem 555 of each spring 550 may slidably move along the interior side 527a of the corresponding rail 523, thus appreciably restricting actuation of the springs 550 and, hence, appreciably reducing the likelihood of an accidental release of the module subassembly 230 from the heatsink subassembly 536.

It should be appreciated that the lighting module 200a and the trim 400a may be removed from the housing assembly 500a after installation, e.g., to repair or replace the lighting module 200a and/or the trim 400a. For example, a method of removing the lighting module 200a and the trim 400a may include the following steps: (1) applying a first force along a vertical downward direction (e.g., by pulling on the handle 235 of the module subassembly 230) to lower the vertical position of the heatsink subassembly 536, the lighting module 200a, and the trim 400a until the heatsink subassembly 536 is engaged in the locked configuration; (2) applying a second force along a vertical downward direction to actuate and disengage the springs 550 from the retaining elements 233 of the module subassembly 230; (3) removing the lighting module 200a and the trim 400a through the aperture 519 and the opening 94; and (4) disconnecting the connector 212 from the connector 592. It should be appreciated that the force required to disengage the module subassembly 230 from the springs 550 may be significantly higher during step (1) than step (2) because in step (2), the end portion 553 of each spring 550 is vertically aligned to the recess 524b of the corresponding rail 523 and, thus, allowed to undergo appreciably more displacement to facilitate disengagement of the spring 550 from the module subassembly 230.

FIGS. 22A and 22B show a method for accessing the wiring hub 580, e.g., to service the wiring connections, after the housing assembly 500a is installed in the ceiling space 90 and the ceiling drywall 92 is installed. Before the method shown in FIGS. 22A and 22B occurs, the method may be preceded by the following steps: (1) removing the lighting module 200a and the trim 400a from the housing assembly 500a (see above method); and (2) applying a force to disengage the heatsink subassembly 536 from the locked configuration thereby allowing the springs 530 to raise the heatsink subassembly 536 to its highest vertical position along the rails 523. Following the preceding steps, the method shown in FIGS. 22A and 22B may include the following steps: (3) applying a force to slidably move the door latch 574 of the wire door subassembly 560 (e.g., via the handle 579) such that the hook 578 is no longer engaged to the slot 513b of the housing 510, thereby allowing the door 567 to transition from the closed position to the open position due to the forces applied by the spring 565 (FIG. 22A); and (4) removing the wiring hub 580 from the housing assembly 500a, e.g., by grabbing the handle 584 and pulling the wiring hub 580 from the wiring cavity 501a to the heatsink cavity 501b through the opening 502/opening 561a and, subsequently, from the heatsink cavity 501b to below the ceiling drywall 92 through the aperture 519 of the housing 510 and the opening 94 of the ceiling drywall 92. Thereafter, the wiring hub 580 may be serviced, e.g. the various electrical connections to the wiring hub may be repaired as needed, all without requiring removal of the ceiling drywall 92.

The wiring hub 580 may be placed back into the wiring cavity 501a after servicing. For example, a method for installing the wiring hub 580 into the housing 510 may include the following steps: (1) inserting the wiring hub 580 into the wiring cavity 501a, e.g., by inserting the wiring hub 580 into the heatsink cavity 501b through the opening 94 and the aperture 519 and, subsequently, into the wiring cavity 501a from the heatsink cavity 501b through the opening 502/opening 561a; (2) applying a force to move the door 567 from the open position to the closed position, thereby allowing the door latch 574 and, in particular, the hook 578 to engage the slot 513b due to the force applied by the spring 572. In step (1), the handle 584 may provide an alignment feature that places the wiring hub 580 near the openings 502 and 561a for later retrieval, as described above in Section 1.1.

### 2. A SECOND EXAMPLE OF A SMALL APERTURE RECESSED LIGHTING APPARATUS

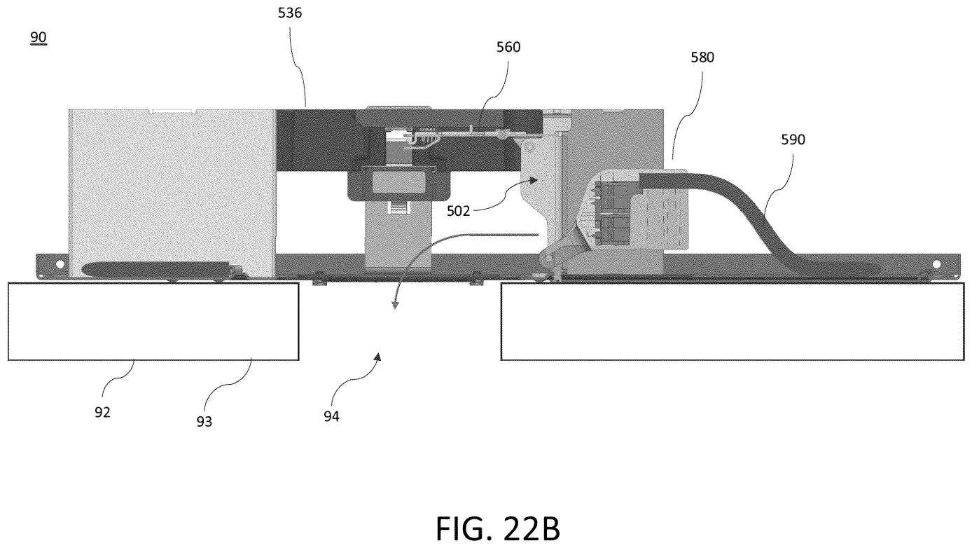

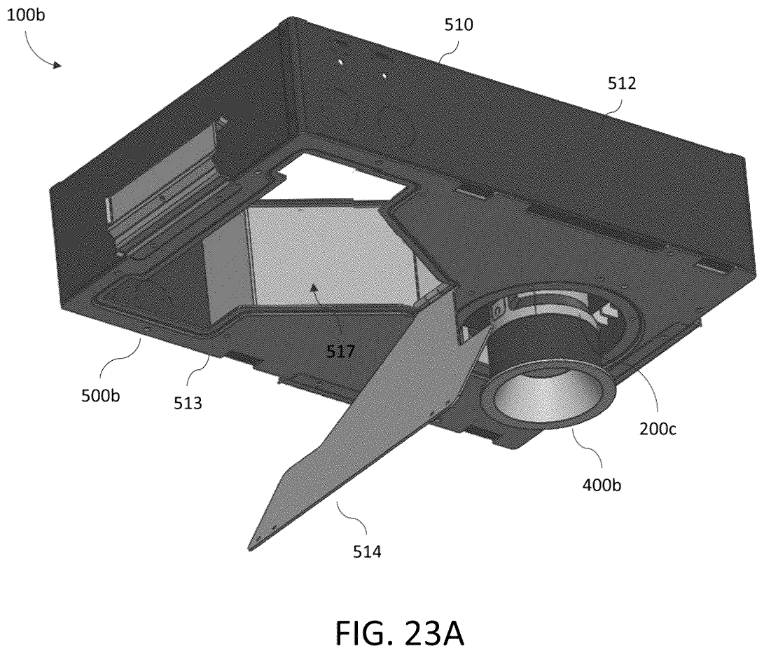

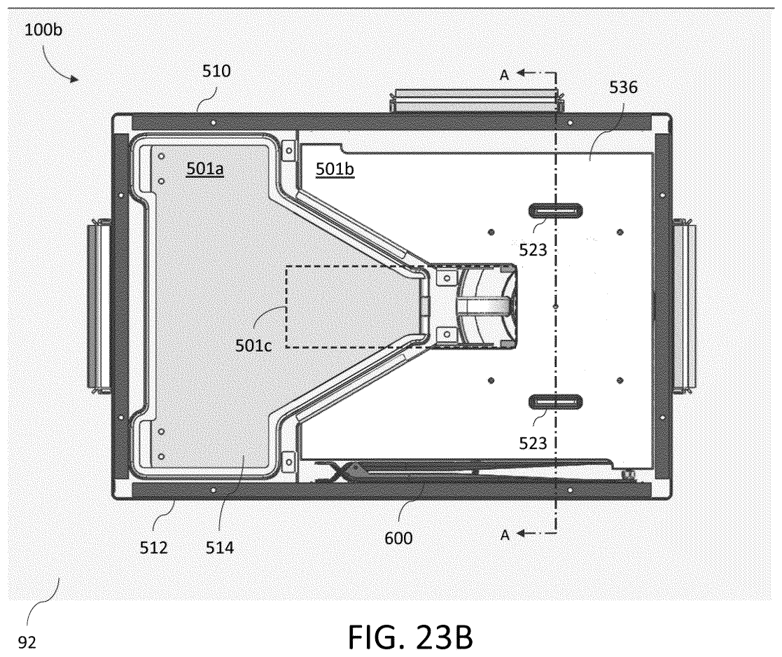

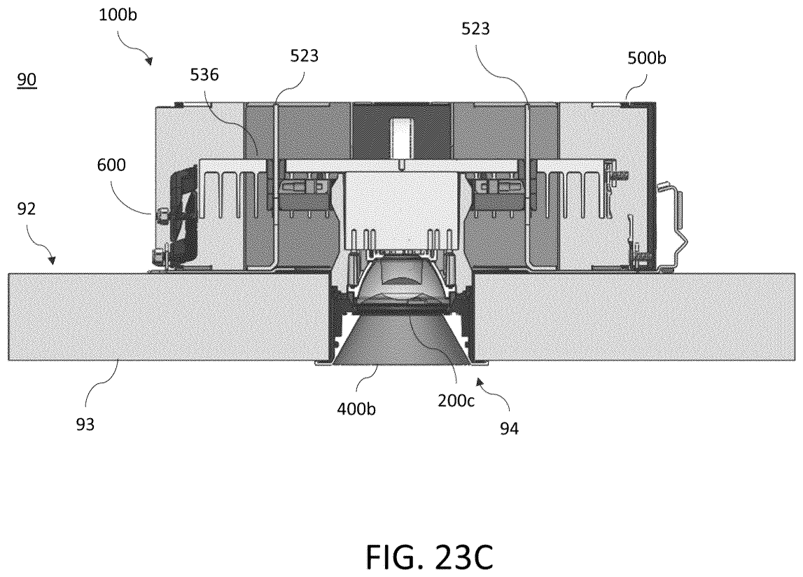

FIGS. 23A-23C show another example lighting apparatus 100b. As shown, the lighting apparatus 100b may include a housing assembly 500b, a lighting module 200c (or, alternatively, a lighting module 200d), and a trim 400b. The lighting apparatus 100b may incorporate one or more of the same features and/or components as the lighting apparatus 100a described in Section 1. For brevity, repeated discussion of these components and/or features are not provided below unless indicated otherwise.

### 2.1 An Example Housing Assembly

FIGS. 24A-24K show several views of the housing assembly 500b. The housing assembly 500b may incorporate one or more of the same features and/or components as the housing assembly 500a. For brevity, repeated discussion of these components and/or features are not provided below unless indicated otherwise.

As shown, the housing assembly 500b may include a housing 510 with a pan frame 513 and a housing cover 512 mounted to the pan frame 513. Together, the housing cover 512 and the pan frame 513 may define a cavity 501. The pan frame 513 may further define an aperture 513a. In this example, the housing assembly 500b is shown without an adapter plate 518 to provide the aperture 519. However, it should be appreciated that the adapter plate 518 may be mounted to the pan frame 513 as described above. The housing 510 may further include one or more dividers 521 to divide the cavity 501 into a wiring cavity 501a and a heatsink cavity 501b adjoining the aperture 519.

In this example, the housing assembly 500b may not include a wire door subassembly 560 to facilitate access between the wiring cavity 501a from the heatsink cavity 501b. Instead, the dividers 521 may form a channel between the wiring cavity 501a and the heatsink cavity 501b to receive, in part, the driver subassembly and the connectors connecting the lighting module 200c to the wiring connections contained within the wiring cavity 501a. For example, FIG. 23B shows the housing assembly 500b may provide a driver region 501c disposed within the wiring cavity 501a and the heatsink cavity 501b to contain the driver subassembly.

The wiring cavity 501a may contain one or more wiring connections with an external electrical system. Accordingly, the housing cover 512 may include one or more knockouts and/or one or more Romex feedthroughs adjoining the wiring cavity 501a. Additionally, the housing assembly 500b may include a wire door plate 514 coupled to the pan frame 513 to provide access to the wiring cavity 501a during installation (e.g., before the ceiling drywall is installed).

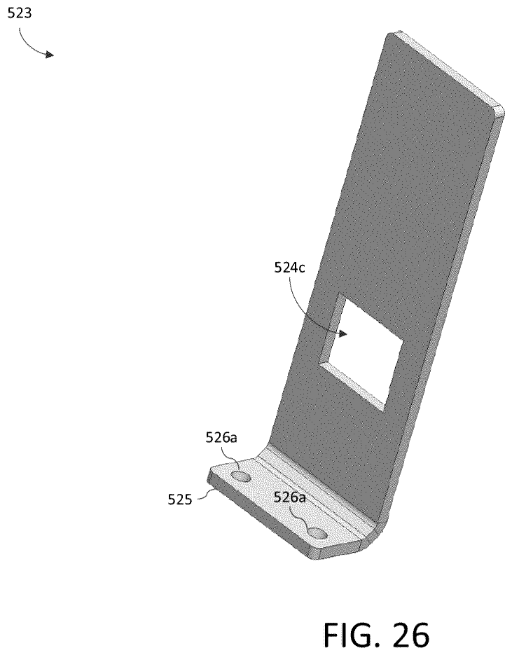

The heatsink cavity 501b may contain a heatsink subassembly 536. The heatsink subassembly 536 may be movably coupled to a pair of rails 523 mounted to the pan frame 513, e.g., via fasteners inserted through fastener openings 526a on the tab 525 of each rail 523 as shown in FIG. 26. As shown, the pair of rails 523 may be oriented vertically to guide movement of the heatsink subassembly 536 and, by extension, the lighting module 200c and the trim 400b along an axis parallel to the centerline axis of the aperture 513a (e.g., a vertical axis). FIGS. 24C and 24E show the heatsink subassembly 536 at a first vertical position close to the aperture 513a. At this position, the heatsink subassembly 536 may be in a locked configuration to facilitate installation or removal of the lighting module 200c. FIGS. 24D and 24F show the heatsink subassembly 536 at a second vertical position far from the aperture 513a.

In this example, the housing assembly 500b may include a sprung scissor linkage mechanism to passively adjust the position (e.g., vertical position) of the heatsink subassembly 536 and, by extension, the lighting module 200c and the trim 400b such that the trim 400b abuts the installation surface (e.g., the bottom surface of the drywall enclosing a ceiling space). In particular, FIGS. 24C-24F show the housing assembly 500b may include a scissor linkage 600 with a first end mounted to the pan frame 513 and a second end mounted to the heatsink subassembly 536. A spring 601 may be directly coupled to the scissor linkage 600 to apply a force that causes the scissor linkage 600 to extend thereby raising the vertical position of the heatsink subassembly 536, the lighting module 200c, and the trim 400b.

As shown in FIGS. 24C and 24D, the scissor linkage 600 may be disposed on one side of the heatsink subassembly 536. In some implementations, the combination of a single scissor linkage 600 and the rails 523 to guide movement of the heatsink subassembly 536 may be sufficient. However, it should be appreciated that, in some implementations, the housing assembly 500b may include multiple scissor linkages 600, e.g., a pair of scissor linkages disposed on opposing sides of the heatsink subassembly 536. In implementations where the housing assembly 500b includes multiple scissor linkages 600, at least one of the scissor linkages 600 may include the spring 601. In some implementations, each scissor linkage 600 may include the spring 601.

FIG. 24G shows the scissor linkage 600 may include an arm 602a and an arm 602b rotatably coupled to the arm 602a. As shown, the arm 602a may include a pin 603a located at or near the center of the arm 602a. The pin 603a may be inserted through a corresponding opening 603c located at or near the center of the arm 602b. A nut 603b may be fastened to the end of the pin 603a to couple the arms 602a and 602b together.

The arm 602a may include a pin 604a disposed at one end of the arm 602a to couple the arm 602a to the pan frame 513. FIG. 24C shows the pin 604a may be inserted through an opening 610b on a tab 610a formed on the pan frame 513. The pin 604a may be secured to the tab 610a via a nut 604b. The arm 602a may further include a pin 605a disposed at the other end of the arm 602a to couple the arm 602a to the heatsink subassembly 536. FIG. 24C shows the pin 605a may be inserted through a slot 612b on a tab 612a formed on one end of the heatsink subassembly 536. The pin 605a may be secured to the tab 612a via a nut 605b. The arm 602b may include a pin 606a disposed at one end of the arm 602b to couple the arm 602b to the pan frame 513. FIG. 24C shows the pin 606a may be inserted through a slot 611b on a tab 611a formed on the pan frame 513. The pin 606a may be secured to the tab 611a via a nut 606b. The arm 602b may further include an opening 607a disposed at the other end of the arm 602b to couple the arm 602b to the heatsink subassembly 536. In particular, a fastener 607b may be inserted through the opening 607a and a corresponding opening 613 on the heatsink subassembly 536. The respective lengths of the slots 611b and 612b may limit the range of motion of the scissor linkage 600.

In some implementations, one or more washers (e.g., Nylon washers) may be disposed between each pin connection in the scissor linkage 600. This includes, for example, the pin joints formed between the arms 602a and 602b via the pin 603a and the nut 603b, the arm 602a and the pan frame 513 via the pin 604a and the nut 604b, the arm 602a and the heatsink subassembly 536 via the pin 605a and the nut 605b, the arm 602b and the pan frame 513 via the pin 606a and the nut 606b, and the arm 602b and the heatsink subassembly 536 via the fastener 607b. The washers may rotation at these foregoing pin joints by providing low friction surfaces in contact with the moving components.

The heatsink subassembly 536 may further include a gearbox 650 to couple the lighting module 200c to the heatsink subassembly 536 and to control whether the heatsink subassembly 536 is in a locked configuration or an unlocked configuration, e.g., when installing or removing the lighting module 200c. As shown in FIGS. 24I-24K, the gearbox 650 may be mounted to the base 537 of the heatsink subassembly 536.

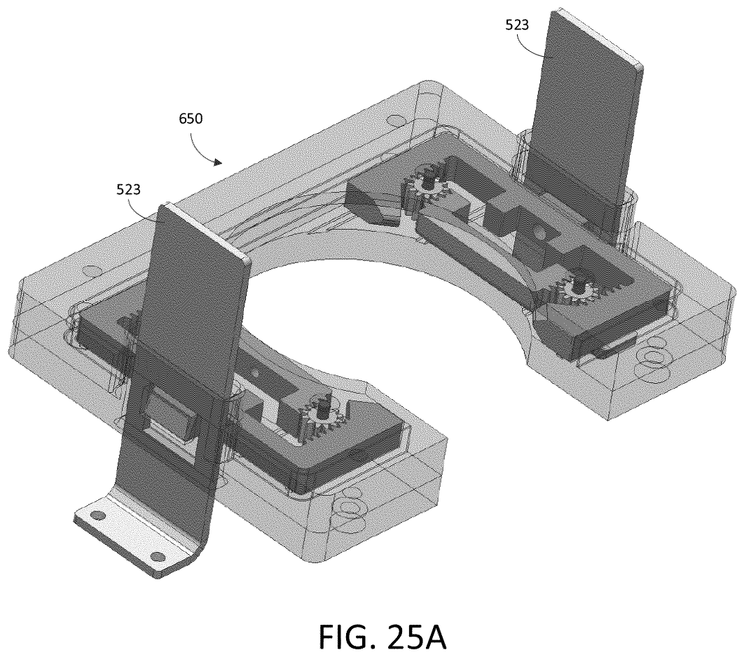

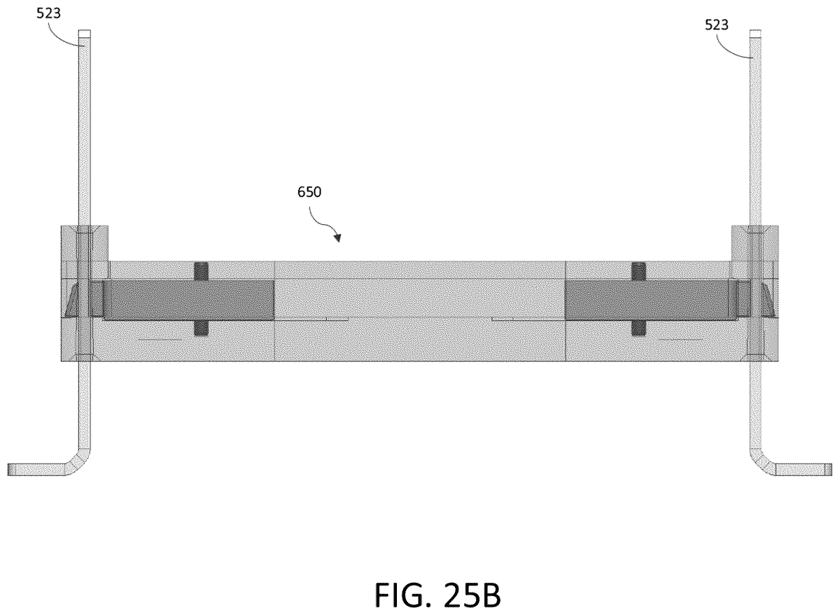

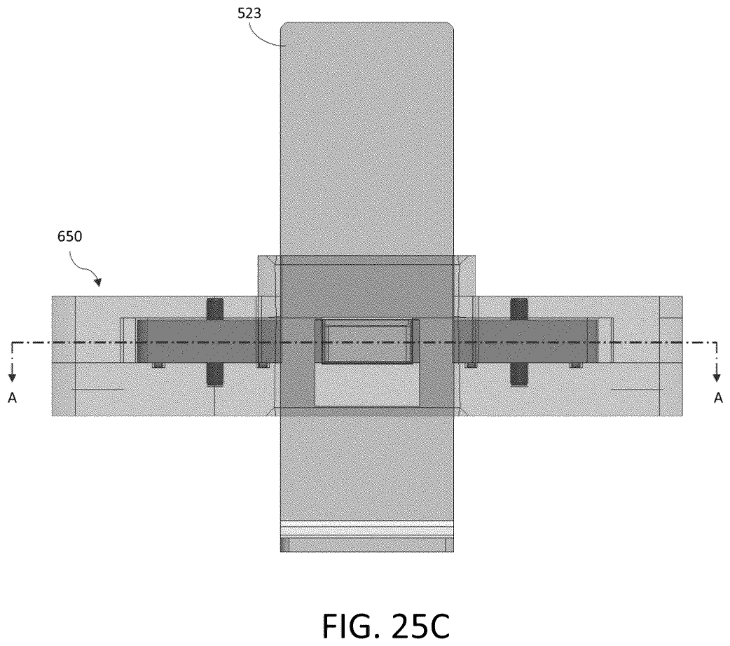

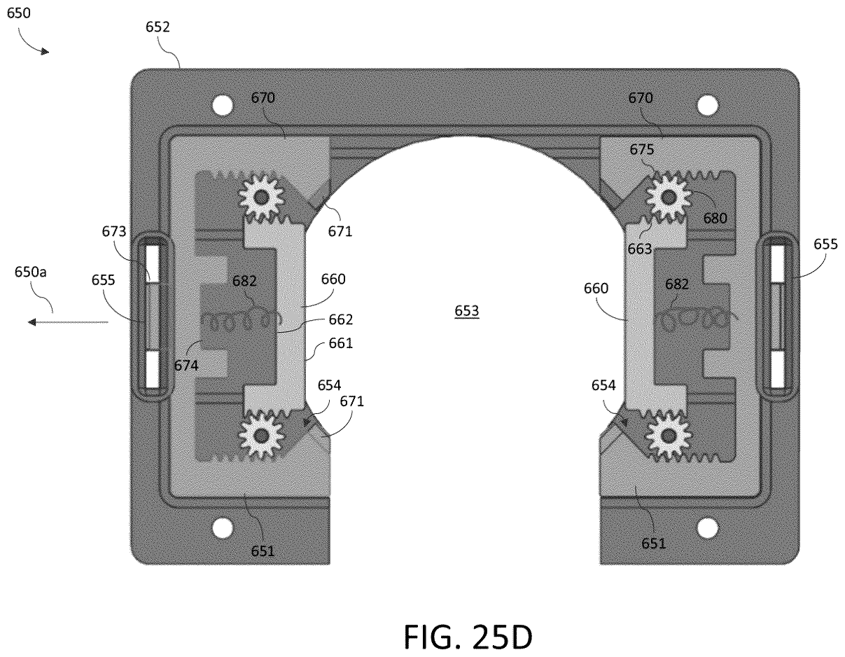

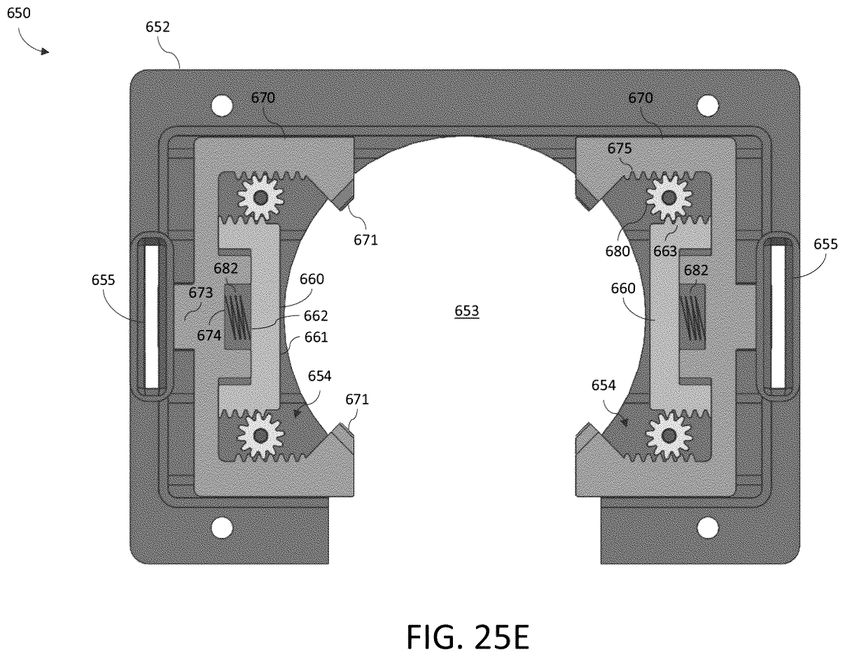

FIGS. 25A-25E show several additional views of the gearbox 650. As shown, the gearbox 650 may include a housing 652 that defines a pair of slots 655 to facilitate movement of the heatsink subassembly 536 along corresponding rails 523. Specifically, each rail 523 may pass through a corresponding slot 655 as shown in FIG. 24K. The housing 652 may further define a central opening 653 that is coaxially aligned with the aperture 513a of the pan frame 513. The central opening 653 may have the same shape and/or dimensions as the aperture that the lighting module 200c passes through during installation. It should be appreciated that the foregoing aperture may correspond to the aperture 519 of the adapter plate 518 rather than the aperture 513a. The geometry of the opening 653 may allow the lighting module 200c and, in particular, the module subassembly 230, to be partially inserted through the opening 653. This, in turn, may allow the gearbox 650 to mechanically couple to the lighting module 200c.

The housing 652 may further define one or more cavities 654 to contain various components of the gearbox 650. For example, FIG. 25D shows the gearbox 650 may include a pair of gear assemblies 651. Each gear assembly 651 may include one inner slider 660 and one outer slider 670. In some implementations, the pair of gear assemblies 651 may be disposed diametrically opposite to one another about the centerline axis of the opening 653, e.g., to interact with opposing sides of the module subassembly 230 of the lighting module 200c.

Each inner slider 660 may be movably coupled to the corresponding outer slider 670 via a pair of gears 680. Specifically, the inner slider 660 may include two sets of gear teeth 663 where each set of gear teeth 663 meshes with the teeth of a corresponding gear 680. Likewise, the outer slider 670 may include two sets of gear teeth 675 where each set of gear teeth 675 meshes with the teeth of a corresponding gear 680. As a result, the inner slider 660 and the outer slider 670 may be constrained to move in opposite directions along the axis 650a. For example, when the inner slider 660 moves toward the opening 653, the outer slider 670 may move away from the opening 653. Likewise, when the inner slider 660 moves away from the opening 653, the outer slider 670 may move toward the opening 653. The range of motion between the inner slider 660 and the outer slider 670 may be constrained, in part, by physical contact with the sides of the housing 652.

The inner slider 660 and the outer slider 670 may both physically interact with the module subassembly 230 of the lighting module 200c. The inner slider 660 may include an engagement portion 661 that extends into the opening 653 when the inner slider 660 is moved towards the opening 653 (see, for example, FIG. 25D). The engagement portion 661 may physically contact, for example, a corresponding element 233a on the module housing 231 of the module subassembly 230. The outer slider 670 may include engagement portions 671 that extend into the opening 653 when the outer slider 670 is moved towards the opening 653 (see, for example, FIG. 25E). The engagement portions 671 may each physically contact, for example, corresponding elements 233b on the module housing 231 of the module subassembly 230.

The outer slider 670 may further include a deadbolt portion 673 to control whether the heatsink subassembly 536 is in a locked or unlocked configuration. Specifically, when the outer slider 670 is moved away from the opening 653, the deadbolt portion 673 may pass through the slot 655 (see FIG. 25D). When the gearbox 650 is mounted onto the rails 523, the deadbolt portion 673 may only pass through the slot 655 if the deadbolt portion 673 is vertically aligned with an opening 524c on the rail 523 (see opening 524c in FIG. 26). Thus, the locked configuration is engaged when the deadbolt portion 673 passes through the slot 655 and the opening 524c because the heatsink subassembly 536 is restrained from moving along the rails 523 under the force from the spring 601. The locked configuration may correspond to when the heatsink subassembly 536 is at its lowest position along the rails 523. The heatsink subassembly 536 may be in the unlocked configuration when the deadbolt portion 673 is not vertically aligned with the opening 524c. In the unlocked configuration, the deadbolt portion 673 may not pass through the slot 655 due to physical contact with the rail 523. Accordingly, in the unlocked configuration, the heatsink subassembly 536 is free to move along the rails 523 under the force from the spring 601.

The gearbox 650 may further include a spring 682 coupled at one end to a mounting surface 662 of the inner slider 660 and at the other end to a mounting surface 674 of the outer slider 670. The spring 682 may be biased to apply a force that pushes the inner slider 660 towards the opening 653 and the outer slider 670 away from the opening 653 (see FIG. 25D). This means the spring 682 may maintain the heatsink subassembly 536 in the locked configuration, e.g. by applying a force that inserts the deadbolt portion 673 of the outer slider 670 through the opening 524c of the rail 523. To disengage the locked configuration and transition the heatsink subassembly 536 to the unlocked configuration, an external force may be applied to the inner sliders 660 (e.g., a force due to physical contact with the module subassembly 230) to counteract the force from the springs 682 and move the inner slider 660 away from the opening 653 and the outer slider 670 towards the opening 653, and compress the springs 682 (see FIG. 25E). When the heatsink subassembly 536 is in the unlocked configuration, the spring 682 may push the deadbolt portion 673 against the interior side 527a of the rail 523, resulting in the deadbolt portion 673 slidably moving along the interior side 527a when the heatsink subassembly 536 moves along the rails 523.

The gearbox 650 may thus be used to couple the lighting module 200c and, in particular, the module subassembly 230, to the heatsink subassembly 536 and disengage the locked configuration as follows. First, any driver subassembly in the lighting module 200c may be connected to appropriate wiring connections and inserted through the aperture 513a of the housing assembly 500a and into the driver region 501c. Thereafter, the module subassembly 230 may be inserted into the heatsink cavity 501b through the aperture 513a. Additionally, the heatsink subassembly 536 may be in the locked configuration, e.g., with the deadbolt portion 673 of each outer slider 670 inserted through the opening 524c of corresponding rails 523. As the module subassembly 230 is inserted into the heatsink cavity 501b, the elements 233a on the exterior of the module housing 231 may physically contact the engagement portions 661 of respective inner sliders 660. This physical contact causes the inner sliders 660 to translate and move away from the opening 653. This, in turn, causes the outer sliders 670 to move towards the opening 653 due to rotation of the gears 680. The motion of the outer sliders 670 cause the following to occur. First, the engagement portions 671 of the outer sliders 670 may physically contact corresponding elements 233b on the exterior of the module housing 231 and clamp the module subassembly 230 such that the module subassembly 230 is secured to the gearbox 650. In some implementations, the clamping of the engagement portions 671 to the module subassembly 230 may cause the module subassembly 230 to physically contact the base 537 of the heatsink subassembly 536, and, thus, form a thermal interface. Second, the motion of the outer sliders 670 may retract corresponding deadbolt portions 673 away from respective openings 524c of the rails 523, thus disengaging the heatsink subassembly 536 from the locked configuration (and engaging the unlocked configuration). Once this occurs, the heatsink subassembly 536, the lighting module 200c, and the trim 400b may move upwards within the heatsink cavity 501b until the flange portion 411 of the trim 400b contacts the installation surface (e.g., the bottom surface of the ceiling drywall, or mud-plate or wood), thus completing the installation.

The lighting module 200c and the trim 400b may be uninstalled by pulling the heatsink subassembly 536, the lighting module 200cm and the trim 400b down along the rails 523 until the heatsink subassembly 536 engages the locked configuration. Before the heatsink subassembly 536 is engaged in the locked configuration, the physical contact between the deadbolt portion 673 and the interior side 527a of the rail 523 may prevent actuation of the gear assemblies 651, thus appreciably reducing the likelihood of the module subassembly 230 disengaging from the heatsink subassembly 536 prematurely. Once in the heatsink subassembly 536 is in the locked configuration, the gear assemblies 651 may be allowed to actuate, e.g., the deadbolt portion 673 may be allowed to move into the slot 655 through the opening 524c on the rail 523, to release the module subassembly 230 from the heatsink subassembly 536.

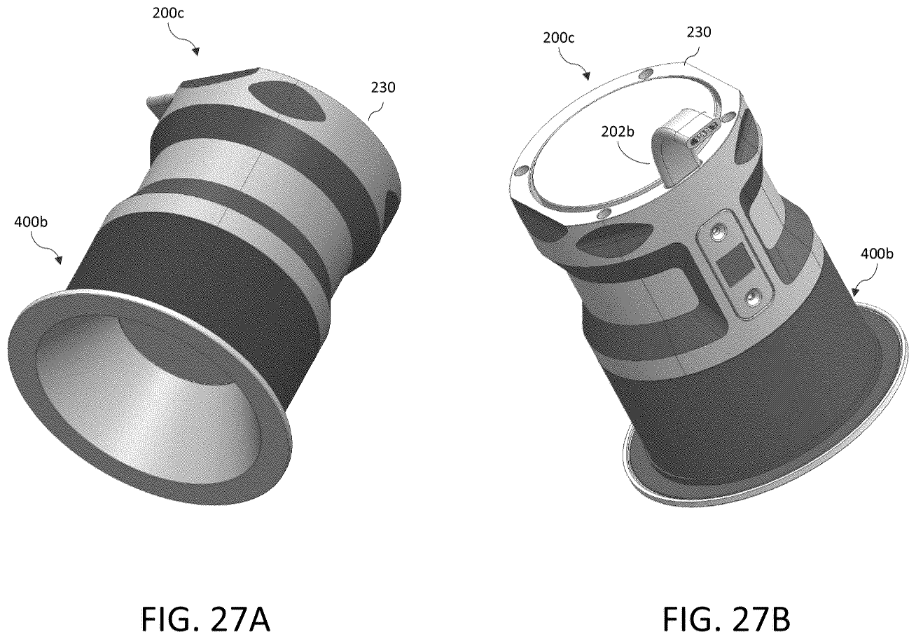

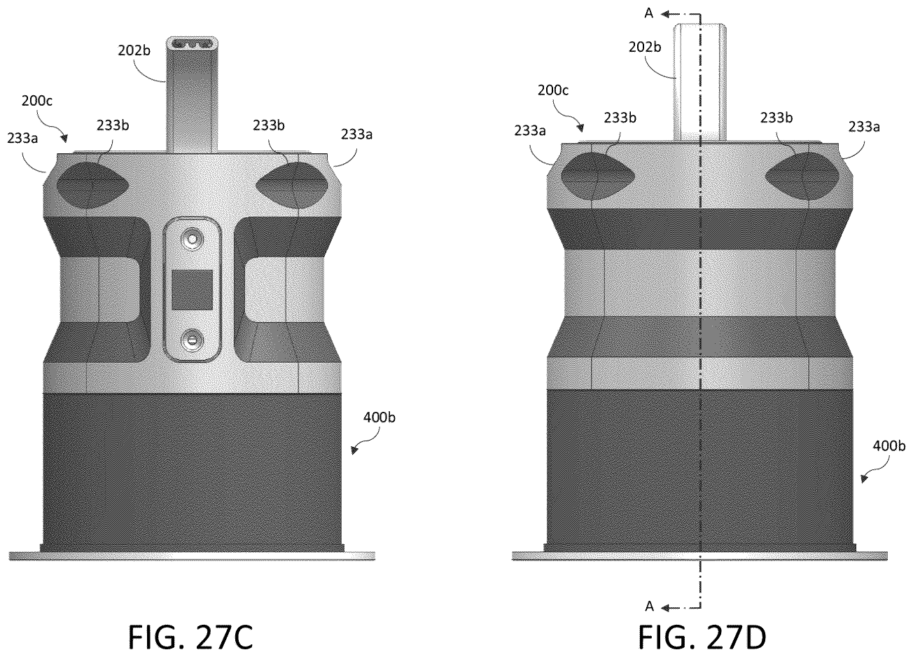

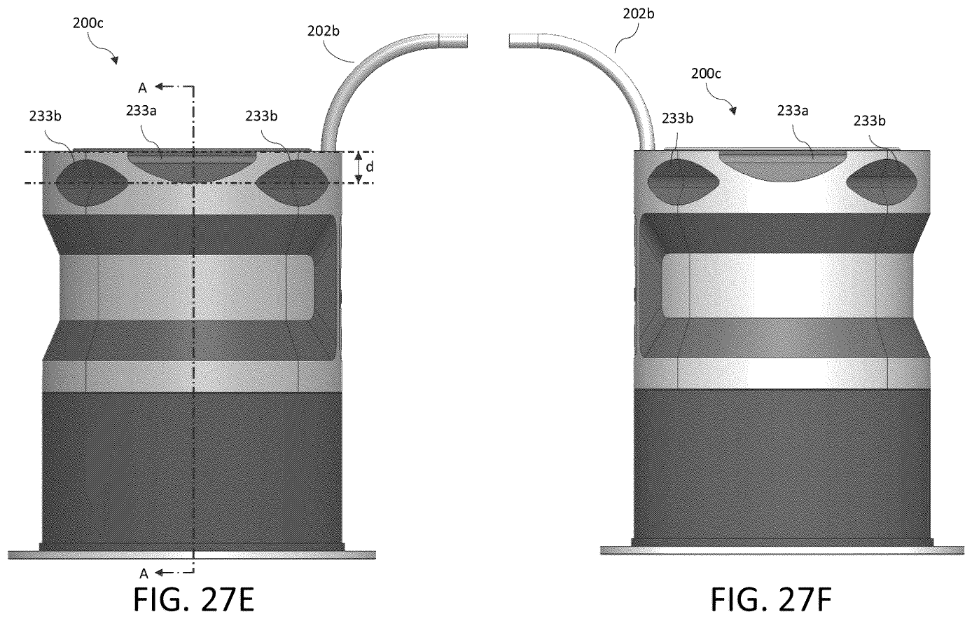

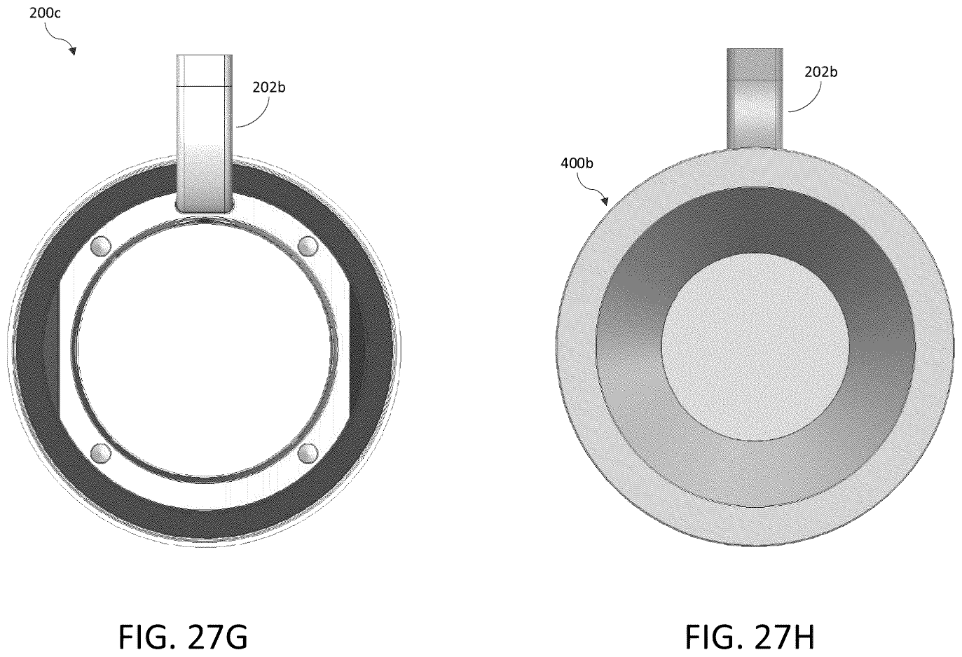

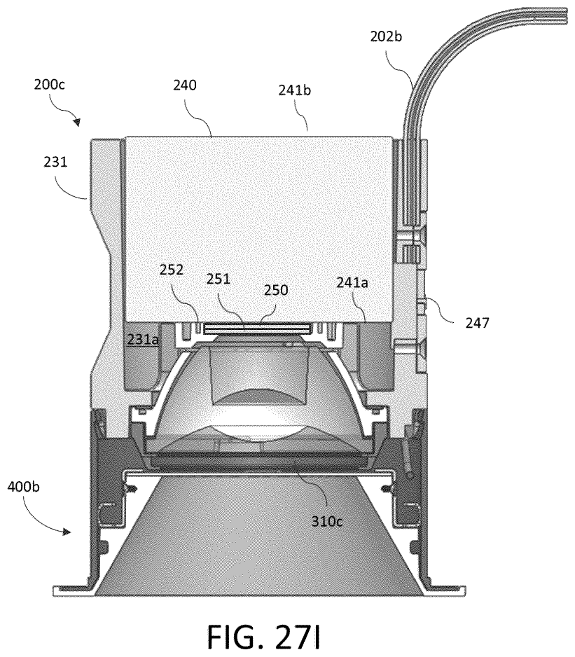

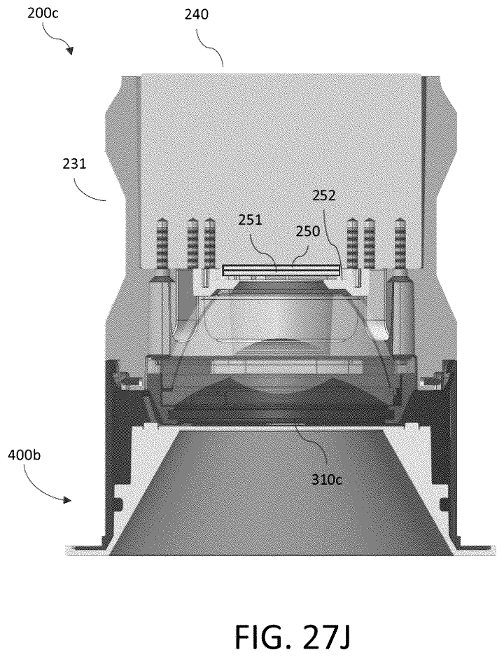

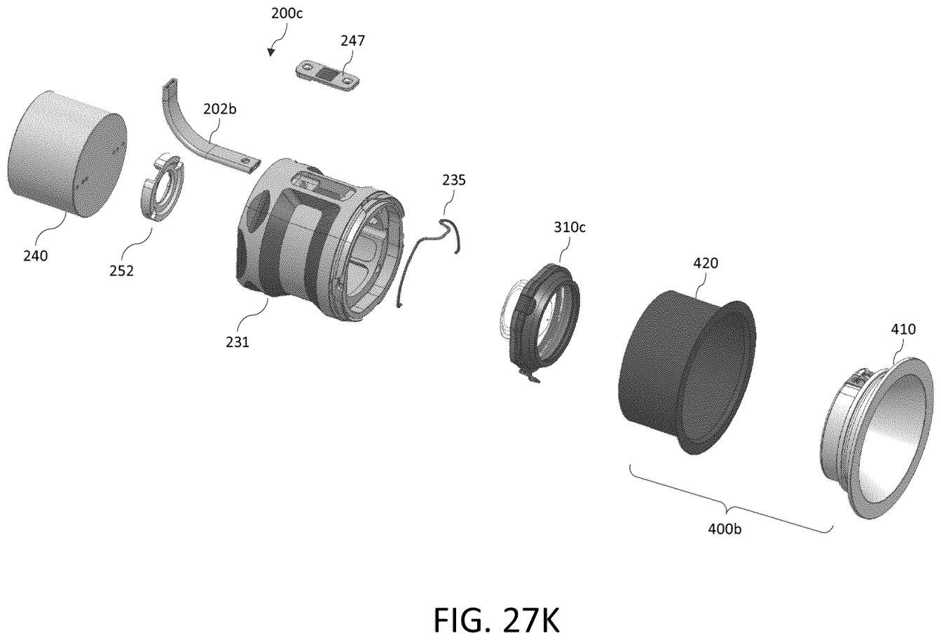

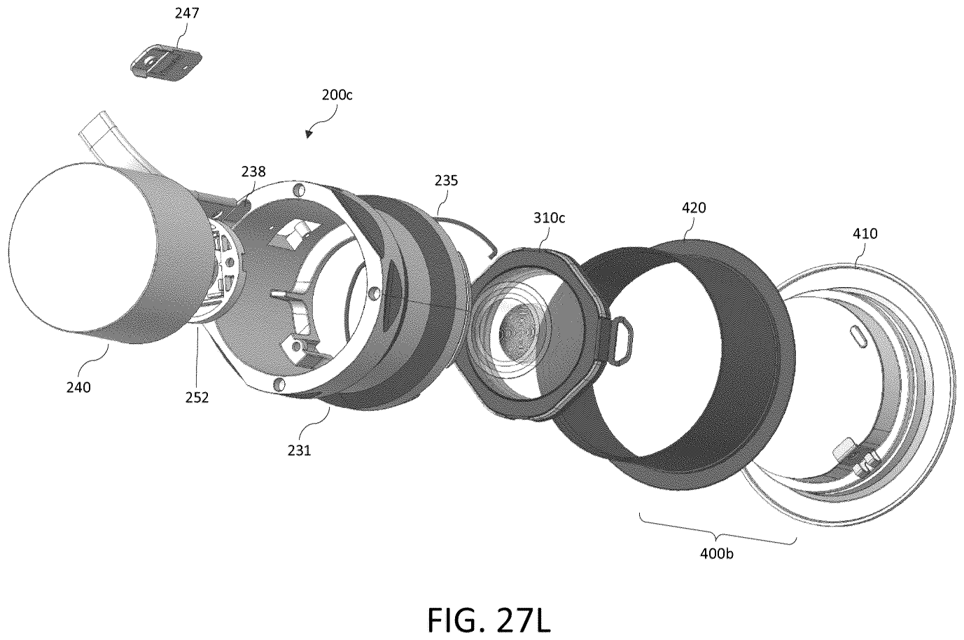

The actuation of the inner slider 660 and the outer slider 670 and their interactions with the elements 233a and 233b may be facilitated, in part, by the elements 233a and 233b each having a vertical span that is offset, but overlapping to one another. For instance, FIG. 27E shows the most recessed portion of the element 233a is offset from the most recessed portion of the element 233b by a distance, d. However, the vertical spans of the elements 233a and 233b may be such that the bottom edge of the element 233a is below the upper edge of the element 233b, i.e., the vertical spans of the elements 233a and 233b overlap.

It should be appreciated that gearbox 650 or the cantilever spring 530/module spring 550 (see Section 1) are non-limiting examples of ways to facilitate engagement of the heatsink subassembly 536 to the lighting modules disclosed herein. In other examples, the housing assemblies disclosed herein may include a planar linkage, and/or a leaf spring to facilitate engagement with the module subassembly 230 and actuate a feature (e.g., a dead-bolt) to control whether the heatsink subassembly 536 is in the locked or unlocked configuration.

In yet another example, the heatsink subassembly 536 may include a spring-loaded locking mechanism (e.g., a twist and lock mechanism) to engage the heatsink subassembly 536 in the locked configuration. The locking mechanism may be actuated by applying a twisting motion to the module subassembly 230. The heatsink subassembly 536 may further include ball-plungers and/or spring clips to provide a snap-fit connection to couple the module subassembly 230 to the heatsink subassembly 536. In this manner, the module subassembly 230 may be inserted and secured to the heatsink subassembly 536 and, thereafter, the heatsink subassembly 536 may be released from the locked configuration by twisting the module subassembly 230 or the trim.

### 2.2 An Example Downlight Lighting Module

FIGS. 27A-27L show several views of the lighting module 200c and the trim 400b mounted to the lighting module 200c. As shown, the lighting module 200c may include a module subassembly 230 and a cable 202b connected to the module subassembly 230, e.g., for connection with a driver subassembly (not shown). In this example, the cable 202b may include an electrical connector (e.g., a Universal Serial Bus (USB) connector) to plug into the driver subassembly. In this manner, the lighting module 200c may provide modularity for assembly, e.g., by allowing the module subassembly 230 to connect to different driver subassemblies (e.g., with different driver electronics). FIG. 27L shows the cable 202b may be inserted through an opening 238 for routing into the module cavity 231a. FIG. 27K shows the module subassembly 231 may provide an opening to access the wiring connection formed with the cable 202b. The opening may be covered by a wiring cover 247. In this example, the module subassembly 230 may include a wiring interface with a thermal cutoff switch.

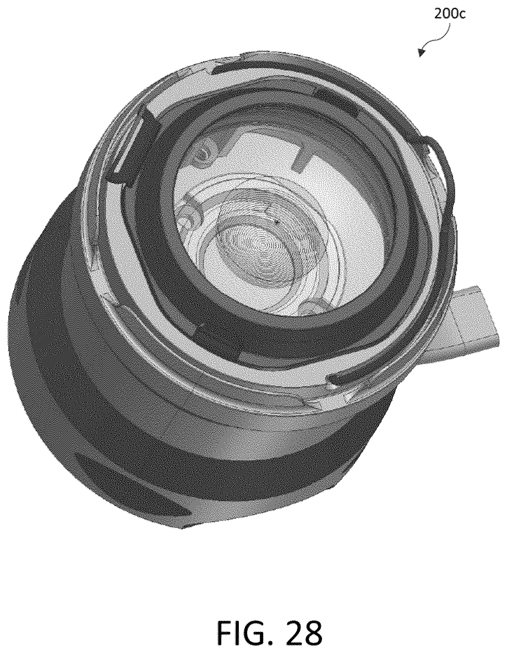

FIG. 28 shows another view of the module subassembly 230 of the lighting module 200c. The lighting module 200c may incorporate one or more of the same components and/or features as the lighting modules 200a and/or 200b. For brevity, repeated discussion of these components and/or features are not provided below unless indicated otherwise.

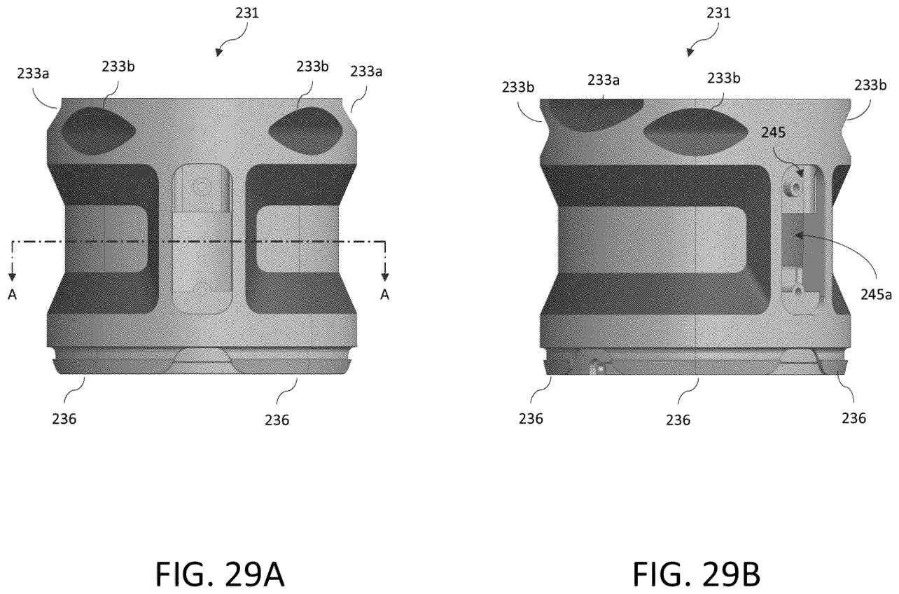

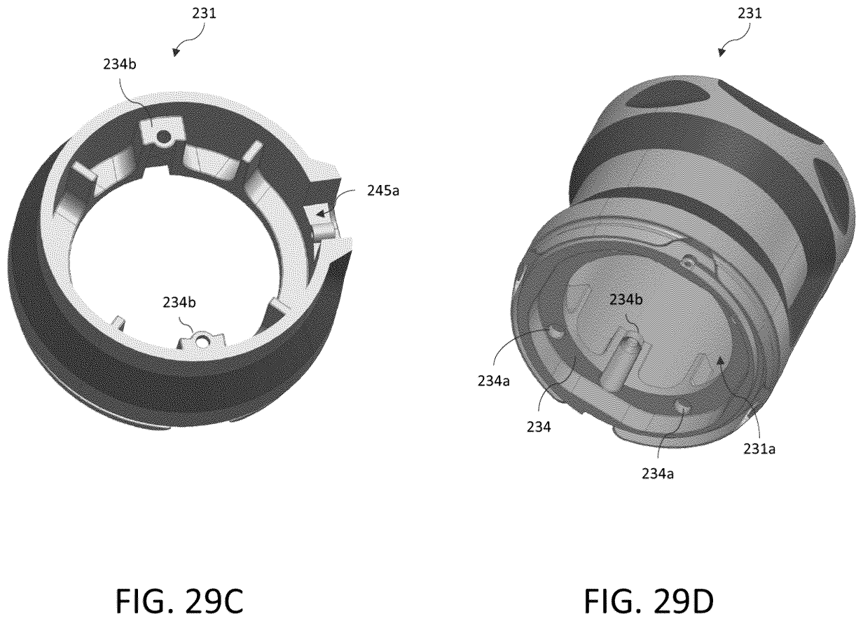

As shown, the module subassembly 230 may include a module housing 231 defining a module cavity 231a containing, at least in part, a core 240, a light source 250, a PCB connector 251, a light source holder 252, and an optical subassembly 310c. The optical subassembly 310c may be magnetically coupled to the module housing 231 via a plurality of magnets 254. FIGS. 29A-29D show several views of the module housing 231 of the lighting module 200c. As shown, the module housing 231 may include the elements 233a and 233b. As described above, the elements 233a may actuate the inner sliders 660 of the gearbox 650 (e.g., via contact with the engagement portions 661 of each inner slider 660). The elements 233b may engage with corresponding engagement portions 671 of the outer sliders 670 to securely couple the module subassembly 230 to the heatsink subassembly 536.

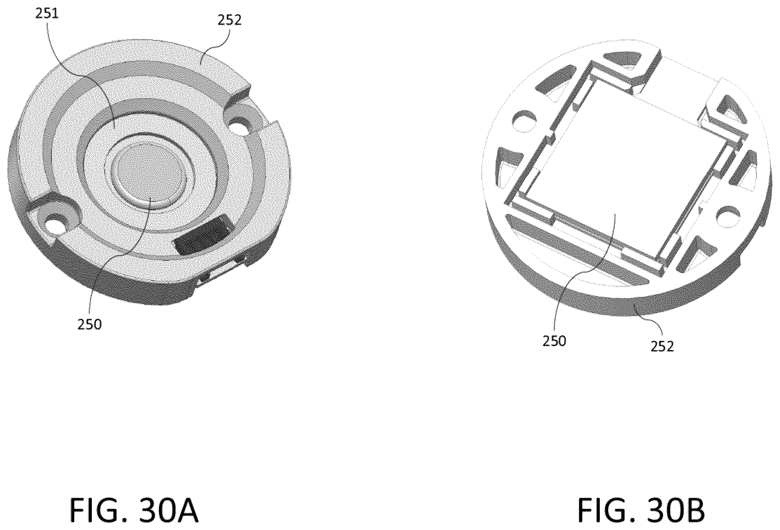

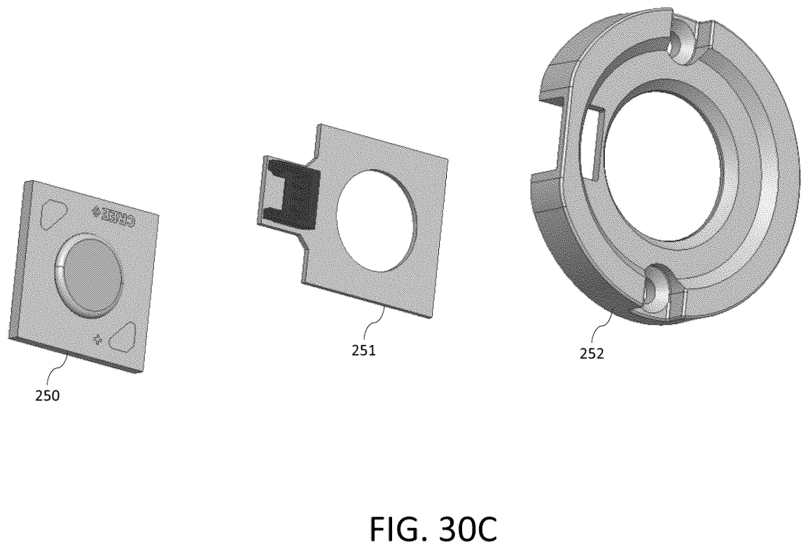

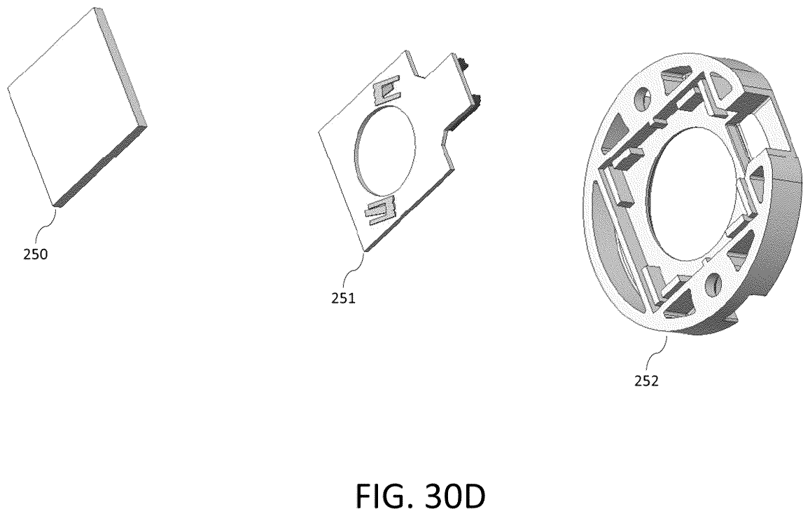

FIGS. 30A-30D show several views of the light source 250, the PCB connector 251, and the light source holder 252. These components may be the same or substantially similar to the light source 250, the PCB connector 251, and the light source holder 252 for the lighting module 200a. For brevity, repeated discussion of these components and/or features are not provided below unless indicated otherwise.

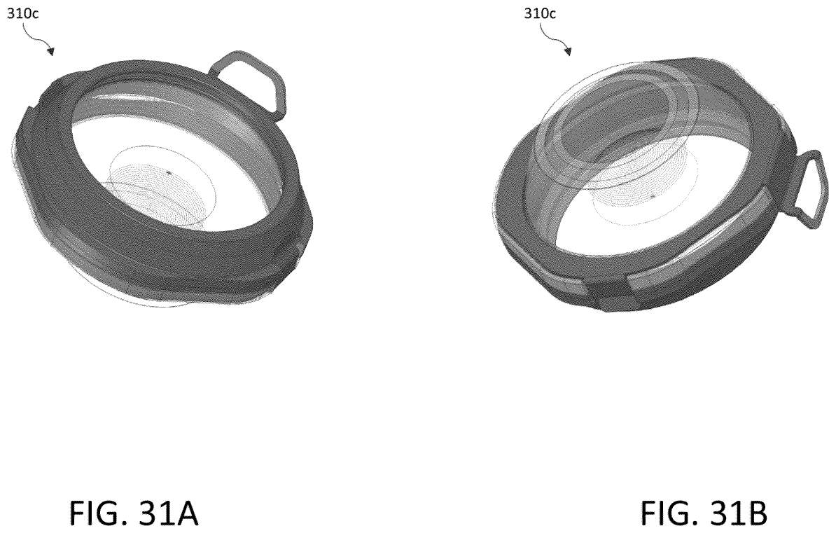

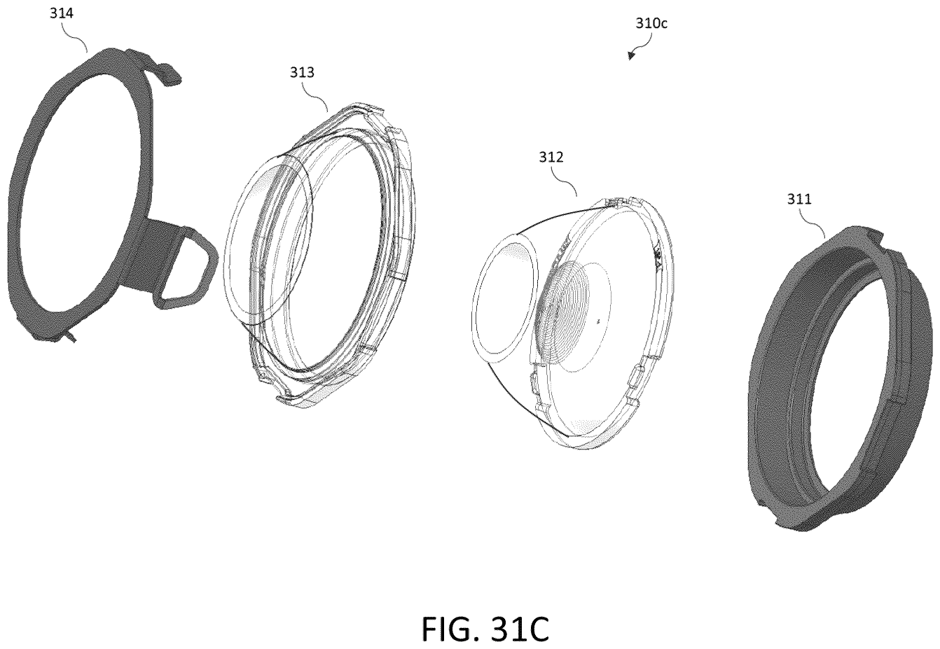

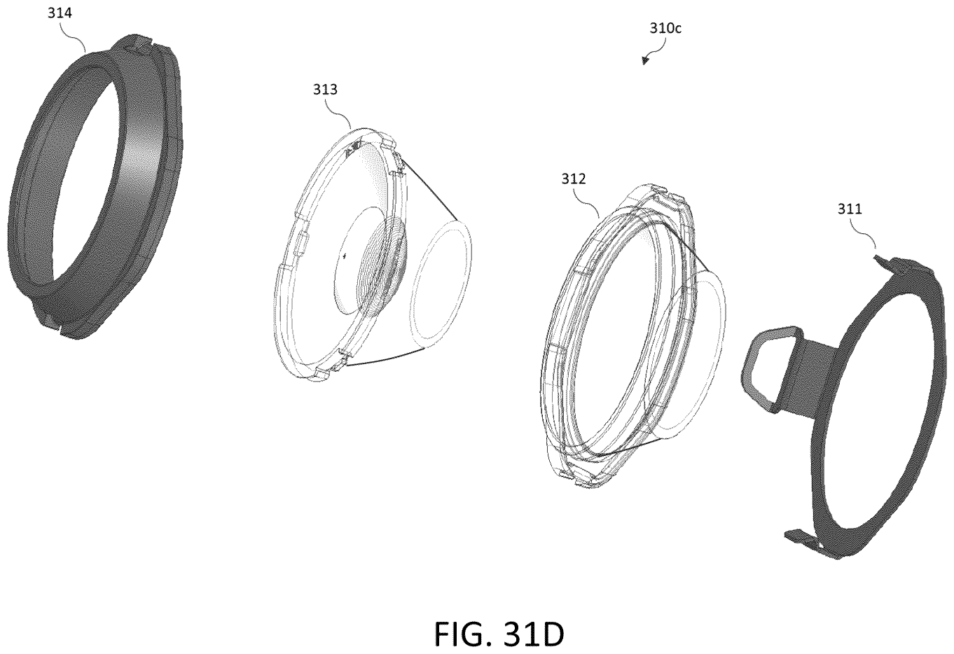

FIGS. 31A-31D show several views of the optical subassembly 310c for the lighting module 200c. The optical subassembly 310c may be the same or substantially similar to the optical subassembly 310a for the lighting module 200a. For brevity, repeated discussion of these components and/or features are not provided below unless indicated otherwise.

### 2.3 An Example Adjustable Lighting Module

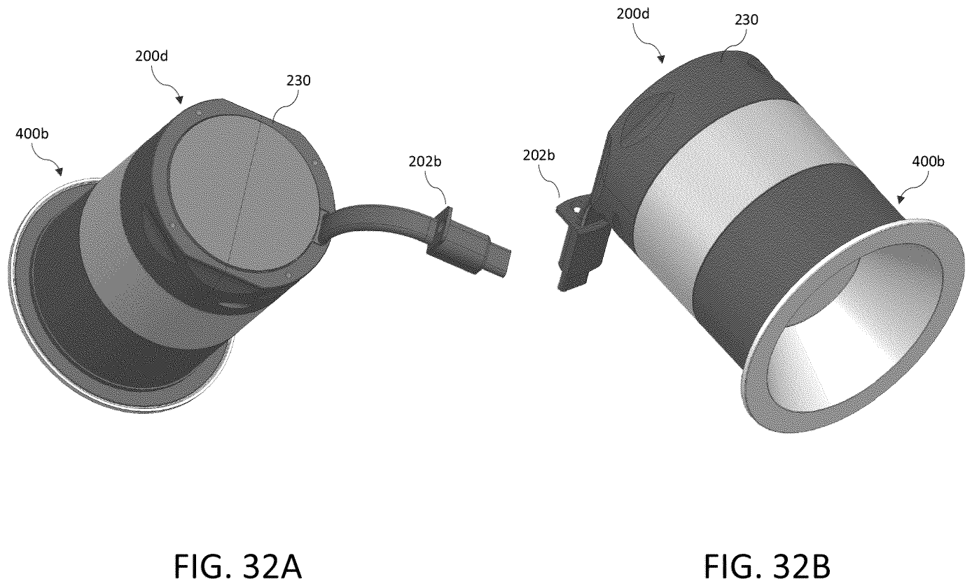

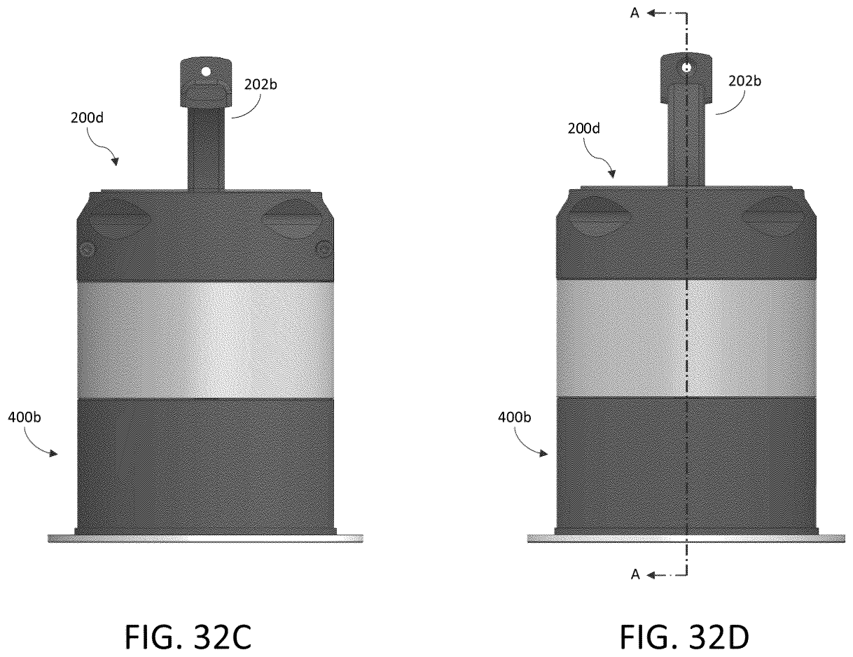

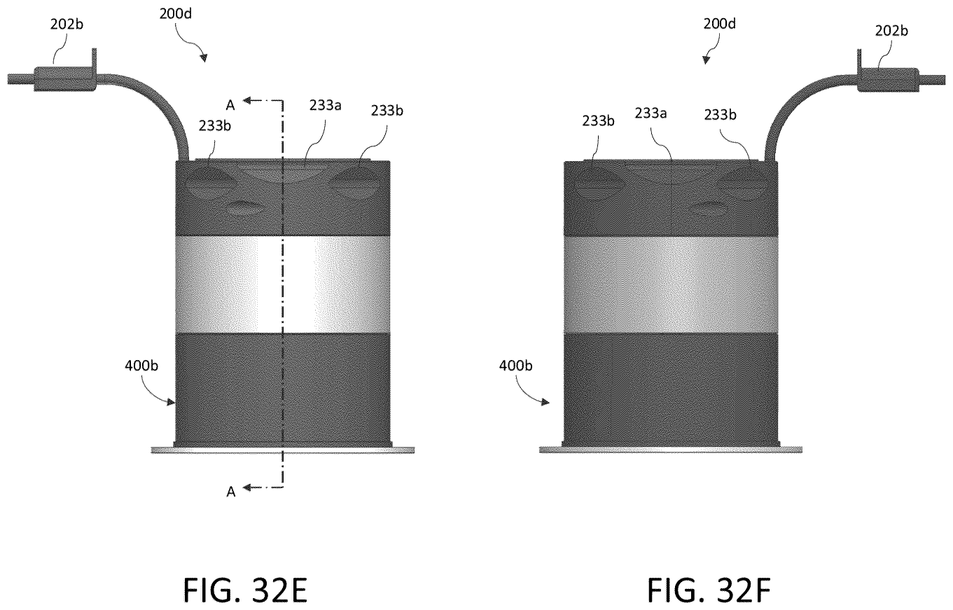

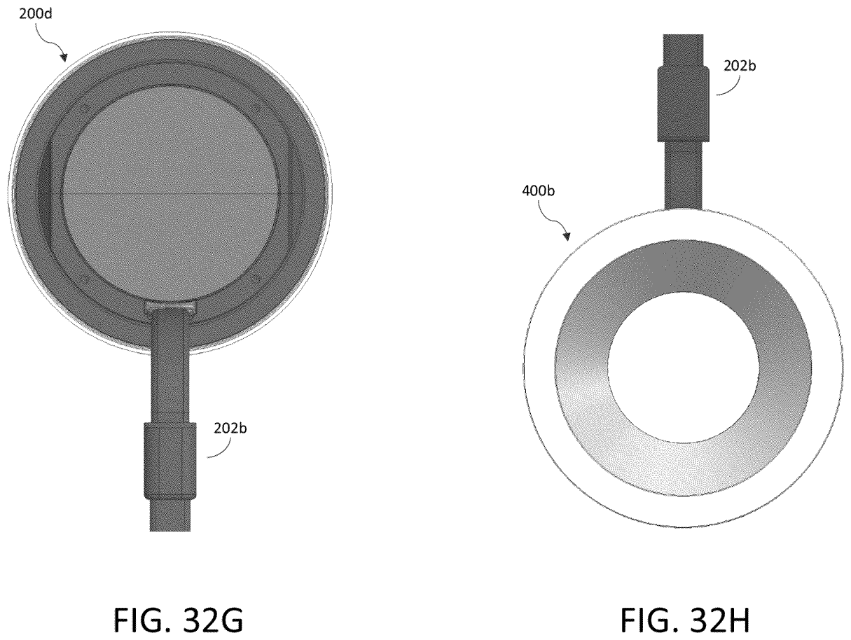

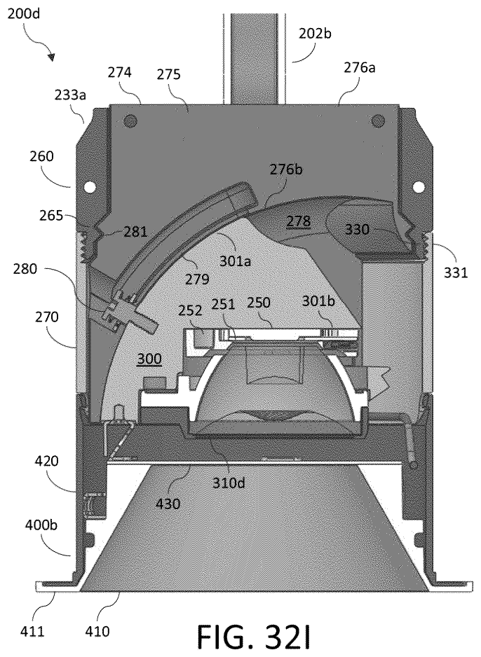

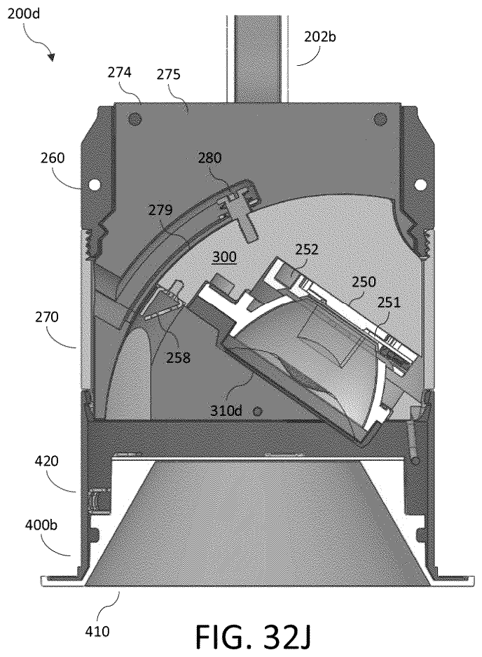

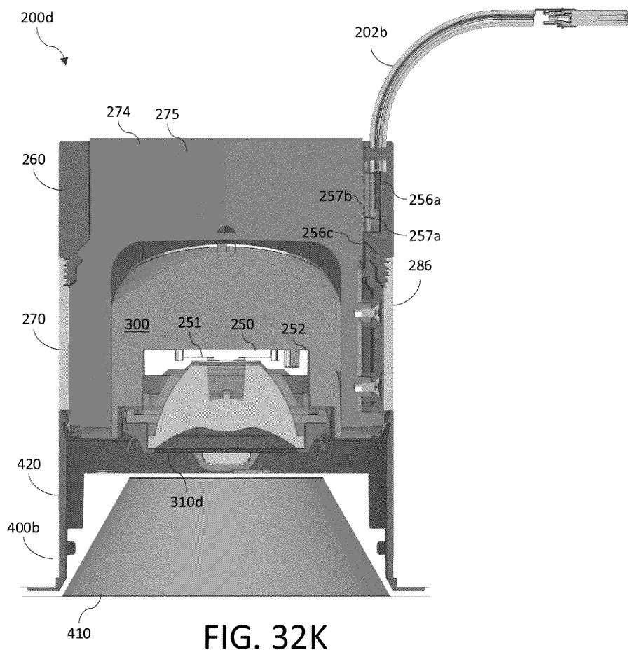

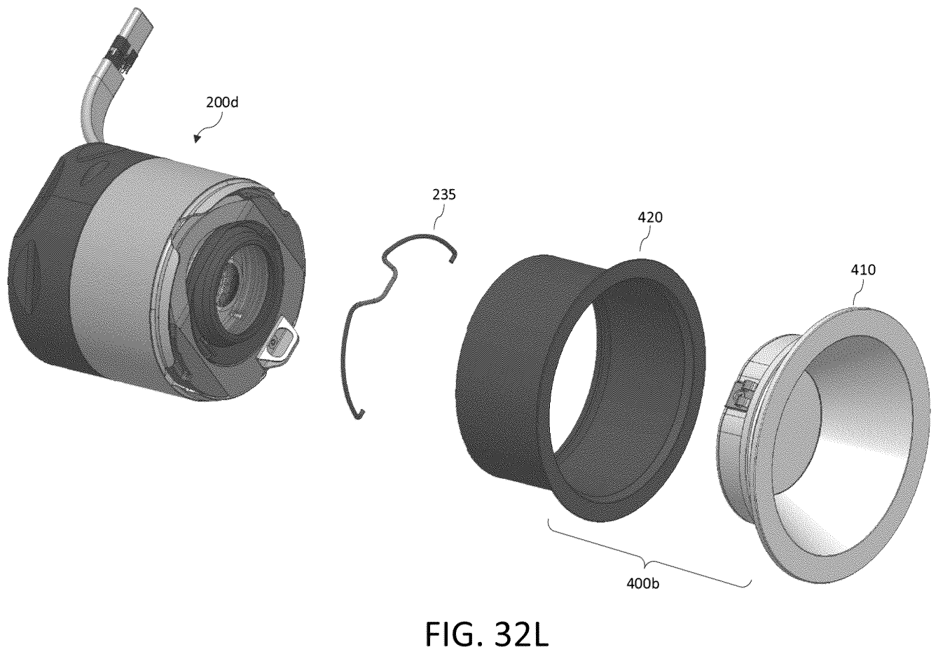

FIGS. 32A-32L show several views of a lighting module 200d configured as an adjustable module and the trim 400b mounted to the lighting module 200d. As shown, the lighting module 200d may include a module subassembly 230 and a cable 202b connected to the module subassembly 230, e.g., for connection with a driver subassembly (not shown).

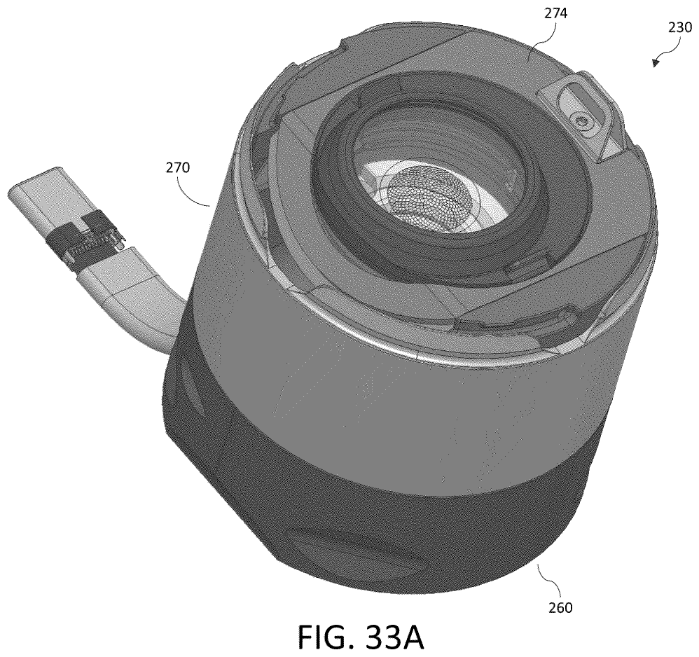

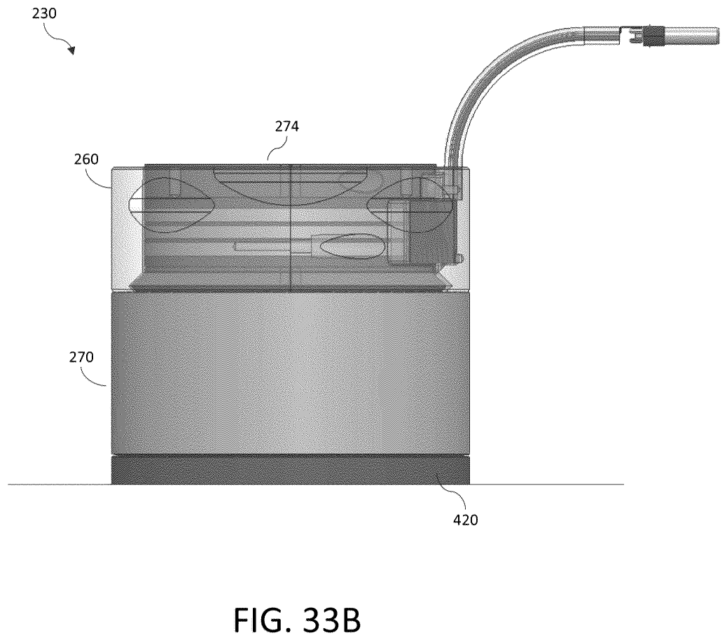

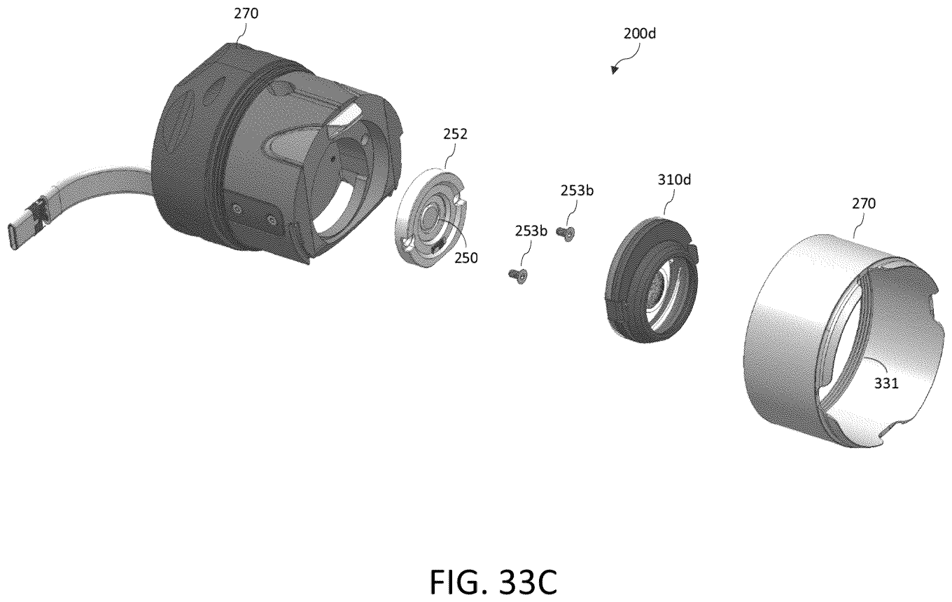

FIGS. 33A-33C show several views of the module subassembly 230 for the lighting module 200d. The lighting module 200d may incorporate one or more of the same components and/or features as the lighting modules 200a, 200b, and/or 200c. For brevity, repeated discussion of these components and/or features are not provided below unless indicated otherwise.

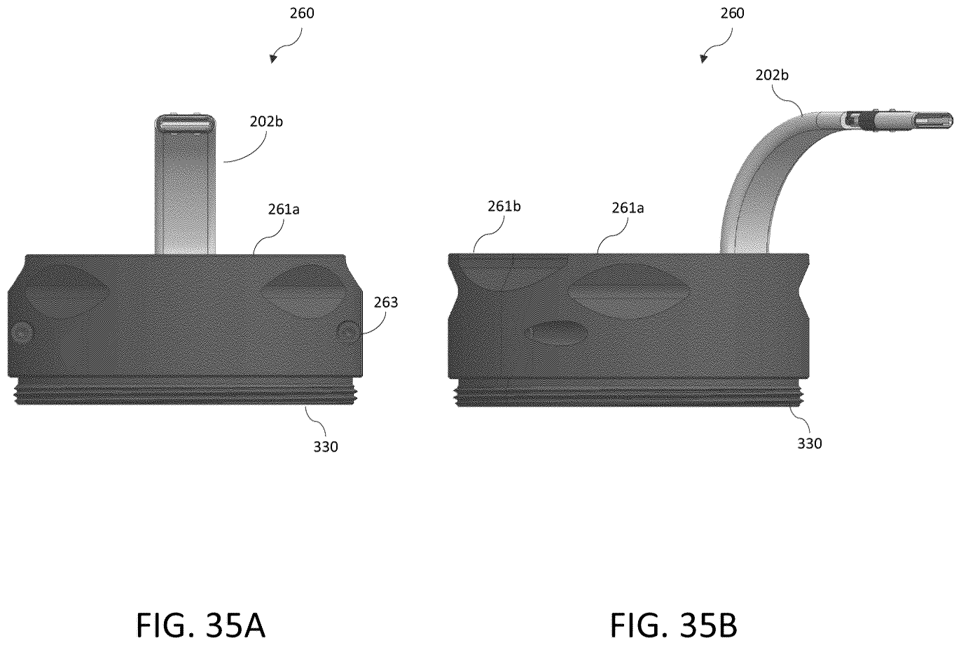

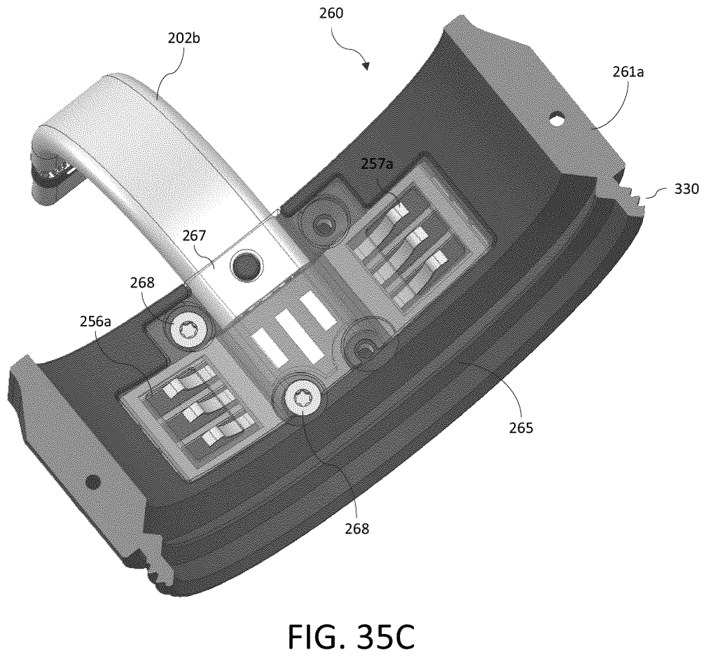

As shown, the module subassembly 230 may include a mount subassembly 260, a collar 270, and a core subassembly 274. The collar 270 may be securely coupled to the mount subassembly 260 and provide a snap-fit connector to facilitate coupling with the trim 400b. In this example, the collar 270 may be coupled to the mount subassembly 260 via a threaded connection. FIGS. 35A and 35B show the mount subassembly 260 may include threads 330 along the bottom, exterior end of the ring mounts 261a and 261b. The threads 330 may couple to corresponding threads 331 disposed on the top, interior end of the collar 270, as shown in FIG. 33C. The core subassembly 274 may be rotatably coupled to the mount subassembly 260, e.g., to rotate about an azimuthal axis.

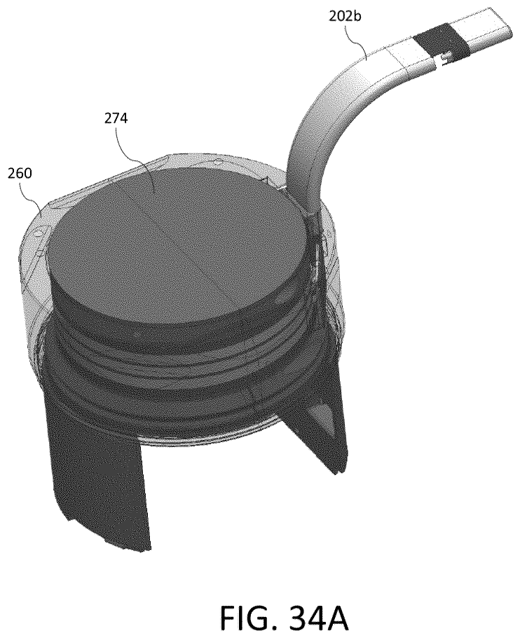

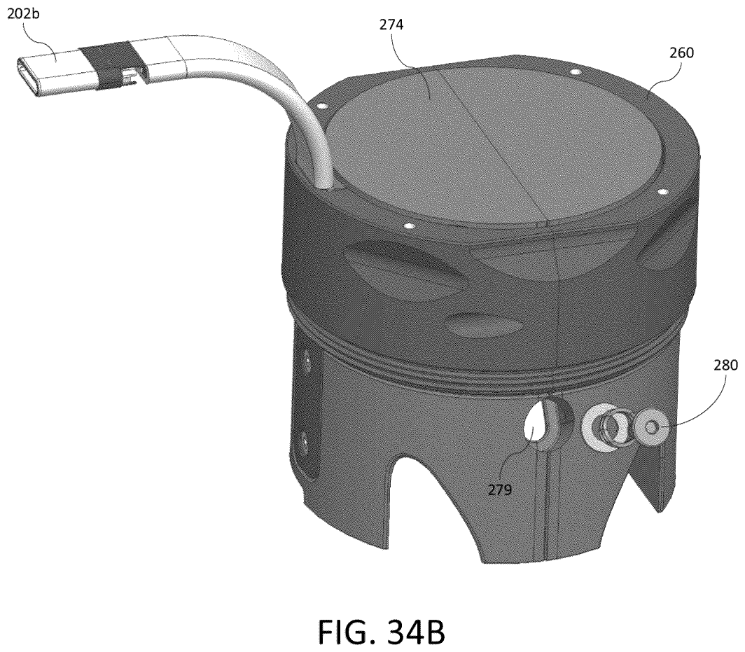

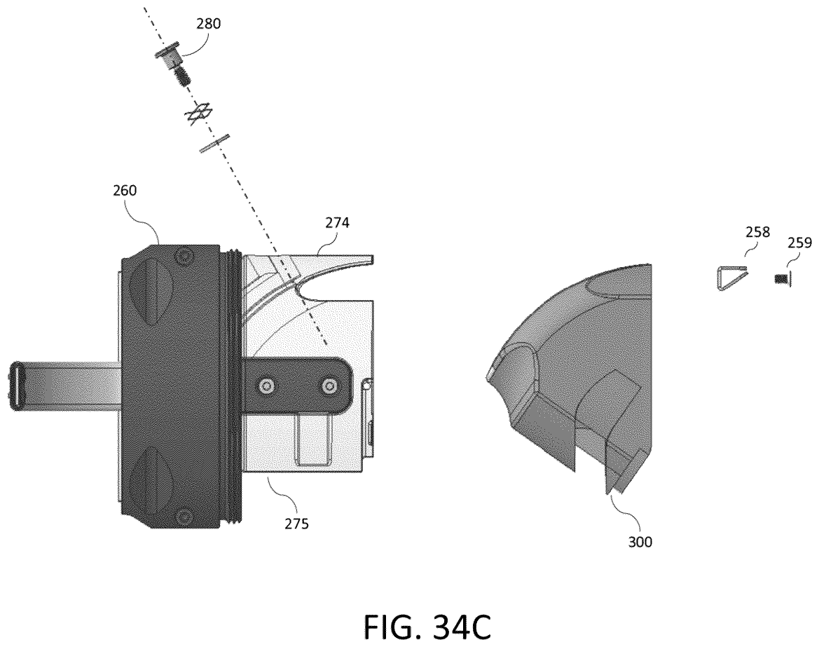

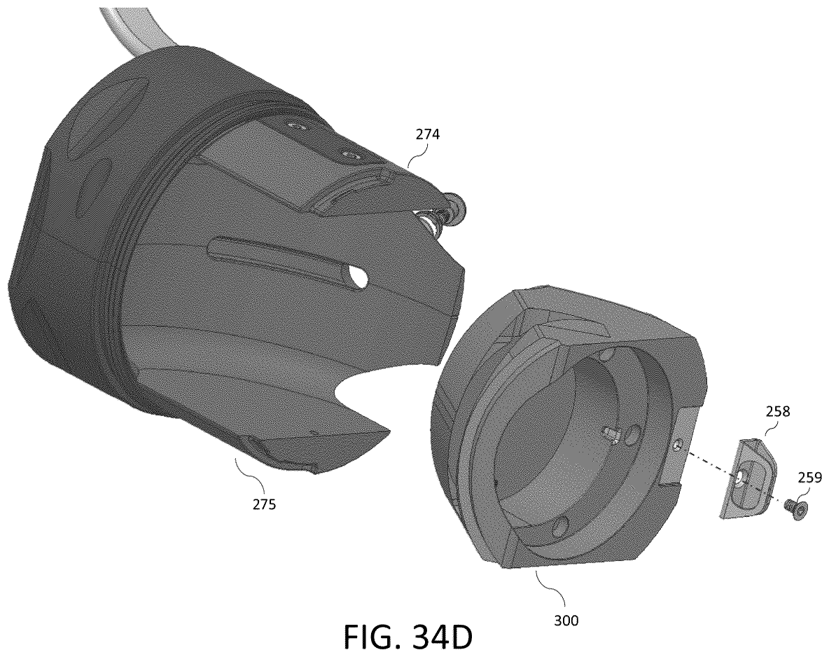

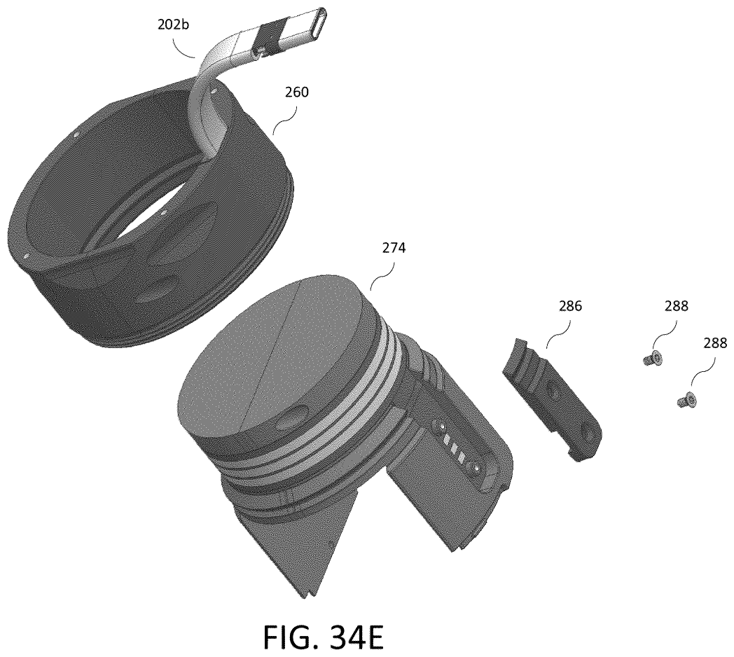

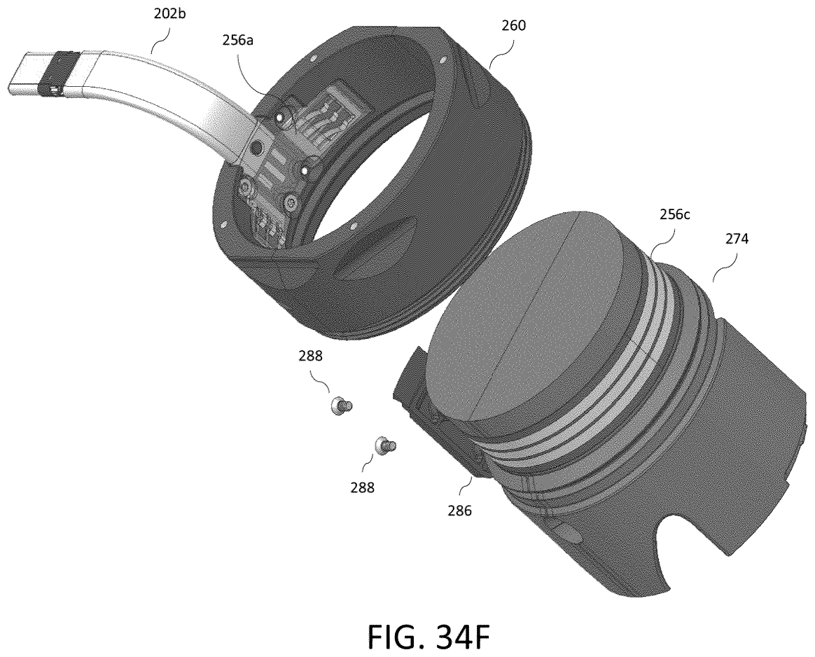

FIGS. 34A-34F show several views of the module subassembly 230 for the lighting module 200d with the collar 270 removed. As shown, the core subassembly 274 may include a core mount 275 and a head mount 300 rotatably coupled to the core mount 275 about a polar axis. The head mount 300, in turn, may support a light source 250, a PCB connector 251, a light source holder 252, and an optical subassembly 310d. In some implementations, the head mount 300 may include a handle 258 to facilitate rotational adjustment of the head mount 300.

FIGS. 35A-35C show several views of the mount subassembly 260. The mount subassembly 260 for the lighting module 200d may incorporate one or more of the same features as the mount subassembly 260 for the lighting module 200b. For brevity, repeated discussion of these features is not provided below unless indicated otherwise. As shown, the mount subassembly 260 may include ring mounts 261a and 261b coupled together via fasteners 263. The ring mounts 261a and 261b may together provide the elements 233a and 233b. Additionally, the ring mounts 261a and 261b may define the threads 330 for connection with the collar 270 and a track 265 to facilitate rotational movement of the core subassembly 274 with respect to the mount subassembly 260.

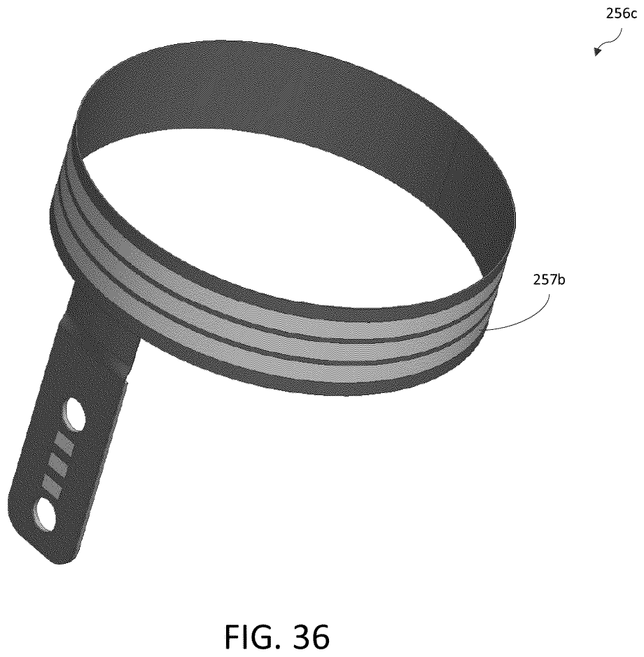

FIG. 36 shows a view of the wiring interface 256c. The wiring interface 256c may incorporate one or more of the same features of the wiring interface 256a. For brevity, repeated discussion of these features is not provided below unless indicated otherwise. Similar to the wiring interface 256b, the wiring interface 256c may include a ring portion supporting a plurality of contact pads 257b and a board portion to facilitate connection with a cable 202c. In this example, the board portion of the wiring interface 256c may not include a thermal cutoff switch.

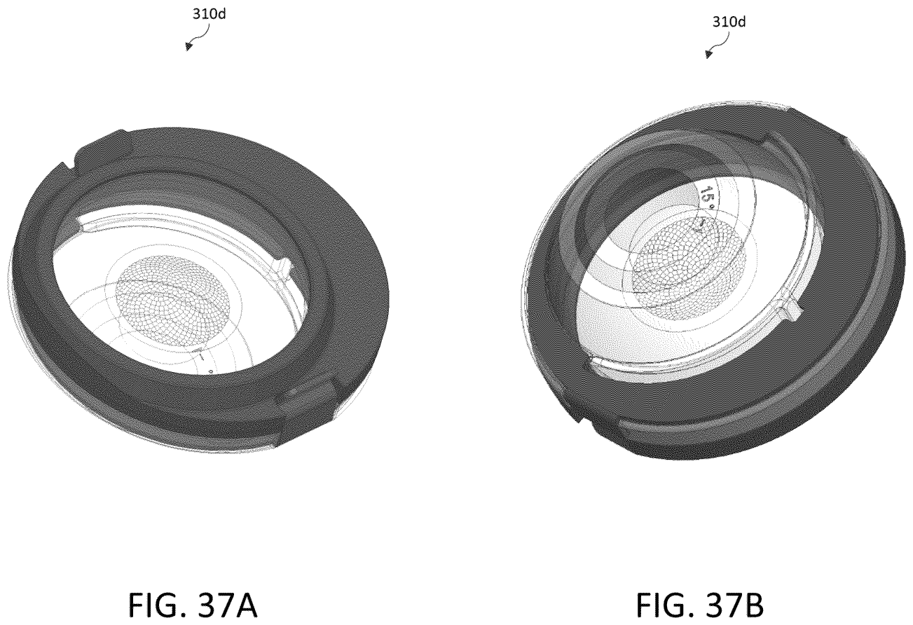

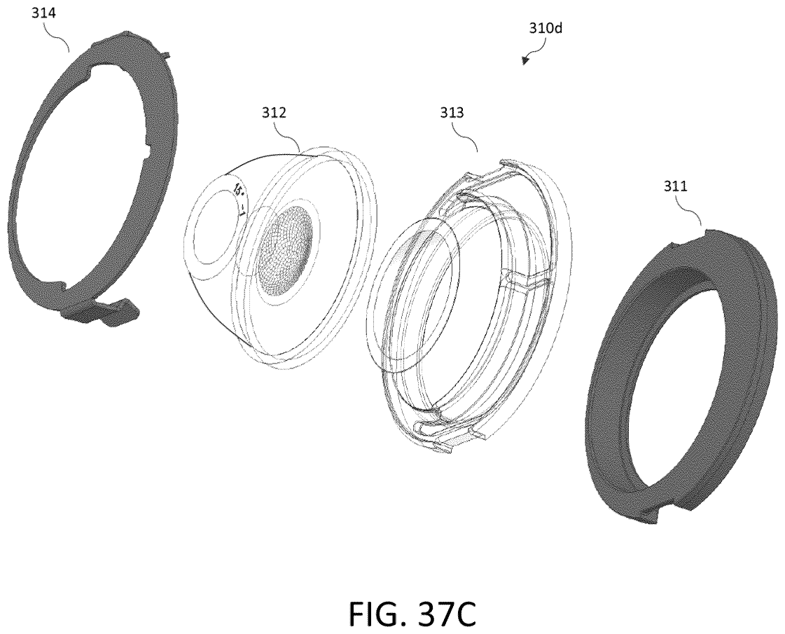

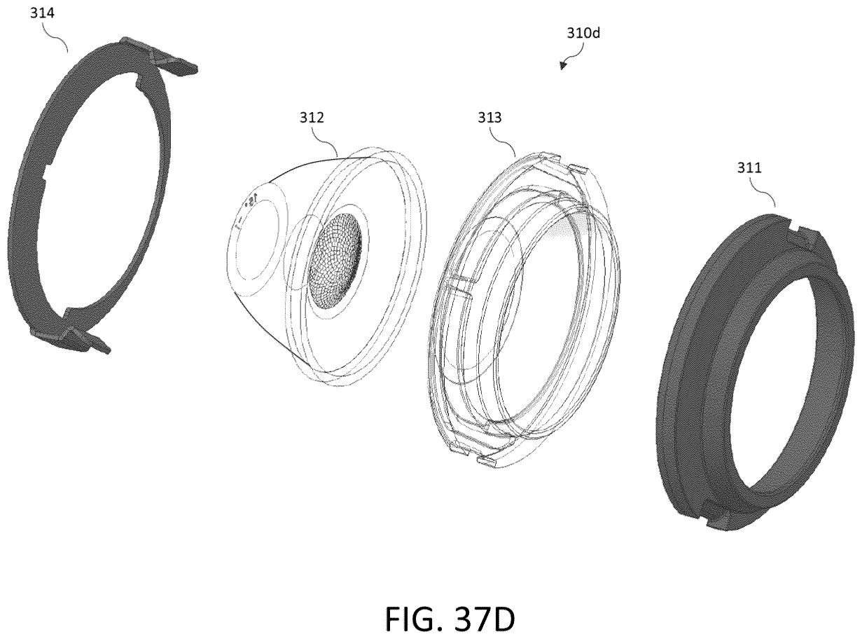

FIGS. 37A-37D show several views of the optical subassembly 310d for the lighting module 200d. The optical subassembly 310c may be the same or substantially similar to the optical subassembly 310b for the lighting module 200b. For brevity, repeated discussion of these components and/or features are not provided below unless indicated otherwise. In this example, the optical subassembly 310d may not include a lens 315.

### 2.4 An Example Trim

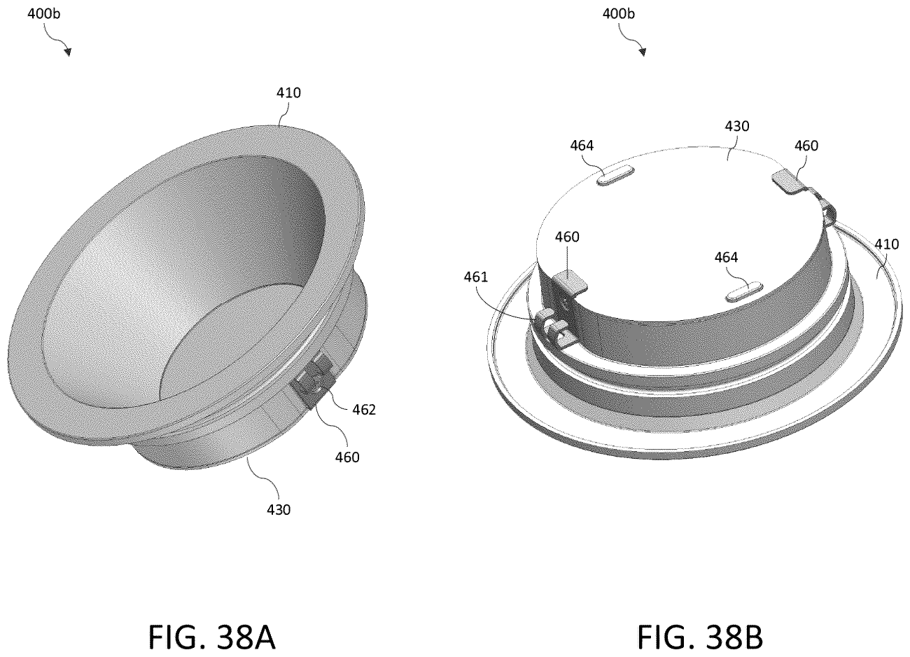

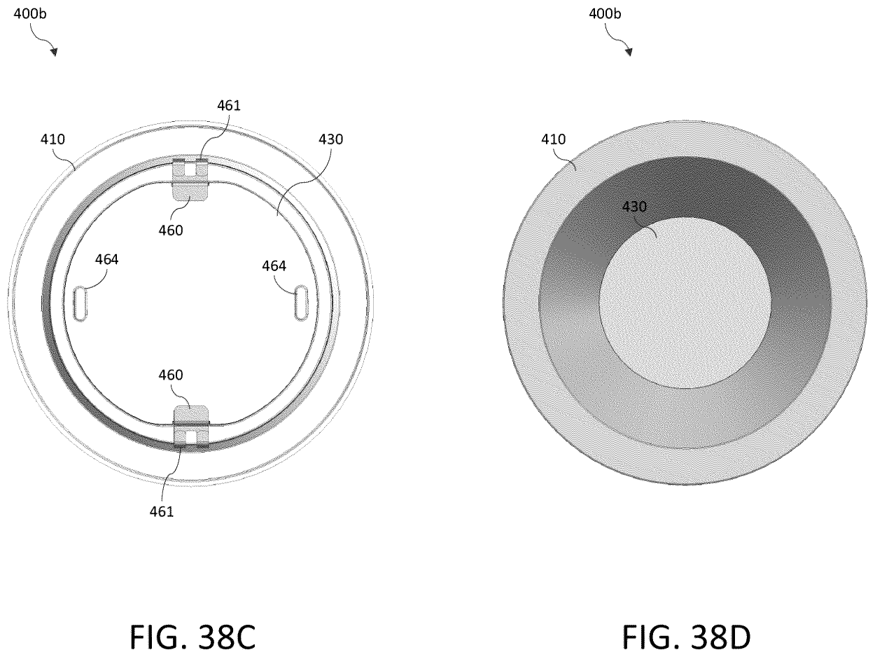

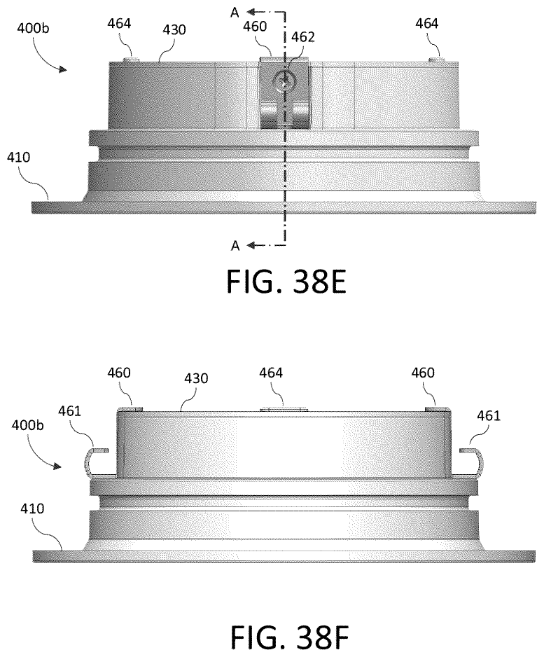

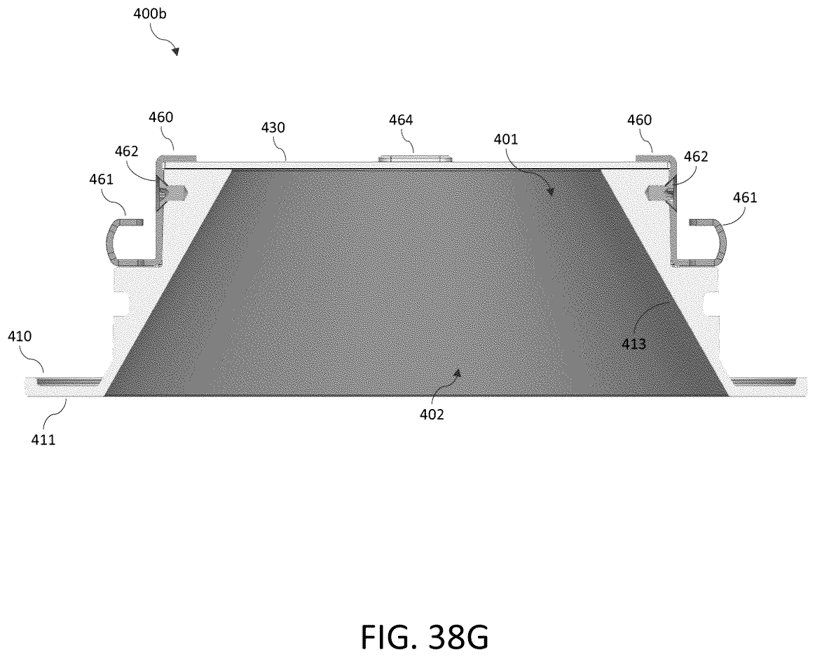

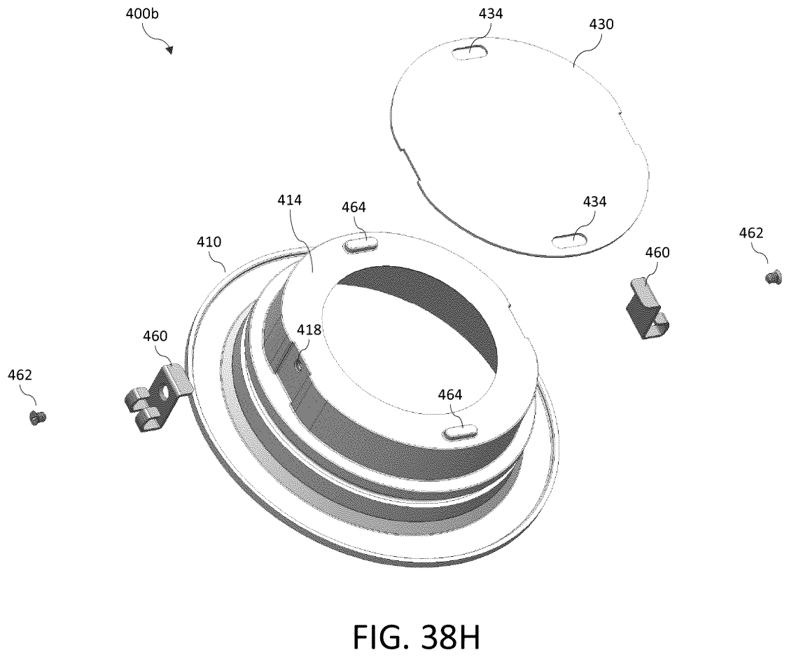

FIGS. 38A-38H show several views of the trim 400b. For clarity, the collar 420 is not shown. The trim 400b may incorporate one or more of the same features and/or components as the trim 400a. For brevity, repeated discussion of these components and/or features are not provided below unless indicated otherwise.

As shown, the trim 400b may include a flange component 410 and a lens 430 mounted to the mounting surface 414 of the flange component 410 via a pair of spring clips 460. Each spring clip 460 may be securely coupled to the flange component 410 via a fastener 462 inserted through a corresponding fastener opening on the spring clip 460 and the fastener opening 418 on the side of the flange component 410. In this manner, the spring clips 460 may clamp the lens 430 to the flange component 410.

In some implementations, the flange component 410 may include bumps 464 to facilitate alignment of the lens 430 to the mounting surface 414 during assembly. For example, FIG. 38H shows the flange component 410 may include a pair of bumps 464 disposed on the mounting surface 414. The lens 430 may include corresponding openings 434 shaped to allow the bumps 464 to pass through when the lens 430 is placed onto the mounting surface 414. During assembly, the lens 430 may be placed onto the mounting surface 414 with the bumps 464 protruding through corresponding openings 434. This, in turn, prevents the lens 430 from slidably moving along the mounting surface 414, particularly as the spring clips 460 are then attached to the flange component 410.

In some implementations, each spring clip 460 may further include a spring end 461 to couple the flange component 410 to the collar 420 (not shown). The spring end 461 may physically contact the interior surface of the collar 420, thus securely coupling the collar 420 to the flange component 410 via friction. The spring end 461 may provide some mechanical compliance to facilitate assembly. As shown in FIG. 38G, the spring clips 460 may be diametrically disposed about the apertures 401 and 402 of the flange component 410 with the respective spring ends 461 protruding laterally outward from the side of the crown 413.

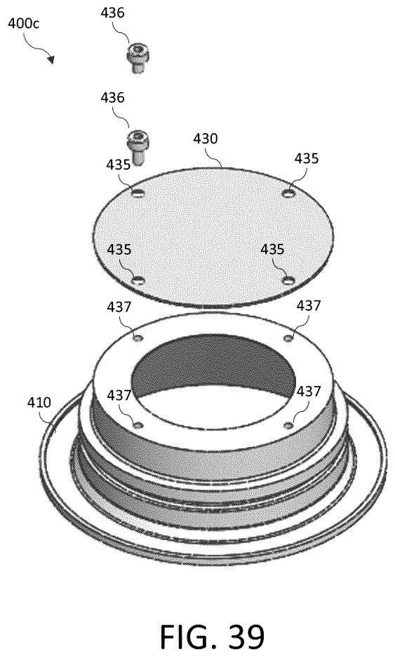

FIG. 39 shows another example trim 400c for the lighting apparatuses disclosed herein. For clarity, the collar 420 is not shown. The trim 400c may incorporate one or more of the same features and/or components as the trims 400a and/or 400b. For brevity, repeated discussion of these components and/or features are not provided below unless indicated otherwise. In this example, the lens 430 may be mounted to the flange component 410 via multiple fasteners 436. Specifically, each fastener 436 may be inserted through a corresponding fastener opening 435 on the lens 430 and a corresponding fastener opening 437 on the mounting surface 414 of the flange component 410.

The trims 400a, 400b, and 400c, as shown, provide a standard trim design, e.g., a trim with a round flange surrounding a frustoconical crown. As described in Section 1.4, it should be appreciated that the trims 400a, 400b, and 400c are non-limiting examples and that other trim designs are contemplated herein. FIGS. 40A-40D show additional examples of trims that may be readily used with the lighting apparatus 100a.

### 3. ADDITIONAL EXAMPLES OF SMALL APERTURE RECESSED LIGHTING APPARATUSES

In one example implementation, a housing assembly is disclosed to facilitate installation of a recessed lighting apparatus in a ceiling space where the housing assembly includes: a housing defining a cavity and an aperture to access the cavity; a heatsink subassembly disposed in the cavity of the housing and movably coupled to the housing along a vertical axis, the heatsink subassembly being configured to support a lighting module at least partially inserted through the aperture of the housing and a trim coupled to the lighting module; and a spring disposed in the cavity of the housing and coupled to the heatsink subassembly, the spring being configured to apply a force to cause the heatsink subassembly, the lighting module, and the trim to move vertically upward along the vertical axis until a portion of the trim physically contacts a bottom surface of a drywall enclosing the ceiling space.

The aperture may have a width ranging from about 1.8 inches to about 2.2 inches. The aperture may have a width equal to about 2 inches. The housing may have a height ranging from about 2.2 inches to about 2.8 inches. The housing may have a height equal to about 2.6 inches. The heatsink subassembly may have a range of travel along the vertical axis ranging from about 1 inch to about 1.25 inches. The heatsink subassembly may have a range of travel along the vertical axis equal to about 1.125 inches. The drywall may have a thickness ranging from about 0.5 inches to about 1.5 inches.

The housing may include a rail aligned to the vertical axis, the heatsink subassembly may be movably coupled to the rail, the spring may be a cantilever spring having one end directly coupled to the rail, and the cantilever spring may be partially disposed beneath the heatsink subassembly and physically contact a portion of the heatsink subassembly to directly apply the force causing the heatsink subassembly to move vertically upward. The cantilever spring may apply the force to the heatsink subassembly at any position of the heatsink subassembly along the rail. The heatsink subassembly may include a bushing, the cantilever spring may include a bump, and the heatsink subassembly may have a locked configuration whereby the heatsink subassembly is positioned along the rail such that the bump of the cantilever spring is disposed above and physically abuts the bushing of the heatsink subassembly thereby preventing vertical upward movement of the heatsink subassembly along the rail. The force may be a first force, and the locked configuration of the heatsink subassembly may be engaged by applying a second force to the heatsink subassembly to (A) move the heatsink subassembly vertically downward along the rail and (B) sufficiently deflect the cantilever spring to allow the bushing to move vertically downward past the bump of the cantilever spring. The force may be a first force, and the locked configuration of the heatsink subassembly may be disengaged by applying a second force to the heatsink subassembly to sufficiently deflect the cantilever spring to allow the bushing to move vertically upward past the bump of the cantilever spring. The heatsink subassembly may be movable along the rail from a first position proximate to the aperture to a second position distal to the aperture, and when the heatsink subassembly is in the locked configuration, the heatsink subassembly may be at the first position. The heatsink subassembly may include one or more handles to facilitate manual movement of the heatsink subassembly along the rail when the lighting module and the trim are not present.

The rail may be a first rail, the cantilever spring may be a first cantilever spring, the force may be a first force, the housing may further include a second rail, and the housing assembly may further include a second cantilever spring having one end directly coupled to the second rail, wherein the second cantilever spring is partially disposed beneath the heatsink subassembly and physically contacts a portion of the heatsink subassembly to apply a second force causing the heatsink subassembly to move vertically upward. The first cantilever spring and the second cantilever spring may be identical. The first cantilever spring may be disposed diametrically opposite to the second cantilever spring about the aperture.

The housing may include a rail aligned to the vertical axis, the heatsink subassembly may be movably coupled to the rail, the housing assembly may further include a scissor linkage having a first end coupled to the housing and a second end coupled to the heatsink subassembly, and the spring may be operably coupled to the scissor linkage, the spring applying the force to actuate the scissor linkage thereby causing the heatsink subassembly to move vertically upward.

The spring may be a first spring, the heatsink subassembly may include a second spring configured to mechanically couple the lighting module to the heatsink subassembly where the second spring may include an engagement portion configured to mechanically couple to a retaining portion of the lighting module and an end portion joined to the engagement portion, and deflection of the engagement portion of the second spring may cause the end portion of the second spring to translationally move. The housing may include a rail having an interior surface facing the end portion of the second spring where the rail includes a recessed portion located at a first position along the rail, when the end portion is at the first position along the rail, the end portion may have a first range of translational movement limited by physical contact with the recessed portion of the rail, when the end portion is at a second position along the rail different from the first position, the end portion may have a second range of translational movement limited by physical contact with the interior surface of the rail, the second range of translational movement being less than the first range of translational movement, the first range of translational movement may allow sufficient deflection of the engagement portion of the second spring to facilitate engagement of the second spring to the lighting module, and the second range of translational movement may limit deflection of the engagement portion of the second spring thereby preventing disengagement of the lighting module from the second spring. When the heatsink subassembly moves vertically upward away from the first position, the end portion of the second spring may slidably move along the interior surface of the rail. The heatsink subassembly may further include a bushing, the first spring may be a cantilever spring where the cantilever spring includes a bump, the heatsink subassembly may have a locked configuration whereby the heatsink subassembly is positioned along the rail such that the bump of the cantilever spring is disposed above and physically abuts the bushing of the heatsink subassembly thereby preventing vertical upward movement of the heatsink subassembly along the rail, and when the heatsink subassembly is in the locked configuration, the heatsink subassembly may be at the first position. The heatsink subassembly may further include a third spring identical to the second spring. The second spring may be disposed diametrically opposite to the third spring about the aperture.

The housing assembly may further include a wiring hub, disposed in the cavity of the housing, configured to electrically couple the lighting module to an external electrical system. The wiring hub may include a plurality of electrical connectors where each electrical connector of the plurality of electrical connectors is configured to receive an electrical wire from the external electrical system. The plurality of electrical connectors may include at least one of a poke-in connector, or a lever connector. The wiring hub may be configured to receive from the external electrical system at least one of electrical power, a control signal to adjust a brightness of light emitted by the lighting module, or a control signal to adjust a color of light emitted by the lighting module. The wiring hub may be removable from the housing through the aperture. The housing may include a plurality of knockouts, where each knockout of the plurality of knockouts is removable to allow an electrical wire from the external electrical system to be inserted into the cavity of the housing. The housing assembly may further include an electrical cable, disposed in the cavity of the housing, having a first end connected to the wiring hub and the second end having an electrical connector configured for connection with a corresponding electrical connector of the lighting module. The housing may include one or more dividers, disposed in the cavity of the housing, to divide the cavity into a wiring cavity containing the wiring hub and a heatsink cavity containing the heatsink subassembly and including the aperture. The housing assembly may further include a wire door plate, removably coupled to a bottom side of the housing, to provide access to the wiring cavity.

The housing assembly may further include a wire door subassembly disposed in the cavity of the housing adjacent to the one or more dividers where the wire door subassembly is movable between an open position and a closed position, wherein when the wire door subassembly is in the open position, the wiring cavity is accessible from the heatsink cavity through the aperture, and when the wire door subassembly is in the closed position, the wire door subassembly prevents access to the wiring cavity from the heatsink cavity. The spring may be a first spring and the force may be a first force, the wire door subassembly may include a second spring to apply a second force to move the wire door subassembly from the closed position to the open position, and a latch mechanism to maintain the wire door subassembly in the closed position where the latch mechanism, when actuated, allows the wire door subassembly to move from the closed position to the open position. The heatsink subassembly may be movable along the rail from a first position proximate to the aperture to a second position distal to the aperture, and the wire door subassembly may only be movable from the closed position to the open position when the heatsink subassembly is at the second position.

A recessed lighting apparatus may include the housing assembly as described above, a lighting module securely coupled to the heatsink subassembly of the housing assembly, and a trim securely coupled to the lighting module. The lighting module may be a downlight module. The lighting module may emit light along an optical axis, and the optical axis may be fixed in a set direction. The lighting module may be an adjustable module. The lighting module may emit light along an optical axis, and the optical axis may be rotatable about at least one axis. The optical axis may be rotatable about a first axis and a second axis orthogonal to the first axis. The lighting module may include: a module subassembly including a light source to emit light; a driver subassembly, electrically coupled to the module subassembly, to provide at least electrical power to the light source; and an electrical connector electrically, coupled to the driver subassembly, to receive at least the electrical power from an external electrical system. The lighting module may be fully disposed in the cavity of the housing. The module subassembly may have a height ranging from about 1.9 inches to about 2.2 inches. The module subassembly may have a height equal to about 2 inches. The module subassembly may have a width ranging from about 1.9 inches to about 2.2 inches. The module subassembly may have a width equal to about 2 inches. The driver subassembly may include an alternating current (AC) to direct current (DC) converter. The module subassembly may further include a module housing defining a module cavity and an opening where the module cavity contains the light source, and an optical subassembly, removably coupled to the module housing and covering the opening of the module housing, to redirect the light emitted by the light source. The module housing may include one or more retaining portions, the spring may be a first spring, and the heatsink subassembly of the housing assembly may include a second spring to mechanically couple the lighting module to the heatsink subassembly where the second spring includes an engagement portion to mechanically couple to one retaining portion of the one or more retaining portions via a snap-fit connection, and an end portion joined to the engagement portion.

In yet another example implementation, a housing assembly to facilitate installation of a recessed lighting apparatus in a ceiling space includes a housing defining a cavity and an aperture to access the cavity, a heatsink subassembly disposed in the cavity of the housing, and a wiring hub, disposed in the cavity of the housing, configured to electrically couple the lighting module to an external electrical system, where the wiring hub is removable from the housing through the aperture.

The housing may comprise one or more dividers, disposed in the cavity of the housing, to divide the cavity into a wiring cavity containing the wiring hub and a heatsink cavity containing the heatsink subassembly and including the aperture, and the housing assembly may further comprise a wire door subassembly disposed in the cavity of the housing adjacent to the one or more dividers where the wire door subassembly is movable between an open position and a closed position, when the wire door subassembly is in the open position, the wiring cavity is accessible from the heatsink cavity through the aperture, and when the wire door subassembly is in the closed position, the wire door subassembly prevents access to the wiring cavity from the heatsink cavity.

In another example implementation, a method is disclosed for installing a lighting module and a trim into a housing assembly of a recessed lighting apparatus. The housing assembly is disposed in a ceiling space enclosed by a drywall, and the housing assembly includes a housing defining a cavity and an aperture to access the cavity, a heatsink subassembly disposed in the cavity of the housing and movably coupled to the housing, and a spring disposed in the cavity of the housing and coupled to the heatsink subassembly. The method includes the following steps: (A) coupling the trim directly to a module subassembly of the lighting module; (B) inserting at least a portion of the module subassembly into the cavity of the housing assembly through the aperture; (C) coupling the module subassembly to a heatsink subassembly of the housing assembly, the heatsink subassembly being in a locked configuration whereby the heatsink subassembly is prevented from moving vertically upward within the cavity of the housing assembly; and (D) disengaging the heatsink subassembly from the locked configuration thereby allowing a spring of the housing assembly to move the heatsink subassembly, the lighting module, and the trim vertically upward until a portion of the trim physically contacts a bottom surface of the drywall.

The method may further include, before at least partially inserting the module subassembly into the cavity of the housing assembly, connecting an electrical connector of the lighting module to a corresponding electrical connector of the housing assembly, and inserting the electrical connector of the lighting module and a driver subassembly of the lighting module into the cavity of the housing assembly. The method may further include, before at least partially inserting the module subassembly into the cavity of the housing assembly, moving the heatsink subassembly vertically downward to engage the locked configuration of the heatsink subassembly. The spring may be a first spring, and coupling the module subassembly to the heatsink subassembly of the housing assembly may include applying a force to one of the module subassembly or the trim to actuate a second spring of the heatsink subassembly so as to mechanically couple the module subassembly to the second spring. The heatsink subassembly may include a bushing, the spring may include a bump, in the locked configuration, the heatsink subassembly may be positioned along the rail such that the bump of the cantilever spring is disposed above and physically abuts the bushing of the heatsink subassembly thereby preventing vertical upward movement of the heatsink subassembly along the rail, and disengaging the heatsink subassembly from the locked configuration may include applying a force to one of the module subassembly or the trim to cause the heatsink subassembly to sufficiently deflect the spring thereby allowing the bushing to move vertically upward past the bump of the spring.

### 4. CONCLUSION

All parameters, dimensions, materials, and configurations described herein are meant to be example and the actual parameters, dimensions, materials, and/or configurations will depend upon the specific application or applications for which the inventive teachings is/are used. It is to be understood that the foregoing embodiments are presented primarily by way of example and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein.

In addition, any combination of two or more such features, systems, articles, materials, kits, and/or methods, if such features, systems, articles, materials, kits, and/or methods are not mutually inconsistent, is included within the inventive scope of the present disclosure. Other substitutions, modifications, changes, and omissions may be made in the design, operating conditions and arrangement of respective elements of the example implementations without departing from the scope of the present disclosure. The use of a numerical range does not preclude equivalents that fall outside the range that fulfill the same function, in the same way, to produce the same result.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All publications, patent applications, patents, and other references mentioned herein are incorporated by reference in their entirety.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/of” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “of” or “and/of” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A housing assembly to facilitate installation of a recessed lighting apparatus in a ceiling space, the housing assembly comprising:
a housing defining a cavity and an aperture to access the cavity;
a heatsink subassembly disposed in the cavity of the housing and movably coupled to the housing along a vertical axis when the housing assembly is installed in the ceiling space, the heatsink subassembly being configured to support a lighting module when the lighting module is at least partially inserted through the aperture of the housing and a trim coupled to the lighting module; and
a spring disposed in the cavity of the housing and coupled to the heatsink subassembly, the spring being configured to apply a force to cause the heatsink subassembly, the lighting module, and the trim to move vertically upward along the vertical axis until a portion of the trim physically contacts a bottom surface of a drywall enclosing the ceiling space when the lighting module is at least partially inserted through the aperture.

2. The housing assembly of claim 1, wherein the aperture has a width ranging from about 1.8 inches to about 2.2 inches.

3. The housing assembly of claim 1, wherein the heatsink subassembly has a range of travel along the vertical axis ranging from about 1 inch to about 1.25 inches.

4. The housing assembly of claim 3, wherein the range of travel of the heatsink subassembly along the vertical axis accommodates the drywall having a thickness ranging from about 0.5 inches to about 1.5 inches.

5. The housing assembly of claim 1, wherein:
the housing comprises a rail aligned to the vertical axis;
the heatsink subassembly is movably coupled to the rail;
the spring is a cantilever spring having one end directly coupled to the rail; and
the cantilever spring physically contacts a bottom portion of the heatsink subassembly to directly apply the force causing the heatsink subassembly to move vertically upward along the vertical axis.

6. The housing assembly of claim 5, wherein the cantilever spring applies the force to move the heatsink subassembly vertically upward along the vertical axis when the heatsink subassembly is at any position along the rail.

7. The housing assembly of claim 5, wherein:
the heatsink subassembly comprises a bushing;
the cantilever spring comprises a bump; and
the heatsink subassembly has a locked configuration whereby the heatsink subassembly is positioned along the rail such that the bump of the cantilever spring is disposed above and physically abuts the bushing of the heatsink subassembly thereby preventing vertical upward movement of the heatsink subassembly along the vertical axis.

8. The housing assembly of claim 7, wherein:
the force is a first force;
the locked configuration of the heatsink subassembly is engaged by applying a second force to the heatsink subassembly to (A) move the heatsink subassembly vertically downward along the rail and (B) sufficiently deflect the cantilever spring to allow the bushing to move vertically downward past the bump of the cantilever spring; and
the locked configuration of the heatsink subassembly is disengaged by applying a third force to the heatsink subassembly to sufficiently deflect the cantilever spring to allow the bushing to move vertically upward past the bump of the cantilever spring.

9. The housing assembly of claim 1, wherein:
the spring is a first spring;
the heatsink subassembly comprises:
a second spring configured to mechanically couple the lighting module to the heatsink subassembly, the second spring comprising:
an engagement portion configured to mechanically couple to a retaining portion of the lighting module; and
an end portion joined to the engagement portion; and
deflection of the engagement portion of the second spring causes the end portion of the second spring to translationally move.

10. The housing assembly of claim 9, wherein:
the housing comprises a rail having an interior surface facing the end portion of the second spring, the rail comprising:
a recessed portion located at a first position along the rail;
when the end portion is at the first position along the rail, the end portion has a first range of translational movement limited by physical contact with the recessed portion of the rail;
when the end portion is at a second position along the rail different from the first position, the end portion has a second range of translational movement limited by physical contact with the interior surface of the rail, the second range of translational movement being less than the first range of translational movement;
the first range of translational movement allows sufficient deflection of the engagement portion of the second spring to facilitate engagement of the second spring to the lighting module; and
the second range of translational movement limits deflection of the engagement portion of the second spring thereby preventing disengagement of the lighting module from the second spring.

11. The housing assembly of claim 10, wherein:
the heatsink subassembly further comprises a bushing;
the first spring is a cantilever spring, the cantilever spring comprising a bump;
the heatsink subassembly has a locked configuration whereby the heatsink subassembly is positioned along the rail such that the bump of the cantilever spring is disposed above and physically abuts the bushing of the heatsink subassembly thereby preventing vertical upward movement of the heatsink subassembly along the vertical axis; and
when the heatsink subassembly is in the locked configuration, the heatsink subassembly is at the first position.

12. The housing assembly of claim 1, further comprising:
a wiring hub, disposed in the cavity of the housing, configured to electrically couple the lighting module to an external electrical system,
wherein the wiring hub is removable from the housing through the aperture.

13. The housing assembly of claim 12, wherein the wiring hub comprises:
a plurality of electrical connectors, each electrical connector of the plurality of electrical connectors configured to receive an electrical wire from the external electrical system, the plurality of electrical connectors comprising at least one of a poke-in connector, or a lever connector.

14. The housing assembly of claim 12, further comprising:
an electrical cable, disposed in the cavity of the housing, having a first end connected to the wiring hub and a second end having an electrical connector configured for connection with a corresponding electrical connector of the lighting module.

15. The housing assembly of claim 12, wherein:
the housing comprises:
one or more dividers, disposed in the cavity of the housing, to divide the cavity into a wiring cavity containing the wiring hub and a heatsink cavity containing the heatsink subassembly and including the aperture; and
the housing assembly further comprises:
a wire door subassembly disposed in the cavity of the housing adjacent to the one or more dividers, the wire door subassembly being movable between an open position and a closed position,
wherein:
when the wire door subassembly is in the open position, the wiring cavity is accessible from the heatsink cavity through the aperture; and
when the wire door subassembly is in the closed position, the wire door subassembly prevents access to the wiring cavity from the heatsink cavity.

16. A recessed lighting apparatus, comprising:
the housing assembly of claim 1;
a lighting module securely coupled to the heatsink subassembly of the housing assembly; and
a trim securely coupled to the lighting module.

17. The recessed lighting apparatus of claim 16, wherein:
the lighting module comprises:
a module housing defining a module cavity and an opening, the module housing comprising one or more retaining portions; and
a light source to emit light through the opening;
the spring is a first spring; and
the heatsink subassembly of the housing assembly comprises:
a second spring to mechanically couple the lighting module to the heatsink subassembly, the second spring comprising:
an engagement portion to mechanically couple to one retaining portion of the one or more retaining portions via a snap-fit connection; and
an end portion joined to the engagement portion.

18. A housing assembly for a recessed lighting apparatus, the housing assembly comprising:
a housing defining a cavity and an aperture to access the cavity, the housing comprising:
a rail;
a heatsink subassembly disposed in the cavity of the housing and slidably coupled to the rail, the heatsink subassembly being configured to support a lighting module and a trim; and
a cantilever spring directly coupled to the rail, the cantilever spring physically contacting a bottom portion of the heatsink subassembly and configured to apply a force causing the heatsink subassembly, the lighting module, and the trim to move along the rail when the lighting module is coupled to the heatsink subassembly.

19. The housing assembly of claim 18, wherein:
the heatsink subassembly comprises a bushing;
the cantilever spring comprises a bump;
the heatsink subassembly has a locked configuration whereby the heatsink subassembly is positioned along the rail such that the bump of the cantilever spring is disposed above and physically abuts the bushing of the heatsink subassembly thereby preventing vertical upward movement of the heatsink subassembly along the rail;
the force is a first force;
the locked configuration of the heatsink subassembly is engaged by applying a second force to the heatsink subassembly to (A) move the heatsink subassembly vertically downward along the rail and (B) sufficiently deflect the cantilever spring to allow the bushing to move vertically downward past the bump of the cantilever spring; and
the locked configuration of the heatsink subassembly is disengaged by applying a third force to the heatsink subassembly to sufficiently deflect the cantilever spring to allow the bushing to move vertically upward past the bump of the cantilever spring.

20. A housing assembly to facilitate installation of a recessed lighting apparatus in a ceiling space, the housing assembly comprising:
a housing defining a cavity and an aperture to access the cavity;
a heatsink subassembly disposed in the cavity of the housing and movably coupled to the housing along a vertical axis when the housing assembly is installed in the ceiling space, the heatsink subassembly being configured to support a lighting module when the lighting module is at least partially inserted through the aperture of the housing and a trim coupled to the lighting module; and
a spring disposed in the cavity of the housing and coupled to the heatsink subassembly, the spring being configured to apply a force to cause the heatsink subassembly, the lighting module, and the trim to move vertically upward along the vertical axis until a portion of the trim physically contacts a bottom surface of a drywall enclosing the ceiling space when the lighting module is at least partially inserted through the aperture,
wherein:
the aperture has a width ranging from about 1.8 inches to about 2.2 inches;
the housing has a height ranging from about 2.2 inches to about 2.8 inches; and
the heatsink subassembly has a range of travel along the vertical axis ranging from about 1 inch to about 1.25 inches.
